(19) United States
(12) Patent Application Publication
(10) Pub. No.: US 2014/0122262 A1
(43) Pub. Date: May 1, 2014

(54) Food Supply Chain Automation Residential Food Management Interface Information System And Method

(71) Applicant: ELWHA LLC, Bellevue, WA (US)

(72) Inventors: Edward K.Y. Jung, Bellevue, WA (US); Royce A. Levien, Lexington, MA (US); Mark A. Malamud, Seattle, WA (US)

(73) Assignee: ELWHA LLC, Bellevue, WA (US)

(21) Appl. No.: 13/785,690

(22) Filed: Mar. 5, 2013

Related U.S. Application Data
(63) Continuation-in-part of application No. 13/755,308, filed on Jan. 31, 2013.
Application No. 13/755,308 is a continuation of application No. 13/755,095, filed on Jan. 31, 2013.
Application No. 13/755,095 is a continuation-in-part of application No. 13/724,062, filed on Dec. 21, 2012.
Application No. 13/724,062 is a continuation of application No. 13/721,558, filed on Dec. 20, 2012.
Application No. 13/721,558 is a continuation-in-part of application No. 13/721,357, filed on Dec. 20, 2012.
Application No. 13/721,357 is a continuation of application No. 13/715,309, filed on Dec. 14, 2012.
Application No. 13/715,309 is a continuation-in-part of application No. 13/720,572, filed on Dec. 19, 2012.
Application No. 13/720,572 is a continuation of application No. 13/709,831, filed on Dec. 10, 2012.
Application No. 13/709,831 is a continuation-in-part of application No. 13/687,382, filed on Nov. 28, 2012.
Application No. 13/687,382 is a continuation of application No. 13/682,939, filed on Nov. 21, 2012.
Application No. 13/682,939 is a continuation-in-part of application No. 13/669,018, filed on Nov. 5, 2012.
Application No. 13/669,018 is a continuation of application No. 13/668,977, filed on Nov. 5, 2012.
Application No. 13/668,977 is a continuation-in-part of application No. 13/663,137, filed on Oct. 29, 2012.
Application No. 13/663,137 is a continuation of application No. 13/663,095, filed on Oct. 29, 2012.
Application No. 13/663,095 is a continuation-in-part of application No. 13/771,664, filed on Feb. 20, 2013.
Application No. 13/771,664 is a continuation of application No. 13/771,506, filed on Feb. 20, 2013.
Application No. 13/771,506 is a continuation of application No. 13/785,283, filed on Mar. 5, 2013.

(51) Int. Cl. G06Q 50/12; G06Q 10/00

(52) U.S. Cl. CPC G06Q 50/12; G06Q 10/00
USPC 705/15

(57) ABSTRACT

A computationally implemented system and method that is designed to, but is not limited to: electronically transmitting one or more residential food management information requests associated with at least in part one or more food related residential conditions affecting residential service of one or more residential food items; and electronically receiving, subsequent to said electronically transmitting, at least a portion of residential food management response information associated with at least in part one or more food related residential conditions affecting residential service of one or more residential food items, said residential food management response information including description logged as accessible through one or more physical accessories and including description of said one or more physical accessories as at least temporarily near to one or more food items. In addition to the foregoing, other method aspects are described in the claims, drawings, and text forming a part of the present disclosure.

### CROSS-REFERENCE TO RELATED APPLICATIONS

The present application is related to and/or claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)). In addition, the present application is related to the “Related Applications,” if any, listed below.

### PRIORITY APPLICATIONS

For purposes of the USPTO extra-statutory requirements, the present application constitutes a continuation-in-part of U.S. patent application Ser. No. 13/771,664, entitled FOOD SUPPLY CHAIN AUTOMATION RESIDENTIAL INFORMATION SYSTEM AND METHOD, naming Edward K. Y. Jung, Royce A. Levien, and Mark A. Malamud as inventors, filed 20 Feb. 2013 with attorney docket no. 0712-003-009-C00001, which is currently co-pending or is an application of which a currently co-pending application is entitled to the benefit of the filing date, and which is a continuation of U.S. patent application Ser. No. 13/771,506, entitled FOOD SUPPLY CHAIN AUTOMATION RESIDENTIAL INFORMATION SYSTEM AND METHOD, naming Edward K. Y. Jung, Royce A. Levien, and Mark A. Malamud as inventors, filed 20 Feb. 2013 with attorney docket no. 0712-003-009-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/755,308, entitled FOOD SUPPLY CHAIN AUTOMATION GROCERY OPERATIONS INTERFACE INFORMATION SYSTEM AND METHOD, naming Edward K. Y. Jung, Royce A. Levien, and Mark A. Malamud as inventors, filed 31 Jan. 2013 with attorney docket no. 0712-003-008-000001, which is currently co-pending or is an application of which a currently co-pending application is entitled to the benefit of the filing date, and which is a continuation of U.S. patent application Ser. No. 13/755,095, entitled FOOD SUPPLY CHAIN AUTOMATION GROCERY OPERATIONS INTERFACE INFORMATION SYSTEM AND METHOD, naming Edward K. Y. Jung, Royce A. Levien, and Mark A. Malamud as inventors, filed 31 Jan. 2013 with attorney docket no. 0712-003-008-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/724,062, entitled FOOD SUPPLY CHAIN AUTOMATION GROCERY INFORMATION SYSTEM AND METHOD, naming Edward K. Y. Jung, Royce A. Levien, and Mark A. Malamud as inventors, filed 21 Dec. 2012 with attorney docket no. 0712-003-007-C00001, which is currently co-pending or is an application of which a currently co-pending application is entitled to the benefit of the filing date, and which is a continuation of U.S. patent application Ser. No. 13/721,558, entitled FOOD SUPPLY CHAIN AUTOMATION GROCERY INFORMATION SYSTEM AND METHOD, naming Edward K. Y. Jung, Royce A. Levien, and Mark A. Malamud as inventors, filed 20 Dec. 2012 with attorney docket no. 0712-003-007-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/721,357, entitled FOOD SUPPLY CHAIN AUTOMATION FOOD SERVICE INFORMATION INTERFACE SYSTEM AND METHOD, naming Edward K. Y. Jung, Royce A. Levien, and Mark A. Malamud as inventors, filed 20 Dec. 2012 with attorney docket no. 0712-003-006-000001, which is currently co-pending or is an application of which a currently co-pending application is entitled to the benefit of the filing date, and which is a continuation of U.S. patent application Ser. No. 13/715,309, entitled FOOD SUPPLY CHAIN AUTOMATION FOOD SERVICE INFORMATION INTERFACE SYSTEM AND METHOD, naming Edward K. Y. Jung, Royce A. Levien, and Mark A. Malamud as inventors, filed 14 Dec. 2012 with attorney docket no. 0712-003-006-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/720,572, entitled FOOD SUPPLY CHAIN AUTOMATION FOOD SERVICE INFORMATION SYSTEM AND METHOD, naming Edward K. Y. Jung, Royce A. Levien, and Mark A. Malamud as inventors, filed 19 Dec. 2012 with attorney docket no. 0712-003-005-C00001, which is currently co-pending or is an application of which a currently co-pending application is entitled to the benefit of the filing date, and which is a continuation of U.S. patent application Ser. No. 13/709,831, entitled FOOD SUPPLY CHAIN AUTOMATION FOOD SERVICE INFORMATION SYSTEM AND METHOD, naming Edward K. Y. Jung, Royce A. Levien, and Mark A. Malamud as inventors, filed 10 Dec. 2012 with attorney docket no. 0712-003-005-000000, which is currently co-pending or is an application of which a currently co-pending application is entitled to the benefit of the filing date.

For purposes of the USPTO extra-statutory requirements, the present application constitutes a continuation-in-part of U.S. patent application Ser. No. 13/687,382, entitled FOOD SUPPLY CHAIN AUTOMATION FARM INTERFACE SYSTEM AND METHOD, naming Edward K. Y. Jung, Royce A. Levien, and Mark A. Malamud as inventors, filed 28 Nov. 2012 with attorney docket no. 0712-003-004-C00001, which is currently co-pending or is an application of which a currently co-pending application is entitled to the benefit of the filing date, and which is a continuation of U.S. patent application Ser. No. 13/682,939, entitled FOOD SUPPLY CHAIN AUTOMATION FARM INTERFACE SYSTEM AND METHOD, naming Edward K. Y. Jung, Royce A. Levien, and Mark A. Malamud as inventors, filed 21 Nov. 2012 with attorney docket no. 0712-003-004-000000.

For purposes of the USPTO extra-statutory requirements, the present application constitutes a continuation-in-part of U.S. patent application Ser. No. 13/669,018, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-C00001, which is currently co-pending or is an application of which a currently co-pending application is entitled to the benefit of the filing date, and which is a continuation of U.S. patent application Ser. No. 13/668,977, entitled FOOD SUPPLY CHAIN AUTOMATION FARM TESTING SYSTEM AND METHOD, naming Edward K. Y. Jung, Royce A. Levien, and Mark A. Malamud as inventors, filed 5 Nov. 2012 with attorney docket no. 0712-003-003-000000.

For purposes of the USPTO extra-statutory requirements, the present application constitutes a continuation-in-part of U.S. patent application Ser. No. 13/663,137, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-C00001, which is currently co-pending or is an application of which a currently co-pending application is entitled to the benefit of the filing date, and which is a continuation of U.S. patent application Ser. No. 13/663,095, entitled FOOD SUPPLY CHAIN AUTOMATION FARM TRACKING SYSTEM AND METHOD, naming Edward K. Y. Jung, Royce A. Levien, and Mark A. Malamud as inventors, filed 29 Oct. 2012 with attorney docket no. 0712-003-002-000000.

### RELATED APPLICATIONS

None

The United States Patent Office (USPTO) has published a notice to the effect that the USPTO's computer programs require that patent applicants reference both a serial number and indicate whether an application is a continuation, continuation-in-part, or divisional of a parent application. Stephen G. Kunin, Benefit of Prior-Filed Application, USPTO Official Gazette Mar. 18, 2003. The USPTO further has provided forms for the Application Data Sheet which allow automatic loading of bibliographic data but which require identification of each application as a continuation, continuation-in-part, or divisional of a parent application. The present Applicant Entity (hereinafter “Applicant”) has provided above a specific reference to the application(s) from which priority is being claimed as recited by statute. Applicant understands that the statute is unambiguous in its specific reference language and does not require either a serial number or any characterization, such as “continuation” or “continuation-in-part,” for claiming priority to U.S. patent applications. Notwithstanding the foregoing, Applicant understands that the USPTO's computer programs have certain data entry requirements, and hence Applicant has provided designation(s) of a relationship between the present application and its parent application(s) as set forth above and in any ADS filed in this application, but expressly points out that such designation(s) are not to be construed in any way as any type of commentary and/or admission as to whether or not the present application contains any new matter in addition to the matter of its parent application(s).

If the listings of applications provided above are inconsistent with the listings provided via an ADS, it is the intent of the Applicant to claim priority to each application that appears in the Priority Applications section of the ADS and to each application that appears in the Priority Applications section of this application.

All subject matter of the Priority Applications and the Related Applications and of any and all parent, grandparent, great-grandparent, etc. applications of the Priority Applications and the Related Applications, including any priority claims, is incorporated herein by reference to the extent such subject matter is not inconsistent herewith.

### SUMMARY

In one aspect, a computationally-implemented method includes, but is not limited to electronically transmitting one or more residential food management information requests associated with at least in part one or more food related residential conditions affecting residential service of one or more residential food items; and electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other method aspects are described in the claims, drawings, and text forming a part of the disclosure set forth herein.

In one or more various aspects, related machines, compositions of matter, or manufactures of systems may include, but are not limited to, circuitry and/or programming for effecting the herein-referenced method aspects; the circuitry and/or programming can be virtually any combination of hardware, software, and/or firmware configured to effect the herein—referenced method aspects depending upon the design choices of the system designer (limited to patentable subject matter under 35 USC 101).

A computationally-implemented system includes, but is not limited to: means for electronically transmitting one or more residential food management information requests associated with at least in part one or more food related residential conditions affecting residential service of one or more residential food items; and means for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other system aspects are described in the claims, drawings, and text forming a part of the disclosure set forth herein.

A computationally-implemented system includes, but is not limited to a electronically transmitting electrical circuitry arrangement for electronically transmitting one or more residential food management information requests associated with at least in part one or more food related residential conditions affecting residential service of one or more residential food items; and an electronically receiving electrical circuitry arrangement for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other system aspects are described in the claims, drawings, and text forming a part of the disclosure set forth herein.

A system includes, but is not limited to a electronically transmitting module configured to operate in accordance with electronically transmitting one or more residential food management information requests associated with at least in part one or more food related residential conditions affecting residential service of one or more residential food items; and an electronically receiving module configured to operate in accordance with electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other system aspects are described in the claims, drawings, and text forming a part of the disclosure set forth herein.

An article of manufacture including one or more non-transitory signal-bearing storage medium bearing one or more instructions for electronically transmitting one or more residential food management information requests associated with at least in part one or more food related residential conditions affecting residential service of one or more residential food items; and one or more instructions for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other computer program product aspects are described in the claims, drawings, and text forming a part of the disclosure set forth herein.

A system including one or more computing devices; and one or more instructions when executed on the one or more computing devices cause the one or more computing devices to perform electronically transmitting one or more residential food management information requests associated with at least in part one or more food related residential conditions affecting residential service of one or more residential food items; and electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. In addition to the foregoing, other computer program product aspects are described in the claims, drawings, and text forming a part of the disclosure set forth herein.

In addition to the foregoing, various other method and/or system and/or program product aspects are set forth and described in the teachings such as text (e.g., claims and/or detailed description) and/or drawings of the present disclosure.

The foregoing is a summary and thus may contain simplifications, generalizations, inclusions, and/or omissions of detail; consequently, those skilled in the art will appreciate that the summary is illustrative only and is NOT intended to be in any way limiting. Other aspects, features, and advantages of the devices and/or processes and/or other subject matter described herein will become apparent in the teachings set forth herein.

### BRIEF DESCRIPTION OF THE FIGURES

For a more complete understanding of embodiments, reference now is made to the following descriptions taken in connection with the accompanying drawings. The use of the same symbols in different drawings typically indicates similar or identical items, unless context dictates otherwise.

With reference now to the figures, shown are one or more examples of is an example of residential food management information interface system that may provide context, for instance, in introducing one or more processes and/or devices described herein

FIG. 1 is a schematic view depicting farm-test co. info hub aspects as related with a residential food management information interface system.

FIG. 2 is a schematic view depicting farm-tracking aspects as related with the residential food management information interface system.

FIG. 3 is a schematic view depicting farm-track co. info hub aspects as related with the residential food management information interface system.

FIG. 4 is a schematic view depicting farm-tracking aspects as related with the residential food management information interface system.

FIG. 5 is a schematic view depicting shipping aspects as related with the residential food management information interface system.

FIG. 6 is a schematic view depicting grocery test and track co. info hub aspects as related with the residential food management information interface system.

FIG. 7 is a schematic view depicting grocery tracking aspects as related with the residential food management information interface system.

FIG. 8 is a schematic view depicting home-test and track co. info hub aspects as related with the residential food management information interface system.

FIG. 9 is a schematic view depicting home tracking aspects as related with the residential food management information interface system.

FIG. 10 is a schematic view depicting restaurant-test and track co. info hub aspects as related with the residential food management information interface system.

FIG. 11 is a schematic view depicting restaurant tracking aspects as related with the residential food management information interface system.

FIG. 12 is a block diagram depicting an exemplary implementation of the residential food management information interface system 10 of FIG. 1 including exemplary subsystems.

FIG. 13 is a block diagram depicting a control and information processing subsystem s100 of an exemplary implementation of the residential food management information interface system 10 of FIG. 1.

FIG. 14 is a block diagram depicting an information storage subsystem s200 of an exemplary implementation of the residential food management information interface system 10 of FIG. 1.

FIG. 15 is a block diagram depicting an information user interface subsystem s300 of an exemplary implementation of the residential food management information interface system 10 of FIG. 1.

FIG. 16 is a block diagram depicting a sensing subsystem s400 of an exemplary implementation of the residential food management information interface system 10 of FIG. 1.

FIG. 17 is a block diagram depicting an electronic communication subsystem s500 of an exemplary implementation of the residential food management information interface system 10 of FIG. 1.

FIG. 18 is a block diagram depicting a power subsystem s600 of an exemplary implementation of the residential food management information interface system 10 of FIG. 1.

FIG. 19 is a block diagram depicting a material processing subsystem s700 of an exemplary implementation of the residential food management information interface system 10 of FIG. 1.

FIG. 20 is a block diagram depicting a merchandizing subsystem s800 of an exemplary implementation of the residential food management information interface system 10 of FIG. 1.

FIG. 21 is a block diagram depicting one or more exemplary electrical circuitry arrangements of the residential food management information interface system 10 of FIG. 1.

FIG. 22 is a block diagram depicting one or more exemplary electrical circuitry arrangements of the residential food management information interface system 10 of FIG. 1.

FIG. 23 is a block diagram depicting one or more exemplary electrical circuitry arrangements of the residential food management information interface system 10 of FIG. 1.

FIG. 24 is a block diagram depicting one or more exemplary electrical circuitry arrangements of the residential food management information interface system 10 of FIG. 1.

FIG. 25 is a block diagram depicting one or more exemplary electrical circuitry arrangements of the residential food management information interface system 10 of FIG. 1.

FIG. 26 is a block diagram depicting one or more exemplary electrical circuitry arrangements of the residential food management information interface system 10 of FIG. 1.

FIG. 27 is a block diagram depicting one or more exemplary electrical circuitry arrangements of the residential food management information interface system 10 of FIG. 1.

FIG. 28 is a block diagram depicting one or more exemplary instructions of the information storage subsystem s200 of the residential food management information interface system 10 of FIG. 1.

FIG. 29 is a block diagram depicting one or more exemplary instructions of the information storage subsystem s200 of the residential food management information interface system 10 of FIG. 1.

FIG. 30 is a block diagram depicting one or more exemplary instructions of the information storage subsystem s200 of the residential food management information interface system 10 of FIG. 1.

FIG. 31 is a block diagram depicting one or more exemplary instructions of the information storage subsystem s200 of the residential food management information interface system 10 of FIG. 1.

FIG. 32 is a block diagram depicting one or more exemplary instructions of the information storage subsystem s200 of the residential food management information interface system 10 of FIG. 1.

FIG. 33 is a block diagram depicting one or more exemplary instructions of the information storage subsystem s200 of the residential food management information interface system 10 of FIG. 1.

FIG. 34 is a block diagram depicting one or more exemplary instructions of the information storage subsystem s200 of the residential food management information interface system 10 of FIG. 1.

FIG. 35 is a block diagram depicting one or more exemplary modules of the residential food management information interface system 10 of FIG. 1.

FIG. 36 is a block diagram depicting one or more exemplary modules of the residential food management information interface system 10 of FIG. 1.

FIG. 37 is a block diagram depicting one or more exemplary modules of the residential food management information interface system 10 of FIG. 1.

FIG. 38 is a block diagram depicting one or more exemplary modules of the residential food management information interface system 10 of FIG. 1.

FIG. 39 is a block diagram depicting one or more exemplary modules of the residential food management information interface system 10 of FIG. 1.

FIG. 40 is a block diagram depicting one or more exemplary modules of the residential food management information interface system 10 of FIG. 1.

FIG. 41 is a block diagram depicting one or more exemplary modules of the residential food management information interface system 10 of FIG. 1.

FIG. 42 is a high-level flowchart illustrating an operational flow o10 representing exemplary operations related to electronically transmitting one or more residential food management information requests associated with at least in part one or more food related residential conditions affecting residential service of one or more residential food items, and electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items at least associated with the depicted exemplary implementations of the system.

FIG. 43 is a high-level flowchart including exemplary implementations of operation o11 of FIG. 42.

FIG. 44 is a high-level flowchart including exemplary implementations of operation o11 of FIG. 42.

FIG. 45 is a high-level flowchart including exemplary implementations of operation o11 of FIG. 42.

FIG. 46 is a high-level flowchart including exemplary implementations of operation o11 of FIG. 42.

FIG. 47 is a high-level flowchart including exemplary implementations of operation o11 of FIG. 42.

FIG. 48 is a high-level flowchart including exemplary implementations of operation o11 of FIG. 42.

FIG. 49 is a high-level flowchart including exemplary implementations of operation o11 of FIG. 42.

FIG. 50 is a high-level flowchart including exemplary implementations of operation o11 of FIG. 42.

FIG. 51 is a high-level flowchart including exemplary implementations of operation o11 of FIG. 42.

FIG. 52 is a high-level flowchart including exemplary implementations of operation o11 of FIG. 42.

FIG. 53 is a high-level flowchart including exemplary implementations of operation o11 of FIG. 42.

FIG. 54 is a high-level flowchart including exemplary implementations of operation o11 of FIG. 42.

FIG. 55 is a high-level flowchart including exemplary implementations of operation o11 of FIG. 42.

FIG. 56 is a high-level flowchart including exemplary implementations of operation o11 of FIG. 42.

FIG. 57 is a high-level flowchart including exemplary implementations of operation o11 of FIG. 42.

FIG. 58 is a high-level flowchart including exemplary implementations of operation o11 of FIG. 42.

FIG. 59 is a high-level flowchart including exemplary implementations of operation o11 of FIG. 42.

FIG. 60 is a high-level flowchart including exemplary implementations of operation o11 of FIG. 42.

FIG. 61 is a high-level flowchart including exemplary implementations of operation o11 of FIG. 42.

FIG. 62 is a high-level flowchart including exemplary implementations of operation o11 of FIG. 42.

FIG. 63 is a high-level flowchart including exemplary implementations of operation o11 of FIG. 42.

FIG. 64 is a high-level flowchart including exemplary implementations of operation o11 of FIG. 42.

FIG. 65 is a high-level flowchart including exemplary implementations of operation o11 of FIG. 42.

FIG. 66 is a high-level flowchart including exemplary implementations of operation o11 of FIG. 42.

FIG. 67 is a high-level flowchart including exemplary implementations of operation o11 of FIG. 42.

FIG. 68 is a high-level flowchart including exemplary implementations of operation o11 of FIG. 42.

FIG. 69 is a high-level flowchart including exemplary implementations of operation o11 of FIG. 42.

FIG. 70 is a high-level flowchart including exemplary implementations of operation o12 of FIG. 42.

FIG. 71 is a high-level flowchart including exemplary implementations of operation o12 of FIG. 42.

FIG. 72 is a high-level flowchart including exemplary implementations of operation o12 of FIG. 42.

FIG. 73 is a high-level flowchart including exemplary implementations of operation o12 of FIG. 42.

FIG. 74 is a high-level flowchart including exemplary implementations of operation o12 of FIG. 42.

FIG. 75 is a high-level flowchart including exemplary implementations of operation o12 of FIG. 42.

FIG. 76 is a high-level flowchart including exemplary implementations of operation o12 of FIG. 42.

FIG. 77 is a high-level flowchart including exemplary implementations of operation o12 of FIG. 42.

FIG. 78 is a high-level flowchart including exemplary implementations of operation o12 of FIG. 42.

FIG. 79 is a high-level flowchart including exemplary implementations of operation o12 of FIG. 42.

FIG. 80 is a high-level flowchart including exemplary implementations of operation o12 of FIG. 42.

FIG. 81 is a high-level flowchart including exemplary implementations of operation o12 of FIG. 42.

FIG. 82 is a high-level flowchart including exemplary implementations of operation o12 of FIG. 42.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

The present application may use formal outline headings for clarity of presentation. However, it is to be understood that the outline headings are for presentation purposes, and that different types of subject matter may be discussed throughout the application (e.g., device(s)/structure(s) may be described under process(es)/operations heading(s) and/or process(es)/operations may be discussed under structure(s)/process(es) headings; and/or descriptions of single topics may span two or more topic headings). Hence, the use of the formal outline headings is not intended to be in any way limiting.

Generally, both commercial and consumer interests are becoming more concerned regarding origins of their food and other ingestible materials. Thus, tracking and testing systems to provide in depth information concerning provenance and other data associated with food and other ingestible materials including farming related production and other handling and processing can also be of interest.

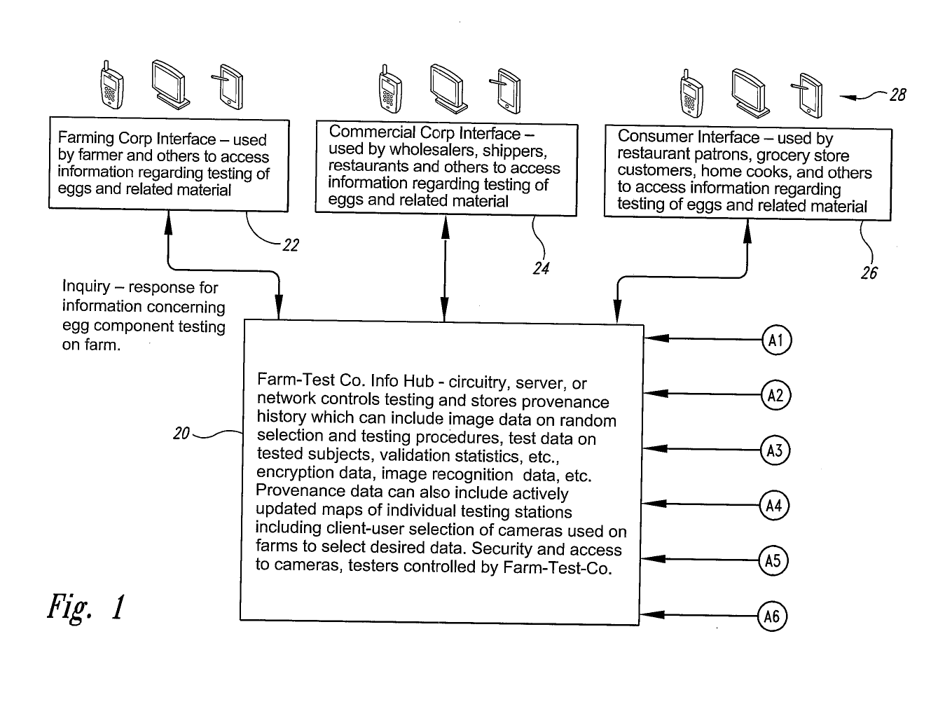

With reference now to the Figures, FIGS. 1-11 depict a schematic diagram of an environment(s) and/or an implementation(s) of technologies described herein. FIGS. 1-11 depict that including physical flows generally including indications as such by use of dashed arrows, the physical flows including that involving handling, testing, worker behavior, animal behavior, and other involvement of items, which can include feed, chicken, egg, carton, containers, transit, grocery store, receiving of containers, unpacking of cartons, shelving of cartons, shopping for cartons, in-store transit of cartons, purchase of carton, transit of carton to home, receiving carton at home, storage of carton at home, removal of egg and preparation of such, etc. Other physical flows are depicted to include transit of container to restaurant, receiving, unpacking, storage, etc. of container at restaurant, unpacking of egg and preparation of in dish, serving and purchasing of dish containing egg, etc. Physical flows are depicted to include testing of grain, chicken, egg, or other items.

FIGS. 1-11 depict that including information flows generally including indications as such by use of solid arrows, the information flows including image data sent from various imaging devices to information hubs, the image data including imaging of various stages of the physical flows. Information flows depicted also include inquiry-responses, initiating of devices, financial data, testing, etc. The information hubs are depicted to include those directed to information flows involving information obtained at farm, transit, restaurant, grocery, home or other locations. The information hubs are depicted to include interchange of information between each other. The information hubs are depicted to communicate with various interfaces to allow for communication therebetween by farming, commercial, restaurant, consumer and other interests. Information in information hubs can allow for research and other activities including determinations of compliance, noncompliance or errors made during one or more physical flows. The examples depicted in FIGS. 1-11 are for illustrative purposes but are not intended to limit aspects to only these examples. Rather they serve to exemplify how data on food provenance and other ingestible material and other sorts of source data can be acquired through various tracking and testing for retrieval and inquiry through such as interfaces shown.

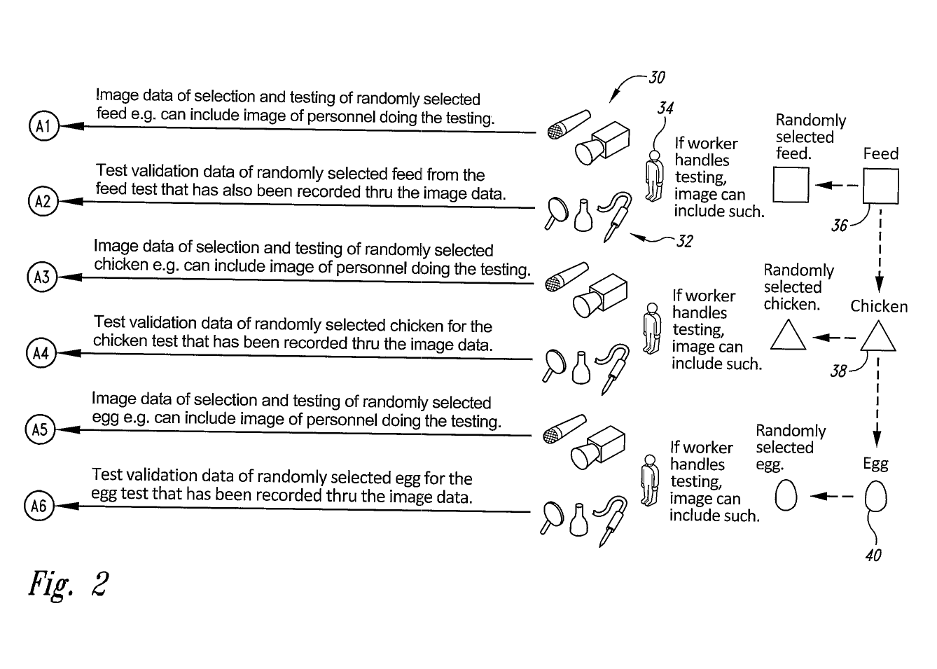

In particular, as shown in FIG. 1, interfaces 22, 24, and 26 are used to interact with Farm-Test Co. Info Hub 20 containing various information related to test of production factors and other items concerning one or more farming related production factors or other items. As shown in FIG. 2, production factors or ingestible material such as feed 36, chicken 38, and egg 40 can be monitored and tested through various sensors 30, 32 further described herein. Behavior of workers 34 can also be monitored.

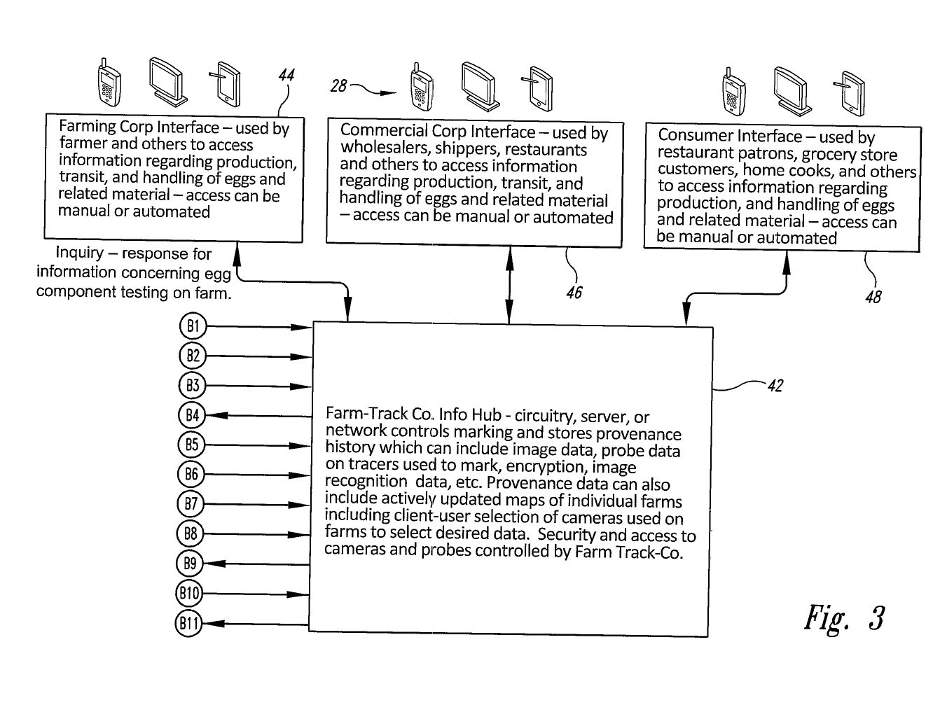

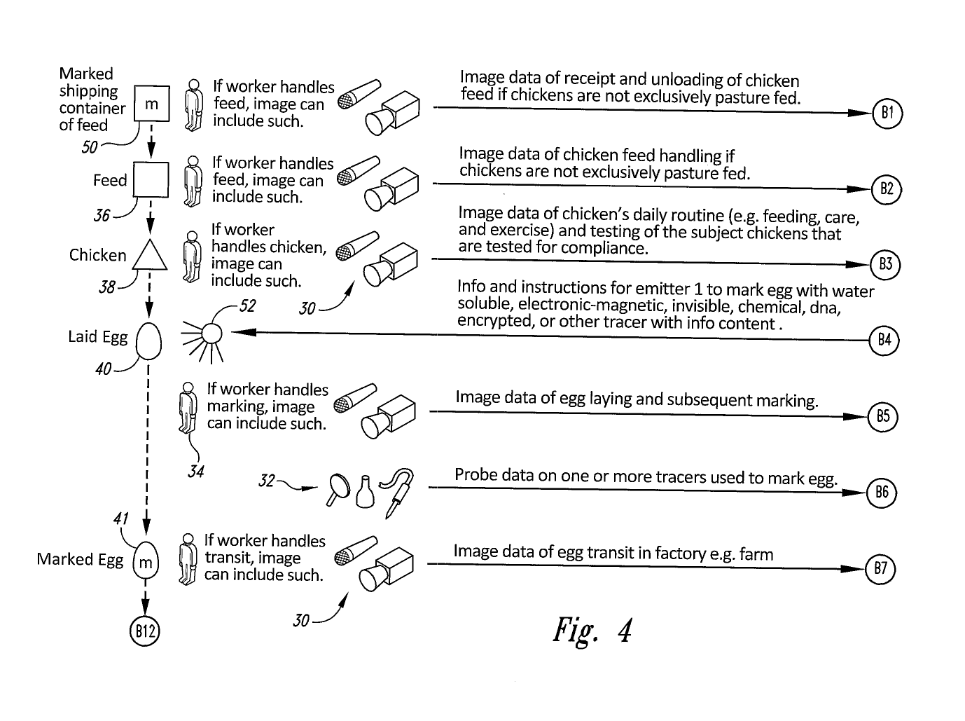

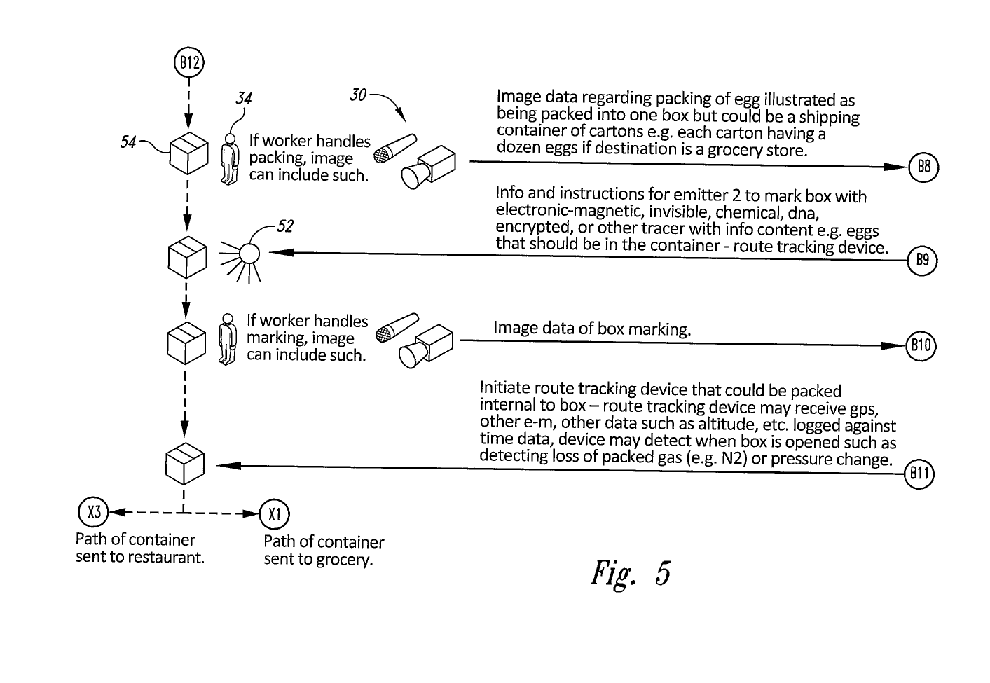

As shown in FIG. 3, interfaces 44, 46, and 48 are used to interact with Farm-Track Co. Info Hub 42 containing various information related to monitoring of production factors and other items concerning one or more farming related production factors or other items. As ingestible material is produced such as egg 40 later becoming marked egg 41 is packed, all such activity involved with such can also be monitored as shown in FIG. 4. The monitoring can be associated with tracers or other labels or marks and also identifiers or other identification information. These associations can be used to access monitoring or testing information through use of tracers and associated identifiers. The tracers can be located at least momentarily in proximity to ingestible material or other production factors to assist in accessing monitoring or testing information. Packing of ingestible material into shipping containers 54 such as shown in FIG. 5 can also be subject to monitoring and labeling of containers through emitters 52.

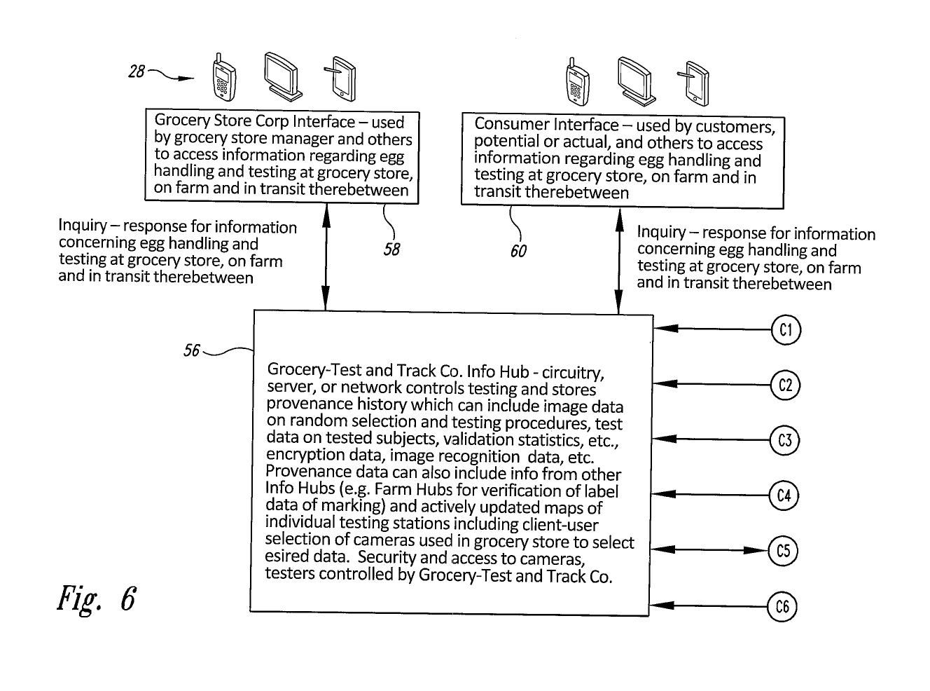

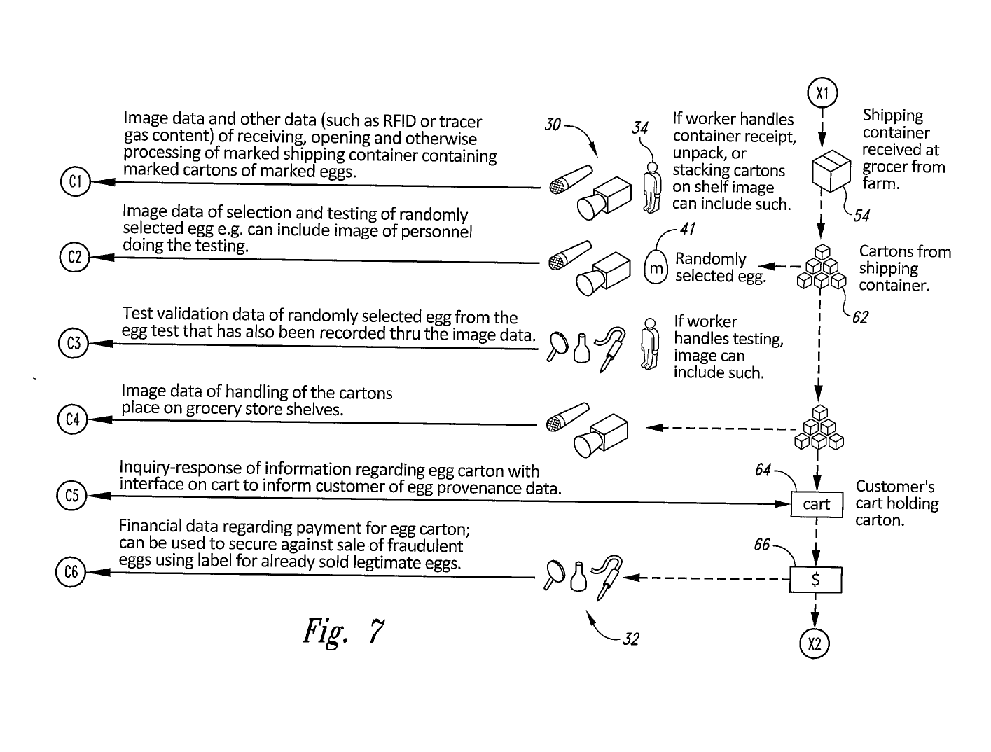

Further monitoring and testing can be performed at commercial locations with information stored on other information hubs such as grocery-test and track co info hub 56 as shown in FIG. 6. Monitoring of grocery activities, such as unpacking cartons 62, use of customer shopping carts 64, and purchase activity 66 shown in FIG. 7, can also be performed.

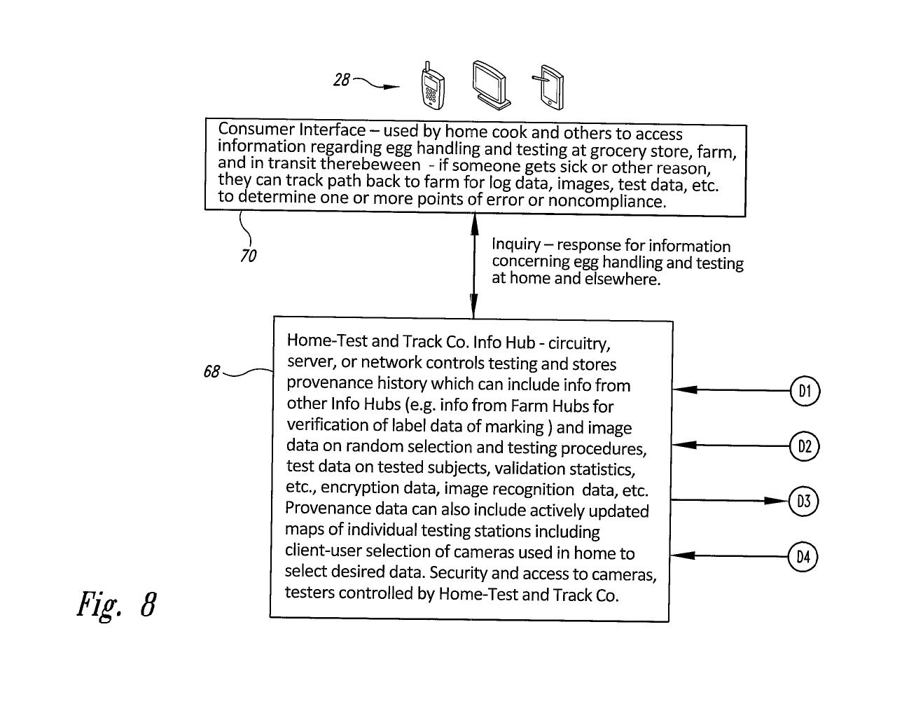

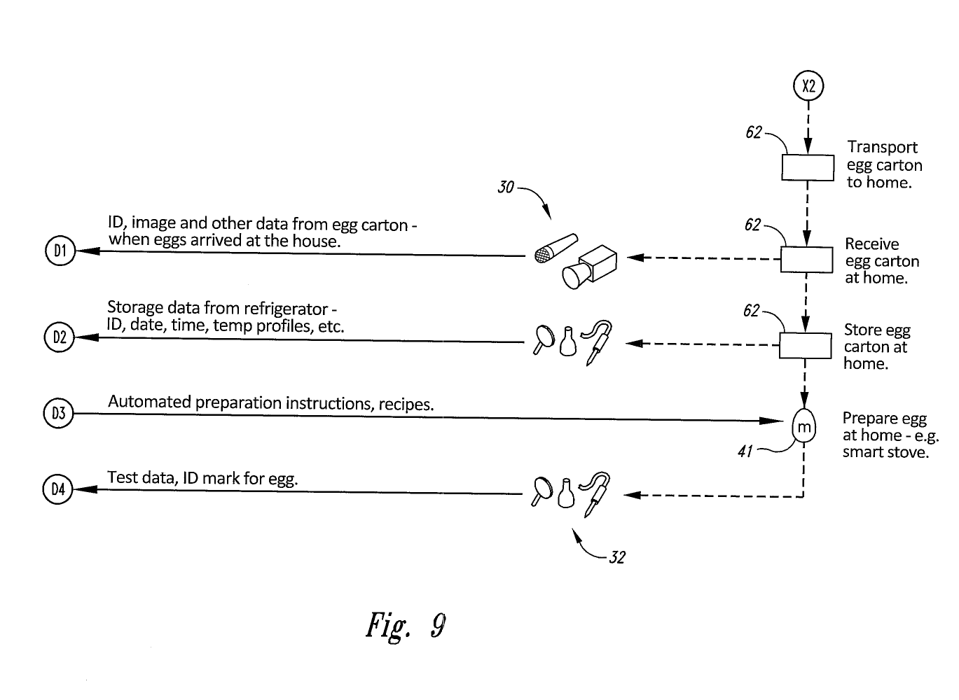

Monitoring, testing and accessing of data can be accomplished at home as well as depicted in FIG. 8 through use of a home-test track co. info hub 68 and consumer interfaces 28. Further illustrative home activities that can be monitored are shown in FIG. 9 to include transporting, receiving, storing and preparing ingestible material.

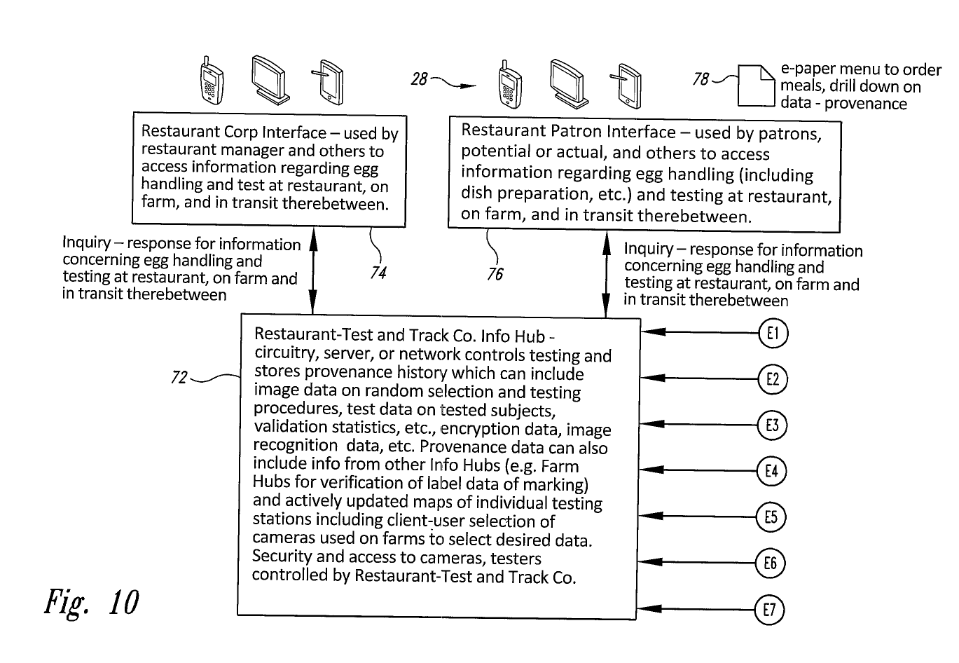

Other commercial venues for monitoring and testing can include restaurants as illustrated in FIG. 10 to include restaurant-test and track co. info hub 72 that can be used for storage and access of provenance data and also monitoring data of activities conducted at a restaurant. This data can be access by both restaurant personnel and restaurant patrons such as through interfaces 74, 76, and 78 to include menuing systems for the patrons.

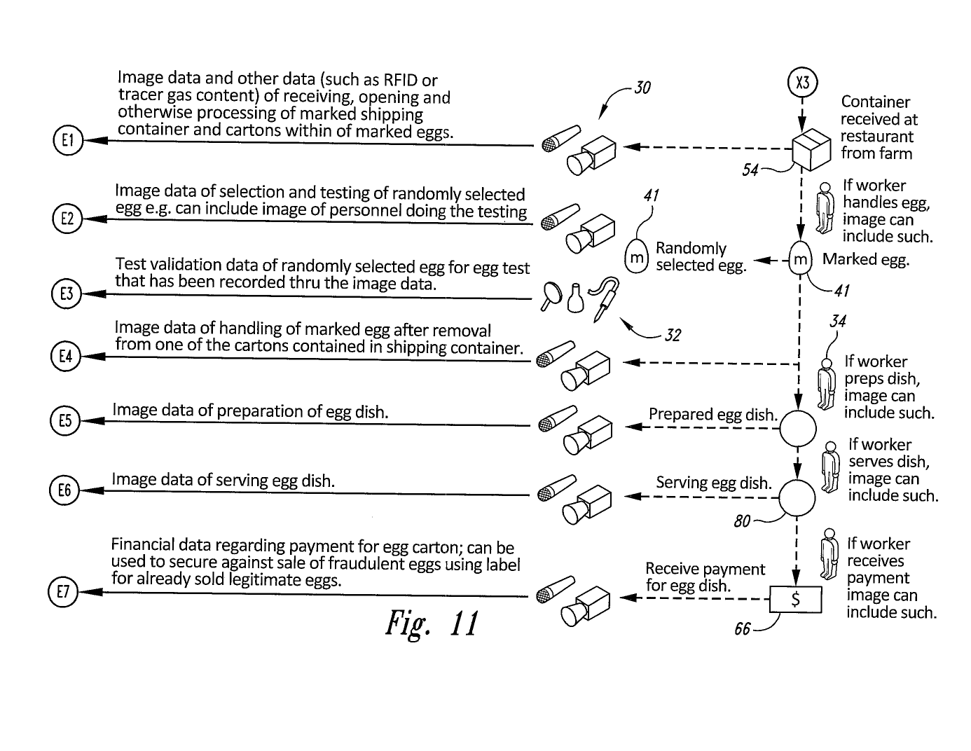

Activities conducted in a restaurant including those depicted in FIG. 11 such as receiving, handling, preparing, serving 80, and transacting payment can be included in monitoring and testing aspects to be stored on the restaurant-test and track co info hub 72 or elsewhere.

Various aspects embodied and illustrated through FIGS. 1-11 can be enumerated below and are provided to provide examples but are not intended to be limiting.

Food Supply Chain Automation
1. Feed (e.g. grain) Farm Track Information Hub
   a. receive fertilizer track and test hub information
   b. receive fertilizer container tracer information or fertilizer tracer information
   c. verify fertilizer container tracer information or fertilizer tracer information with fertilizer track hub information
   d. receive internal fertilizer container tracker information
   e. verify internal fertilizer container tracker information with fertilizer track hub information
   f. receive local fertilizer container handling audio-video and sensor information
   g. scan local fertilizer container handling audio-video and sensor information for error or noncompliance
   h. receive accounting information of production factor use for local fertilizer container handling
   i. correlate local fertilizer container handling audio-video and sensor information with accounting information of production factor use for local fertilizer container handling
   j. associate local fertilizer container handling audio-video and sensor information with fertilizer tracer information
   k. receive local fertilizer handling audio-video and sensor information
   l. scan local fertilizer handling audio-video and sensor information for error or noncompliance
   m. receive accounting information of production factor use for local fertilizer handling
   n. correlate local fertilizer behavior and handling audio-video and sensor information with accounting information of production factor use for local fertilizer handling
   o. associate local fertilizer handling audio-video and sensor information with animal tracer information
   p. receive local feed (grain) handling audio-video and sensor information
   q. associate local feed handling audio-video and sensor information with feed container tracer information or feed tracer information
   r. receive local grain field handling audio-video and sensor information
   s. scan local grain field handling audio-video and sensor information for error or noncompliance
   t. receive accounting information of production factor use for local grain field handling
   u. correlate local grain field handling audio-video and sensor information with accounting information of production factor use for local fertilizer handling
   v. associate local grain field handling audio-video and sensor information with animal tracer information
2. Animal (e.g. chicken) Farm Track and Test Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. send alert to initiate feed sample test event
   l. receive feed test sample tracer information
   m. verify feed test sample tracer information with egg track hub information
   n. receive feed test sample handling audio-video and sensor information
   o. associate feed test sample handing audio-video and sensor information with chicken tracer information
   p. scan feed test sample handling audio-video and sensor information for error or noncompliance
   q. receive accounting information of production factor use for feed test sample handling
   r. correlate feed test sample handling audio-video and sensor information with accounting information of production factor use for feed test sample handling
   s. receive test results for feed test sample
   t. associate test results for feed test sample with feed test sample tracer information
   u. update feed (grain) farm track information hub re butchered chicken portion test sample testing
   v. receive local chicken behavior and handling audio-video and sensor information
   w. associate local chicken behavior and handling audio-video and sensor information with chicken tracer information
   x. scan local chicken behavior and handling audio-video and sensor information for error or noncompliance
   y. receive accounting information of production factor use for local chicken behavior and handling
   z. correlate local chicken behavior and handling audio-video and sensor information with accounting information of production factor use for local chicken behavior and handling
   aa. send alert to initiate chicken sample test event
   bb. receive chicken test sample tracer information
   cc. verify chicken test sample tracer information with egg track hub information
   dd. receive chicken test sample handling audio-video and sensor information
   ee. associate chicken test sample handing audio-video and sensor information with chicken tracer information
   ff. scan chicken test sample handling audio-video and sensor information for error or noncompliance
   gg. receive accounting information of production factor use for chicken test sample handling
   hh. correlate chicken test sample handling audio-video and sensor information with accounting information of production factor use for chicken test sample handling
   ii. receive test results for chicken test sample
   jj. associate test results for chicken test sample with chicken test sample tracer information
   kk. update feed (grain) farm track information hub re chicken test sample testing
   ll. scan chicken behavior and handling audio-video and sensor information to determine egg was laid
   mm. instruct emitter to mark laid egg with egg tracer(s) upon determining egg was laid
   nn. receive local egg marking audio-video and sensor information
   oo. scan local egg marking audio-video and sensor information for error or noncompliance
   pp. receive accounting information of production factor use for local egg marking
   qq. correlate local egg marking audio-video and sensor information with accounting information of production factor use for local egg marking
   rr. associate audio-video and sensor information of egg marking with egg tracer information
   ss. associate egg tracer information with tracer information of chicken that laid egg
   tt. receive local egg handling audio-video and sensor information
   uu. scan local egg handling audio-video and sensor information for error or noncompliance
   vv. receive accounting information of production factor use for local egg handling
   ww. correlate local egg handling audio-video and sensor information with accounting information of production factor use for local egg handling
   xx. associate local egg handling audio-video and sensor information with egg tracer information
   yy. send alert to initiate egg sample test event
   zz. receive egg test sample tracer information
   aaa. verify egg test sample tracer information with egg track hub information
   bbb. receive egg test sample handling audio-video and sensor information
   ccc. associate egg test sample handing audio-video and sensor information with chicken tracer information
   ddd. scan egg test sample handling audio-video and sensor information for error or noncompliance
   eee. receive accounting information of production factor use for egg test sample handling
   fff. correlate egg test sample handling audio-video and sensor information with accounting information of production factor use for egg test sample handling
   ggg. receive test results for egg test sample
   hhh. associate test results for egg test sample with egg test sample tracer information
   iii. update feed (grain) farm track information hub re egg test sample testing
   jjj. receive local egg hatching into hatched chicken audio-video and sensor information
   kkk. scan local egg hatching into hatched audio-video and sensor information for error or noncompliance
   lll. receive accounting information of production factor use for local egg hatching into hatched chicken
   mmm. correlate local egg hatching audio-video and sensor information with accounting information of production factor use for local egg hatching into hatched chicken
   nnn. associate local egg hatching into hatched chicken audio-video and sensor information with egg tracer information
   ooo. send alert to initiate hatched chicken sample test event
   ppp. receive hatched chicken test sample tracer information
   qqq. verify hatched chicken test sample tracer information with egg track hub information
   rrr. receive hatched chicken test sample handling audio-video and sensor information
   sss. associate hatched chicken test sample handing audio-video and sensor information with chicken tracer information
   ttt. scan hatched chicken test sample handling audio-video and sensor information for error or noncompliance
   uuu. receive accounting information of production factor use for hatched chicken test sample handling
   vvv. correlate hatched chicken test sample handling audio-video and sensor information with accounting information of production factor use for hatched chicken test sample handling
   www. receive test results for hatched chicken test sample
   xxx. associate test results for hatched chicken test sample with hatched chicken test sample tracer information
   yyy. update feed (grain) farm track information hub re hatched chicken test sample testing
   zzz. instruct emitter to mark local hatched chicken with hatched chicken tracer(s)
   aaaa. receive local hatched chicken marking audio-video and sensor information
   bbbb. scan local hatched chicken marking audio-video and sensor information for error or noncompliance
   cccc. receive accounting information of production factor use for local hatched chicken marking
   dddd. correlate local hatched chicken marking audio-video and sensor information with accounting information of production factor use for local hatched chicken marking
   eeee. associate local hatched chicken audio-video and sensor information with local hatched chicken tracer information
   ffff. receive local hatched chicken behavior audio-video and sensor information
   gggg. scan local hatched chicken behavior audio-video and sensor information for error or noncompliance
   hhhh. receive accounting information of production factor use for local hatched chicken behavior
   iiii. correlate local hatched chicken behavior audio-video and sensor information with accounting information of production factor use for local hatched chicken behavior
   jjjj. associate local hatched chicken behavior audio-video and sensor information with local hatched chicken tracer information
   kkkk. send alert to initiate hatched chicken sample test event
   llll. receive hatched chicken test sample tracer information
   mmmm. verify hatched chicken test sample tracer information with egg track hub information
   nnnn. receive hatched chicken test sample handling audio-video and sensor information
   oooo. associate hatched chicken test sample handing audio-video and sensor information with chicken tracer information
   pppp. scan hatched chicken test sample handling audio-video and sensor information for error or noncompliance
   qqqq. receive accounting information of production factor use for hatched chicken test sample handling
   rrrr. correlate hatched chicken test sample handling audio-video and sensor information with accounting information of production factor use for hatched chicken test sample handling
   ssss. receive test results for hatched chicken test sample
   tttt. associate test results for hatched chicken test sample with hatched chicken test sample tracer information
   uuuu. update feed (grain) farm track information hub re hatched chicken test sample testing
   vvvv. scan handling and behavior of local hatched chicken to determine when slaughter of local hatched chicken occurs
   wwww. scan handling of slaughter of local hatched chicken for error or non-compliance
   xxxx. receive accounting information of production factor use for slaughter of local hatched chicken
   yyyy. correlate slaughter of local hatched chicken behavior audio-video and sensor information with accounting information of production factor use for slaughter of local hatched chicken
   zzzz. associate slaughter of local hatched chicken audio-video and sensor information with local hatched chicken tracer information
   aaaaa. scan handling and behavior of local hatched chicken to determine when butcher of local hatched chicken occurs
   bbbbb. scan handling of butcher of local hatched chicken for error or non-compliance
   ccccc. receive accounting information of production factor use for butcher of local hatched chicken
   ddddd. correlate butcher of local hatched chicken audio-video and sensor information with accounting information of production factor use for butcher of local hatched chicken
   eeeee. associate butcher of local hatched chicken audio-video and sensor information with local hatched chicken tracer
   fffff. instruct emitter to mark each portion of butchered chicken with chicken portion tracer(s)
   ggggg. receive butchered chicken portion marking audio-video and sensor information
   hhhhh. scan butchered chicken portion marking audio-video and sensor information for error or noncompliance
   iiiii. receive accounting information of production factor use for butchered chicken portion marking
   jjjjj. correlate butchered chicken portion marking audio-video and sensor information with accounting information of production factor use for butchered chicken portion marking
   kkkkk. associate butchered chicken portion marking audio-video and sensor information with butchered chicken portion tracer information
   lllll. send alert to initiate butchered chicken portion sample test event
   mmmmm. receive butchered chicken portion test sample tracer information
   nnnnn. verify butchered chicken portion test sample tracer information with egg track hub information
   ooooo. receive butchered chicken portion test sample handling audio-video and sensor information
   ppppp. associate butchered chicken portion test sample handing audio-video and sensor information with chicken tracer information
   qqqqq. scan butchered chicken portion test sample handling audio-video and sensor information for error or noncompliance
   rrrrr. receive accounting information of production factor use for butchered chicken portion test sample handling
   sssss. correlate butchered chicken portion test sample handling audio-video and sensor information with accounting information of production factor use for butchered chicken portion test sample handling
   ttttt. receive test results for butchered chicken portion test sample
   uuuuu. associate test results for butchered chicken portion test sample with butchered chicken portion test sample tracer information
   vvvvv. update feed (grain) farm track information hub re butchered chicken portion test sample testing
   wwwww. receive local packing butchered chicken portion into butchered chicken portion carton audio-video and sensor information
   xxxxx. scan local packing butchered chicken portion into butchered chicken portion carton handling audio-video and sensor information for error or noncompliance
   yyyyy. receive accounting information of production factor use for local packing butchered chicken portion into butchered chicken portion carton
   zzzzz. correlate local packing butchered chicken portion into butchered chicken portion carton handling audio-video and sensor information with accounting information of production factor use for local packing butchered chicken portion into butchered chicken portion carton
   aaaaaa. associate local packing butchered chicken portion into butchered chicken portion carton audio-video and sensor information with butchered chicken portion tracer information
   bbbbbb. instruct emitter to mark butchered chicken portion carton with butchered chicken portion carton tracer(s)
   cccccc. receive local butchered chicken portion carton marking audio-video and sensor information
   dddddd. scan local butchered chicken portion carton marking audio-video and sensor information for error or noncompliance
   eeeeee. receive accounting information of production factor use for local butchered chicken portion carton marking
   ffffff. correlate local butchered chicken portion carton marking audio-video and sensor information with accounting information of production factor use for local butchered chicken portion carton marking
   gggggg. associate butchered chicken portion carton marking audio-video and sensor information with butchered chicken portion carton tracer information
   hhhhhh. receive local packing butchered chicken portion carton into carton container audio-video and sensor information
   iiiiii. scan local packing butchered chicken portion carton into carton container audio-video and sensor information for error or noncompliance
   jjjjjj. receive accounting information of production factor use for local packing butchered chicken portion carton into carton container
   kkkkkk. correlate local packing butchered chicken portion carton into carton container audio-video and sensor information with accounting information of production factor use for local packing butchered chicken portion carton into carton container
   llllll. associate local packing butchered chicken portion carton into carton container audio-video and sensor information with carton container tracer information
   mmmmmm. instruct emitter to mark carton container with carton container tracer(s)
   nnnnnn. receive local carton container marking audio-video and sensor information
   oooooo. scan local carton container marking audio-video and sensor information for error or noncompliance
   pppppp. receive accounting information of production factor use for local carton container marking
   qqqqqq. correlate local carton container marking audio-video and sensor information with accounting information of production factor use for local carton container marking
   rrrrrrr. associate local carton container marking audio-video and sensor information with carton container tracer information
3. Egg Farm Track Information Hub
   a. receive feed track hub information
   b. receive feed container tracer information or feed tracer information
   c. verify feed container tracer information or feed tracer information with feed track hub information
   d. receive internal feed container tracker information
   e. verify internal feed container tracker information with feed track hub information
   f. receive local feed handling audio-video and sensor information
   g. associate local feed handling audio-video and sensor information with chicken tracer information
   h. scan local feed handling audio-video and sensor information for error or noncompliance
   i. receive accounting information of production factor use for local feed handling
   j. correlate local feed handling audio-video and sensor information with accounting information of production factor use for local feed handling
   k. receive chicken track hub information
   l. receive chicken container tracer information or chicken tracer information
   m. verify chicken container tracer information or chicken tracer information with chicken track hub information
   n. receive internal chicken container tracker information
   o. verify internal chicken container tracker information with chicken track hub information
   p. receive local chicken behavior and handling audio-video and sensor information
   q. associate local chicken behavior and handling audio-video and sensor information with chicken tracer information
   r. scan local chicken behavior and handling audio-video and sensor information for error or noncompliance
   s. receive accounting information of production factor use for local chicken behavior and handling
   t. correlate local chicken behavior and handling audio-video and sensor information with accounting information of production factor use for local chicken behavior and handling
   u. scan chicken behavior and handling audio-video and sensor information to determine egg was laid
   v. instruct emitter to mark laid egg with egg tracer(s) upon determining egg was laid
   w. receive local egg marking audio-video and sensor information
   x. scan local egg marking audio-video and sensor information for error or noncompliance
   y. receive accounting information of production factor use for local egg marking
   z. correlate local egg marking audio-video and sensor information with accounting information of production factor use for local egg marking
   aa. associate audio-video and sensor information of egg marking with egg tracer information
   bb. associate egg tracer information with tracer information of chicken that laid egg
   cc. receive local egg handling (includes marking) audio-video and sensor information
   dd. scan local egg handling audio-video and sensor information for error or noncompliance
   ee. receive accounting information of production factor use for local egg handling
   ff. correlate local egg handling audio-video and sensor information with accounting information of production factor use for local egg handling
   gg. associate local egg handling audio-video and sensor information with egg tracer information
   hh. receive local packing egg into egg carton audio-video and sensor information
   ii. scan local packing egg into egg carton handling audio-video and sensor information for error or noncompliance
   jj. receive accounting information of production factor use for local packing egg into egg carton
   kk. correlate local packing egg into egg carton handling audio-video and sensor information with accounting information of production factor use for local packing egg into egg carton
   ll. associate local packing egg into egg carton audio-video and sensor information with egg tracer information
   mm. instruct emitter to mark egg carton with egg carton tracer(s)
   nn. receive local egg carton marking audio-video and sensor information
   oo. scan local egg carton marking audio-video and sensor information for error or noncompliance
   pp. receive accounting information of production factor use for local egg carton marking
   qq. correlate local egg carton marking audio-video and sensor information with accounting information of production factor use for local egg carton marking
   rr. associate egg carton marking audio-video and sensor information with egg carton tracer information
   ss. receive local egg carton handling audio-video and sensor handling information
   tt. scan local egg carton handling audio-video and sensor information for error or noncompliance
   uu. receive accounting information of production factor use for local egg carton handling
   vv. correlate local egg carton handling audio-video and sensor information with accounting information of production factor use for local egg carton handling
   ww. associate local egg carton handling audio-video and sensor information with egg carton tracer information
   xx. associate carton tracer information with egg tracer information
   yy. receive local packing egg carton into carton container audio-video and sensor information
   zz. scan local packing egg carton into carton container audio-video and sensor information for error or noncompliance
   aaa. receive accounting information of production factor use for local packing egg carton into carton container
   bbb. correlate local packing egg carton into carton container audio-video and sensor information with accounting information of production factor use for local packing egg carton into carton container
   ccc. associate local packing egg carton into carton container audio-video and sensor information with carton container tracer information
   ddd. instruct emitter to mark carton container with carton container tracer(s)
   eee. receive local carton container marking audio-video and sensor information
   fff. scan local carton container marking audio-video and sensor information for error or noncompliance
   ggg. receive accounting information of production factor use for local carton container marking
   hhh. correlate local carton container marking audio-video and sensor information with accounting information of production factor use for local carton container marking
   iii. associate local carton container marking audio-video and sensor information with carton container tracer information
   jjj. receive local carton container handling audio-video and sensor information
   kkk. scan local carton container handling audio-video and sensor information for error or noncompliance
   lll. receive accounting information of production factor use for local carton container handling
   mmm. correlate local carton container handling audio-video and sensor information with accounting information of production factor use for local carton container handling
   nnn. associate carton container handling audio-video and sensor information with carton container tracer information
   ooo. associate carton container tracer information with egg carton tracer information
   ppp. initiate tracker placed internally in carton container during packing thereof
   qqq. receive egg test hub information
4. Egg Farm Test Information Hub
   a. receive egg track hub information
   b. send alert to initiate local feed sample test event
   c. receive local feed test sample tracer information
   d. verify local feed test sample tracer information with egg track hub information
   e. receive local feed test sample handling audio-video and sensor information
   f. associate local feed test sample handing audio-video and sensor information with local feed test sample tracer information
   g. scan local feed test sample handling audio-video and sensor information for error or noncompliance
   h. receive accounting information of production factor use for local feed test sample handling
   i. correlate local feed test sample handling audio-video and sensor information with accounting information of production factor use for local feed test sample handling
   j. receive test results for local feed test sample
   k. associate test results for local feed test sample with local feed test sample tracer information
   l. update egg farm track information hub re local feed test sample testing
   m. update chicken farm track information hub re local feed test sample testing
   n. update feed (grain) farm track information hub re local feed test sample testing
   o. send alert to initiate local chicken sample test event
   p. receive local chicken test sample tracer information
   q. verify local chicken test sample tracer information with egg track hub information
   r. receive local chicken test sample handling audio-video and sensor information
   s. associate local chicken test sample handing audio-video and sensor information with chicken tracer information
   t. scan local chicken test sample handling audio-video and sensor information for error or noncompliance
   u. receive accounting information of production factor use for local chicken test sample handling
   v. correlate local chicken test sample handling audio-video and sensor information with accounting information of production factor use for local chicken test sample handling
   w. receive test results for local chicken test sample
   x. associate test results for local chicken test sample with local chicken test sample tracer information
   y. update egg farm track information hub re local chicken test sample testing
   z. update chicken farm track information hub re local chicken test sample testing
   aa. update feed (grain) farm track information hub re local chicken test sample testing
   bb. receive local egg test sample tracer information
   cc. verify local egg test sample tracer information with egg track hub information
   dd. receive local egg test sample handling audio-video and sensor information
   ee. associate local egg test sample handing audio-video and sensor information with egg tracer information
   ff. scan local egg test sample handling audio-video and sensor information for error or noncompliance
   gg. receive accounting information of production factor use for local egg test sample handling
   hh. correlate local egg test sample handling audio-video and sensor information with accounting information of production factor use for local egg test sample handling
   ii. receive test results for local egg test sample
   jj. associate test results for local egg test sample with local egg test sample tracer information
   kk. update egg farm track information hub re local egg test sample testing
   ll. update chicken farm track information hub re local egg test sample testing
   mm. update feed (grain) farm track information hub re local egg test sample testing
5. Restaurant Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. receive local egg handling audio-video and sensor information
   r. scan local egg handling audio-video and sensor information for error or noncompliance
   s. receive accounting information of production factor use for local egg handling
   t. correlate local egg handling audio-video and sensor information with accounting information of production factor use for local egg handling
   u. associate local egg handling audio-video and sensor information with egg tracer information
   v. send alert to initiate local egg sample test event
   w. receive local egg test sample tracer information
   x. verify local egg test sample tracer information with egg track hub information
   y. receive local egg test sample handling audio-video and sensor information
   z. associate local egg test sample handing audio-video and sensor information with egg tracer information
   aa. scan local egg test sample handling audio-video and sensor information for error or noncompliance
   bb. receive accounting information of production factor use for local egg test sample handling
   cc. correlate local egg test sample handling audio-video and sensor information with accounting information of production factor use for local egg test sample handling
   dd. receive test results for local egg test sample
   ee. associate test results for local egg test sample with local egg test sample tracer information
   ff. update egg farm track information hub re local egg test sample testing
   gg. update chicken farm track information hub re local egg test sample testing
   hh. update feed (grain) farm track information hub re local egg test sample testing
   ii. receive local egg dish preparation audio-video and sensor information
   jj. scan local egg dish preparation audio-video and sensor information for error or noncompliance
   kk. receive accounting information of production factor use for local egg dish preparation
   ll. correlate local egg dish preparation audio-video and sensor information with accounting information of production factor use for local egg dish preparation
   mm. associate local egg dish preparation audio-video and sensor information with egg tracer information
   nn. receive local egg dish serving audio-video and sensor information
   oo. scan local egg dish serving audio-video and sensor information for error or noncompliance
   pp. receive accounting information of production factor use for local egg dish serving
   qq. correlate local egg dish serving audio-video and sensor information with accounting information of production factor use for local egg dish serving
   rr. associate local egg dish serving audio-video and sensor information with egg tracer information
   ss. receive local egg dish payment audio-video and sensor information
   tt. scan local egg dish payment audio-video and sensor information for error or noncompliance
   uu. receive accounting information of production factor use for local egg dish payment
   vv. correlate local egg dish payment audio-video and sensor information with accounting information of production factor use for local egg dish payment
   ww. associate local egg dish payment audio-video and sensor information with egg tracer information
6. Grocery Test and Track Information Hub
   a. receive egg farm track hub information
   b. receive egg farm test hub information
   c. receive carton container tracer information
   d. verify carton container tracer information with egg track hub information
   e. receive internal carton container tracker information
   f. verify internal carton container tracker information with egg track hub information
   g. receive local carton container handling audio-video and sensor information
   h. scan local carton container handling audio-video and sensor information for error or noncompliance
   i. receive accounting information of production factor use for local carton container handling
   j. correlate local carton container handling audio-video and sensor information with accounting information of production factor use for local carton container handling
   k. associate local handling of carton container audio-video and sensor information with carton container tracer information
   l. receive local egg carton handling audio-video and sensor information
   m. scan local egg carton handling audio-video and sensor information for error or noncompliance
   n. receive accounting information of production factor use for local egg carton handling
   o. correlate local egg carton handling audio-video and sensor information with accounting information of production factor use for local egg carton handling
   p. associate local egg carton handling audio-video and sensor information with egg carton tracer information
   q. send alert to initiate local egg sample test event
   r. receive local egg test sample tracer information
   s. verify local egg test sample tracer information with egg track hub information
   t. receive local egg test sample handling audio-video and sensor information
   u. associate local egg test sample handing audio-video and sensor information with egg tracer information
   v. scan local egg test sample handling audio-video and sensor information for error or noncompliance
   w. receive accounting information of production factor use for local egg test sample handling
   x. correlate local egg test sample handling audio-video and sensor information with accounting information of production factor use for local egg test sample handling
   y. receive test results for local egg test sample
   z. associate test results for local egg test sample with local egg test sample tracer information
   aa. update egg farm track information hub re local egg test sample testing
   bb. update chicken farm track information hub re local egg test sample testing
   cc. update feed (grain) farm track information hub re local egg test sample testing
   dd. receive local egg carton payment audio-video and sensor information
   ee. scan local egg carton payment audio-video and sensor information for error or noncompliance
   ff. receive accounting information of production factor use for local egg carton payment
   gg. correlate local egg carton payment audio-video and sensor information with accounting information of production factor use for local egg carton payment
   hh. associate local egg carton payment audio-video and sensor information with egg carton tracer information
7. Home Test and Track Information Hub
   a. receive grocery test and track hub information
   b. receive egg carton tracer information
   c. verify egg carton tracer information with egg track hub information
   d. receive internal carton container tracker information
   e. verify internal carton container tracker information with egg track hub information
   f. receive local egg carton handling audio-video and sensor information
   g. scan local egg carton handling audio-video and sensor information for error or noncompliance
   h. receive accounting information of production factor use for local egg carton handling
   i. correlate local egg carton handling audio-video and sensor information with accounting information of production factor use for local egg carton handling
   j. associate local egg carton handling audio-video and sensor information with egg carton tracer information
   k. receive local egg handling audio-video and sensor information
   l. scan local egg handling audio-video and sensor information for error or noncompliance
   m. receive accounting information of production factor use for local egg handling
   n. correlate local egg handling audio-video and sensor information with accounting information of production factor use for local egg handling
   o. associate local egg handling audio-video and sensor information with egg tracer information
   p. send alert to initiate local egg sample test event
   q. receive local egg test sample tracer information
   r. verify local egg test sample tracer information with egg track hub information
   s. receive local egg test sample handling audio-video and sensor information
   t. associate local egg test sample handing audio-video and sensor information with egg tracer information
   u. scan local egg test sample handling audio-video and sensor information for error or noncompliance
   v. receive accounting information of production factor use for local egg test sample handling
   w. correlate local egg test sample handling audio-video and sensor information with accounting information of production factor use for local egg test sample handling
   x. receive test results for local egg test sample
   y. associate test results for local egg test sample with local egg test sample tracer information
   z. update grocery track information hub re local egg test sample testing
   aa. update egg farm track information hub re local egg test sample testing
   bb. update chicken farm track information hub re local egg test sample testing
   cc. update feed (grain) farm track information hub re local egg test sample testing
   dd. receive local egg dish preparation audio-video and sensor information
   ee. scan local egg dish preparation audio-video and sensor information for error or noncompliance
   ff. receive accounting information of production factor use for local egg dish preparation
   gg. correlate local egg dish preparation audio-video and sensor information with accounting information of production factor use for local egg dish preparation
   hh. associate local egg dish preparation audio-video and sensor information with egg tracer information
   ii. receive local egg dish serving audio-video and sensor information
   jj. scan local egg dish serving audio-video and sensor information for error or noncompliance
   kk. receive accounting information of production factor use for local egg dish serving
   ll. correlate local egg dish serving audio-video and sensor information with accounting information of production factor use for local egg dish serving
   mm. associate local egg dish serving audio-video and sensor information with egg tracer information

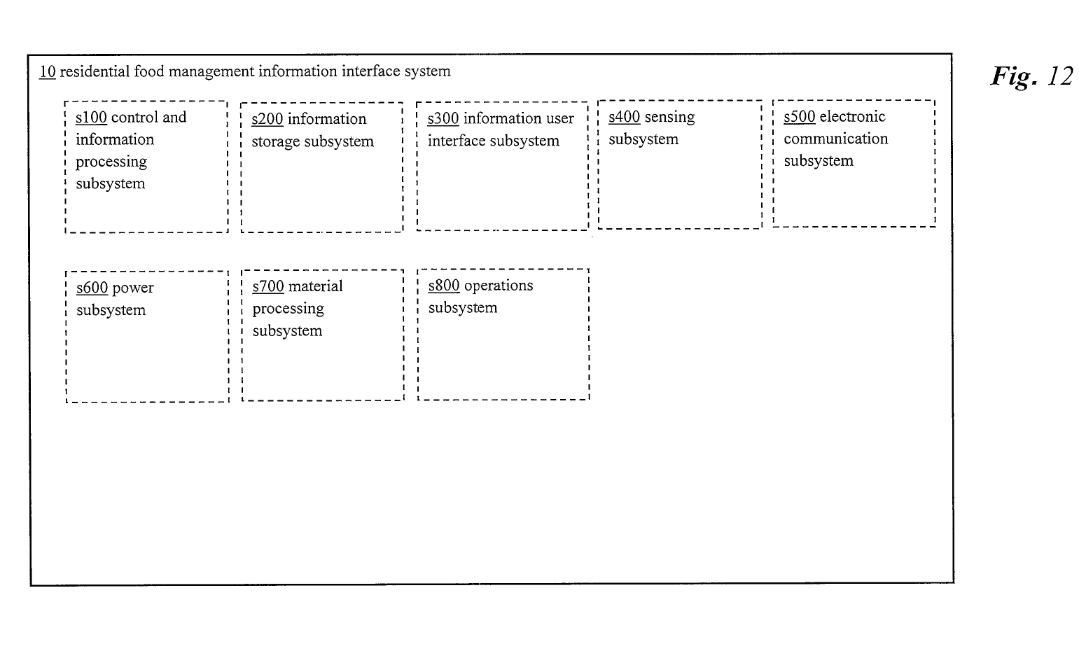

An exemplary version of the residential food management information interface system 10 is shown in FIG. 12 to optionally include various subsystems such as control and information processing subsystem s100, information storage subsystem s200, information user interface subsystem s300, sensing subsystem s400, electronic communication subsystem s500, power subsystem s600, material processing subsystem s700, and merchandizing subsystem s800.

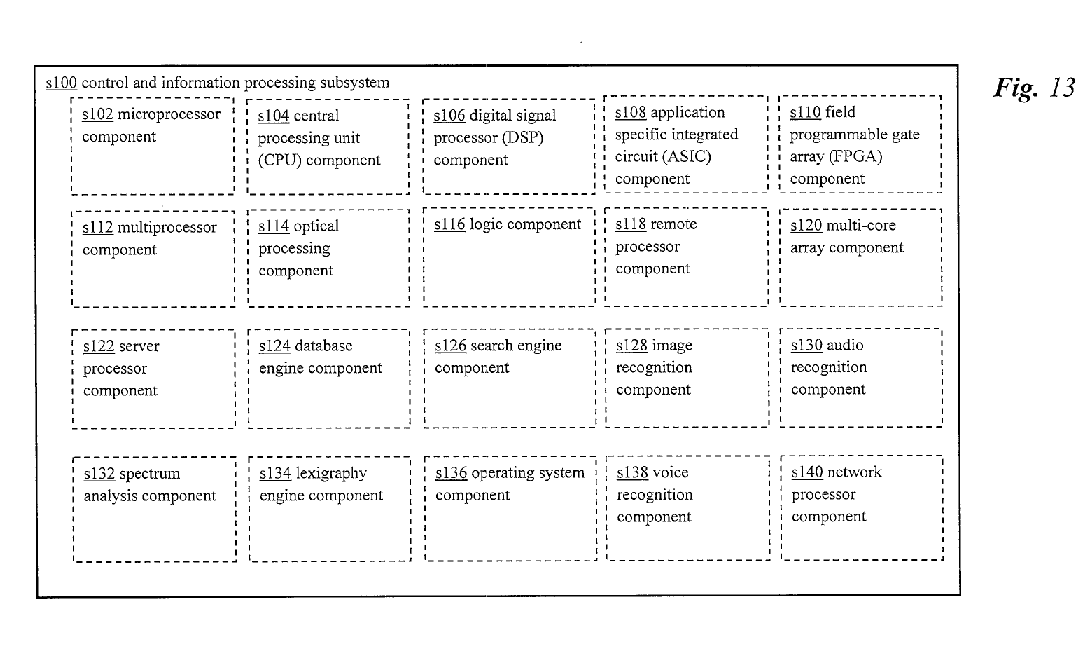

An exemplary implementation of the control and information processing subsystem s100 is shown in FIG. 13 to optionally include various components such as microprocessor component s102, central processing unit (CPU) component s104, digital signal processor (DSP) component s106, application specific integrated circuit (ASIC) component s108, field programmable gate array (FPGA) component s110, multiprocessor component s112, optical processing component s114, logic component s116, remote processor component s118, multi-core array component s120, server processor component s122, database engine component s124, search engine component s126, image recognition component s128, audio recognition component s130, spectrum analysis component s132, lexigraphy engine component s134, operating system component s136, voice recognition component s138, and network processor component s140.

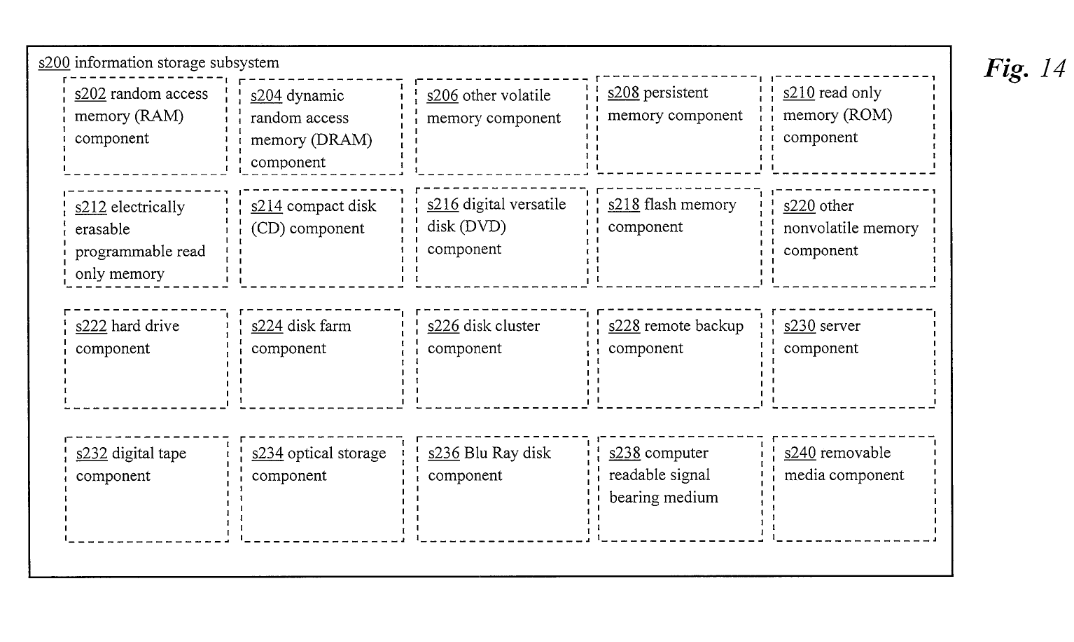

An exemplary implementation of the information storage subsystem s200 is shown in FIG. 14 to optionally include various components such as random access memory (RAM) component s202, dynamic random access memory (DRAM) component s204, other volatile memory component s206, persistent memory component s208, read only memory (ROM) component s210, electrically erasable programmable read only memory (EEPROM) component s212, compact disk (CD) component s214, digital versatile disk (DVD) component s216, flash memory component s218, other nonvolatile memory component s220, hard drive component s222, disk farm component s224, disk cluster component s226, remote backup component s228, server component s230, digital tape component s232, optical storage component s234, Blu Ray disk component s236, computer readable signal bearing medium s238, and removable media component s240.

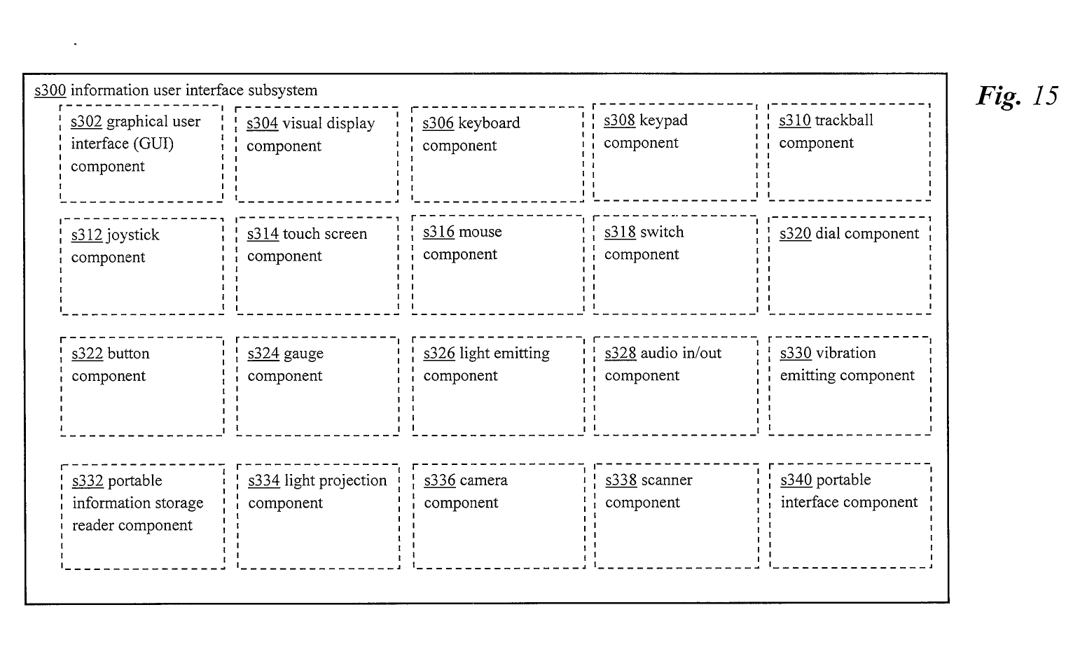

An exemplary implementation of the information user interface subsystem s300 is shown in FIG. 15 to optionally include various components such as graphical user interface (GUI) component s302, visual display component s304, keyboard component s306, keypad component s308, trackball component s310, joystick component s312, touch screen component s314, mouse component s316, switch component s318, dial component s320, button component s322, gauge component s324, light emitting component s326, audio in/out component s328, vibration emitting component s330, portable information storage reader component s332, light projection component s334, camera component s336, scanner component s338, and portable interface component s340.

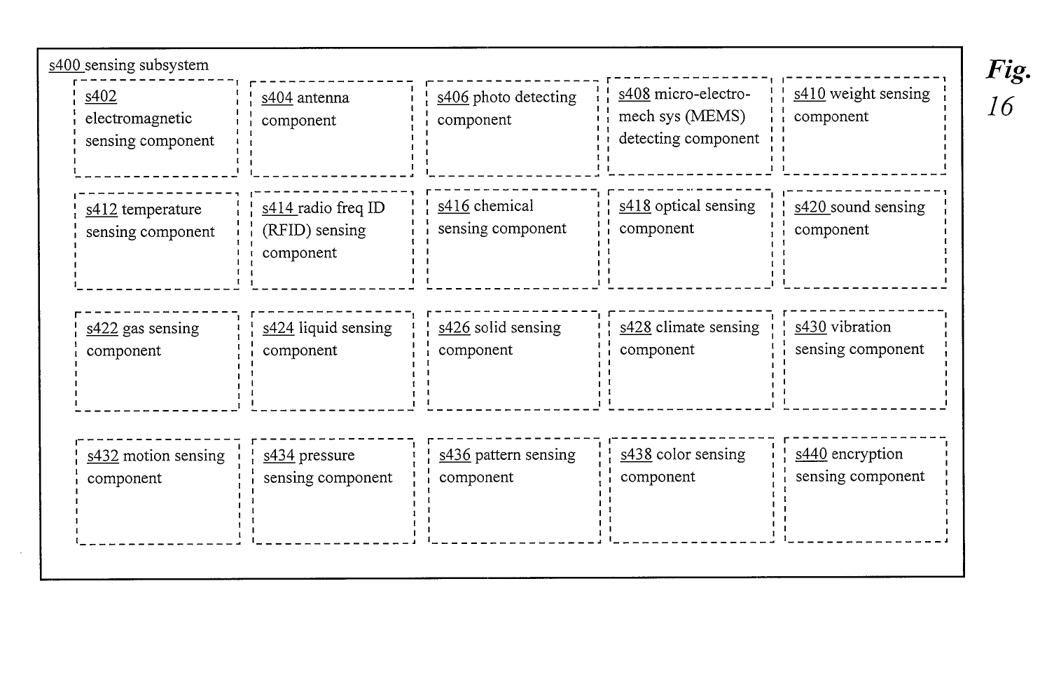

An exemplary implementation of the sensing subsystem s400 is shown in FIG. 16 to optionally include various components such as electromagnetic sensing component s402, antenna component s404, photo detecting component s406, micro-electro-mech sys (MEMS) detecting component s408, weight sensing component s410, temperature sensing component s412, radio freq ID (RFID) sensing component s414, chemical sensing component s416, optical sensing component s418, sound sensing component s420, solid sensing component s422, liquid sensing component s424, solid sensing component s426, climate sensing component s428, vibration sensing component s430, motion sensing component s432, pressure sensing component s434, pattern sensing component s436, color sensing component s438, and encryption sensing component s440.

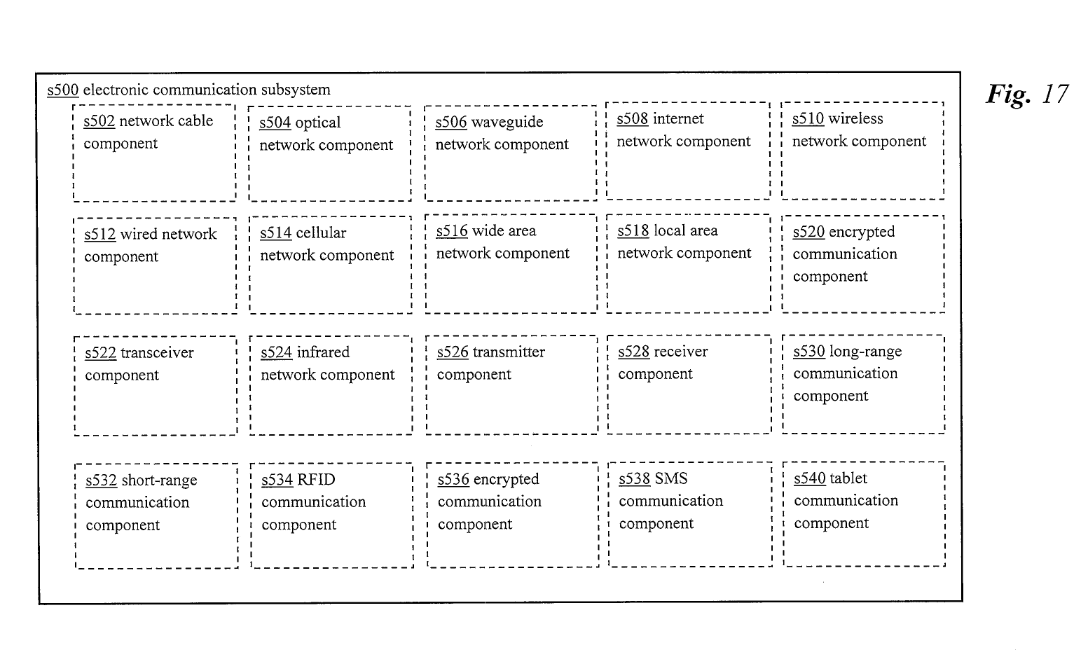

An exemplary implementation of the electronic communication subsystem s500 is shown in FIG. 17 to optionally include various components such as network cable component s502, optical network component s504, waveguide network component s506, internet network component s508, wireless network component s510, wired network component s512, cellular network component s514, wide area network component s516, local area network component s518, encrypted communication component s520, transceiver component s522, infrared network component s524, transmitter component s526, receiver component s528, receiver component s528, long-range communication component s530, short-range communication component s532, RFID communication component s534, encrypted communication component s536, SMS communication component s538, and tablet communication component s540.

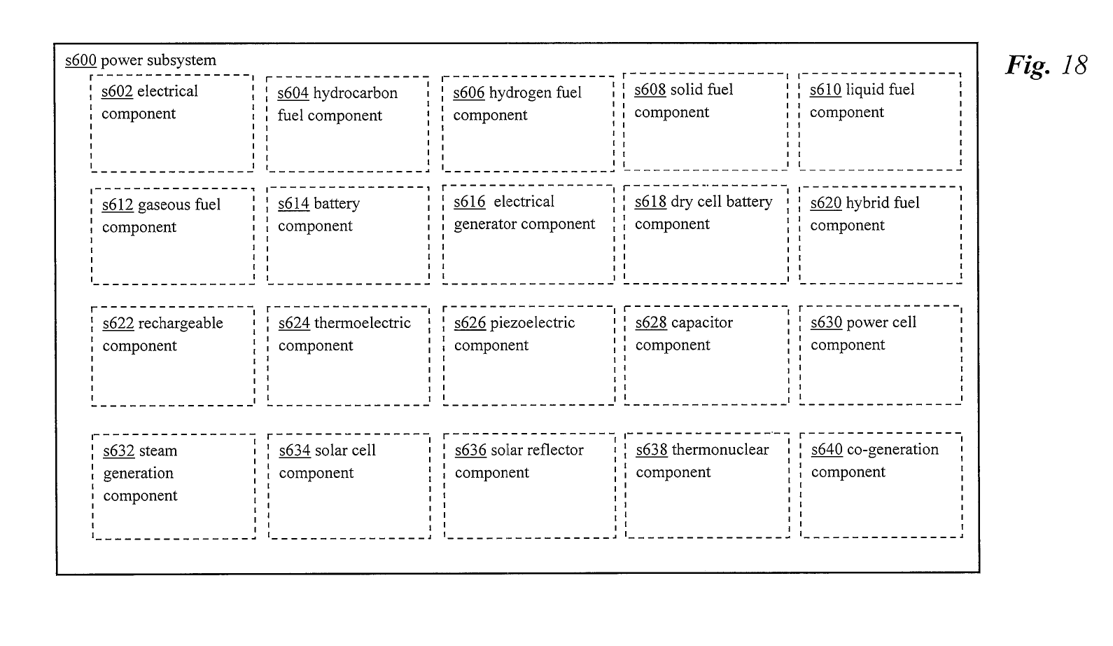

An exemplary implementation of the power subsystem s600 is shown in FIG. 18 to optionally include various components such as electrical component s602, hydrocarbon fuel component s604, hydrogen fuel component s606, solid fuel component s608, liquid fuel component s610, gaseous fuel component s612, battery component s614, battery component s622, battery component s624, battery component s626, battery component s628, power cell component s630, steam generation component s632, solar cell component s634, solar reflector component s636, thermonuclear component s638, and co-generation component s640.

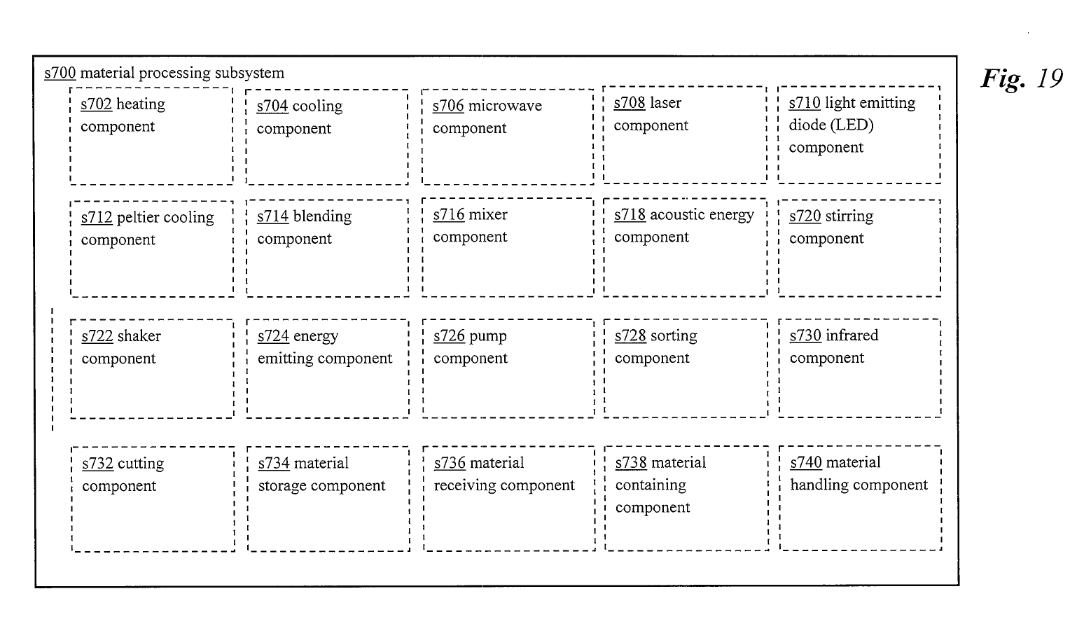

An exemplary implementation of the material processing subsystem s700 is shown in FIG. 19 to optionally include various components such as heating component s702, cooling component s704, microwave component s706, laser component s708, light emitting diode (LED) component s710, peltier cooling component s712, blending component s714, mixer component s716, acoustic energy component s718, stirring component s720, shaker component s722, energy emitting component s724, pump component s726, sorting component s728, infrared component s730, cutting component s732, material storage component s734, material receiving component s736, material containing component s738, and material handling component s740.

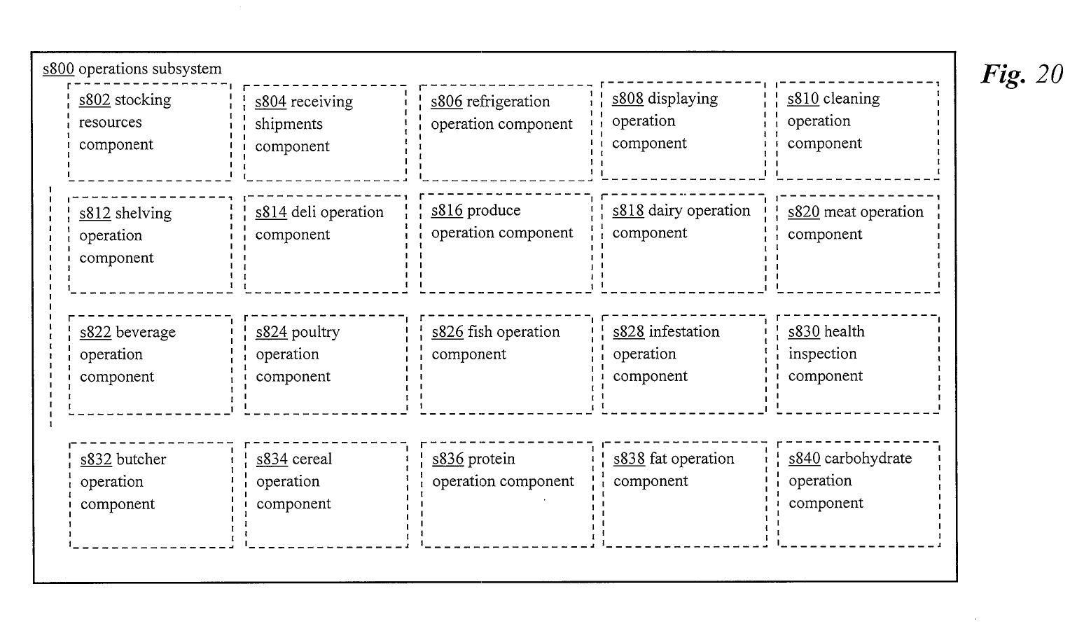

An exemplary implementation of the merchandizing subsystem s800 is shown in FIG. 20 to optionally include various components such as stocking resources component s802, receiving shipments component s804, refrigeration operation component s806, displaying operation component s808, cleaning operation component s810, shelving operation component s812, deli operation component s814, produce operation component s816, dairy operation component s818, meat operation component s820, beverage operation component s822, poultry operation component s824, fish operation component s826, infestation operation component s828, health inspection component s830, butcher operation component s832, cereal operation component s834, protein operation component s836, fat operation component s838, and carbohydrate operation component s840.

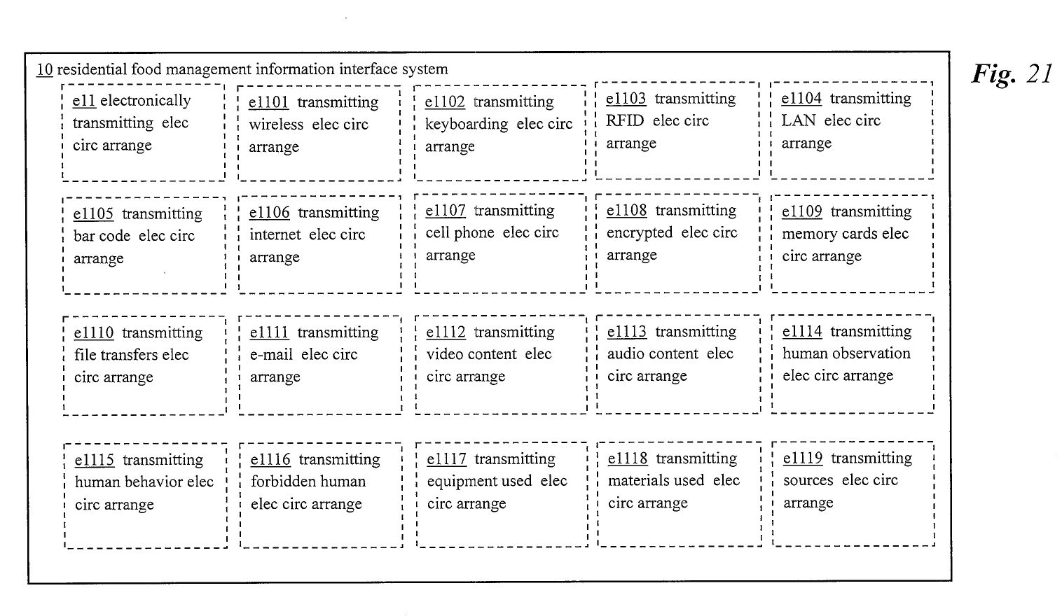

Implementations involve different combinations (otherwise known as “electrical circuitry arrangements”) of components from the subsystems of the residential food management information interface system 10. Exemplary depictions of some of these electrical circuitry arrangements are shown in FIG. 21 to include electronically transmitting electrical circuitry arrangement e11, transmitting wireless electrical circuitry arrangement e1101, transmitting keyboarding electrical circuitry arrangement e1102, transmitting RFID electrical circuitry arrangement e1103, transmitting LAN electrical circuitry arrangement e1104, transmitting bar code electrical circuitry arrangement e1105, transmitting internet electrical circuitry arrangement e1106, transmitting cell phone electrical circuitry arrangement e1107, transmitting encrypted electrical circuitry arrangement e1108, transmitting memory cards electrical circuitry arrangement e1109, transmitting file transfers electrical circuitry arrangement e1110, transmitting e-mail electrical circuitry arrangement e1111, transmitting video content electrical circuitry arrangement e1112, transmitting audio content electrical circuitry arrangement e1113, transmitting human observation electrical circuitry arrangement e1114, transmitting human behavior electrical circuitry arrangement e1115, transmitting forbidden human electrical circuitry arrangement e1116, transmitting equipment used electrical circuitry arrangement e1117, transmitting materials used electrical circuitry arrangement e1118, and transmitting sources electrical circuitry arrangement e1119.

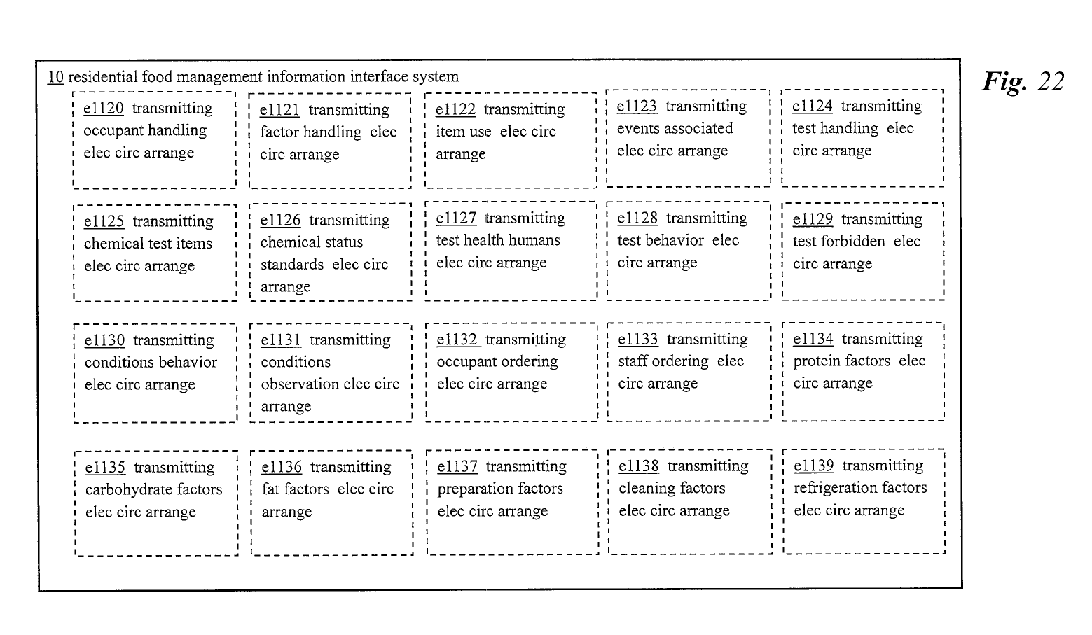

Some of these electrical circuitry arrangements are depicted in FIG. 22 to include transmitting occupant handling electrical circuitry arrangement e1120, transmitting factor handling electrical circuitry arrangement e1121, transmitting item use electrical circuitry arrangement e1122, transmitting events associated electrical circuitry arrangement e1123, transmitting test handling electrical circuitry arrangement e1124, transmitting chemical test items electrical circuitry arrangement e1125, transmitting chemical status standards electrical circuitry arrangement e1126, transmitting test health humans electrical circuitry arrangement e1127, transmitting test behavior electrical circuitry arrangement e1128, transmitting test forbidden electrical circuitry arrangement e1129, transmitting conditions behavior electrical circuitry arrangement e1130, transmitting conditions observation electrical circuitry arrangement e113, transmitting occupant ordering electrical circuitry arrangement e1132, transmitting staff ordering electrical circuitry arrangement e1133, transmitting protein factors electrical circuitry arrangement e1134, transmitting carbohydrate factors electrical circuitry arrangement e1135, transmitting fat factors electrical circuitry arrangement e1136, transmitting preparation factors electrical circuitry arrangement e1137, transmitting cleaning factors electrical circuitry arrangement e1138, and transmitting refrigeration factors electrical circuitry arrangement e1139.

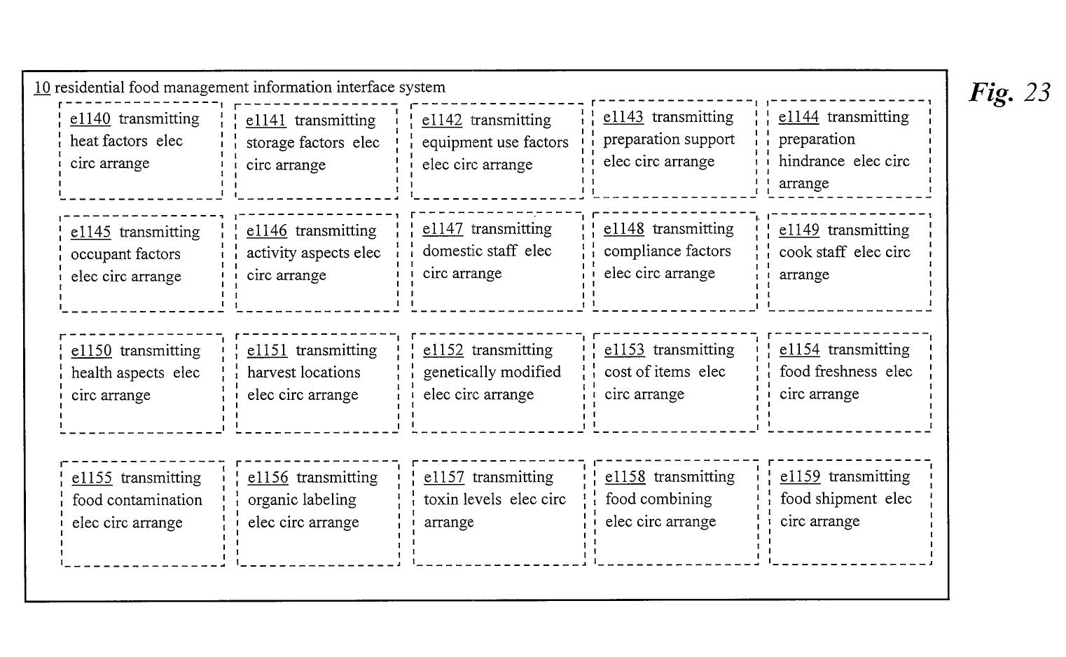

Some of these electrical circuitry arrangements are depicted in FIG. 23 to include transmitting heat factors electrical circuitry arrangement e1140, transmitting storage factors electrical circuitry arrangement e1141, transmitting equipment use factors electrical circuitry arrangement e1142, transmitting preparation support electrical circuitry arrangement e1143, transmitting preparation hindrance electrical circuitry arrangement e1144, transmitting occupant factors electrical circuitry arrangement e1145, transmitting activity aspects electrical circuitry arrangement e1146, transmitting domestic staff electrical circuitry arrangement e1147, transmitting compliance factors electrical circuitry arrangement e1148, transmitting cook staff electrical circuitry arrangement e1149, transmitting health aspects electrical circuitry arrangement e1150, transmitting harvest locations electrical circuitry arrangement e1151, transmitting genetically modified electrical circuitry arrangement e1152, transmitting cost of items electrical circuitry arrangement e1153, transmitting food freshness electrical circuitry arrangement e1154, transmitting food contamination electrical circuitry arrangement e1155, transmitting organic labeling electrical circuitry arrangement e1156, transmitting toxin levels electrical circuitry arrangement e1157, transmitting food combining electrical circuitry arrangement e1158, and transmitting food shipment electrical circuitry arrangement e1159.

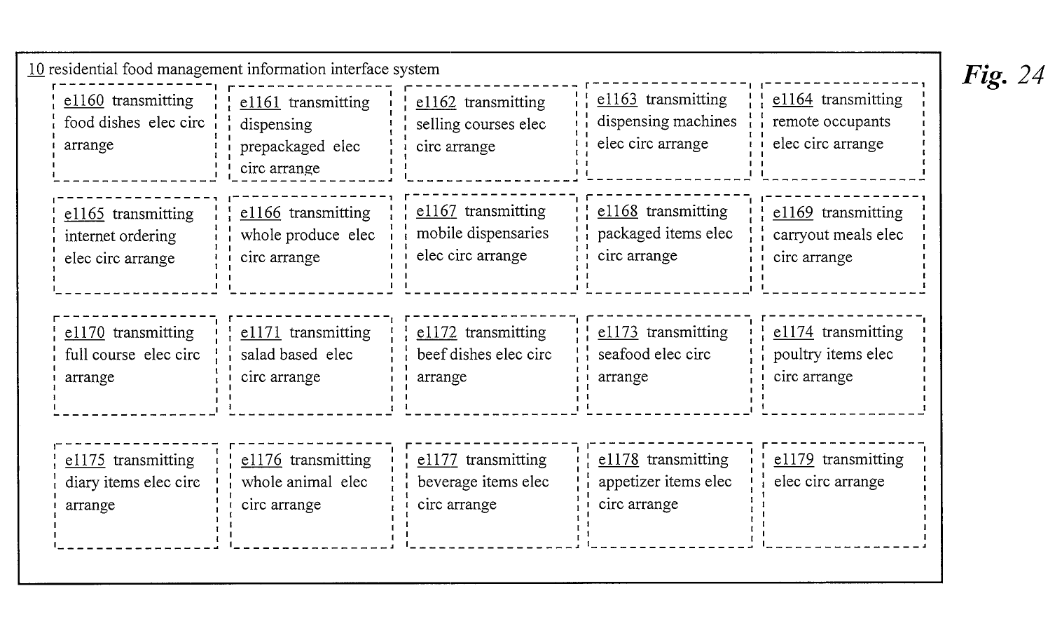

Some of these electrical circuitry arrangements are depicted in FIG. 24 to include transmitting food dishes electrical circuitry arrangement e1160, transmitting dispensing prepackaged electrical circuitry arrangement e1161, transmitting selling courses electrical circuitry arrangement e1162, transmitting dispensing machines electrical circuitry arrangement e1163, transmitting remote occupants electrical circuitry arrangement e1164, transmitting internet ordering electrical circuitry arrangement e1165, and transmitting whole produce electrical circuitry arrangement e1166, transmitting mobile dispensaries electrical circuitry arrangement e1167, transmitting packaged items electrical circuitry arrangement e1168, transmitting carryout meals electrical circuitry arrangement e1169, transmitting full course electrical circuitry arrangement e1170, transmitting salad based electrical circuitry arrangement e1171, transmitting beef dishes electrical circuitry arrangement e1172, transmitting seafood electrical circuitry arrangement e1173, transmitting poultry items electrical circuitry arrangement e1174, transmitting diary items electrical circuitry arrangement e1175, transmitting whole animal electrical circuitry arrangement e1176, transmitting beverage items electrical circuitry arrangement e1177, transmitting appetizer items electrical circuitry arrangement e1178, and transmitting electrical circuitry arrangement e1179.

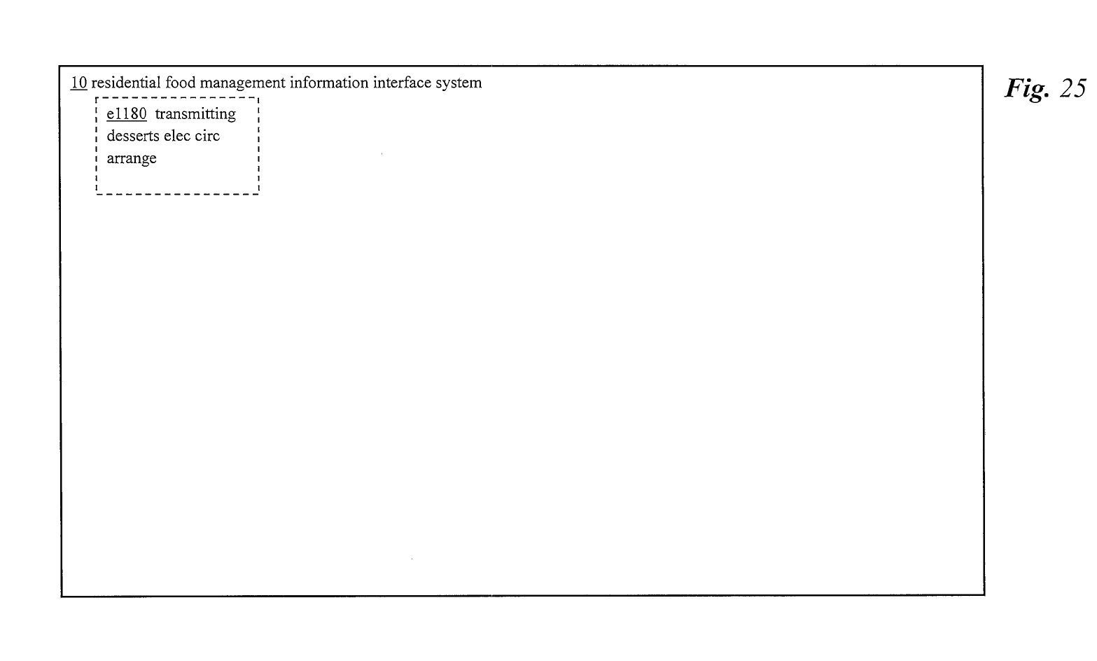

Some of these electrical circuitry arrangements are depicted in FIG. 25 to include transmitting desserts electrical circuitry arrangement e1180.

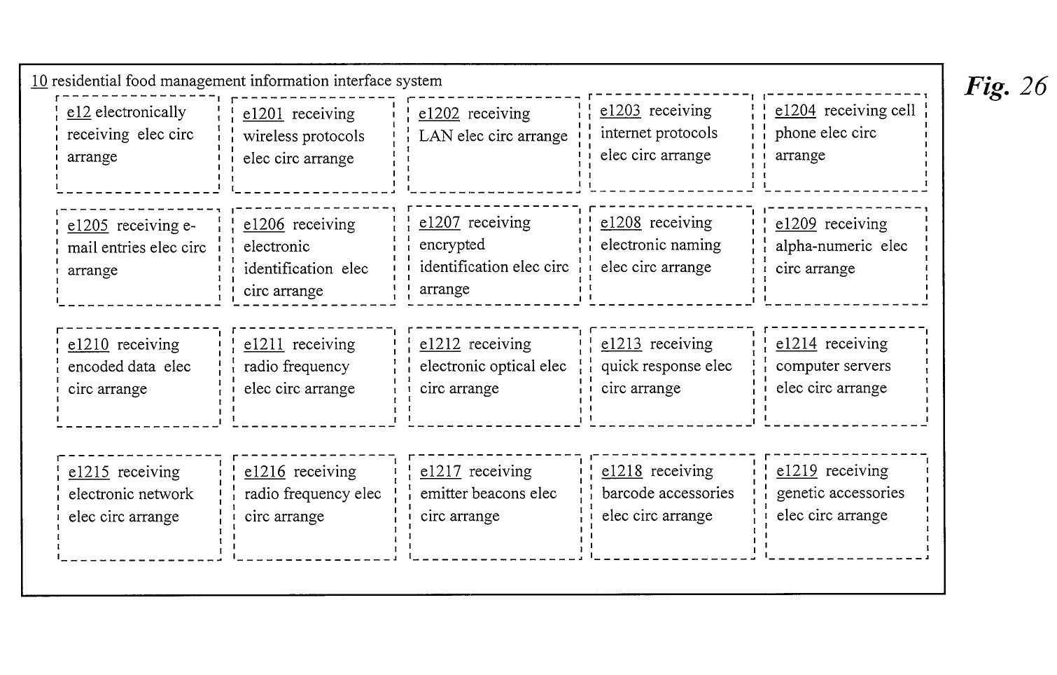

Some of these electrical circuitry arrangements are depicted in FIG. 26 to include electronically receiving electrical circuitry arrangement e12, receiving wireless protocols electrical circuitry arrangement e1201, receiving LAN electrical circuitry arrangement e1202, receiving internet protocols electrical circuitry arrangement e1203, receiving cell phone electrical circuitry arrangement e1204, receiving e-mail entries electrical circuitry arrangement e1205, receiving electronic identification electrical circuitry arrangement e1206, receiving encrypted identification electrical circuitry arrangement e1207, receiving electronic naming electrical circuitry arrangement e1208, receiving alpha-numeric electrical circuitry arrangement e1209, receiving encoded data electrical circuitry arrangement e1210, receiving radio frequency electrical circuitry arrangement e1211, and receiving electronic optical electrical circuitry arrangement e1212, receiving quick response electrical circuitry arrangement e1213, receiving computer servers electrical circuitry arrangement e1214, receiving electronic network electrical circuitry arrangement e1215, receiving radio frequency electrical circuitry arrangement e1216, receiving emitter beacons electrical circuitry arrangement e1217, receiving barcode accessories electrical circuitry arrangement e1218, and receiving genetic accessories electrical circuitry arrangement e1219.

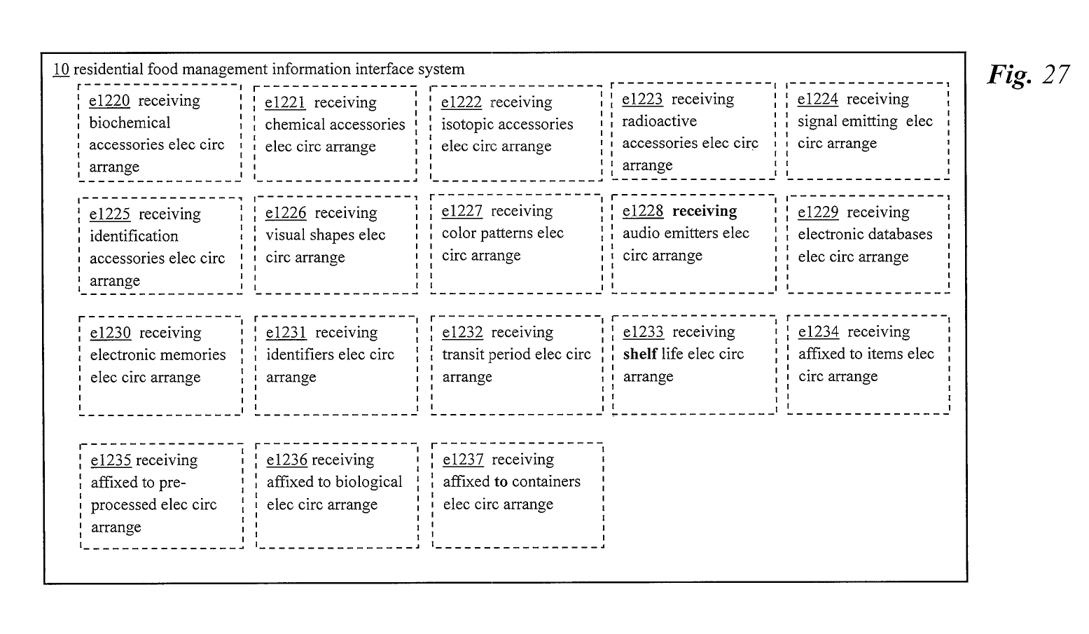

Some of these electrical circuitry arrangements are depicted in FIG. 27 to include receiving biochemical accessories electrical circuitry arrangement e1220, receiving chemical accessories electrical circuitry arrangement e1221, receiving isotopic accessories electrical circuitry arrangement e1222, receiving radioactive accessories electrical circuitry arrangement e1223, receiving signal emitting electrical circuitry arrangement e1224, receiving identification accessories electrical circuitry arrangement e1225, receiving visual shapes electrical circuitry arrangement e1226, receiving color patterns electrical circuitry arrangement e1227, receiving audio emitters electrical circuitry arrangement e1228, receiving electronic databases electrical circuitry arrangement e1229, receiving affixed to items electrical circuitry arrangement e1234, receiving identifiers electrical circuitry arrangement e1231, receiving transit period electrical circuitry arrangement e1232, receiving shelf life electrical circuitry arrangement e1233, receiving affixed to items electrical circuitry arrangement e1234, receiving affixed to pre-processed electrical circuitry arrangement e1235, receiving affixed to biological electrical circuitry arrangement e1236, and receiving affixed to containers electrical circuitry arrangement e1237.

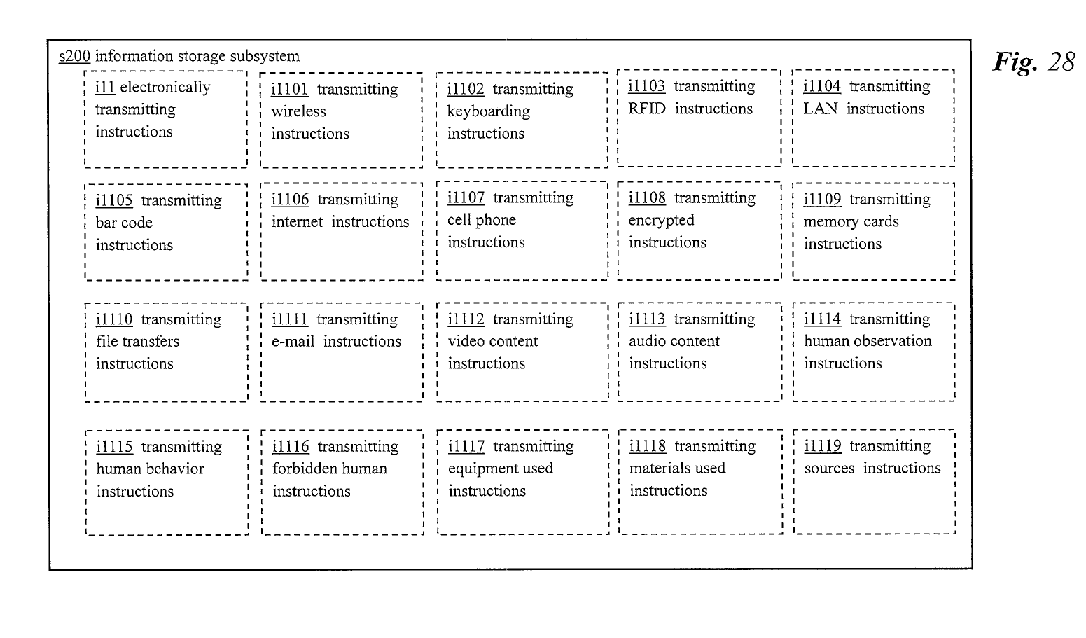

In implementations one or more instructions are stored and/or otherwise borne in various subsystems, components, and/or accessories of the residential food management information interface system 10 such as being borne in a non-transitory signal bearing medium of information storage subsystem s200. One or more exemplary instructions depicted in FIG. 28 as being borne in an exemplary version of a non-transitory signal bearing medium of information storage subsystem s200 include one or more electronically transmitting instructions i11, one or more transmitting wireless instructions i1101, one or more transmitting keyboarding instructions i1102, one or more transmitting RFID instructions i1103, one or more transmitting LAN instructions i1104, one or more transmitting bar code instructions i1105, one or more transmitting internet instructions i1106, one or more transmitting cell phone instructions i1107, one or more transmitting encrypted instructions i1108, one or more transmitting memory cards instructions i1109, one or more transmitting file transfers instructions i1110, one or more transmitting e-mail instructions i1111, one or more transmitting video content instructions i1112, one or more transmitting audio content instructions i1113, one or more transmitting human observation instructions i1114, one or more transmitting human behavior instructions i1115, one or more transmitting forbidden human instructions i1116, one or more transmitting equipment used instructions i1117, one or more transmitting materials used instructions i1118, and one or more transmitting sources instructions i1119.

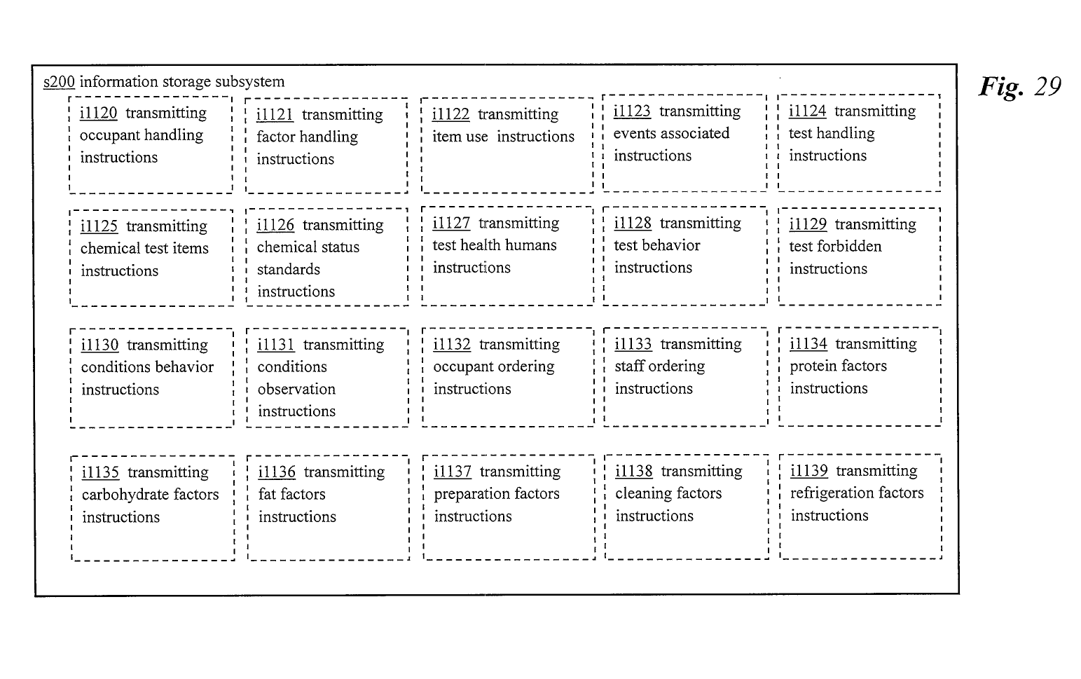

One or more exemplary instructions depicted in FIG. 29 as being borne in an exemplary version of a non-transitory signal bearing medium of information storage subsystem s200 include one or more transmitting occupant handling instructions i1120, one or more transmitting factor handling instructions i1121, one or more transmitting item use instructions i1122, one or more transmitting events associated instructions i1123, one or more transmitting test handling instructions i1124, one or more transmitting chemical test items instructions i1125, one or more transmitting chemical status standards instructions i1126, one or more transmitting test health humans instructions i1127, one or more transmitting test behavior instructions i1128, one or more transmitting test forbidden instructions i1129, one or more transmitting conditions behavior instructions i1130, one or more transmitting conditions observation instructions i1131, one or more transmitting occupant ordering instructions i1132, one or more transmitting staff ordering instructions i1133, one or more transmitting protein factors instructions i1134, one or more transmitting carbohydrate factors instructions i1135, one or more transmitting fat factors instructions i1136, one or more transmitting preparation factors instructions i1137, one or more transmitting cleaning factors instructions i1138, and one or more transmitting refrigeration factors instructions i1139.

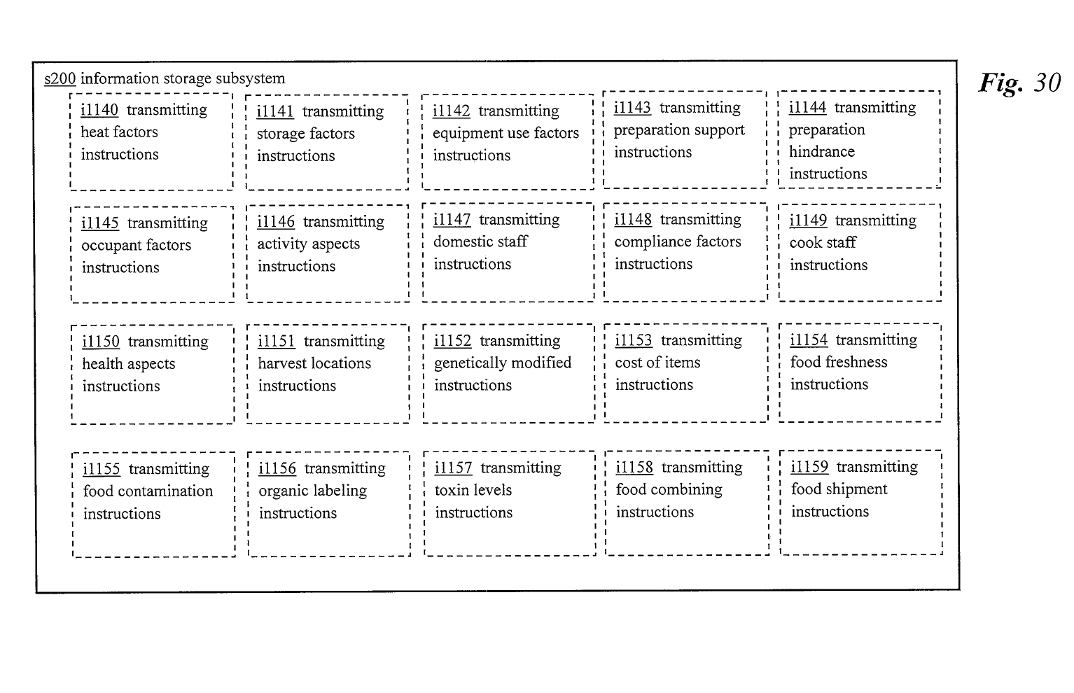

One or more exemplary instructions depicted in FIG. 30 as being borne in an exemplary version of a non-transitory signal bearing medium of information storage subsystem s200 include one or more transmitting heat factors instructions i1140, one or more transmitting storage factors instructions i1141, one or more transmitting equipment use factors instructions i1142, one or more transmitting preparation support instructions i1143, one or more transmitting preparation hindrance instructions i1144, one or more transmitting occupant factors instructions i1145, one or more transmitting activity aspects instructions i1146, one or more transmitting domestic staff instructions i1147, one or more transmitting compliance factors instructions i1148, one or more transmitting cook staff instructions i1149, one or more transmitting health aspects instructions i1150, one or more transmitting harvest locations instructions i1151, one or more transmitting genetically modified instructions i1152, one or more transmitting cost of items instructions i1153, one or more transmitting food freshness instructions i1154, one or more transmitting food contamination instructions i1155, one or more transmitting organic labeling instructions i1156, one or more transmitting toxin levels instructions i1157, one or more transmitting food combining instructions i1158, and one or more transmitting food shipment instructions i1159.

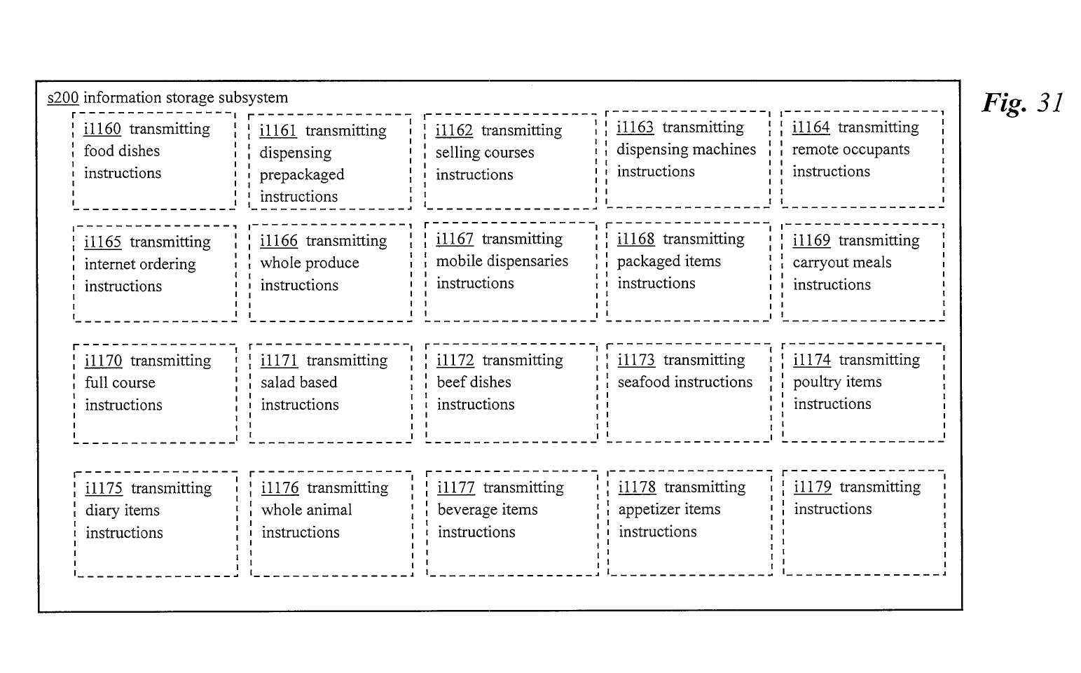

One or more exemplary instructions depicted in FIG. 31 as being borne in an exemplary version of a non-transitory signal bearing medium of information storage subsystem s200 include one or more transmitting food dishes instructions i1160, one or more transmitting dispensing prepackaged instructions i1161, one or more transmitting selling courses instructions i1162, one or more transmitting dispensing machines instructions i1163, one or more transmitting remote occupants instructions i1164, one or more transmitting internet ordering instructions i1165, and one or more transmitting whole produce instructions i1166, one or more transmitting mobile dispensaries instructions i1167, one or more transmitting packaged items instructions i1168, one or more transmitting carryout meals instructions i1169, one or more transmitting full course instructions i1170, one or more transmitting salad based instructions i1171, one or more transmitting beef dishes instructions i1172, one or more transmitting seafood instructions i1173, one or more transmitting poultry items instructions i1174, one or more transmitting diary items instructions i1175, one or more transmitting whole animal instructions i1176, one or more transmitting beverage items instructions i1177, one or more transmitting appetizer items instructions i1178, and one or more transmitting instructions i1179.

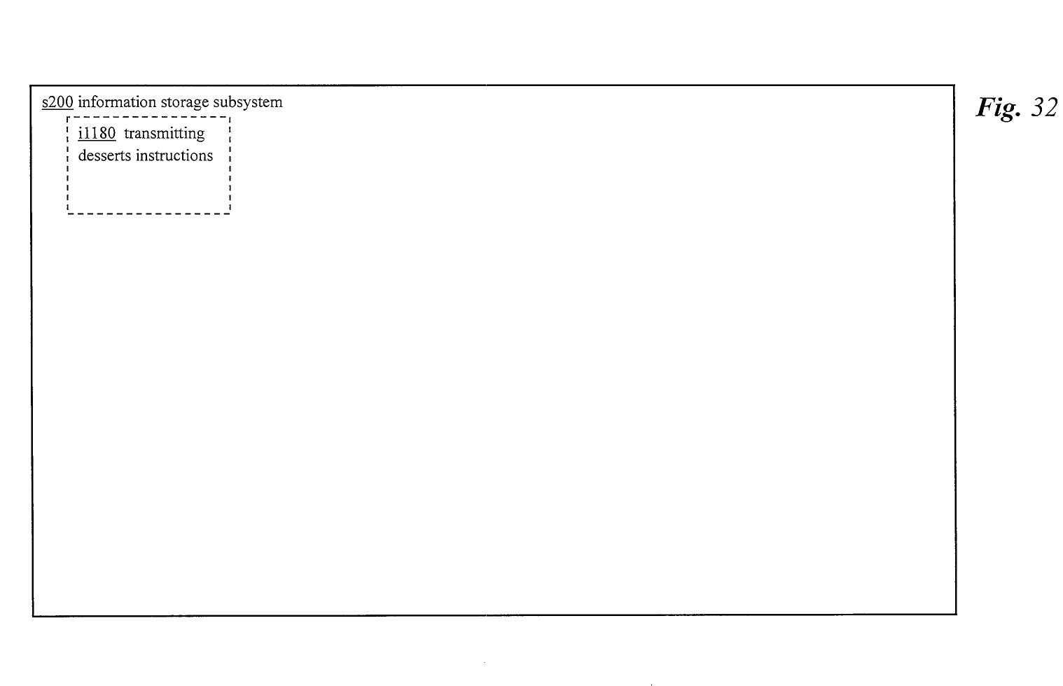

One or more exemplary instructions depicted in FIG. 32 as being borne in an exemplary version of a non-transitory signal bearing medium of information storage subsystem s200 include one or more transmitting desserts instructions i1180.

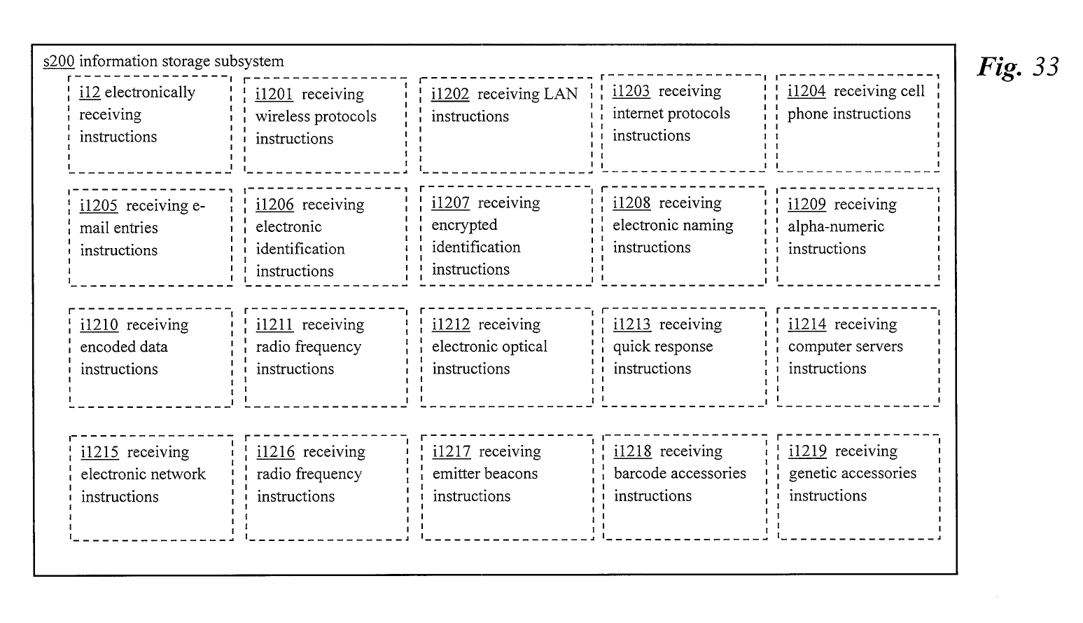

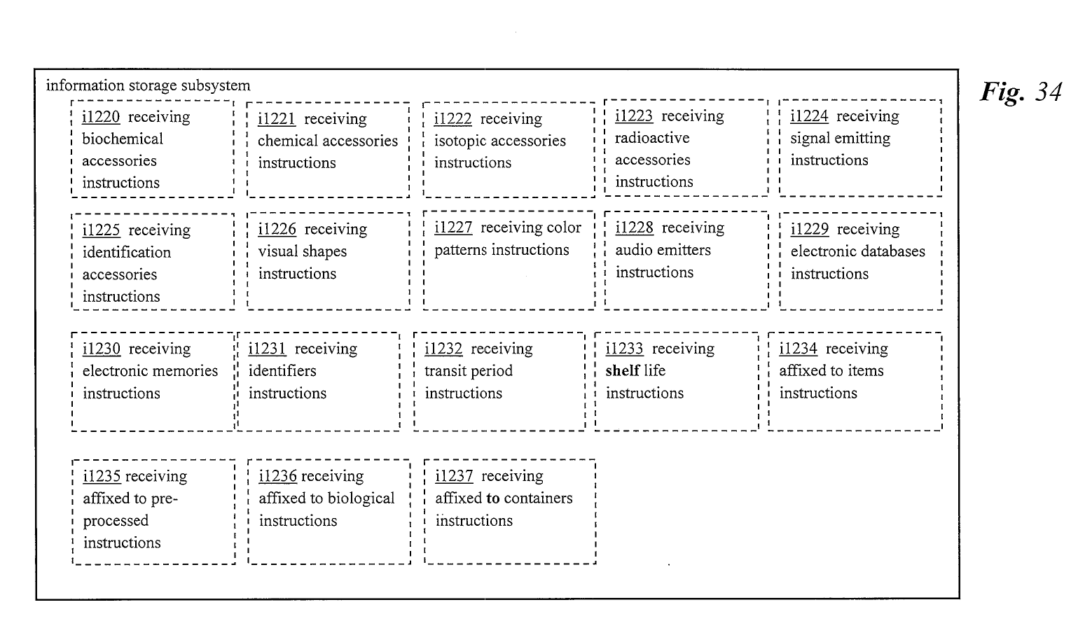

One or more exemplary instructions depicted in FIG. 33 as being borne in an exemplary version of a non-transitory signal bearing medium of information storage subsystem s200 include one or more electronically receiving instructions i12, one or more receiving wireless protocols instructions i1201, one or more receiving LAN instructions i1202, one or more receiving internet protocols instructions i1203, one or more receiving cell phone instructions i1204, one or more receiving e-mail entries instructions i1205, one or more receiving electronic identification instructions i1206, one or more receiving encrypted identification instructions i1207, one or more receiving electronic naming instructions i1208, one or more receiving alpha-numeric instructions i1209, one or more receiving encoded data instructions i1210, one or more receiving radio frequency instructions i1211, one or more receiving electronic optical instructions i1212, one or more receiving quick response instructions i1213, one or more receiving computer servers instructions i1214, one or more receiving electronic network instructions i1215, one or more receiving radio frequency instructions i1216, one or more receiving emitter beacons instructions i1217, one or more receiving barcode accessories instructions i1218, and one or more receiving genetic accessories instructions i1219. One or more exemplary instructions depicted in FIG. 34 as being borne in an exemplary version of a non-transitory signal bearing medium of information storage subsystem s200 include one or more receiving biochemical accessories instructions i1220, one or more receiving chemical accessories instructions i1221, one or more receiving isotopic accessories instructions i1222, one or more receiving radioactive accessories instructions i1223, one or more receiving signal emitting instructions i1224, one or more receiving identification accessories instructions i1225, one or more receiving visual shapes instructions i1226, one or more receiving color patterns instructions i1227, one or more receiving audio emitters instructions i1228, one or more receiving electronic databases instructions i1229, one or more receiving affixed to items instructions i1234, one or more receiving identifiers instructions i1231, one or more receiving transit period instructions i1232, one or more receiving shelf life instructions i1233, one or more receiving affixed to items instructions i1234, one or more receiving affixed to pre-processed instructions i1235, one or more receiving affixed to biological instructions i1236, and one or more receiving affixed to containers instructions i1237.

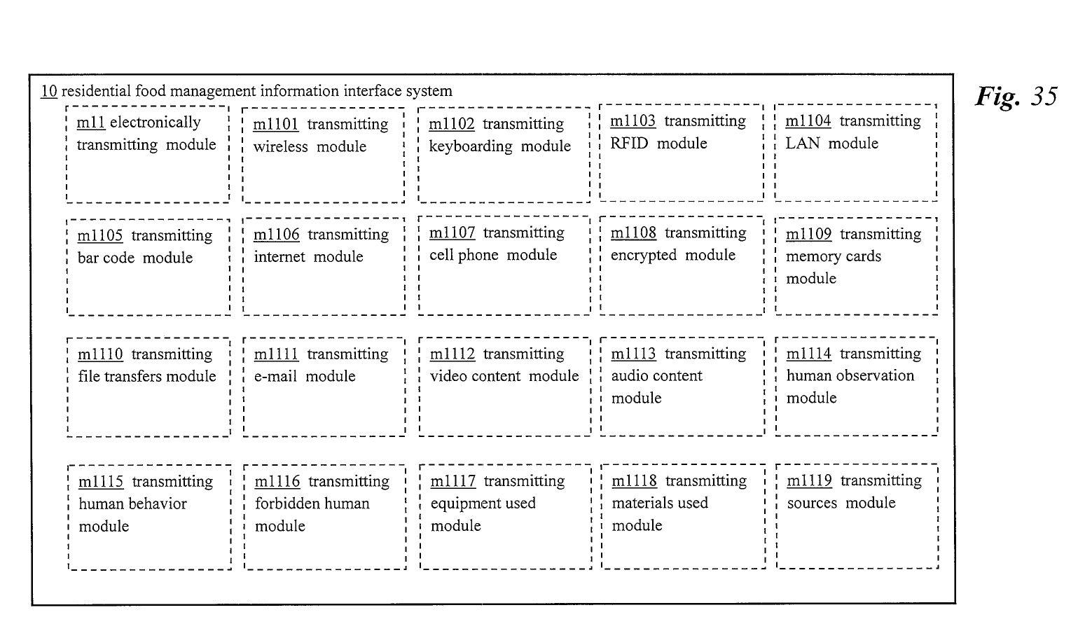

Implementations of modules involve different combinations (limited to patentable subject matter under 35 U.S.C. 101) of one or more aspects from one or more of the electrical circuitry arrangements and/or one or more aspects from one or more of the instructions of the residential food management information interface system 10. Exemplary depictions of some of these modules are shown in FIG. 35 to include electronically transmitting module m11, transmitting wireless module m1101, transmitting keyboarding module m1102, transmitting RFID module m1103, transmitting LAN module m1104, transmitting bar code module m1105, transmitting internet module m1106, transmitting cell phone module m1107, transmitting encrypted module m1108, transmitting memory cards module m1109, transmitting file transfers module m1110, transmitting e-mail module m1111, transmitting video content module m1112, transmitting audio content module m1113, transmitting human observation module m1114, transmitting human behavior module m1115, transmitting forbidden human module m1116, transmitting equipment used module m1117, transmitting materials used module m1118, and transmitting sources module m1119.

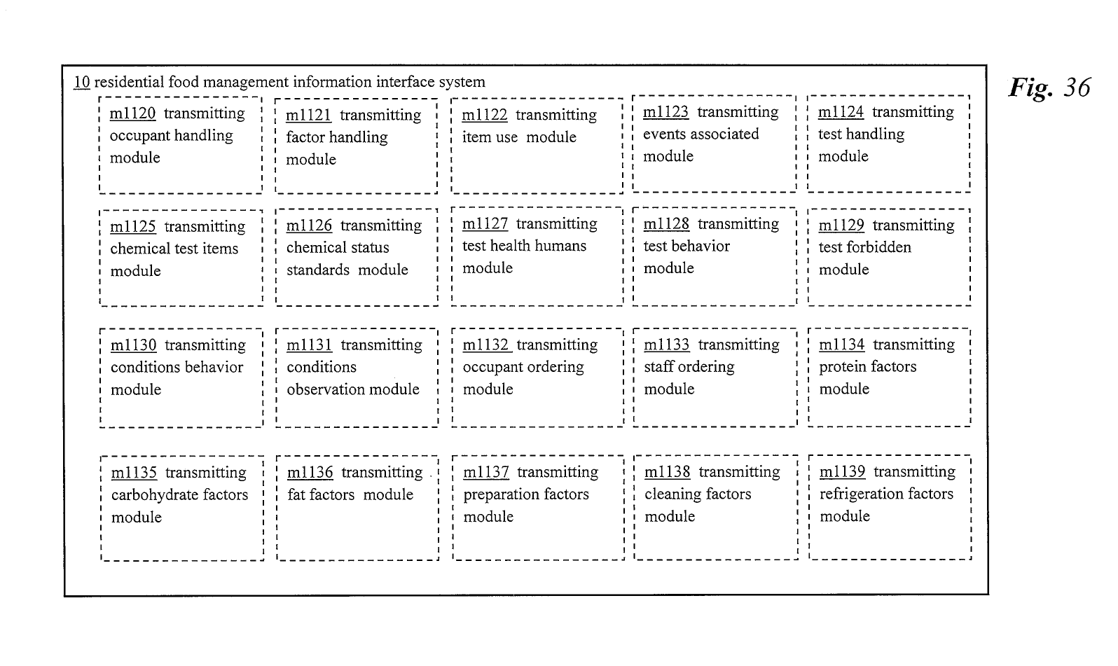

Some of these modules are depicted in FIG. 36 to include transmitting occupant handling module m1120, transmitting factor handling module m1121, transmitting item use module m1122, transmitting events associated module m1123, transmitting test handling module m1124, transmitting chemical test items module m1125, transmitting chemical status standards module m1126, transmitting test health humans module m1127, transmitting test behavior module m1128, transmitting test forbidden module m1129, transmitting conditions behavior module m1130, transmitting conditions observation module m113, transmitting occupant ordering module m1132, transmitting staff ordering module m1133, transmitting protein factors module m1134, transmitting carbohydrate factors module m1135, transmitting fat factors module m1136, transmitting preparation factors module m1137, transmitting cleaning factors module m1138, and transmitting refrigeration factors module m1139.

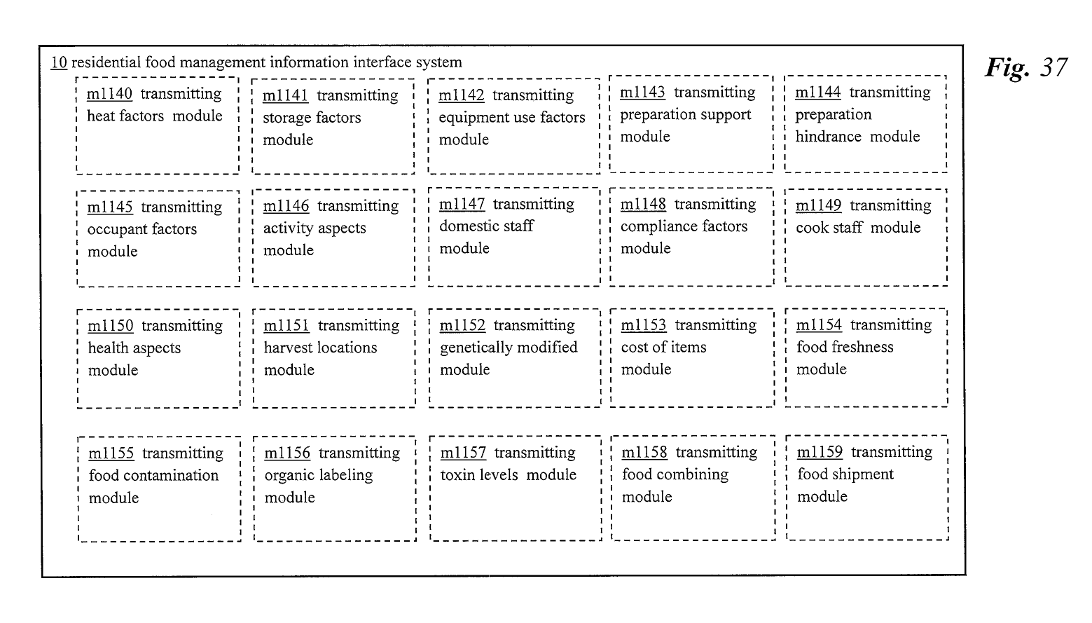

Some of these modules are depicted in FIG. 37 to include transmitting heat factors module m1140, transmitting storage factors module m1141, transmitting equipment use factors module m1142, transmitting preparation support module m1143, transmitting preparation hindrance module m1144, transmitting occupant factors module m1145, transmitting activity aspects module m1146, transmitting domestic staff module m1147, transmitting compliance factors module m1148, transmitting cook staff module m1149, transmitting health aspects module m1150, transmitting harvest locations module m1151, transmitting genetically modified module m1152, transmitting cost of items module m1153, transmitting food freshness module m1154, transmitting food contamination module m1155, transmitting organic labeling module m1156, transmitting toxin levels module m1157, transmitting food combining module m1158, and transmitting food shipment module m1159.

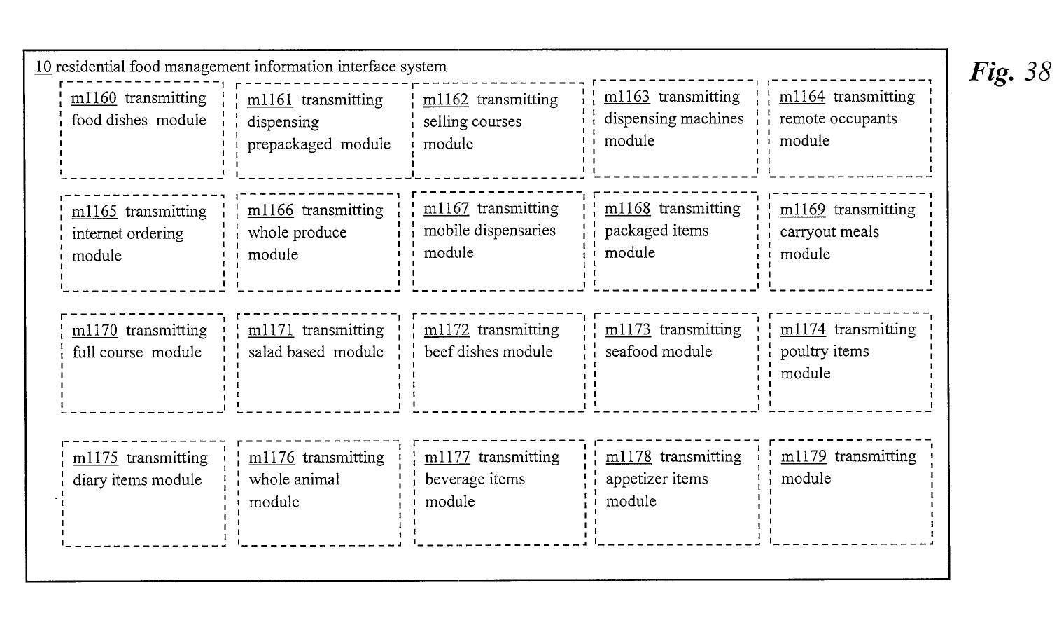

Some of these modules are depicted in FIG. 38 to include transmitting food dishes module m1160, transmitting dispensing prepackaged module m1161, transmitting selling courses module m1162, transmitting dispensing machines module m1163, transmitting remote occupants module m1164, transmitting internet ordering module m1165, and transmitting whole produce module m1166, transmitting mobile dispensaries module m1167, transmitting packaged items module m1168, transmitting carryout meals module m1169, transmitting full course module m1170, transmitting salad based module m1171, transmitting beef dishes module m1172, transmitting seafood module m1173, transmitting poultry items module m1174, transmitting diary items module m1175, transmitting whole animal module m1176, transmitting beverage items module m1177, transmitting appetizer items module m1178, and transmitting module m1179.

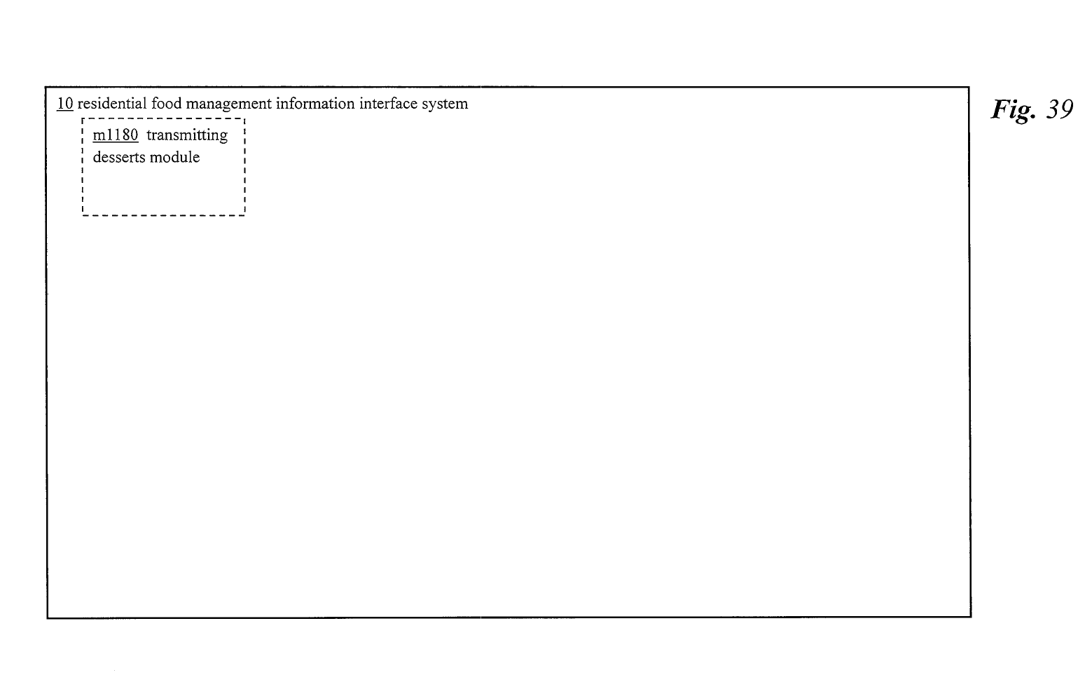

Some of these modules are depicted in FIG. 39 to include transmitting desserts.

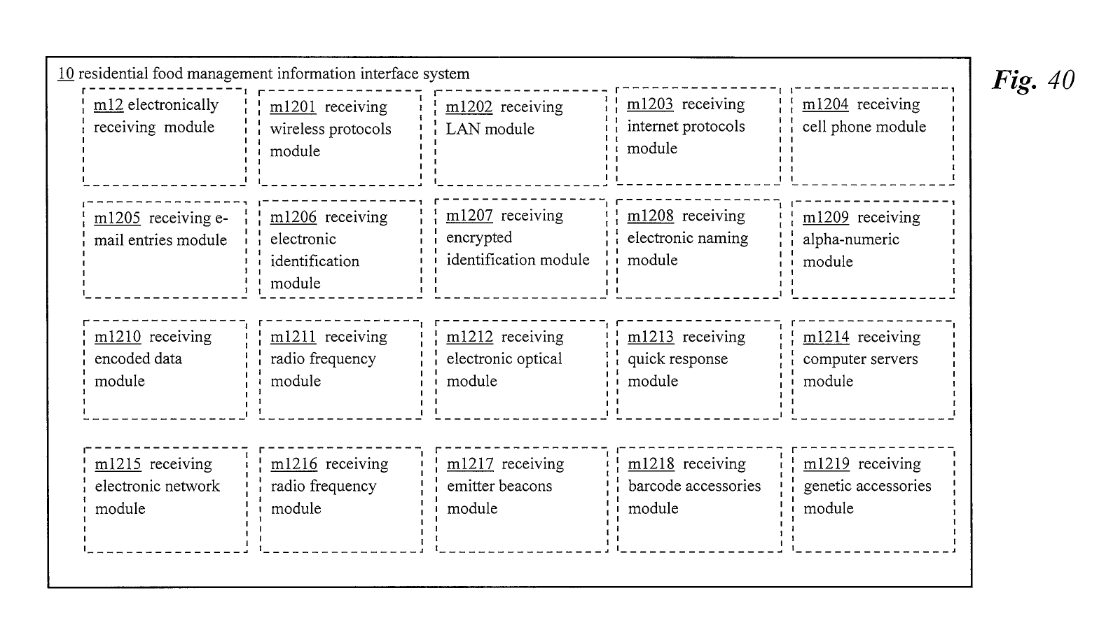

Some of these modules are depicted in FIG. 40 to include electronically receiving module m12, receiving wireless protocols module m1201, receiving LAN module m1202, receiving internet protocols module m1203, receiving cell phone module m1204, receiving e-mail entries module m1205, receiving electronic identification module m1206, receiving encrypted identification module m1207, receiving electronic naming module m1208, receiving alpha-numeric module m1209, receiving encoded data module m1210, receiving radio frequency module m1211, and receiving electronic optical module m1212, receiving quick response module m1213, receiving computer servers module m1214, receiving electronic network module m1215, receiving radio frequency module m1216, receiving emitter beacons module m1217, receiving barcode accessories module m1218, and receiving genetic accessories module m1219.

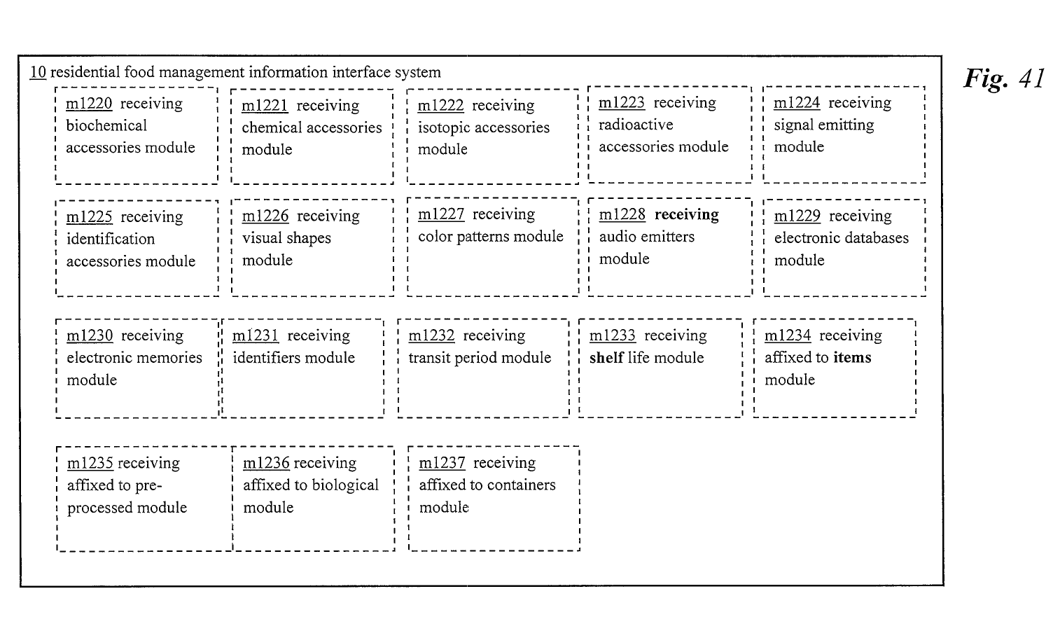

Some of these modules are depicted in FIG. 41 to include receiving biochemical accessories module m12, receiving chemical accessories module m1221, receiving isotopic accessories module m1222, receiving radioactive accessories module m1223, receiving signal emitting module m1224, receiving identification accessories module m1225, receiving visual shapes module m1226, receiving color patterns module m1227, receiving audio emitters module m1228, receiving electronic databases module m1229, receiving affixed to items module m1234, receiving identifiers module m1231, receiving transit period module m1232, receiving shelf life module m1233, receiving affixed to items module m1234, receiving affixed to pre-processed module m1235, receiving affixed to biological module m1236, and receiving affixed to containers module m1237.

In some implementations, non-transitory signal-bearing medium of information storage subsystem s200 as articles of manufacture may store the one or more exemplary instructions. In some implementations, the non-transitory signal bearing medium may include a computer-readable medium. In some implementations, the non-transitory signal-bearing medium may include a recordable medium. In some implementations, the signal-bearing medium may include a communication medium.

The various subsystems and components of the residential food management information interface system s10 such as the control and information processing subsystem s100, the information storage subsystem s200, the information user interface subsystems 300, the sensing subsystem s400 and the electronic communication subsystem s500 and their sub-components and the other exemplary entities depicted may be embodied by hardware, software and/or firmware (limited to patentable subject matter under 35 USC 101). For example, in some implementations of the residential food management information interface system s10, aspects may be implemented with a processor (e.g., microprocessor, controller, and so forth) executing computer readable instructions (e.g., computer program product) stored in a storage medium (e.g., volatile or non-volatile memory) such as a signal-bearing medium. Alternatively, hardware such as application specific integrated circuit (ASIC) may be employed in order to implement such modules in some alternative implementations.

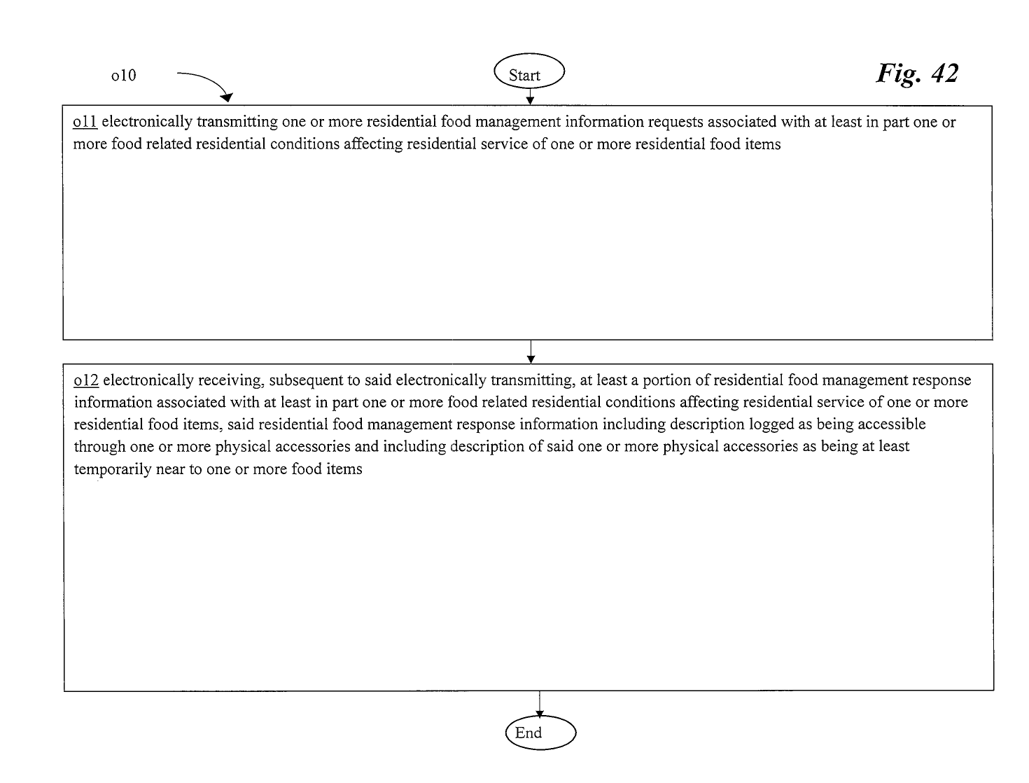

An operational flow o10 as shown in FIG. 42 represents example operations related to electronically transmitting one or more residential food management information requests associated with at least in part one or more food related residential conditions affecting residential service of one or more residential food items and electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items.

FIG. 42 and those figures that follow may have various examples of operational flows, and explanation may be provided with respect to the above-described examples of FIGS. 1-11 and/or with respect to other examples and contexts. Nonetheless, it should be understood that the operational flows may be executed in a number of other environments and contexts, and/or in modified versions of FIGS. 1-11. Furthermore, although the various operational flows are presented in the sequence(s) illustrated, it should be understood that the various operations may be performed in other orders than those which are illustrated, or may be performed concurrently.

In FIG. 42 and those figures that follow, various operations may be depicted in a box-within-a-box manner. Such depictions may indicate that an operation in an internal box may comprise an optional exemplary implementation of the operational step illustrated in one or more external boxes. However, it should be understood that internal box operations may be viewed as independent operations separate from any associated external boxes and may be performed in any sequence with respect to all other illustrated operations, or may be performed concurrently.

For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

As shown in FIG. 42, the operational flow o10 proceeds to operation o11 for electronically transmitting one or more residential food management information requests associated with at least in part one or more food related residential conditions affecting residential service of one or more residential food items. An exemplary version of a non-transitory signal bearing medium of information storage subsystem s200 is depicted as bearing one or more electronically transmitting instructions i11 that when executed will direct performance of the operation o11. In an implementation, the one or more electronically transmitting instructions i11 when executed direct electronically transmitting (e.g. wifi, laptop entry, RFID scan, etc.) one or more residential food management information requests (e.g. AVI file format, MP3 file format, audio listening, etc.) associated with at least in part (e.g. associated, affected, affecting, etc.) one or more food related residential conditions (e.g. organic produce delivery schedule, cost of residential labor, record keeping methods, etc.) affecting (e.g. associated, affected, affecting, etc.) residential service of (e.g. fine dining food item presentation, fast food item presentation, family buffet food item presentation, etc.) one or more residential food items (e.g. beef main course, pork main course, fish main course, etc.). Furthermore, the electronically transmitting electrical circuitry arrangement (“elec circ arrange”) e11 when activated will perform the operation o1101. Also, the transmitting wireless module m1101, when executed and/or activated, will direct performance of and/or performs the operation o11. In an implementation, the electronically transmitting electrical circuitry arrangement e11, when activated performs electronically transmitting (e.g. wifi, laptop entry, RFID scan, etc.) one or more residential food management information requests (e.g. AVI file format, MP3 file format, audio listening, etc.) associated with at least in part (e.g. associated, affected, affecting, etc.) one or more food related residential conditions (e.g. organic produce delivery schedule, cost of residential labor, record keeping methods, etc.) affecting (e.g. associated, affected, affecting, etc.) residential service of (e.g. fine dining food item presentation, fast food item presentation, family buffet food item presentation, etc.) one or more residential food items (e.g. beef main course, pork main course, fish main course, etc.). Also, the electronically transmitting module m11, when executed and/or activated, will direct performance of and/or perform the operation o11. In an implementation, the electronically transmitting one or more residential food management information requests associated with at least in part one or more food related residential conditions affecting residential service of one or more residential food items is carried out by electronically transmitting (e.g. wifi, laptop entry, RFID scan, etc.) one or more residential food management information requests (e.g. AVI file format, MP3 file format, audio listening, etc.) associated with at least in part (e.g. associated, affected, affecting, etc.) one or more food related residential conditions (e.g. organic produce delivery schedule, cost of residential labor, record keeping methods, etc.) affecting (e.g. associated, affected, affecting, etc.) residential service of (e.g. fine dining food item presentation, fast food item presentation, family buffet food item presentation, etc.) one or more residential food items (e.g. beef main course, pork main course, fish main course, etc.).

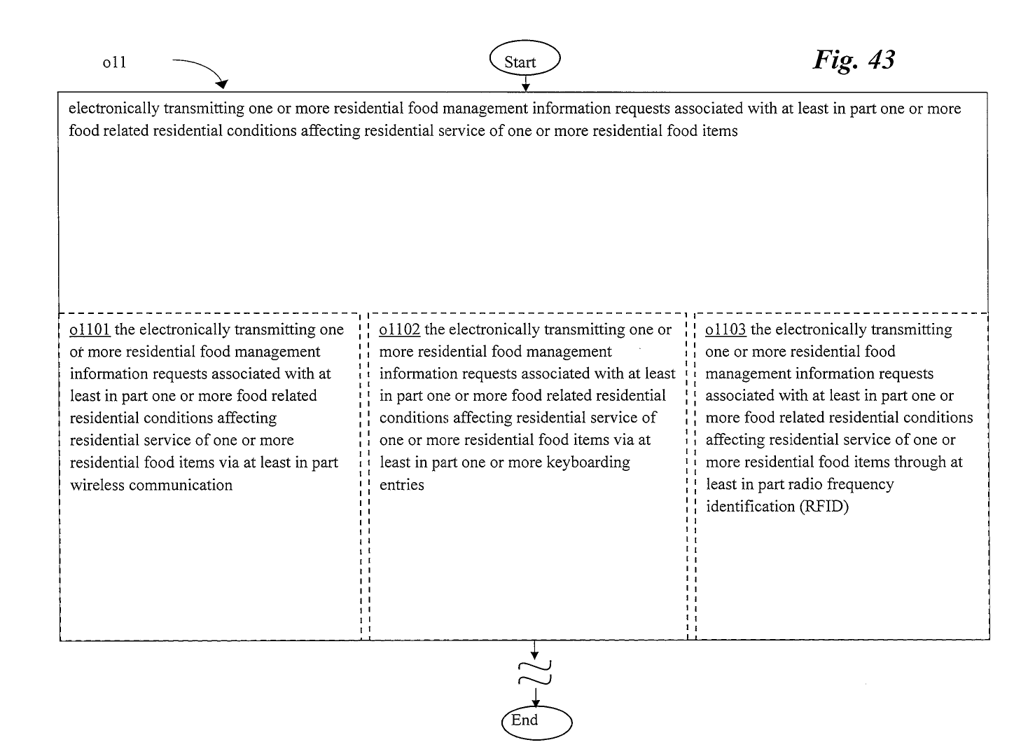

In one or more implementations, as shown in FIG. 43, operation o11 includes an operation o1101 for the electronically transmitting one or more residential food management information requests associated with at least in part one or more food related residential conditions affecting residential service of one or more residential food items via at least in part wireless communication. Origination of an illustratively derived transmitting wireless component group can be accomplished through skilled in the art design choice selection of one or more of the above depicted components from one or more of the above depicted subsystems shown in FIG. 12. Components from the transmitting wireless component group can be used in implementing execution of the one or more transmitting wireless instructions i1101 of FIG. 28, can be used in performance of the transmitting wireless electrical circuitry arrangement e1101 of FIG. 21, and/or can be used in otherwise fulfillment of the operation o1101. An exemplary non-transitory signal bearing medium version of the information storage subsystem s200 is depicted in FIG. 28 as bearing the one or more transmitting wireless instructions i1101 that when executed will direct performance of the operation o1101. Furthermore, the transmitting wireless electrical circuitry arrangement (“elec circ arrange”) e1101, when activated, will perform the operation o1101. Also, the transmitting wireless module m1101, when executed and/or activated, will direct performance of and/or perform the operation o1101. For instance, in one or more exemplary implementations, the one or more transmitting wireless instructions i1101, when executed, direct performance of the operation o1101 in the illustrative depiction as follows, and/or the transmitting wireless electrical circuitry arrangement e1101, when activated, performs the operation o1101 in the illustrative depiction as follows, and/or the transmitting wireless module m1101, when executed and/or activated, directs performance of and/or performs the operation o1101 in the illustrative depiction as follows, and/or the operation o1101 is otherwise carried out in the illustrative depiction as follows: the electronically transmitting (e.g. wifi, etc.) one or more residential food management information requests (e.g. AVI file format, etc.) associated with at least in part (e.g. associated, etc.) one or more food related residential conditions (e.g. organic produce delivery schedule, etc.) affecting (e.g. associated, etc.) residential service of (e.g. fine dining food item presentation, etc.) one or more residential food items (e.g. beef main course, etc.) via at least in part wireless communication (e.g. wifi, etc.).

In one or more implementations, as shown in FIG. 43, operation o11 includes an operation o1102 for the electronically transmitting one or more residential food management information requests associated with at least in part one or more food related residential conditions affecting residential service of one or more residential food items via at least in part one or more keyboarding entries. Origination of an illustratively derived transmitting keyboarding component group can be accomplished through skilled in the art design choice selection of one or more of the above depicted components from one or more of the above depicted subsystems shown in FIG. 12. Components from the transmitting keyboarding component group can be used in implementing execution of the one or more transmitting keyboarding instructions i1102 of FIG. 28, can be used in performance of the transmitting keyboarding electrical circuitry arrangement e1102 of FIG. 21, and/or can be used in otherwise fulfillment of the operation o1102. An exemplary non-transitory signal bearing medium version of the information storage subsystem s200 is depicted in FIG. 28 as bearing the one or more transmitting keyboarding instructions i1102 that when executed will direct performance of the operation o1102. Furthermore, the transmitting keyboarding electrical circuitry arrangement (“elec circ arrange”) e1102, when activated, will perform the operation o1102. Also, the transmitting keyboarding module m1102, when executed and/or activated, will direct performance of and/or perform the operation o1102. For instance, in one or more exemplary implementations, the one or more transmitting keyboarding instructions i1102, when executed, direct performance of the operation o1102 in the illustrative depiction as follows, and/or the transmitting keyboarding electrical circuitry arrangement e1102, when activated, performs the operation o1102 in the illustrative depiction as follows, and/or the transmitting keyboarding module m1102, when executed and/or activated, directs performance of and/or performs the operation o1102 in the illustrative depiction as follows, and/or the operation o1102 is otherwise carried out in the illustrative depiction as follows: the electronically transmitting (e.g. laptop entry, etc.) one or more residential food management information requests (e.g. MP3 file format, etc.) associated with at least in part (e.g. affected, etc.) one or more food related residential conditions (e.g. cost of residential labor, etc.) affecting (e.g. affected, etc.) residential service of (e.g. fast food item presentation, etc.) one or more residential food items (e.g. pork main course, etc.) via at least in part one or more keyboarding entries (e.g. laptop entry, etc.).

In one or more implementations, as shown in FIG. 43, operation o11 includes an operation o1103 for the electronically transmitting one or more residential food management information requests associated with at least in part one or more food related residential conditions affecting residential service of one or more residential food items through at least in part radio frequency identification (RFID). Origination of an illustratively derived transmitting RFID component group can be accomplished through skilled in the art design choice selection of one or more of the above depicted components from one or more of the above depicted subsystems shown in FIG. 12. Components from the transmitting RFID component group can be used in implementing execution of the one or more transmitting RFID instructions i1103 of FIG. 28, can be used in performance of the transmitting RFID electrical circuitry arrangement e1103 of FIG. 21, and/or can be used in otherwise fulfillment of the operation o1103. An exemplary non-transitory signal bearing medium version of the information storage subsystem s200 is depicted in FIG. 28 as bearing the one or more transmitting RFID instructions i1103 that when executed will direct performance of the operation o1103. Furthermore, the transmitting RFID electrical circuitry arrangement (“elec circ arrange”) e1103, when activated, will perform the operation o1103. Also, the transmitting RFID module m1103, when executed and/or activated, will direct performance of and/or perform the operation o1103. For instance, in one or more exemplary implementations, the one or more transmitting RFID instructions i1103, when executed, direct performance of the operation o1103 in the illustrative depiction as follows, and/or the transmitting RFID electrical circuitry arrangement e1103, when activated, performs the operation o1103 in the illustrative depiction as follows, and/or the transmitting RFID module m1103, when executed and/or activated, directs performance of and/or performs the operation o1103 in the illustrative depiction as follows, and/or the operation o1103 is otherwise carried out in the illustrative depiction as follows: the electronically transmitting (e.g. RFID scan, etc.) one or more residential food management information requests (e.g. audio listening, etc.) associated with at least in part (e.g. affecting, etc.) one or more food related residential conditions (e.g. record keeping methods, etc.) affecting (e.g. affecting, etc.) residential service of (e.g. family buffet food item presentation, etc.) one or more residential food items (e.g. fish main course, etc.) through at least in part radio frequency identification (RFID) (e.g. RFID scan, etc.).

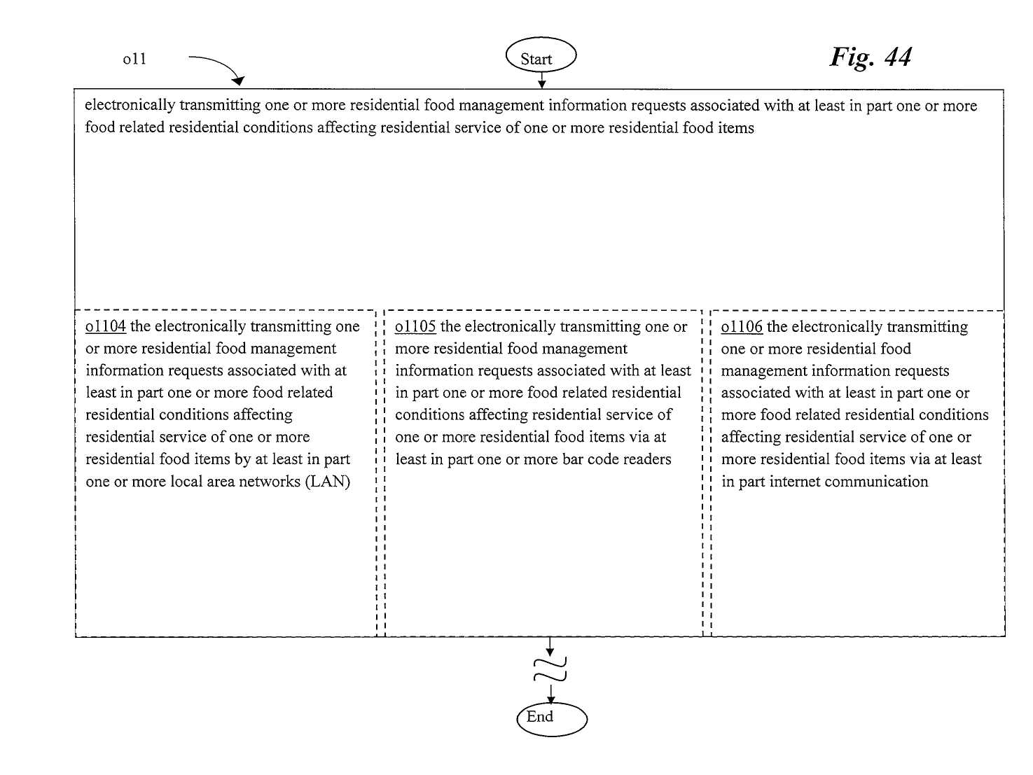

In one or more implementations, as shown in FIG. 44, operation o11 includes an operation o1104 for the electronically transmitting one or more residential food management information requests associated with at least in part one or more food related residential conditions affecting residential service of one or more residential food items by at least in part one or more local area networks (LAN). Origination of an illustratively derived transmitting LAN component group can be accomplished through skilled in the art design choice selection of one or more of the above depicted components from one or more of the above depicted subsystems shown in FIG. 12. Components from the transmitting LAN component group can be used in implementing execution of the one or more transmitting LAN instructions i1104 of FIG. 28, can be used in performance of the transmitting LAN electrical circuitry arrangement e1104 of FIG. 21, and/or can be used in otherwise fulfillment of the operation o1104. An exemplary non-transitory signal bearing medium version of the information storage subsystem s200 is depicted in FIG. 28 as bearing the one or more transmitting LAN instructions i1104 that when executed will direct performance of the operation o1104. Furthermore, the transmitting LAN electrical circuitry arrangement (“elec circ arrange”) e1104, when activated, will perform the operation o1104. Also, the transmitting LAN module m1104, when executed and/or activated, will direct performance of and/or perform the operation o1104. For instance, in one or more exemplary implementations, the one or more transmitting LAN instructions i1104, when executed, direct performance of the operation o1104 in the illustrative depiction as follows, and/or the transmitting LAN electrical circuitry arrangement e1104, when activated, performs the operation o1104 in the illustrative depiction as follows, and/or the transmitting LAN module m1104, when executed and/or activated, directs performance of and/or performs the operation o1104 in the illustrative depiction as follows, and/or the operation o1104 is otherwise carried out in the illustrative depiction as follows: the electronically transmitting (e.g. ethernet, etc.) one or more residential food management information requests (e.g. disobeying safety protocols, etc.) associated with at least in part (e.g. argue, etc.) one or more food related residential conditions (e.g. certification deadlines, etc.) affecting (e.g. argue, etc.) residential service of (e.g. mobile catering food item presentation, etc.) one or more residential food items (e.g. tofu main course, etc.) by at least in part one or more local area networks (LAN) (e.g. ethernet, etc.).

In one or more implementations, as shown in FIG. 44, operation o11 includes an operation o1105 for the electronically transmitting one or more residential food management information requests associated with at least in part one or more food related residential conditions affecting residential service of one or more residential food items via at least in part one or more bar code readers. Origination of an illustratively derived transmitting bar code component group can be accomplished through skilled in the art design choice selection of one or more of the above depicted components from one or more of the above depicted subsystems shown in FIG. 12. Components from the transmitting bar code component group can be used in implementing execution of the one or more transmitting bar code instructions i1105 of FIG. 28, can be used in performance of the transmitting bar code electrical circuitry arrangement e1105 of FIG. 21, and/or can be used in otherwise fulfillment of the operation o1105. An exemplary non-transitory signal bearing medium version of the information storage subsystem s200 is depicted in FIG. 28 as bearing the one or more transmitting bar code instructions i1105 that when executed will direct performance of the operation o1105. Furthermore, the transmitting bar code electrical circuitry arrangement (“elec circ arrange”) e1105, when activated, will perform the operation o1105. Also, the transmitting bar code module m1105, when executed and/or activated, will direct performance of and/or perform the operation o1105. For instance, in one or more exemplary implementations, the one or more transmitting bar code instructions i1105, when executed, direct performance of the operation o1105 in the illustrative depiction as follows, and/or the transmitting bar code electrical circuitry arrangement e1105, when activated, performs the operation o1105 in the illustrative depiction as follows, and/or the transmitting bar code module m1105, when executed and/or activated, directs performance of and/or performs the operation o1105 in the illustrative depiction as follows, and/or the operation o1105 is otherwise carried out in the illustrative depiction as follows: the electronically transmitting (e.g. UPC scan, etc.) one or more residential food management information requests (e.g. preparation rates of residential food items, etc.) associated with at least in part (e.g. connected, etc.) one or more food related residential conditions (e.g. types of food items on order, etc.) affecting (e.g. connected, etc.) residential service of (e.g. institutional home food item presentation, etc.) one or more residential food items (e.g. chicken main course, etc.) via at least in part one or more bar code readers (e.g. UPC scan, etc.).

In one or more implementations, as shown in FIG. 44, operation o11 includes an operation o1106 for the electronically transmitting one or more residential food management information requests associated with at least in part one or more food related residential conditions affecting residential service of one or more residential food items via at least in part internet communication. Origination of an illustratively derived transmitting internet component group can be accomplished through skilled in the art design choice selection of one or more of the above depicted components from one or more of the above depicted subsystems shown in FIG. 12. Components from the transmitting internet component group can be used in implementing execution of the one or more transmitting internet instructions i1106 of FIG. 28, can be used in performance of the transmitting internet electrical circuitry arrangement e1106 of FIG. 21, and/or can be used in otherwise fulfillment of the operation o1106. An exemplary non-transitory signal bearing medium version of the information storage subsystem s200 is depicted in FIG. 28 as bearing the one or more transmitting internet instructions i1106 that when executed will direct performance of the operation o1106. Furthermore, the transmitting internet electrical circuitry arrangement (“elec circ arrange”) e1106, when activated, will perform the operation o1106. Also, the transmitting internet module m1106, when executed and/or activated, will direct performance of and/or perform the operation o1106. For instance, in one or more exemplary implementations, the one or more transmitting internet instructions i1106, when executed, direct performance of the operation o1106 in the illustrative depiction as follows, and/or the transmitting internet electrical circuitry arrangement e1106, when activated, performs the operation o1106 in the illustrative depiction as follows, and/or the transmitting internet module m1106, when executed and/or activated, directs performance of and/or performs the operation o1106 in the illustrative depiction as follows, and/or the operation o1106 is otherwise carried out in the illustrative depiction as follows: the electronically transmitting (e.g. HTML code, etc.) one or more residential food management information requests (e.g. food poisoning reports, etc.) associated with at least in part (e.g. commit to, etc.) one or more food related residential conditions (e.g. banned food preparation practices, etc.) affecting (e.g. commit to, etc.) residential service of (e.g. school lunch food item presentation, etc.) one or more residential food items (e.g. seafood main course, etc.) via at least in part internet communication (e.g. HTML code, etc.).

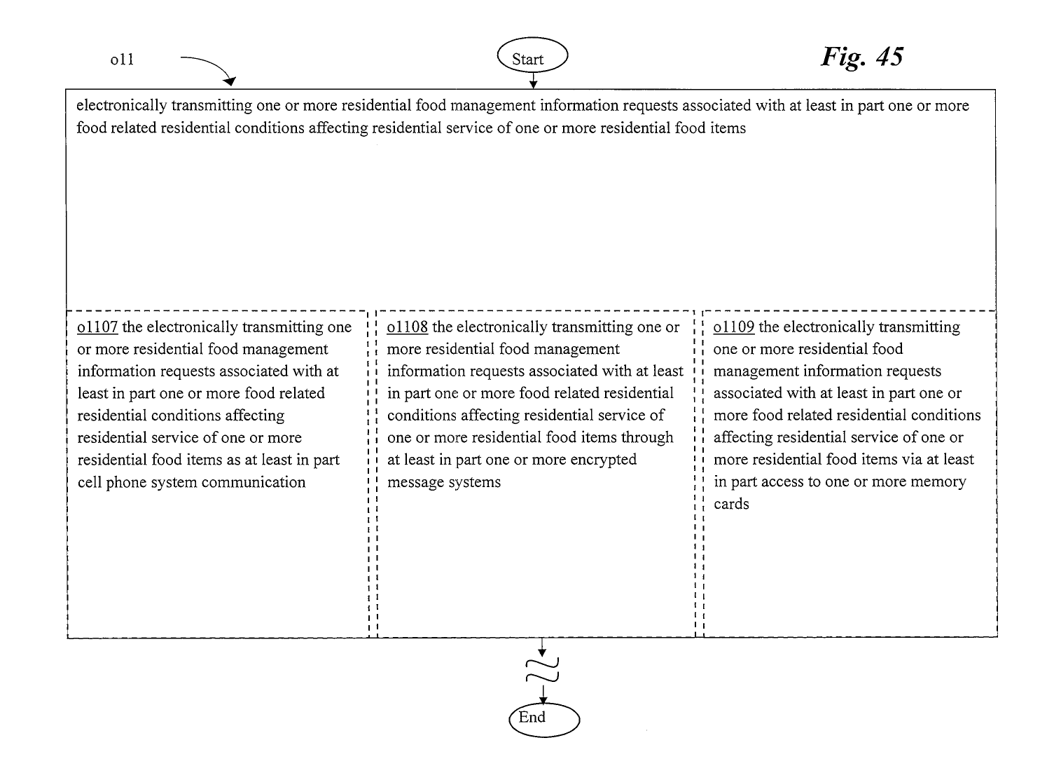

In one or more implementations, as shown in FIG. 45, operation o11 includes an operation o1107 for the electronically transmitting one or more residential food management information requests associated with at least in part one or more food related residential conditions affecting residential service of one or more residential food items as at least in part cell phone system communication. Origination of an illustratively derived transmitting cell phone component group can be accomplished through skilled in the art design choice selection of one or more of the above depicted components from one or more of the above depicted subsystems shown in FIG. 12. Components from the transmitting cell phone component group can be used in implementing execution of the one or more transmitting cell phone instructions i1107 of FIG. 28, can be used in performance of the transmitting cell phone electrical circuitry arrangement e1107 of FIG. 21, and/or can be used in otherwise fulfillment of the operation o1107. An exemplary non-transitory signal bearing medium version of the information storage subsystem s200 is depicted in FIG. 28 as bearing the one or more transmitting cell phone instructions i1107 that when executed will direct performance of the operation o1107. Furthermore, the transmitting cell phone electrical circuitry arrangement (“elec circ arrange”) e1107, when activated, will perform the operation o1107. Also, the transmitting cell phone module m1107, when executed and/or activated, will direct performance of and/or perform the operation o1107. For instance, in one or more exemplary implementations, the one or more transmitting cell phone instructions i1107, when executed, direct performance of the operation o1107 in the illustrative depiction as follows, and/or the transmitting cell phone electrical circuitry arrangement e1107, when activated, performs the operation o1107 in the illustrative depiction as follows, and/or the transmitting cell phone module m1107, when executed and/or activated, directs performance of and/or performs the operation o1107 in the illustrative depiction as follows, and/or the operation o1107 is otherwise carried out in the illustrative depiction as follows: the electronically transmitting (e.g. MMS, etc.) one or more residential food management information requests (e.g. residential occupant illness reports, etc.) associated with at least in part (e.g. absorbed by, etc.) one or more food related residential conditions (e.g. amount of seasonal residential occupant traffic, etc.) affecting (e.g. absorbed by, etc.) residential service of (e.g. elderly home food item presentation, etc.) one or more residential food items (e.g. poultry main course, etc.) as at least in part cell phone system communication (e.g. MMS, etc.).

In one or more implementations, as shown in FIG. 45, operation o11 includes an operation o1108 for the electronically transmitting one or more residential food management information requests associated with at least in part one or more food related residential conditions affecting residential service of one or more residential food items through at least in part one or more encrypted message systems. Origination of an illustratively derived transmitting encrypted component group can be accomplished through skilled in the art design choice selection of one or more of the above depicted components from one or more of the above depicted subsystems shown in FIG. 12. Components from the transmitting encrypted component group can be used in implementing execution of the one or more transmitting encrypted instructions i1108 of FIG. 28, can be used in performance of the transmitting encrypted electrical circuitry arrangement e1108 of FIG. 21, and/or can be used in otherwise fulfillment of the operation o1108. An exemplary non-transitory signal bearing medium version of the information storage subsystem s200 is depicted in FIG. 28 as bearing the one or more transmitting encrypted instructions i1108 that when executed will direct performance of the operation o1108. Furthermore, the transmitting encrypted electrical circuitry arrangement (“elec circ arrange”) e1108, when activated, will perform the operation o1108. Also, the transmitting encrypted module m1108, when executed and/or activated, will direct performance of and/or perform the operation o1108. For instance, in one or more exemplary implementations, the one or more transmitting encrypted instructions i1108, when executed, direct performance of the operation o1108 in the illustrative depiction as follows, and/or the transmitting encrypted electrical circuitry arrangement e1108, when activated, performs the operation o1108 in the illustrative depiction as follows, and/or the transmitting encrypted module m1108, when executed and/or activated, directs performance of and/or performs the operation o1108 in the illustrative depiction as follows, and/or the operation o1108 is otherwise carried out in the illustrative depiction as follows: the electronically transmitting (e.g. 256-bit AES, etc.) one or more residential food management information requests (e.g. residential occupant frequency rates, etc.) associated with at least in part (e.g. embraced by, etc.) one or more food related residential conditions (e.g. predicted amounts of expenditures regarding particular residential food items, etc.) affecting (e.g. embraced by, etc.) residential service of (e.g. street vendor food item presentation, etc.) one or more residential food items (e.g. diary main course, etc.) through at least in part one or more encrypted message systems (e.g. 256-bit AES, etc.).

In one or more implementations, as shown in FIG. 45, operation o11 includes an operation o1109 for the electronically transmitting one or more residential food management information requests associated with at least in part one or more food related residential conditions affecting residential service of one or more residential food items via at least in part access to one or more memory cards. Origination of an illustratively derived transmitting memory cards component group can be accomplished through skilled in the art design choice selection of one or more of the above depicted components from one or more of the above depicted subsystems shown in FIG. 12. Components from the transmitting memory cards component group can be used in implementing execution of the one or more transmitting memory cards instructions i1109 of FIG. 28, can be used in performance of the transmitting memory cards electrical circuitry arrangement e1109 of FIG. 21, and/or can be used in otherwise fulfillment of the operation o1109. An exemplary non-transitory signal bearing medium version of the information storage subsystem s200 is depicted in FIG. 28 as bearing the one or more transmitting memory cards instructions i1109 that when executed will direct performance of the operation o1109. Furthermore, the transmitting memory cards electrical circuitry arrangement (“elec circ arrange”) e1109, when activated, will perform the operation o1109. Also, the transmitting memory cards module m1109, when executed and/or activated, will direct performance of and/or perform the operation o1109. For instance, in one or more exemplary implementations, the one or more transmitting memory cards instructions i1109, when executed, direct performance of the operation o1109 in the illustrative depiction as follows, and/or the transmitting memory cards electrical circuitry arrangement e1109, when activated, performs the operation o1109 in the illustrative depiction as follows, and/or the transmitting memory cards module m1109, when executed and/or activated, directs performance of and/or performs the operation o1109 in the illustrative depiction as follows, and/or the operation o1109 is otherwise carried out in the illustrative depiction as follows: the electronically transmitting (e.g. compact flash, etc.) one or more residential food management information requests (e.g. total residential occupant expenditures, etc.) associated with at least in part (e.g. containing, etc.) one or more food related residential conditions (e.g. fluctuations in workforce at residential locations, etc.) affecting (e.g. containing, etc.) residential service of (e.g. mobile kitchen food item presentation, etc.) one or more residential food items (e.g. vegetarian main course, etc.) via at least in part access to one or more memory cards (e.g. compact flash, etc.).

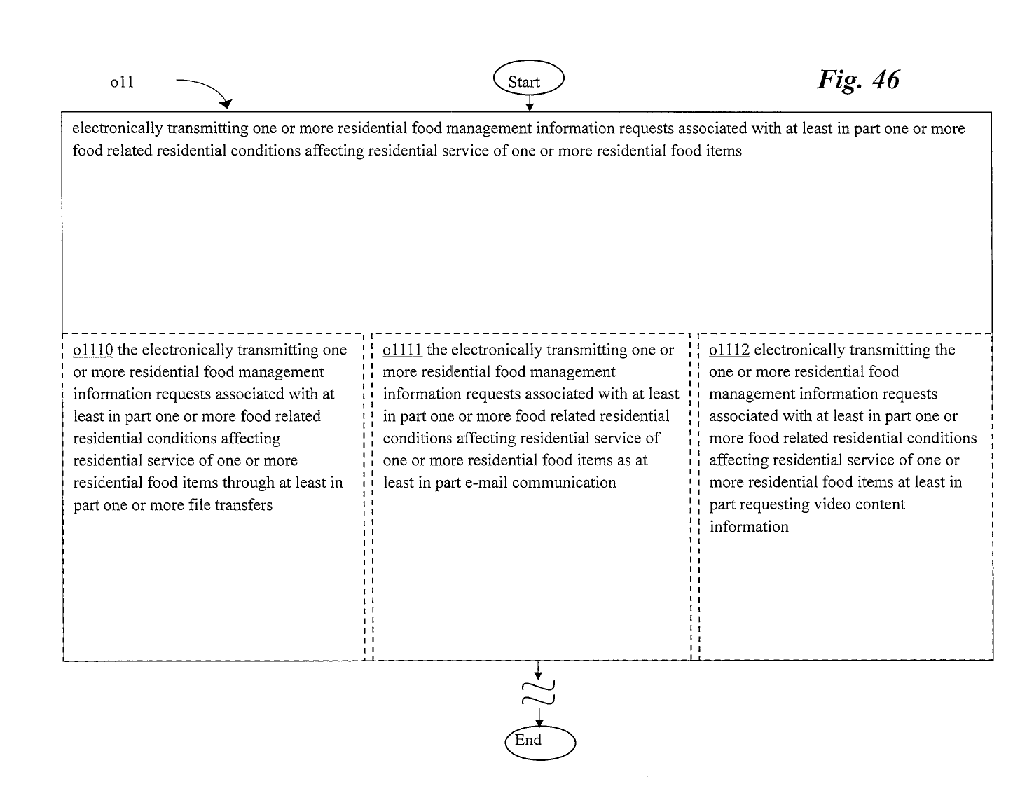

In one or more implementations, as shown in FIG. 46, operation o11 includes an operation o1110 for the electronically transmitting one or more residential food management information requests associated with at least in part one or more food related residential conditions affecting residential service of one or more residential food items through at least in part one or more file transfers. Origination of an illustratively derived transmitting file transfers component group can be accomplished through skilled in the art design choice selection of one or more of the above depicted components from one or more of the above depicted subsystems shown in FIG. 12. Components from the transmitting file transfers component group can be used in implementing execution of the one or more transmitting file transfers instructions i1110 of FIG. 28, can be used in performance of the transmitting file transfers electrical circuitry arrangement e1110 of FIG. 21, and/or can be used in otherwise fulfillment of the operation o1110. An exemplary non-transitory signal bearing medium version of the information storage subsystem s200 is depicted in FIG. 28 as bearing the one or more transmitting file transfers instructions i1110 that when executed will direct performance of the operation o1110. Furthermore, the transmitting file transfers electrical circuitry arrangement (“elec circ arrange”) e1110, when activated, will perform the operation o1110. Also, the transmitting file transfers module m1110, when executed and/or activated, will direct performance of and/or perform the operation o1110. For instance, in one or more exemplary implementations, the one or more transmitting file transfers instructions i1110, when executed, direct performance of the operation o1110 in the illustrative depiction as follows, and/or the transmitting file transfers electrical circuitry arrangement e1110, when activated, performs the operation o1110 in the illustrative depiction as follows, and/or the transmitting file transfers module m1110, when executed and/or activated, directs performance of and/or performs the operation o1110 in the illustrative depiction as follows, and/or the operation o1110 is otherwise carried out in the illustrative depiction as follows: the electronically transmitting (e.g. push-based, etc.) one or more residential food management information requests (e.g. average shelf life of produce used, etc.) associated with at least in part (e.g. engaging, etc.) one or more food related residential conditions (e.g. cost factors for preparation of residential meals, etc.) affecting (e.g. engaging, etc.) residential service of (e.g. visiting nursing food item presentation, etc.) one or more residential food items (e.g. salad main course, etc.) through at least in part one or more file transfers (e.g. push-based, etc.).

In one or more implementations, as shown in FIG. 46, operation o11 includes an operation o1111 for the electronically transmitting one or more residential food management information requests associated with at least in part one or more food related residential conditions affecting residential service of one or more residential food items as at least in part e-mail communication. Origination of an illustratively derived transmitting e-mail component group can be accomplished through skilled in the art design choice selection of one or more of the above depicted components from one or more of the above depicted subsystems shown in FIG. 12. Components from the transmitting e-mail component group can be used in implementing execution of the one or more transmitting e-mail instructions i1111 of FIG. 28, can be used in performance of the transmitting e-mail electrical circuitry arrangement e1111 of FIG. 21, and/or can be used in otherwise fulfillment of the operation o1111. An exemplary non-transitory signal bearing medium version of the information storage subsystem s200 is depicted in FIG. 28 as bearing the one or more transmitting e-mail instructions i1111 that when executed will direct performance of the operation o1111. Furthermore, the transmitting e-mail electrical circuitry arrangement (“elec circ arrange”) e1111, when activated, will perform the operation o1111. Also, the transmitting e-mail module m1111, when executed and/or activated, will direct performance of and/or perform the operation o1111. For instance, in one or more exemplary implementations, the one or more transmitting e-mail instructions i1111, when executed, direct performance of the operation o1111 in the illustrative depiction as follows, and/or the transmitting e-mail electrical circuitry arrangement e1111, when activated, performs the operation o1111 in the illustrative depiction as follows, and/or the transmitting e-mail module m1111, when executed and/or activated, directs performance of and/or performs the operation o1111 in the illustrative depiction as follows, and/or the operation o1111 is otherwise carried out in the illustrative depiction as follows: the electronically transmitting (e.g. SMTP server, etc.) one or more residential food management information requests (e.g. residential occupant accident reports, etc.) associated with at least in part (e.g. engaged by, etc.) one or more food related residential conditions (e.g. shipping costs incurred, etc.) affecting (e.g. engaged by, etc.) residential service of (e.g. deli aspects food item presentation, etc.) one or more residential food items (e.g. grain main course, etc.) as at least in part e-mail communication (e.g. SMTP server, etc.).

In one or more implementations, as shown in FIG. 46, operation o11 includes an operation o1112 for electronically transmitting the one or more residential food management information requests associated with at least in part one or more food related residential conditions affecting residential service of one or more residential food items at least in part requesting video content information. Origination of an illustratively derived transmitting video content component group can be accomplished through skilled in the art design choice selection of one or more of the above depicted components from one or more of the above depicted subsystems shown in FIG. 12. Components from the transmitting video content component group can be used in implementing execution of the one or more transmitting video content instructions i1112 of FIG. 28, can be used in performance of the transmitting video content electrical circuitry arrangement e1112 of FIG. 21, and/or can be used in otherwise fulfillment of the operation o1112. An exemplary non-transitory signal bearing medium version of the information storage subsystem s200 is depicted in FIG. 28 as bearing the one or more transmitting video content instructions i1112 that when executed will direct performance of the operation o1112. Furthermore, the transmitting video content electrical circuitry arrangement (“elec circ arrange”) e1112, when activated, will perform the operation o1112. Also, the transmitting video content module m1112, when executed and/or activated, will direct performance of and/or perform the operation o1112. For instance, in one or more exemplary implementations, the one or more transmitting video content instructions i1112, when executed, direct performance of the operation o1112 in the illustrative depiction as follows, and/or the transmitting video content electrical circuitry arrangement e1112, when activated, performs the operation o1112 in the illustrative depiction as follows, and/or the transmitting video content module m1112, when executed and/or activated, directs performance of and/or performs the operation o1112 in the illustrative depiction as follows, and/or the operation o1112 is otherwise carried out in the illustrative depiction as follows: electronically transmitting (e.g. radio wave, etc.) the one or more residential food management information requests (e.g. duration of time required to store received stock in refrigeration, etc.) associated with at least in part (e.g. incorporating, etc.) one or more food related residential conditions (e.g. shipping schedules involved with food items received by various grocers or farms to residential locations, etc.) affecting (e.g. incorporating, etc.) residential service of (e.g. fine dining food item purchases, etc.) one or more residential food items (e.g. bean main course, etc.) at least in part requesting video content information (e.g. video content of residential staff handling food items, etc.).

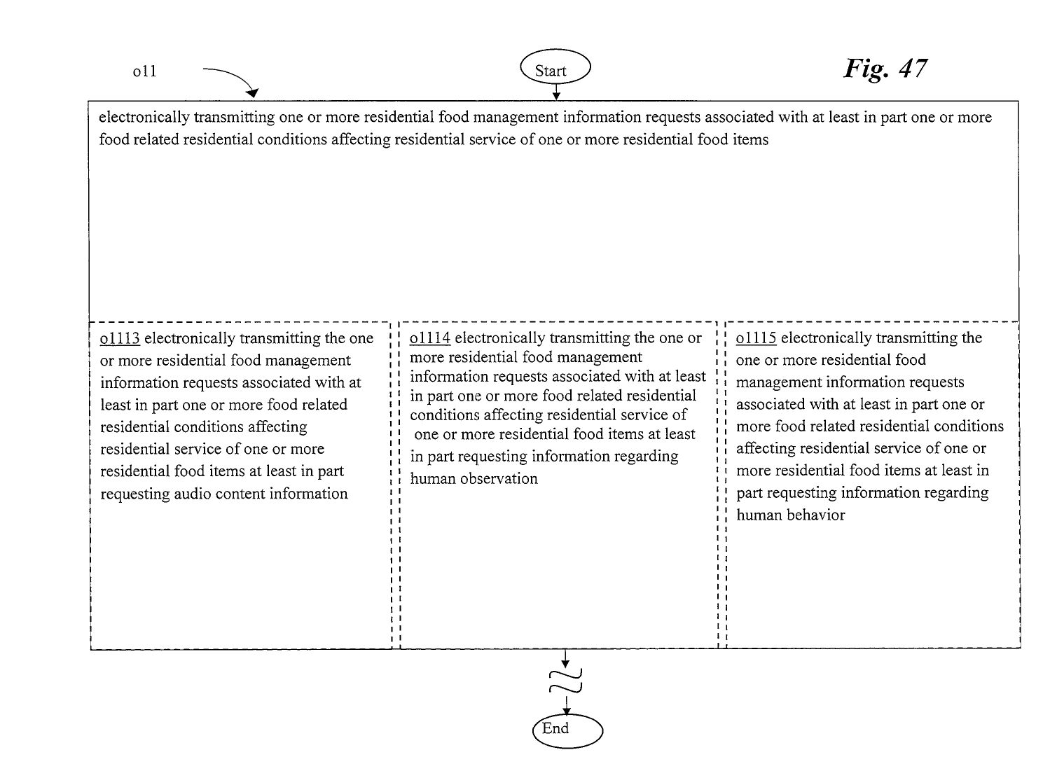

In one or more implementations, as shown in FIG. 47, operation o11 includes an operation o1113 for electronically transmitting the one or more residential food management information requests associated with at least in part one or more food related residential conditions affecting residential service of one or more residential food items at least in part requesting audio content information.

Origination of an illustratively derived transmitting audio content component group can be accomplished through skilled in the art design choice selection of one or more of the above depicted components from one or more of the above depicted subsystems shown in FIG. 12. Components from the transmitting audio content component group can be used in implementing execution of the one or more transmitting audio content instructions i1113 of FIG. 28, can be used in performance of the transmitting audio content electrical circuitry arrangement e1113 of FIG. 21, and/or can be used in otherwise fulfillment of the operation o1113. An exemplary non-transitory signal bearing medium version of the information storage subsystem s200 is depicted in FIG. 28 as bearing the one or more transmitting audio content instructions i1113 that when executed will direct performance of the operation o1113. Furthermore, the transmitting audio content electrical circuitry arrangement (“elec circ arrange”) e1113, when activated, will perform the operation o1113. Also, the transmitting audio content module m1113, when executed and/or activated, will direct performance of and/or perform the operation o1113. For instance, in one or more exemplary implementations, the one or more transmitting audio content instructions i1113, when executed, direct performance of the operation o1113 in the illustrative depiction as follows, and/or the transmitting audio content electrical circuitry arrangement e1113, when activated, performs the operation o1113 in the illustrative depiction as follows, and/or the transmitting audio content module m1113, when executed and/or activated, directs performance of and/or performs the operation o1113 in the illustrative depiction as follows, and/or the operation o1113 is otherwise carried out in the illustrative depiction as follows: electronically transmitting (e.g. infra-red, etc.) the one or more residential food management information requests (e.g. WAV file format, etc.) associated with at least in part (e.g. engrossing, etc.) one or more food related residential conditions (e.g. known pandemic status, etc.) affecting (e.g. engrossing, etc.) residential service of (e.g. fast food item purchases, etc.) one or more residential food items (e.g. cooked main course, etc.) at least in part requesting audio content information (e.g. WAV or mp3 file format, etc.).

In one or more implementations, as shown in FIG. 47, operation o11 includes an operation o1114 for electronically transmitting the one or more residential food management information requests associated with at least in part one or more food related residential conditions affecting residential service of one or more residential food items at least in part requesting information regarding human observation. Origination of an illustratively derived transmitting human observation component group can be accomplished through skilled in the art design choice selection of one or more of the above depicted components from one or more of the above depicted subsystems shown in FIG. 12. Components from the transmitting human observation component group can be used in implementing execution of the one or more transmitting human observation instructions i1114 of FIG. 28, can be used in performance of the transmitting human observation electrical circuitry arrangement e1114 of FIG. 21, and/or can be used in otherwise fulfillment of the operation o1114. An exemplary non-transitory signal bearing medium version of the information storage subsystem s200 is depicted in FIG. 28 as bearing the one or more transmitting human observation instructions i1114 that when executed will direct performance of the operation o1114. Furthermore, the transmitting human observation electrical circuitry arrangement (“elec circ arrange”) e1114, when activated, will perform the operation o1114. Also, the transmitting human observation module m1114, when executed and/or activated, will direct performance of and/or perform the operation o1114. For instance, in one or more exemplary implementations, the one or more transmitting human observation instructions i1114, when executed, direct performance of the operation o1114 in the illustrative depiction as follows, and/or the transmitting human observation electrical circuitry arrangement e1114, when activated, performs the operation o1114 in the illustrative depiction as follows, and/or the transmitting human observation module m1114, when executed and/or activated, directs performance of and/or performs the operation o1114 in the illustrative depiction as follows, and/or the operation o1114 is otherwise carried out in the illustrative depiction as follows: electronically transmitting (e.g. bluetooth, etc.) the one or more residential food management information requests (e.g. visual observation, etc.) associated with at least in part (e.g. implicate, etc.) one or more food related residential conditions (e.g. market demands, etc.) affecting (e.g. implicate, etc.) residential service of (e.g. family buffet food item purchases, etc.) one or more residential food items (e.g. raw main course, etc.) at least in part requesting information regarding human observation (e.g. visual observation, etc.).

In one or more implementations, as shown in FIG. 47, operation o11 includes an operation o1115 for electronically transmitting the one or more residential food management information requests associated with at least in part one or more food related residential conditions affecting residential service of one or more residential food items at least in part requesting information regarding human behavior. Origination of an illustratively derived transmitting human behavior component group can be accomplished through skilled in the art design choice selection of one or more of the above depicted components from one or more of the above depicted subsystems shown in FIG. 12. Components from the transmitting human behavior component group can be used in implementing execution of the one or more transmitting human behavior instructions i1115 of FIG. 28, can be used in performance of the transmitting human behavior electrical circuitry arrangement e1115 of FIG. 21, and/or can be used in otherwise fulfillment of the operation o1115. An exemplary non-transitory signal bearing medium version of the information storage subsystem s200 is depicted in FIG. 28 as bearing the one or more transmitting human behavior instructions i1115 that when executed will direct performance of the operation o1115. Furthermore, the transmitting human behavior electrical circuitry arrangement (“elec circ arrange”) e1115, when activated, will perform the operation o1115. Also, the transmitting human behavior module m1115, when executed and/or activated, will direct performance of and/or perform the operation o1115. For instance, in one or more exemplary implementations, the one or more transmitting human behavior instructions i1115, when executed, direct performance of the operation o1115 in the illustrative depiction as follows, and/or the transmitting human behavior electrical circuitry arrangement e1115, when activated, performs the operation o1115 in the illustrative depiction as follows, and/or the transmitting human behavior module m1115, when executed and/or activated, directs performance of and/or performs the operation o1115 in the illustrative depiction as follows, and/or the operation o1115 is otherwise carried out in the illustrative depiction as follows: electronically transmitting (e.g. webpage, etc.) the one or more residential food management information requests (e.g. following safety protocols, etc.) associated with at least in part (e.g. necessitate, etc.) one or more food related residential conditions (e.g. crop disease status, etc.) affecting (e.g. necessitate, etc.) residential service of (e.g. mobile catering food item purchases, etc.) one or more residential food items (e.g. buffet main course, etc.) at least in part requesting information regarding human behavior (e.g. compliance with safety protocols, etc.).

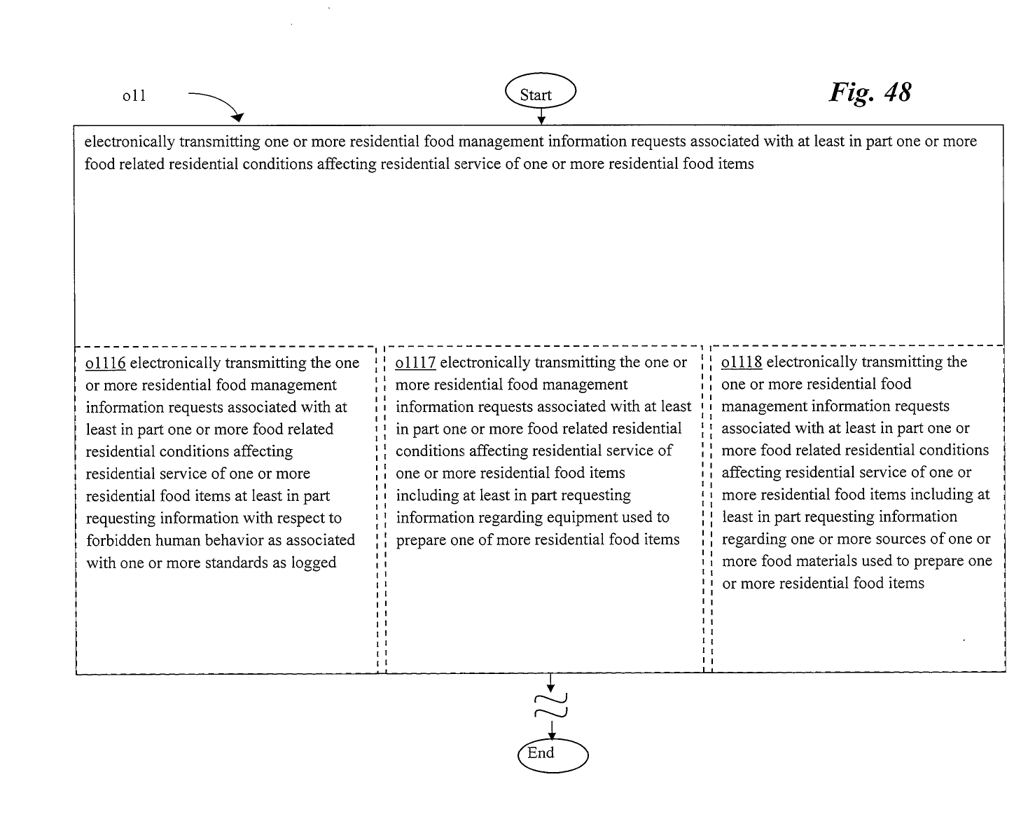

In one or more implementations, as shown in FIG. 48, operation o11 includes an operation o1116 for electronically transmitting the one or more residential food management information requests associated with at least in part one or more food related residential conditions affecting residential service of one or more residential food items at least in part requesting information with respect to forbidden human behavior as associated with one or more standards as logged. Origination of an illustratively derived transmitting forbidden human component group can be accomplished through skilled in the art design choice selection of one or more of the above depicted components from one or more of the above depicted subsystems shown in FIG. 12. Components from the transmitting forbidden human component group can be used in implementing execution of the one or more transmitting forbidden human instructions i1116 of FIG. 28, can be used in performance of the transmitting forbidden human electrical circuitry arrangement e1116 of FIG. 21, and/or can be used in otherwise fulfillment of the operation o1116. An exemplary non-transitory signal bearing medium version of the information storage subsystem s200 is depicted in FIG. 28 as bearing the one or more transmitting forbidden human instructions i1116 that when executed will direct performance of the operation o1116. Furthermore, the transmitting forbidden human electrical circuitry arrangement (“elec circ arrange”) e1116, when activated, will perform the operation o1116. Also, the transmitting forbidden human module m1116, when executed and/or activated, will direct performance of and/or perform the operation o1116. For instance, in one or more exemplary implementations, the one or more transmitting forbidden human instructions i1116, when executed, direct performance of the operation o1116 in the illustrative depiction as follows, and/or the transmitting forbidden human electrical circuitry arrangement e1116, when activated, performs the operation o1116 in the illustrative depiction as follows, and/or the transmitting forbidden human module m1116, when executed and/or activated, directs performance of and/or performs the operation o1116 in the illustrative depiction as follows, and/or the operation o1116 is otherwise carried out in the illustrative depiction as follows: electronically transmitting (e.g. website, etc.) the one or more residential food management information requests (e.g. document forgery, etc.) associated with at least in part (e.g. presuppose, etc.) one or more food related residential conditions (e.g. climate conditions near the one or more residential locations, etc.) affecting (e.g. presuppose, etc.) residential service of (e.g. institutional home food item purchases, etc.) one or more residential food items (e.g. soup main course, etc.) at least in part requesting information with respect to forbidden human behavior as associated with one or more standards as logged (e.g. document forgery, etc.).

In one or more implementations, as shown in FIG. 48, operation o11 includes an operation o1117 for electronically transmitting the one or more residential food management information requests associated with at least in part one or more food related residential conditions affecting residential service of one or more residential food items including at least in part requesting information regarding equipment used to prepare one of more residential food items. Origination of an illustratively derived transmitting equipment used component group can be accomplished through skilled in the art design choice selection of one or more of the above depicted components from one or more of the above depicted subsystems shown in FIG. 12. Components from the transmitting equipment used component group can be used in implementing execution of the one or more transmitting equipment used instructions i1117 of FIG. 28, can be used in performance of the transmitting equipment used electrical circuitry arrangement e1117 of FIG. 21, and/or can be used in otherwise fulfillment of the operation o1117. An exemplary non-transitory signal bearing medium version of the information storage subsystem s200 is depicted in FIG. 28 as bearing the one or more transmitting equipment used instructions i1117 that when executed will direct performance of the operation o1117. Furthermore, the transmitting equipment used electrical circuitry arrangement (“elec circ arrange”) e1117, when activated, will perform the operation o1117. Also, the transmitting equipment used module m1117, when executed and/or activated, will direct performance of and/or perform the operation o1117. For instance, in one or more exemplary implementations, the one or more transmitting equipment used instructions i1117, when executed, direct performance of the operation o1117 in the illustrative depiction as follows, and/or the transmitting equipment used electrical circuitry arrangement e1117, when activated, performs the operation o1117 in the illustrative depiction as follows, and/or the transmitting equipment used module m1117, when executed and/or activated, directs performance of and/or performs the operation o1117 in the illustrative depiction as follows, and/or the operation o1117 is otherwise carried out in the illustrative depiction as follows: electronically transmitting (e.g. cellphone entry, etc.) the one or more residential food management information requests (e.g. residential occupant demographics, etc.) associated with at least in part (e.g. related to, etc.) one or more food related residential conditions (e.g. hygiene practices of the residential food preparation occupants, etc.) affecting (e.g. related to, etc.) residential service of (e.g. school lunch food item purchases, etc.) one or more residential food items (e.g. stew main course, etc.) including at least in part requesting information regarding equipment used to prepare one of more residential food items (e.g. manufacture recalls regarding equipment used to prepare meals, etc.).

In one or more implementations, as shown in FIG. 48, operation o11 includes an operation o1118 for electronically transmitting the one or more residential food management information requests associated with at least in part one or more food related residential conditions affecting residential service of one or more residential food items including at least in part requesting information regarding one or more sources of one or more food materials used to prepare one or more residential food items. Origination of an illustratively derived transmitting materials used component group can be accomplished through skilled in the art design choice selection of one or more of the above depicted components from one or more of the above depicted subsystems shown in FIG. 12. Components from the transmitting materials used component group can be used in implementing execution of the one or more transmitting materials used instructions i1118 of FIG. 28, can be used in performance of the transmitting materials used electrical circuitry arrangement e1118 of FIG. 21, and/or can be used in otherwise fulfillment of the operation o1118. An exemplary non-transitory signal bearing medium version of the information storage subsystem s200 is depicted in FIG. 28 as bearing the one or more transmitting materials used instructions i1118 that when executed will direct performance of the operation o1118. Furthermore, the transmitting materials used electrical circuitry arrangement (“elec circ arrange”) e1118, when activated, will perform the operation o1118. Also, the transmitting materials used module m1118, when executed and/or activated, will direct performance of and/or perform the operation o1118. For instance, in one or more exemplary implementations, the one or more transmitting materials used instructions i1118, when executed, direct performance of the operation o1118 in the illustrative depiction as follows, and/or the transmitting materials used electrical circuitry arrangement e1118, when activated, performs the operation o1118 in the illustrative depiction as follows, and/or the transmitting materials used module m1118, when executed and/or activated, directs performance of and/or performs the operation o1118 in the illustrative depiction as follows, and/or the operation o1118 is otherwise carried out in the illustrative depiction as follows: electronically transmitting (e.g. satellite transmission, etc.) the one or more residential food management information requests (e.g. facility temperature, etc.) associated with at least in part (e.g. relationship, etc.) one or more food related residential conditions (e.g. turnover rate of produce supply, etc.) affecting (e.g. relationship, etc.) residential service of (e.g. elderly home food item purchases, etc.) one or more residential food items (e.g. hot dish main course, etc.) including at least in part requesting information regarding one or more sources of one or more food materials used to prepare one or more residential food items (e.g. identification and description of farms and grocers used to acquire produce to make meals, etc.).

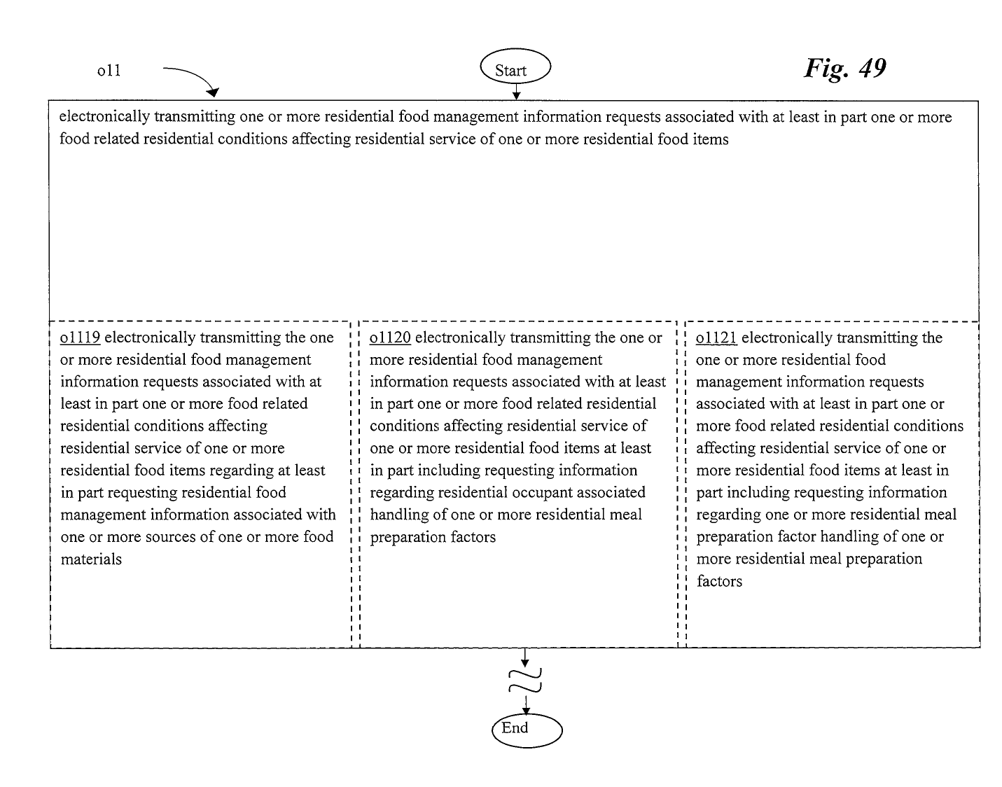

In one or more implementations, as shown in FIG. 49, operation o11 includes an operation o1119 for electronically transmitting the one or more residential food management information requests associated with at least in part one or more food related residential conditions affecting residential service of one or more residential food items regarding at least in part requesting residential food management information associated with one or more sources of one or more food materials. Origination of an illustratively derived transmitting sources component group can be accomplished through skilled in the art design choice selection of one or more of the above depicted components from one or more of the above depicted subsystems shown in FIG. 12. Components from the transmitting sources component group can be used in implementing execution of the one or more transmitting sources instructions i1119 of FIG. 28, can be used in performance of the transmitting sources electrical circuitry arrangement e1119 of FIG. 21, and/or can be used in otherwise fulfillment of the operation o1119. An exemplary non-transitory signal bearing medium version of the information storage subsystem s200 is depicted in FIG. 28 as bearing the one or more transmitting sources instructions i1119 that when executed will direct performance of the operation o1119. Furthermore, the transmitting sources electrical circuitry arrangement (“elec circ arrange”) e1119, when activated, will perform the operation o1119. Also, the transmitting sources module m1119, when executed and/or activated, will direct performance of and/or perform the operation o1119. For instance, in one or more exemplary implementations, the one or more transmitting sources instructions i1119, when executed, direct performance of the operation o1119 in the illustrative depiction as follows, and/or the transmitting sources electrical circuitry arrangement e1119, when activated, performs the operation o1119 in the illustrative depiction as follows, and/or the transmitting sources module m1119, when executed and/or activated, directs performance of and/or performs the operation o1119 in the illustrative depiction as follows, and/or the operation o1119 is otherwise carried out in the illustrative depiction as follows: electronically transmitting (e.g. pull-based, etc.) the one or more residential food management information requests (e.g. cold packing, etc.) associated with at least in part (e.g. suggest, etc.) one or more food related residential conditions (e.g. shipment time required from farm through grocer to residential location, etc.) affecting (e.g. suggest, etc.) residential service of (e.g. street vendor food item purchases, etc.) one or more residential food items (e.g. cold dish main course, etc.) regarding at least in part requesting residential food management information associated with one or more sources of one or more food materials (e.g. which residential food items are most popular as correlated with what farms and grocers were used to supply ingestible materials to make the residential food items, etc.).

In one or more implementations, as shown in FIG. 49, operation o11 includes an operation o1120 for electronically transmitting the one or more residential food management information requests associated with at least in part one or more food related residential conditions affecting residential service of one or more residential food items at least in part including requesting information regarding residential occupant associated handling of one or more residential meal preparation factors. Origination of an illustratively derived transmitting occupant handling component group can be accomplished through skilled in the art design choice selection of one or more of the above depicted components from one or more of the above depicted subsystems shown in FIG. 12. Components from the transmitting occupant handling component group can be used in implementing execution of the one or more transmitting occupant handling instructions i1120 of FIG. 29, can be used in performance of the transmitting occupant handling electrical circuitry arrangement e1120 of FIG. 22, and/or can be used in otherwise fulfillment of the operation o1120. An exemplary non-transitory signal bearing medium version of the information storage subsystem s200 is depicted in FIG. 29 as bearing the one or more transmitting occupant handling instructions i1120 that when executed will direct performance of the operation o1120. Furthermore, the transmitting occupant handling electrical circuitry arrangement (“elec circ arrange”) e1120, when activated, will perform the operation o1120. Also, the transmitting occupant handling module m1120, when executed and/or activated, will direct performance of and/or perform the operation o1120. For instance, in one or more exemplary implementations, the one or more transmitting occupant handling instructions i1120, when executed, direct performance of the operation o1120 in the illustrative depiction as follows, and/or the transmitting occupant handling electrical circuitry arrangement e1120, when activated, performs the operation o1120 in the illustrative depiction as follows, and/or the transmitting occupant handling module m1120, when executed and/or activated, directs performance of and/or performs the operation o1120 in the illustrative depiction as follows, and/or the operation o1120 is otherwise carried out in the illustrative depiction as follows: electronically transmitting (e.g. POP3 server, etc.) the one or more residential food management information requests (e.g. oven operation, etc.) associated with at least in part (e.g. tangle, etc.) one or more food related residential conditions (e.g. maintenance procedure on residential food preparation equipment, etc.) affecting (e.g. tangle, etc.) residential service of (e.g. mobile kitchen food item purchases, etc.) one or more residential food items (e.g. weight loss main, etc.) at least in part including requesting information regarding residential occupant associated handling of one or more residential meal preparation factors (e.g. compliance with maintenance and cleaning procedures for the residential meal preparation equipment, etc.).

In one or more implementations, as shown in FIG. 49, operation o11 includes an operation o1121 for electronically transmitting the one or more residential food management information requests associated with at least in part one or more food related residential conditions affecting residential service of one or more residential food items at least in part including requesting information regarding one or more residential meal preparation factor handling of one or more residential meal preparation factors. Origination of an illustratively derived transmitting factor handling component group can be accomplished through skilled in the art design choice selection of one or more of the above depicted components from one or more of the above depicted subsystems shown in FIG. 12. Components from the transmitting factor handling component group can be used in implementing execution of the one or more transmitting factor handling instructions i1121 of FIG. 29, can be used in performance of the transmitting factor handling electrical circuitry arrangement e1121 of FIG. 22, and/or can be used in otherwise fulfillment of the operation o1121. An exemplary non-transitory signal bearing medium version of the information storage subsystem s200 is depicted in FIG. 29 as bearing the one or more transmitting factor handling instructions i1121 that when executed will direct performance of the operation o1121. Furthermore, the transmitting factor handling electrical circuitry arrangement (“elec circ arrange”) e1121, when activated, will perform the operation o1121. Also, the transmitting factor handling module m1121, when executed and/or activated, will direct performance of and/or perform the operation o1121. For instance, in one or more exemplary implementations, the one or more transmitting factor handling instructions i1121, when executed, direct performance of the operation o1121 in the illustrative depiction as follows, and/or the transmitting factor handling electrical circuitry arrangement e1121, when activated, performs the operation o1121 in the illustrative depiction as follows, and/or the transmitting factor handling module m1121, when executed and/or activated, directs performance of and/or performs the operation o1121 in the illustrative depiction as follows, and/or the operation o1121 is otherwise carried out in the illustrative depiction as follows: electronically transmitting (e.g. hardware based encryption, etc.) the one or more residential food management information requests (e.g. electricity usage, etc.) associated with at least in part (e.g. exclude, etc.) one or more food related residential conditions (e.g. cost of equipment used for residential preparation of residential meals, etc.) affecting (e.g. exclude, etc.) residential service of (e.g. visiting nursing food item purchases, etc.) one or more residential food items (e.g. sports nutrition main course, etc.) at least in part including requesting information regarding one or more residential meal preparation factor handling of one or more residential meal preparation factors (e.g. handling of machines configured to produce residential drink mixtures, etc.).

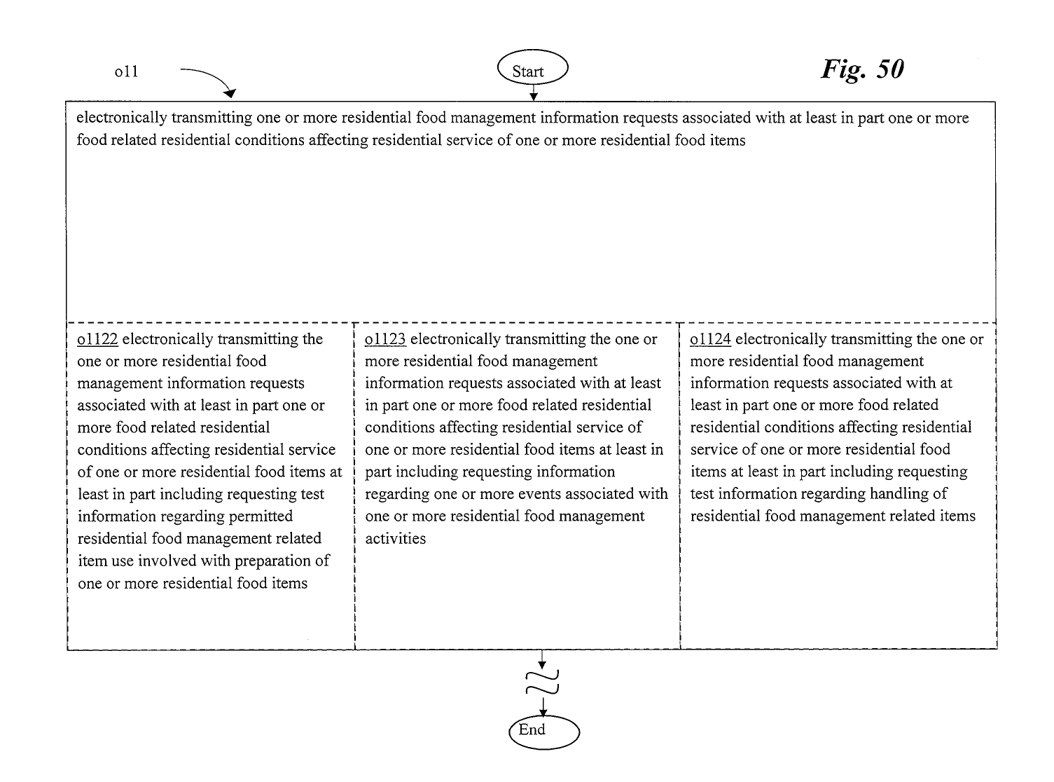

In one or more implementations, as shown in FIG. 50, operation o11 includes an operation o1122 for electronically transmitting the one or more residential food management information requests associated with at least in part one or more food related residential conditions affecting residential service of one or more residential food items at least in part including requesting test information regarding permitted residential food management related item use involved with preparation of one or more residential food items. Origination of an illustratively derived transmitting item use component group can be accomplished through skilled in the art design choice selection of one or more of the above depicted components from one or more of the above depicted subsystems shown in FIG. 12. Components from the transmitting item use component group can be used in implementing execution of the one or more transmitting item use instructions i1122 of FIG. 29, can be used in performance of the transmitting item use electrical circuitry arrangement e1122 of FIG. 22, and/or can be used in otherwise fulfillment of the operation o1122. An exemplary non-transitory signal bearing medium version of the information storage subsystem s200 is depicted in FIG. 29 as bearing the one or more transmitting item use instructions i1122 that when executed will direct performance of the operation o1122. Furthermore, the transmitting item use electrical circuitry arrangement (“elec circ arrange”) e1122, when activated, will perform the operation o1122. Also, the transmitting item use module m1122, when executed and/or activated, will direct performance of and/or perform the operation o1122. For instance, in one or more exemplary implementations, the one or more transmitting item use instructions i1122, when executed, direct performance of the operation o1122 in the illustrative depiction as follows, and/or the transmitting item use electrical circuitry arrangement e1122, when activated, performs the operation o1122 in the illustrative depiction as follows, and/or the transmitting item use module m1122, when executed and/or activated, directs performance of and/or performs the operation o1122 in the illustrative depiction as follows, and/or the operation o1122 is otherwise carried out in the illustrative depiction as follows: electronically transmitting (e.g. software based encryption, etc.) the one or more residential food management information requests (e.g. refrigeration temperatures, etc.) associated with at least in part (e.g. bound, etc.) one or more food related residential conditions (e.g. residential equipment maintenance schedule, etc.) affecting (e.g. bound, etc.) residential service of (e.g. deli aspects food item purchases, etc.) one or more residential food items (e.g. baked main course, etc.) at least in part including requesting test information regarding permitted residential food management related item use involved with preparation of one or more residential food items (e.g. testing for toxin levels with organic produce to confirm quality claims for residential meals, etc.).

In one or more implementations, as shown in FIG. 50, operation o11 includes an operation o1123 for electronically transmitting the one or more residential food management information requests associated with at least in part one or more food related residential conditions affecting residential service of one or more residential food items at least in part including requesting information regarding one or more events associated with one or more residential food management activities. Origination of an illustratively derived transmitting events associated component group can be accomplished through skilled in the art design choice selection of one or more of the above depicted components from one or more of the above depicted subsystems shown in FIG. 12. Components from the transmitting events associated component group can be used in implementing execution of the one or more transmitting events associated instructions i1123 of FIG. 29, can be used in performance of the transmitting events associated electrical circuitry arrangement e1123 of FIG. 22, and/or can be used in otherwise fulfillment of the operation o1123. An exemplary non-transitory signal bearing medium version of the information storage subsystem s200 is depicted in FIG. 29 as bearing the one or more transmitting events associated instructions i1123 that when executed will direct performance of the operation o1123. Furthermore, the transmitting events associated electrical circuitry arrangement (“elec circ arrange”) e1123, when activated, will perform the operation o1123. Also, the transmitting events associated module m1123, when executed and/or activated, will direct performance of and/or perform the operation o1123. For instance, in one or more exemplary implementations, the one or more transmitting events associated instructions i1123, when executed, direct performance of the operation o1123 in the illustrative depiction as follows, and/or the transmitting events associated electrical circuitry arrangement e1123, when activated, performs the operation o1123 in the illustrative depiction as follows, and/or the transmitting events associated module m1123, when executed and/or activated, directs performance of and/or performs the operation o1123 in the illustrative depiction as follows, and/or the operation o1123 is otherwise carried out in the illustrative depiction as follows: electronically transmitting (e.g. SD card, etc.) the one or more residential food management information requests (e.g. sanitization protocol observance, etc.) associated with at least in part (e.g. requiring, etc.) one or more food related residential conditions (e.g. tool requirements for repair of residential food preparation equipment, etc.) affecting (e.g. requiring, etc.) residential service of (e.g. fine dining food item use, etc.) one or more residential food items (e.g. fried main course, etc.) at least in part including requesting information regarding one or more events associated with one or more residential food management activities (e.g. health inspection of a residential facilities, etc.).

In one or more implementations, as shown in FIG. 50, operation o11 includes an operation o1124 for electronically transmitting the one or more residential food management information requests associated with at least in part one or more food related residential conditions affecting residential service of one or more residential food items at least in part including requesting test information regarding handling of residential food management related items. Origination of an illustratively derived transmitting test handling component group can be accomplished through skilled in the art design choice selection of one or more of the above depicted components from one or more of the above depicted subsystems shown in FIG. 12. Components from the transmitting test handling component group can be used in implementing execution of the one or more transmitting test handling instructions i1124 of FIG. 29, can be used in performance of the transmitting test handling electrical circuitry arrangement e1124 of FIG. 22, and/or can be used in otherwise fulfillment of the operation o1124. An exemplary non-transitory signal bearing medium version of the information storage subsystem s200 is depicted in FIG. 29 as bearing the one or more transmitting test handling instructions i1124 that when executed will direct performance of the operation o1124. Furthermore, the transmitting test handling electrical circuitry arrangement (“elec circ arrange”) e1124, when activated, will perform the operation o1124. Also, the transmitting test handling module m1124, when executed and/or activated, will direct performance of and/or perform the operation o1124. For instance, in one or more exemplary implementations, the one or more transmitting test handling instructions i1124, when executed, direct performance of the operation o1124 in the illustrative depiction as follows, and/or the transmitting test handling electrical circuitry arrangement e1124, when activated, performs the operation o1124 in the illustrative depiction as follows, and/or the transmitting test handling module m1124, when executed and/or activated, directs performance of and/or performs the operation o1124 in the illustrative depiction as follows, and/or the operation o1124 is otherwise carried out in the illustrative depiction as follows: electronically transmitting (e.g. SIM card, etc.) the one or more residential food management information requests (e.g. presence of insecticides in food, etc.) associated with at least in part (e.g. enveloped, etc.) one or more food related residential conditions (e.g. local regulations, etc.) affecting (e.g. enveloped, etc.) residential service of (e.g. fast food item use, etc.) one or more residential food items (e.g. grilled main course, etc.) at least in part including requesting test information regarding handling of residential food management related items (e.g. bacteria testing of surfaces used in handling residential meals, etc.).

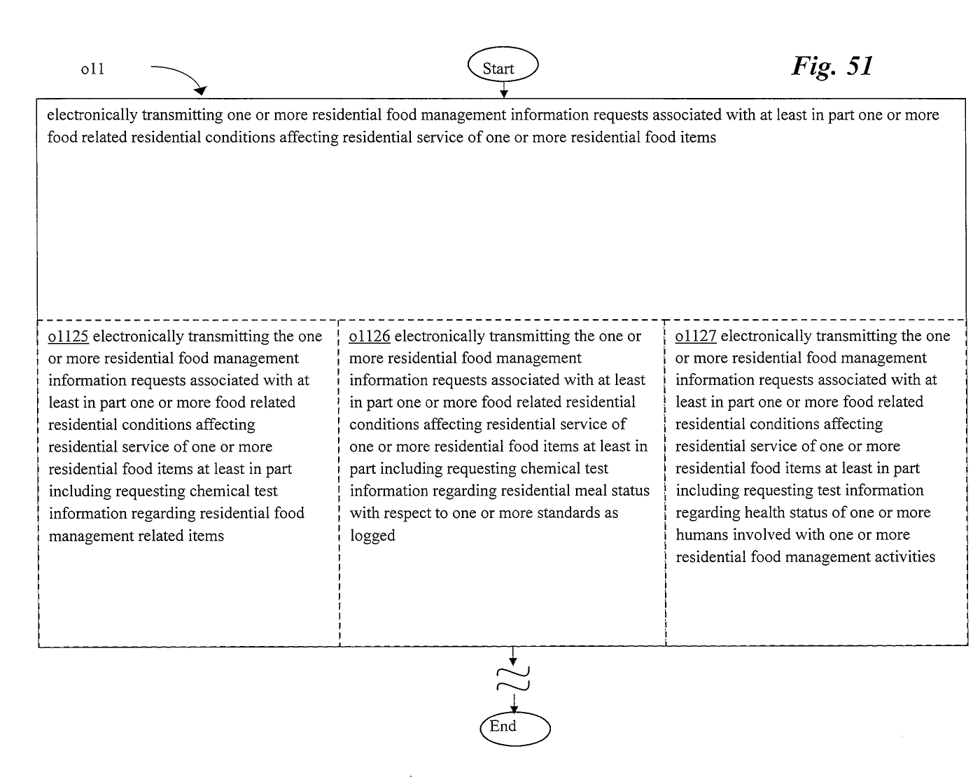

In one or more implementations, as shown in FIG. 51, operation o11 includes an operation o1125 for electronically transmitting the one or more residential food management information requests associated with at least in part one or more food related residential conditions affecting residential service of one or more residential food items at least in part including requesting chemical test information regarding residential food management related items. Origination of an illustratively derived transmitting chemical test items component group can be accomplished through skilled in the art design choice selection of one or more of the above depicted components from one or more of the above depicted subsystems shown in FIG. 12. Components from the transmitting chemical test items component group can be used in implementing execution of the one or more transmitting chemical test items instructions i1125 of FIG. 29, can be used in performance of the transmitting chemical test items electrical circuitry arrangement e1125 of FIG. 22, and/or can be used in otherwise fulfillment of the operation o1125. An exemplary non-transitory signal bearing medium version of the information storage subsystem s200 is depicted in FIG. 29 as bearing the one or more transmitting chemical test items instructions i1125 that when executed will direct performance of the operation o1125. Furthermore, the transmitting chemical test items electrical circuitry arrangement (“elec circ arrange”) e1125, when activated, will perform the operation o1125. Also, the transmitting chemical test items module m1125, when executed and/or activated, will direct performance of and/or perform the operation o1125. For instance, in one or more exemplary implementations, the one or more transmitting chemical test items instructions i1125, when executed, direct performance of the operation o1125 in the illustrative depiction as follows, and/or the transmitting chemical test items electrical circuitry arrangement e1125, when activated, performs the operation o1125 in the illustrative depiction as follows, and/or the transmitting chemical test items module m1125, when executed and/or activated, directs performance of and/or performs the operation o1125 in the illustrative depiction as follows, and/or the operation o1125 is otherwise carried out in the illustrative depiction as follows: electronically transmitting (e.g. email, etc.) the one or more residential food management information requests (e.g. preparation speed of cooks, etc.) associated with at least in part (e.g. envelope, etc.) one or more food related residential conditions (e.g. type of cuisine prepared by the residential food location, etc.) affecting (e.g. envelope, etc.) residential service of (e.g. family buffet food item use, etc.) one or more residential food items (e.g. steamed main course, etc.) at least in part including requesting chemical test information regarding residential food management related items (e.g. residue testing to determine levels toxins on surfaces in handling residential meals, etc.).

In one or more implementations, as shown in FIG. 51, operation o11 includes an operation o1126 for electronically transmitting the one or more residential food management information requests associated with at least in part one or more food related residential conditions affecting residential service of one or more residential food items at least in part including requesting chemical test information regarding residential meal status with respect to one or more standards as logged. Origination of an illustratively derived transmitting chemical status standards component group can be accomplished through skilled in the art design choice selection of one or more of the above depicted components from one or more of the above depicted subsystems shown in FIG. 12. Components from the transmitting chemical status standards component group can be used in implementing execution of the one or more transmitting chemical status standards instructions i1126 of FIG. 29, can be used in performance of the transmitting chemical status standards electrical circuitry arrangement e1126 of FIG. 22, and/or can be used in otherwise fulfillment of the operation o1126. An exemplary non-transitory signal bearing medium version of the information storage subsystem s200 is depicted in FIG. 29 as bearing the one or more transmitting chemical status standards instructions i1126 that when executed will direct performance of the operation o1126. Furthermore, the transmitting chemical status standards electrical circuitry arrangement (“elec circ arrange”) e1126, when activated, will perform the operation o1126. Also, the transmitting chemical status standards module m1126, when executed and/or activated, will direct performance of and/or perform the operation o1126. For instance, in one or more exemplary implementations, the one or more transmitting chemical status standards instructions i1126, when executed, direct performance of the operation o1126 in the illustrative depiction as follows, and/or the transmitting chemical status standards electrical circuitry arrangement e1126, when activated, performs the operation o1126 in the illustrative depiction as follows, and/or the transmitting chemical status standards module m1126, when executed and/or activated, directs performance of and/or performs the operation o1126 in the illustrative depiction as follows, and/or the operation o1126 is otherwise carried out in the illustrative depiction as follows: electronically transmitting (e.g. peer to peer, etc.) the one or more residential food management information requests (e.g. labor force scheduling, etc.) associated with at least in part (e.g. associate with, etc.) one or more food related residential conditions (e.g. demographic location of the residential food location, etc.) affecting (e.g. associate with, etc.) residential service of (e.g. mobile catering food item use, etc.) one or more residential food items (e.g. chilled main course, etc.) at least in part including requesting chemical test information regarding residential meal status with respect to one or more standards as logged (e.g. testing residential meat meals for growth hormone levels, etc.).

In one or more implementations, as shown in FIG. 51, operation o11 includes an operation o1127 for electronically transmitting the one or more residential food management information requests associated with at least in part one or more food related residential conditions affecting residential service of one or more residential food items at least in part including requesting test information regarding health status of one or more humans involved with one or more residential food management activities. Origination of an illustratively derived transmitting test health humans component group can be accomplished through skilled in the art design choice selection of one or more of the above depicted components from one or more of the above depicted subsystems shown in FIG. 12. Components from the transmitting test health humans component group can be used in implementing execution of the one or more transmitting test health humans instructions i1127 of FIG. 29, can be used in performance of the transmitting test health humans electrical circuitry arrangement e1127 of FIG. 22, and/or can be used in otherwise fulfillment of the operation o1127. An exemplary non-transitory signal bearing medium version of the information storage subsystem s200 is depicted in FIG. 29 as bearing the one or more transmitting test health humans instructions i1127 that when executed will direct performance of the operation o1127. Furthermore, the transmitting test health humans electrical circuitry arrangement (“elec circ arrange”) e1127, when activated, will perform the operation o1127. Also, the transmitting test health humans module m1127, when executed and/or activated, will direct performance of and/or perform the operation o1127. For instance, in one or more exemplary implementations, the one or more transmitting test health humans instructions i1127, when executed, direct performance of the operation o1127 in the illustrative depiction as follows, and/or the transmitting test health humans electrical circuitry arrangement e1127, when activated, performs the operation o1127 in the illustrative depiction as follows, and/or the transmitting test health humans module m1127, when executed and/or activated, directs performance of and/or performs the operation o1127 in the illustrative depiction as follows, and/or the operation o1127 is otherwise carried out in the illustrative depiction as follows: electronically transmitting (e.g. 10-key, etc.) the one or more residential food management information requests (e.g. future market demands, etc.) associated with at least in part (e.g. embroil, etc.) one or more food related residential conditions (e.g. age of equipment used in the residential location, etc.) affecting (e.g. embroil, etc.) residential service of (e.g. institutional home food item use, etc.) one or more residential food items (e.g. microwaved main course, etc.) at least in part including requesting test information regarding health status of one or more humans involved with one or more residential food management activities (e.g. infectious disease testing of residential occupants, etc.).

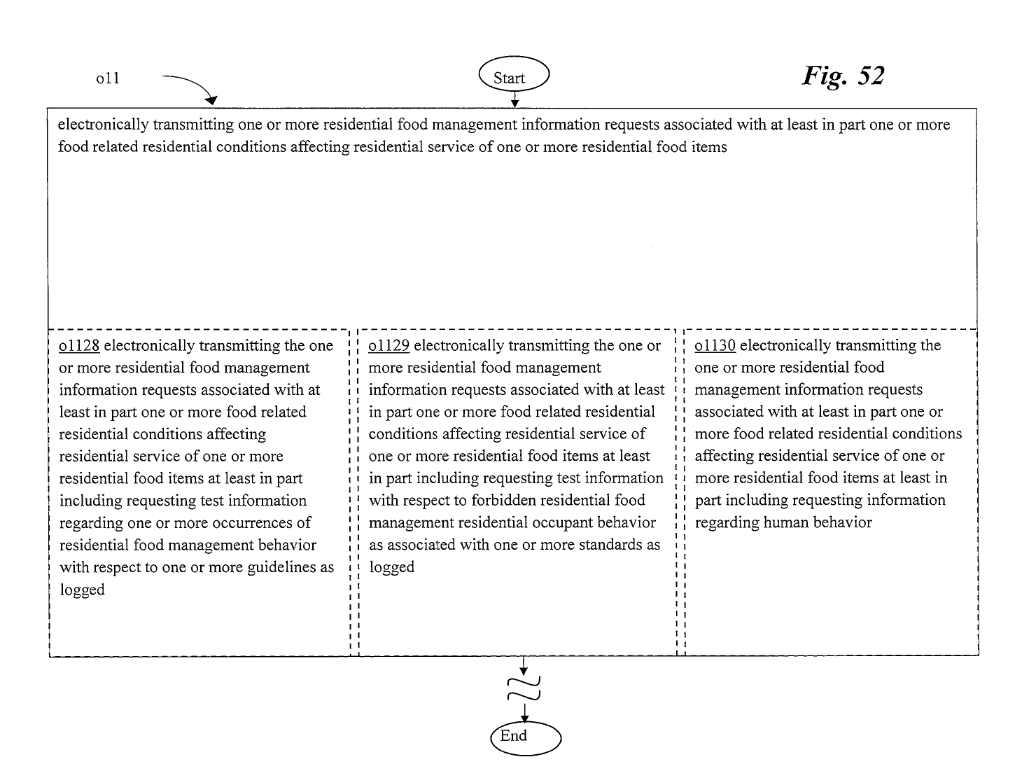

In one or more implementations, as shown in FIG. 52, operation o11 includes an operation o1128 for electronically transmitting the one or more residential food management information requests associated with at least in part one or more food related residential conditions affecting residential service of one or more residential food items at least in part including requesting test information regarding one or more occurrences of residential food management behavior with respect to one or more guidelines as logged. Origination of an illustratively derived transmitting test behavior component group can be accomplished through skilled in the art design choice selection of one or more of the above depicted components from one or more of the above depicted subsystems shown in FIG. 12. Components from the transmitting test behavior component group can be used in implementing execution of the one or more transmitting test behavior instructions i1128 of FIG. 29, can be used in performance of the transmitting test behavior electrical circuitry arrangement e1128 of FIG. 22, and/or can be used in otherwise fulfillment of the operation o1128. An exemplary non-transitory signal bearing medium version of the information storage subsystem s200 is depicted in FIG. 29 as bearing the one or more transmitting test behavior instructions i1128 that when executed will direct performance of the operation o1128. Furthermore, the transmitting test behavior electrical circuitry arrangement (“elec circ arrange”) e1128, when activated, will perform the operation o1128. Also, the transmitting test behavior module m1128, when executed and/or activated, will direct performance of and/or perform the operation o1128. For instance, in one or more exemplary implementations, the one or more transmitting test behavior instructions i1128, when executed, direct performance of the operation o1128 in the illustrative depiction as follows, and/or the transmitting test behavior electrical circuitry arrangement e1128, when activated, performs the operation o1128 in the illustrative depiction as follows, and/or the transmitting test behavior module m1128, when executed and/or activated, directs performance of and/or performs the operation o1128 in the illustrative depiction as follows, and/or the operation o1128 is otherwise carried out in the illustrative depiction as follows: electronically transmitting (e.g. USB port, etc.) the one or more residential food management information requests (e.g. improper data calculation, etc.) associated with at least in part (e.g. take in, etc.) one or more food related residential conditions (e.g. distribution of various type of foods served, etc.) affecting (e.g. take in, etc.) residential service of (e.g. school lunch food item use, etc.) one or more residential food items (e.g. convection oven prepared main course, etc.) at least in part including requesting test information regarding one or more occurrences of residential food management behavior with respect to one or more guidelines as logged (e.g. residential food management residential occupant hygiene habits, etc.).

In one or more implementations, as shown in FIG. 52, operation o11 includes an operation o1129 for electronically transmitting the one or more residential food management information requests associated with at least in part one or more food related residential conditions affecting residential service of one or more residential food items at least in part including requesting test information with respect to forbidden residential food management residential occupant behavior as associated with one or more standards as logged. Origination of an illustratively derived transmitting test forbidden component group can be accomplished through skilled in the art design choice selection of one or more of the above depicted components from one or more of the above depicted subsystems shown in FIG. 12. Components from the transmitting test forbidden component group can be used in implementing execution of the one or more transmitting test forbidden instructions i1129 of FIG. 29, can be used in performance of the transmitting test forbidden electrical circuitry arrangement e1129 of FIG. 22, and/or can be used in otherwise fulfillment of the operation o1129. An exemplary non-transitory signal bearing medium version of the information storage subsystem s200 is depicted in FIG. 29 as bearing the one or more transmitting test forbidden instructions i1129 that when executed will direct performance of the operation o1129. Furthermore, the transmitting test forbidden electrical circuitry arrangement (“elec circ arrange”) e1129, when activated, will perform the operation o1129. Also, the transmitting test forbidden module m1129, when executed and/or activated, will direct performance of and/or perform the operation o1129. For instance, in one or more exemplary implementations, the one or more transmitting test forbidden instructions i1129, when executed, direct performance of the operation o1129 in the illustrative depiction as follows, and/or the transmitting test forbidden electrical circuitry arrangement e1129, when activated, performs the operation o1129 in the illustrative depiction as follows, and/or the transmitting test forbidden module m1129, when executed and/or activated, directs performance of and/or performs the operation o1129 in the illustrative depiction as follows, and/or the operation o1129 is otherwise carried out in the illustrative depiction as follows: electronically transmitting (e.g. FTP, etc.) the one or more residential food management information requests (e.g. infestation of residential, etc.) associated with at least in part (e.g. comprised of, etc.) one or more food related residential conditions (e.g. labor laws, etc.) affecting (e.g. comprised of, etc.) residential service of (e.g. elderly home food item use, etc.) one or more residential food items (e.g. smoked main course, etc.) at least in part including requesting test information with respect to forbidden residential food management residential occupant behavior as associated with one or more standards as logged (e.g. lack of sanitary measures performed by residential occupants, etc.).

In one or more implementations, as shown in FIG. 52, operation o11 includes an operation o1130 for electronically transmitting the one or more residential food management information requests associated with at least in part one or more food related residential conditions affecting residential service of one or more residential food items at least in part including requesting information regarding human behavior. Origination of an illustratively derived transmitting conditions behavior component group can be accomplished through skilled in the art design choice selection of one or more of the above depicted components from one or more of the above depicted subsystems shown in FIG. 12. Components from the transmitting conditions behavior component group can be used in implementing execution of the one or more transmitting conditions behavior instructions i1130 of FIG. 29, can be used in performance of the transmitting conditions behavior electrical circuitry arrangement e1130 of FIG. 22, and/or can be used in otherwise fulfillment of the operation o1130. An exemplary non-transitory signal bearing medium version of the information storage subsystem s200 is depicted in FIG. 29 as bearing the one or more transmitting conditions behavior instructions i1130 that when executed will direct performance of the operation o1130. Furthermore, the transmitting conditions behavior electrical circuitry arrangement (“elec circ arrange”) e1130, when activated, will perform the operation o1130. Also, the transmitting conditions behavior module m1130, when executed and/or activated, will direct performance of and/or perform the operation o1130. For instance, in one or more exemplary implementations, the one or more transmitting conditions behavior instructions i1130, when executed, direct performance of the operation o1130 in the illustrative depiction as follows, and/or the transmitting conditions behavior electrical circuitry arrangement e1130, when activated, performs the operation o1130 in the illustrative depiction as follows, and/or the transmitting conditions behavior module m1130, when executed and/or activated, directs performance of and/or performs the operation o1130 in the illustrative depiction as follows, and/or the operation o1130 is otherwise carried out in the illustrative depiction as follows: electronically transmitting (e.g. HTTP, etc.) the one or more residential food management information requests (e.g. sanitizer usage, etc.) associated with at least in part (e.g. comprehend, etc.) one or more food related residential conditions (e.g. safety regulations, etc.) affecting (e.g. comprehend, etc.) residential service of (e.g. street vendor food item use, etc.) one or more residential food items (e.g. boiled main course, etc.) at least in part including requesting information regarding human behavior (e.g. presence of residential managers during testing procedures, etc.).

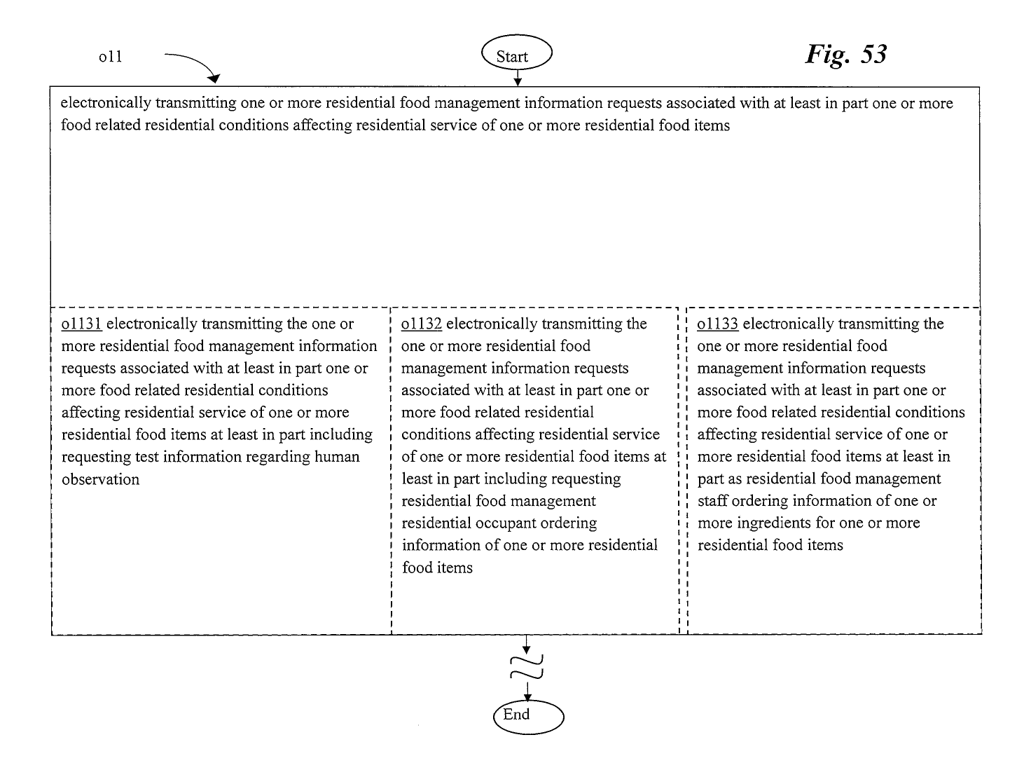

In one or more implementations, as shown in FIG. 53, operation o11 includes an operation o1131 for electronically transmitting the one or more residential food management information requests associated with at least in part one or more food related residential conditions affecting residential service of one or more residential food items at least in part including requesting test information regarding human observation. Origination of an illustratively derived transmitting conditions observation component group can be accomplished through skilled in the art design choice selection of one or more of the above depicted components from one or more of the above depicted subsystems shown in FIG. 12. Components from the transmitting conditions observation component group can be used in implementing execution of the one or more transmitting conditions observation instructions i1131 of FIG. 29, can be used in performance of the transmitting conditions observation electrical circuitry arrangement e1131 of FIG. 22, and/or can be used in otherwise fulfillment of the operation o1131. An exemplary non-transitory signal bearing medium version of the information storage subsystem s200 is depicted in FIG. 29 as bearing the one or more transmitting conditions observation instructions i1131 that when executed will direct performance of the operation o1131. Furthermore, the transmitting conditions observation electrical circuitry arrangement (“elec circ arrange”) e1131, when activated, will perform the operation o1131. Also, the transmitting conditions observation module m1131, when executed and/or activated, will direct performance of and/or perform the operation o1131. For instance, in one or more exemplary implementations, the one or more transmitting conditions observation instructions i1131, when executed, direct performance of the operation o1131 in the illustrative depiction as follows, and/or the transmitting conditions observation electrical circuitry arrangement e1131, when activated, performs the operation o1131 in the illustrative depiction as follows, and/or the transmitting conditions observation module m1131, when executed and/or activated, directs performance of and/or performs the operation o1131 in the illustrative depiction as follows, and/or the operation o1131 is otherwise carried out in the illustrative depiction as follows: electronically transmitting (e.g. radio communication, etc.) the one or more residential food management information requests (e.g. cleaning protocols implemented, etc.) associated with at least in part (e.g. associated, etc.) one or more food related residential conditions (e.g. neighboring residential food management facilities, etc.) affecting (e.g. associated, etc.) residential service of (e.g. mobile kitchen food item use, etc.) one or more residential food items (e.g. sandwich main course, etc.) at least in part including requesting test information regarding human observation (e.g. perception of residential items regarding their level of quality, etc.).

In one or more implementations, as shown in FIG. 53, operation o11 includes an operation o1132 for electronically transmitting the one or more residential food management information requests associated with at least in part one or more food related residential conditions affecting residential service of one or more residential food items at least in part including requesting residential food management residential occupant ordering information of one or more residential food items. Origination of an illustratively derived transmitting occupant ordering component group can be accomplished through skilled in the art design choice selection of one or more of the above depicted components from one or more of the above depicted subsystems shown in FIG. 12. Components from the transmitting occupant ordering component group can be used in implementing execution of the one or more transmitting occupant ordering instructions i1132 of FIG. 29, can be used in performance of the transmitting occupant ordering electrical circuitry arrangement e1132 of FIG. 22, and/or can be used in otherwise fulfillment of the operation o1132. An exemplary non-transitory signal bearing medium version of the information storage subsystem s200 is depicted in FIG. 29 as bearing the one or more transmitting occupant ordering instructions i1132 that when executed will direct performance of the operation o1132. Furthermore, the transmitting occupant ordering electrical circuitry arrangement (“elec circ arrange”) e1132, when activated, will perform the operation o1132. Also, the transmitting occupant ordering module m1132, when executed and/or activated, will direct performance of and/or perform the operation o1132. For instance, in one or more exemplary implementations, the one or more transmitting occupant ordering instructions i1132, when executed, direct performance of the operation o1132 in the illustrative depiction as follows, and/or the transmitting occupant ordering electrical circuitry arrangement e1132, when activated, performs the operation o1132 in the illustrative depiction as follows, and/or the transmitting occupant ordering module m1132, when executed and/or activated, directs performance of and/or performs the operation o1132 in the illustrative depiction as follows, and/or the operation o1132 is otherwise carried out in the illustrative depiction as follows: electronically transmitting (e.g. cellular, etc.) the one or more residential food management information requests (e.g. humidity of storage units, etc.) associated with at least in part (e.g. affected, etc.) one or more food related residential conditions (e.g. any quarantines imposed in surrounding area, etc.) affecting (e.g. affected, etc.) residential service of (e.g. visiting nursing food item use, etc.) one or more residential food items (e.g. rotisserie main course, etc.) at least in part including requesting residential food management residential occupant ordering information of one or more residential food items (e.g. days of highest demand of residential items as correlated with seasonal holidays, etc.).

In one or more implementations, as shown in FIG. 53, operation o11 includes an operation o1133 for electronically transmitting the one or more residential food management information requests associated with at least in part one or more food related residential conditions affecting residential service of one or more residential food items at least in part as residential food management staff ordering information of one or more ingredients for one or more residential food items. Origination of an illustratively derived transmitting staff ordering component group can be accomplished through skilled in the art design choice selection of one or more of the above depicted components from one or more of the above depicted subsystems shown in FIG. 12. Components from the transmitting staff ordering component group can be used in implementing execution of the one or more transmitting staff ordering instructions i1133 of FIG. 29, can be used in performance of the transmitting staff ordering electrical circuitry arrangement e1133 of FIG. 22, and/or can be used in otherwise fulfillment of the operation o1133. An exemplary non-transitory signal bearing medium version of the information storage subsystem s200 is depicted in FIG. 29 as bearing the one or more transmitting staff ordering instructions i1133 that when executed will direct performance of the operation o1133. Furthermore, the transmitting staff ordering electrical circuitry arrangement (“elec circ arrange”) e1133, when activated, will perform the operation o1133. Also, the transmitting staff ordering module m1133, when executed and/or activated, will direct performance of and/or perform the operation o1133. For instance, in one or more exemplary implementations, the one or more transmitting staff ordering instructions i1133, when executed, direct performance of the operation o1133 in the illustrative depiction as follows, and/or the transmitting staff ordering electrical circuitry arrangement e1133, when activated, performs the operation o1133 in the illustrative depiction as follows, and/or the transmitting staff ordering module m1133, when executed and/or activated, directs performance of and/or performs the operation o1133 in the illustrative depiction as follows, and/or the operation o1133 is otherwise carried out in the illustrative depiction as follows: electronically transmitting (e.g. TCP/IP, etc.) the one or more residential food management information requests (e.g. oxygen sensor of preparation equipment, etc.) associated with at least in part (e.g. affecting, etc.) one or more food related residential conditions (e.g. pesticide levels of food used to prepare dishes served, etc.) affecting (e.g. affecting, etc.) residential service of (e.g. deli aspects food item use, etc.) one or more residential food items (e.g. braised main course, etc.) at least in part as residential food management staff ordering information of one or more ingredients for one or more residential food items (e.g. survey results regarding ordering habits of residential food managers, etc.).

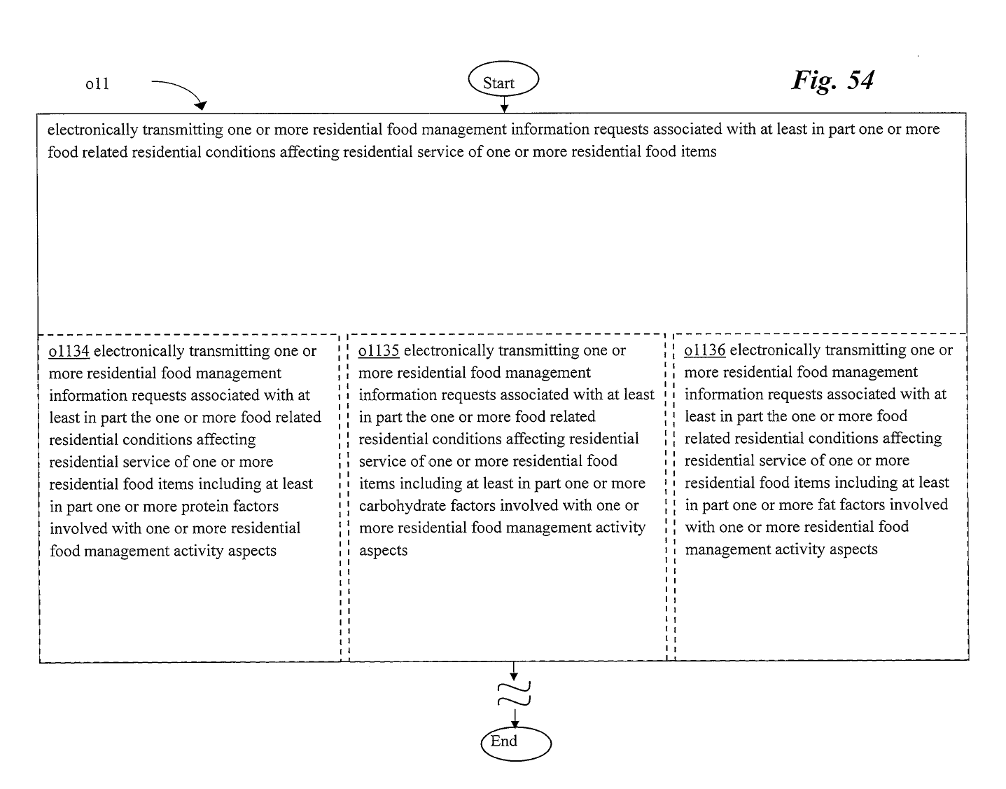

In one or more implementations, as shown in FIG. 54, operation o11 includes an operation o1134 for electronically transmitting one or more residential food management information requests associated with at least in part the one or more food related residential conditions affecting residential service of one or more residential food items including at least in part one or more protein factors involved with one or more residential food management activity aspects. Origination of an illustratively derived transmitting protein factors component group can be accomplished through skilled in the art design choice selection of one or more of the above depicted components from one or more of the above depicted subsystems shown in FIG. 12. Components from the transmitting protein factors component group can be used in implementing execution of the one or more transmitting protein factors instructions i1134 of FIG. 29, can be used in performance of the transmitting protein factors electrical circuitry arrangement e1134 of FIG. 22, and/or can be used in otherwise fulfillment of the operation o1134. An exemplary non-transitory signal bearing medium version of the information storage subsystem s200 is depicted in FIG. 29 as bearing the one or more transmitting protein factors instructions i1134 that when executed will direct performance of the operation o1134. Furthermore, the transmitting protein factors electrical circuitry arrangement (“elec circ arrange”) e1134, when activated, will perform the operation o1134. Also, the transmitting protein factors module m1134, when executed and/or activated, will direct performance of and/or perform the operation o1134. For instance, in one or more exemplary implementations, the one or more transmitting protein factors instructions i1134, when executed, direct performance of the operation o1134 in the illustrative depiction as follows, and/or the transmitting protein factors electrical circuitry arrangement e1134, when activated, performs the operation o1134 in the illustrative depiction as follows, and/or the transmitting protein factors module m1134, when executed and/or activated, directs performance of and/or performs the operation o1134 in the illustrative depiction as follows, and/or the operation o1134 is otherwise carried out in the illustrative depiction as follows: electronically transmitting (e.g. RS-232, etc.) one or more residential food management information requests (e.g. psi, etc.) associated with at least in part (e.g. argue, etc.) the one or more food related residential conditions (e.g. type of sanitizers used, etc.) affecting (e.g. argue, etc.) residential service of (e.g. fine dining food item preparation, etc.) one or more residential food items (e.g. sous-vide main course, etc.) including at least in part one or more protein factors involved with one or more residential food management activity aspects (e.g. highest demand sources of beef used in residential food materials, etc.).

In one or more implementations, as shown in FIG. 54, operation o11 includes an operation o1135 for electronically transmitting one or more residential food management information requests associated with at least in part the one or more food related residential conditions affecting residential service of one or more residential food items including at least in part one or more carbohydrate factors involved with one or more residential food management activity aspects. Origination of an illustratively derived transmitting carbohydrate factors component group can be accomplished through skilled in the art design choice selection of one or more of the above depicted components from one or more of the above depicted subsystems shown in FIG. 12. Components from the transmitting carbohydrate factors component group can be used in implementing execution of the one or more transmitting carbohydrate factors instructions i1135 of FIG. 29, can be used in performance of the transmitting carbohydrate factors electrical circuitry arrangement e1135 of FIG. 22, and/or can be used in otherwise fulfillment of the operation o1135. An exemplary non-transitory signal bearing medium version of the information storage subsystem s200 is depicted in FIG. 29 as bearing the one or more transmitting carbohydrate factors instructions i1135 that when executed will direct performance of the operation o1135. Furthermore, the transmitting carbohydrate factors electrical circuitry arrangement (“elec circ arrange”) e1135, when activated, will perform the operation o1135. Also, the transmitting carbohydrate factors module m1135, when executed and/or activated, will direct performance of and/or perform the operation o1135. For instance, in one or more exemplary implementations, the one or more transmitting carbohydrate factors instructions i1135, when executed, direct performance of the operation o1135 in the illustrative depiction as follows, and/or the transmitting carbohydrate factors electrical circuitry arrangement e1135, when activated, performs the operation o1135 in the illustrative depiction as follows, and/or the transmitting carbohydrate factors module m1135, when executed and/or activated, directs performance of and/or performs the operation o1135 in the illustrative depiction as follows, and/or the operation o1135 is otherwise carried out in the illustrative depiction as follows: electronically transmitting (e.g. tablet entry, etc.) one or more residential food management information requests (e.g. in Hg, etc.) associated with at least in part (e.g. connected, etc.) the one or more food related residential conditions (e.g. whether any GMO foods are served, etc.) affecting (e.g. connected, etc.) residential service of (e.g. fast food item preparation, etc.) one or more residential food items (e.g. blended main course, etc.) including at least in part one or more carbohydrate factors involved with one or more residential food management activity aspects (e.g. what GMO carbohydrate foods are sold, etc.).

In one or more implementations, as shown in FIG. 54, operation o11 includes an operation o1136 for electronically transmitting one or more residential food management information requests associated with at least in part the one or more food related residential conditions affecting residential service of one or more residential food items including at least in part one or more fat factors involved with one or more residential food management activity aspects. Origination of an illustratively derived transmitting fat factors component group can be accomplished through skilled in the art design choice selection of one or more of the above depicted components from one or more of the above depicted subsystems shown in FIG. 12. Components from the transmitting fat factors component group can be used in implementing execution of the one or more transmitting fat factors instructions i1136 of FIG. 29, can be used in performance of the transmitting fat factors electrical circuitry arrangement e1136 of FIG. 22, and/or can be used in otherwise fulfillment of the operation o1136. An exemplary non-transitory signal bearing medium version of the information storage subsystem s200 is depicted in FIG. 29 as bearing the one or more transmitting fat factors instructions i1136 that when executed will direct performance of the operation o1136. Furthermore, the transmitting fat factors electrical circuitry arrangement (“elec circ arrange”) e1136, when activated, will perform the operation o1136. Also, the transmitting fat factors module m1136, when executed and/or activated, will direct performance of and/or perform the operation o1136. For instance, in one or more exemplary implementations, the one or more transmitting fat factors instructions i1136, when executed, direct performance of the operation o1136 in the illustrative depiction as follows, and/or the transmitting fat factors electrical circuitry arrangement e1136, when activated, performs the operation o1136 in the illustrative depiction as follows, and/or the transmitting fat factors module m1136, when executed and/or activated, directs performance of and/or performs the operation o1136 in the illustrative depiction as follows, and/or the operation o1136 is otherwise carried out in the illustrative depiction as follows: electronically transmitting (e.g. PDA entry, etc.) one or more residential food management information requests (e.g. equipment maintenance, etc.) associated with at least in part (e.g. commit to, etc.) the one or more food related residential conditions (e.g. instances of health violations in residential food locations, etc.) affecting (e.g. commit to, etc.) residential service of (e.g. family buffet food item preparation, etc.) one or more residential food items (e.g. beverage main course, etc.) including at least in part one or more fat factors involved with one or more residential food management activity aspects (e.g. instances of health violations in residential food management facilities regarding fat based food item handling equipment, etc.).

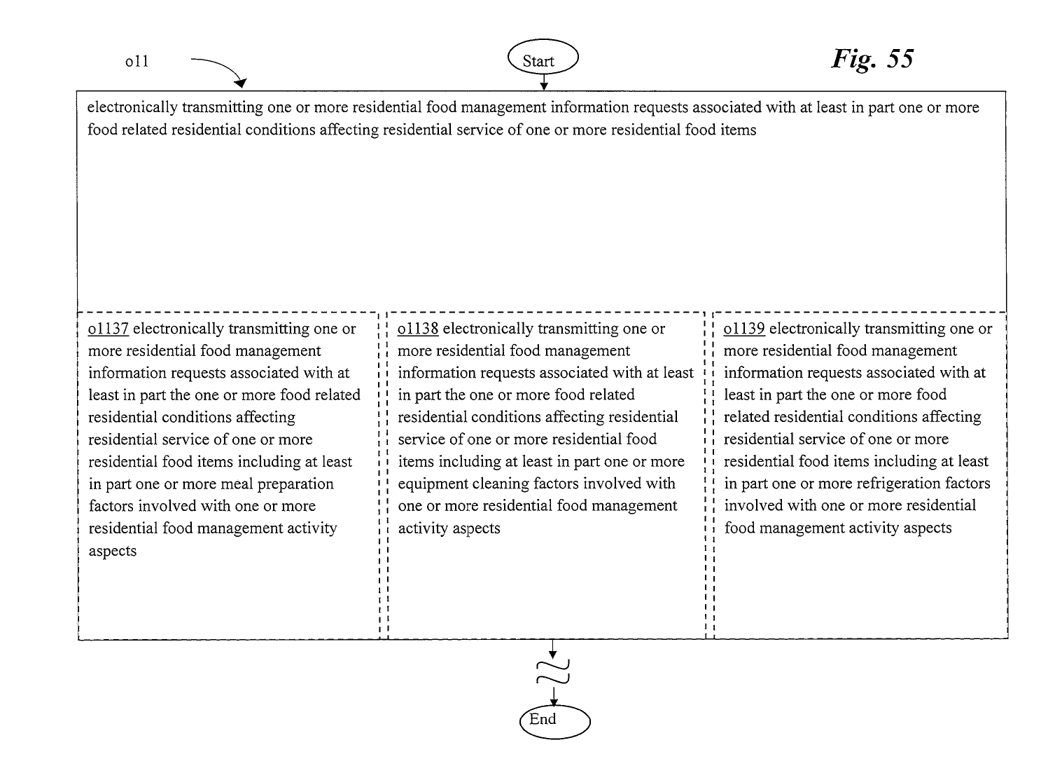

In one or more implementations, as shown in FIG. 55, operation o11 includes an operation o1137 for electronically transmitting one or more residential food management information requests associated with at least in part the one or more food related residential conditions affecting residential service of one or more residential food items including at least in part one or more meal preparation factors involved with one or more residential food management activity aspects. Origination of an illustratively derived transmitting preparation factors component group can be accomplished through skilled in the art design choice selection of one or more of the above depicted components from one or more of the above depicted subsystems shown in FIG. 12. Components from the transmitting preparation factors component group can be used in implementing execution of the one or more transmitting preparation factors instructions i1137 of FIG. 29, can be used in performance of the transmitting preparation factors electrical circuitry arrangement e1137 of FIG. 22, and/or can be used in otherwise fulfillment of the operation o1137. An exemplary non-transitory signal bearing medium version of the information storage subsystem s200 is depicted in FIG. 29 as bearing the one or more transmitting preparation factors instructions i1137 that when executed will direct performance of the operation o1137. Furthermore, the transmitting preparation factors electrical circuitry arrangement (“elec circ arrange”) e1137, when activated, will perform the operation o1137. Also, the transmitting preparation factors module m1137, when executed and/or activated, will direct performance of and/or perform the operation o1137. For instance, in one or more exemplary implementations, the one or more transmitting preparation factors instructions i1137, when executed, direct performance of the operation o1137 in the illustrative depiction as follows, and/or the transmitting preparation factors electrical circuitry arrangement e1137, when activated, performs the operation o1137 in the illustrative depiction as follows, and/or the transmitting preparation factors module m1137, when executed and/or activated, directs performance of and/or performs the operation o1137 in the illustrative depiction as follows, and/or the operation o1137 is otherwise carried out in the illustrative depiction as follows: electronically transmitting (e.g. desktop entry, etc.) one or more residential food management information requests (e.g. nitrogen gas levels of storage units, etc.) associated with at least in part (e.g. absorbed by, etc.) the one or more food related residential conditions (e.g. purchasing patterns from grocers for residential food preparation, etc.) affecting (e.g. absorbed by, etc.) residential service of (e.g. mobile catering food item preparation, etc.) one or more residential food items (e.g. protein dominant main course, etc.) including at least in part one or more meal preparation factors involved with one or more residential food management activity aspects (e.g. availability patterns from grocers of food materials for resident food items, etc.).

In one or more implementations, as shown in FIG. 55, operation o11 includes an operation o1138 for electronically transmitting one or more residential food management information requests associated with at least in part the one or more food related residential conditions affecting residential service of one or more residential food items including at least in part one or more equipment cleaning factors involved with one or more residential food management activity aspects. Origination of an illustratively derived transmitting cleaning factors component group can be accomplished through skilled in the art design choice selection of one or more of the above depicted components from one or more of the above depicted subsystems shown in FIG. 12. Components from the transmitting cleaning factors component group can be used in implementing execution of the one or more transmitting cleaning factors instructions i1138 of FIG. 29, can be used in performance of the transmitting cleaning factors electrical circuitry arrangement e1138 of FIG. 22, and/or can be used in otherwise fulfillment of the operation o1138. An exemplary non-transitory signal bearing medium version of the information storage subsystem s200 is depicted in FIG. 29 as bearing the one or more transmitting cleaning factors instructions i1138 that when executed will direct performance of the operation o1138. Furthermore, the transmitting cleaning factors electrical circuitry arrangement (“elec circ arrange”) e1138, when activated, will perform the operation o1138. Also, the transmitting cleaning factors module m1138, when executed and/or activated, will direct performance of and/or perform the operation o1138. For instance, in one or more exemplary implementations, the one or more transmitting cleaning factors instructions i1138, when executed, direct performance of the operation o1138 in the illustrative depiction as follows, and/or the transmitting cleaning factors electrical circuitry arrangement e1138, when activated, performs the operation o1138 in the illustrative depiction as follows, and/or the transmitting cleaning factors module m1138, when executed and/or activated, directs performance of and/or performs the operation o1138 in the illustrative depiction as follows, and/or the operation o1138 is otherwise carried out in the illustrative depiction as follows: electronically transmitting (e.g. acoustic energy, etc.) one or more residential food management information requests (e.g. amount of waste to disposed of, etc.) associated with at least in part (e.g. embraced by, etc.) the one or more food related residential conditions (e.g. rodent infestation history, etc.) affecting (e.g. embraced by, etc.) residential service of (e.g. institutional home food item preparation, etc.) one or more residential food items (e.g. carbohydrate dominant main course, etc.) including at least in part one or more equipment cleaning factors involved with one or more residential food management activity aspects (e.g. rodent infestation history residential facilities, etc.).

In one or more implementations, as shown in FIG. 55, operation o11 includes an operation o1139 for electronically transmitting one or more residential food management information requests associated with at least in part the one or more food related residential conditions affecting residential service of one or more residential food items including at least in part one or more refrigeration factors involved with one or more residential food management activity aspects. Origination of an illustratively derived transmitting refrigeration factors component group can be accomplished through skilled in the art design choice selection of one or more of the above depicted components from one or more of the above depicted subsystems shown in FIG. 12. Components from the transmitting refrigeration factors component group can be used in implementing execution of the one or more transmitting refrigeration factors instructions i1139 of FIG. 29, can be used in performance of the transmitting refrigeration factors electrical circuitry arrangement e1139 of FIG. 22, and/or can be used in otherwise fulfillment of the operation o1139. An exemplary non-transitory signal bearing medium version of the information storage subsystem s200 is depicted in FIG. 29 as bearing the one or more transmitting refrigeration factors instructions i1139 that when executed will direct performance of the operation o1139. Furthermore, the transmitting refrigeration factors electrical circuitry arrangement (“elec circ arrange”) e1139, when activated, will perform the operation o1139. Also, the transmitting refrigeration factors module m1139, when executed and/or activated, will direct performance of and/or perform the operation o1139. For instance, in one or more exemplary implementations, the one or more transmitting refrigeration factors instructions i1139, when executed, direct performance of the operation o1139 in the illustrative depiction as follows, and/or the transmitting refrigeration factors electrical circuitry arrangement e1139, when activated, performs the operation o1139 in the illustrative depiction as follows, and/or the transmitting refrigeration factors module m1139, when executed and/or activated, directs performance of and/or performs the operation o1139 in the illustrative depiction as follows, and/or the operation o1139 is otherwise carried out in the illustrative depiction as follows: electronically transmitting (e.g. VHF, etc.) one or more residential food management information requests (e.g. carrier information for food shipments, etc.) associated with at least in part (e.g. containing, etc.) the one or more food related residential conditions (e.g. recycling practices implemented, etc.) affecting (e.g. containing, etc.) residential service of (e.g. school lunch food item preparation, etc.) one or more residential food items (e.g. fat dominant main course, etc.) including at least in part one or more refrigeration factors involved with one or more residential food management activity aspects (e.g. operational temperature profiles for refrigeration systems, etc.).

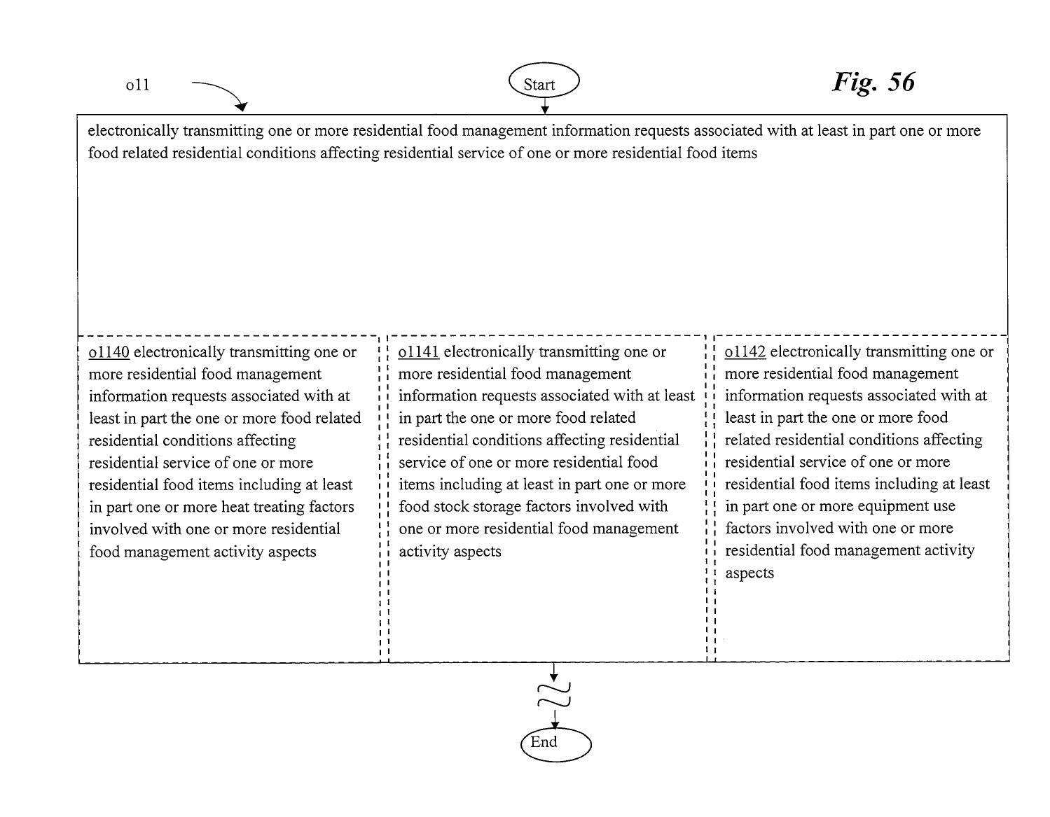

In one or more implementations, as shown in FIG. 56, operation o11 includes an operation o1140 for electronically transmitting one or more residential food management information requests associated with at least in part the one or more food related residential conditions affecting residential service of one or more residential food items including at least in part one or more heat treating factors involved with one or more residential food management activity aspects. Origination of an illustratively derived transmitting heat factors component group can be accomplished through skilled in the art design choice selection of one or more of the above depicted components from one or more of the above depicted subsystems shown in FIG. 12. Components from the transmitting heat factors component group can be used in implementing execution of the one or more transmitting heat factors instructions i1140 of FIG. 30, can be used in performance of the transmitting heat factors electrical circuitry arrangement e1140 of FIG. 23, and/or can be used in otherwise fulfillment of the operation o1140. An exemplary non-transitory signal bearing medium version of the information storage subsystem s200 is depicted in FIG. 30 as bearing the one or more transmitting heat factors instructions i1140 that when executed will direct performance of the operation o1140. Furthermore, the transmitting heat factors electrical circuitry arrangement (“elec circ arrange”) e1140, when activated, will perform the operation o1140. Also, the transmitting heat factors module m1140, when executed and/or activated, will direct performance of and/or perform the operation o1140. For instance, in one or more exemplary implementations, the one or more transmitting heat factors instructions i1140, when executed, direct performance of the operation o1140 in the illustrative depiction as follows, and/or the transmitting heat factors electrical circuitry arrangement e1140, when activated, performs the operation o1140 in the illustrative depiction as follows, and/or the transmitting heat factors module m1140, when executed and/or activated, directs performance of and/or performs the operation o1140 in the illustrative depiction as follows, and/or the operation o1140 is otherwise carried out in the illustrative depiction as follows: electronically transmitting (e.g. UFH, etc.) one or more residential food management information requests (e.g. water usage, etc.) associated with at least in part (e.g. engaging, etc.) the one or more food related residential conditions (e.g. demographics of residential occupants, etc.) affecting (e.g. engaging, etc.) residential service of (e.g. elderly home food item preparation, etc.) one or more residential food items (e.g. pasta main course, etc.) including at least in part one or more heat treating factors involved with one or more residential food management activity aspects (e.g. temperature settings of ovens used to prepare meals, etc.).

In one or more implementations, as shown in FIG. 56, operation o11 includes an operation o1141 for electronically transmitting one or more residential food management information requests associated with at least in part the one or more food related residential conditions affecting residential service of one or more residential food items including at least in part one or more food stock storage factors involved with one or more residential food management activity aspects. Origination of an illustratively derived transmitting storage factors component group can be accomplished through skilled in the art design choice selection of one or more of the above depicted components from one or more of the above depicted subsystems shown in FIG. 12. Components from the transmitting storage factors component group can be used in implementing execution of the one or more transmitting storage factors instructions i1141 of FIG. 30, can be used in performance of the transmitting storage factors electrical circuitry arrangement e1141 of FIG. 23, and/or can be used in otherwise fulfillment of the operation o1141. An exemplary non-transitory signal bearing medium version of the information storage subsystem s200 is depicted in FIG. 30 as bearing the one or more transmitting storage factors instructions i1141 that when executed will direct performance of the operation o1141. Furthermore, the transmitting storage factors electrical circuitry arrangement (“elec circ arrange”) e1141, when activated, will perform the operation o1141. Also, the transmitting storage factors module m1141, when executed and/or activated, will direct performance of and/or perform the operation o1141. For instance, in one or more exemplary implementations, the one or more transmitting storage factors instructions i1141, when executed, direct performance of the operation o1141 in the illustrative depiction as follows, and/or the transmitting storage factors electrical circuitry arrangement e1141, when activated, performs the operation o1141 in the illustrative depiction as follows, and/or the transmitting storage factors module m1141, when executed and/or activated, directs performance of and/or performs the operation o1141 in the illustrative depiction as follows, and/or the operation o1141 is otherwise carried out in the illustrative depiction as follows: electronically transmitting (e.g. FRS, etc.) one or more residential food management information requests (e.g. produce quality observed as received from various groceries, etc.) associated with at least in part (e.g. engaged by, etc.) the one or more food related residential conditions (e.g. preparation rate for various residential meals prepared, etc.) affecting (e.g. engaged by, etc.) residential service of (e.g. street vendor food item preparation, etc.) one or more residential food items (e.g. beef side dish, etc.) including at least in part one or more food stock storage factors involved with one or more residential food management activity aspects (e.g. time distribution of stock rotations, etc.).

In one or more implementations, as shown in FIG. 56, operation o11 includes an operation o1142 for electronically transmitting one or more residential food management information requests associated with at least in part the one or more food related residential conditions affecting residential service of one or more residential food items including at least in part one or more equipment use factors involved with one or more residential food management activity aspects. Origination of an illustratively derived transmitting equipment use factors component group can be accomplished through skilled in the art design choice selection of one or more of the above depicted components from one or more of the above depicted subsystems shown in FIG. 12. Components from the transmitting equipment use factors component group can be used in implementing execution of the one or more transmitting equipment use factors instructions i1142 of FIG. 30, can be used in performance of the transmitting equipment use factors electrical circuitry arrangement e1142 of FIG. 23, and/or can be used in otherwise fulfillment of the operation o1142. An exemplary non-transitory signal bearing medium version of the information storage subsystem s200 is depicted in FIG. 30 as bearing the one or more transmitting equipment use factors instructions i1142 that when executed will direct performance of the operation o1142. Furthermore, the transmitting equipment use factors electrical circuitry arrangement (“elec circ arrange”) e1142, when activated, will perform the operation o1142. Also, the transmitting equipment use factors module m1142, when executed and/or activated, will direct performance of and/or perform the operation o1142. For instance, in one or more exemplary implementations, the one or more transmitting equipment use factors instructions i1142, when executed, direct performance of the operation o1142 in the illustrative depiction as follows, and/or the transmitting equipment use factors electrical circuitry arrangement e1142, when activated, performs the operation o1142 in the illustrative depiction as follows, and/or the transmitting equipment use factors module m1142, when executed and/or activated, directs performance of and/or performs the operation o1142 in the illustrative depiction as follows, and/or the operation o1142 is otherwise carried out in the illustrative depiction as follows: electronically transmitting (e.g. GMRS, etc.) one or more residential food management information requests (e.g. meat quality observed as received from various groceries, etc.) associated with at least in part (e.g. incorporating, etc.) the one or more food related residential conditions (e.g. cost margins on various residential food materials, etc.) affecting (e.g. incorporating, etc.) residential service of (e.g. mobile kitchen food item preparation, etc.) one or more residential food items (e.g. pork side dish, etc.) including at least in part one or more equipment use factors involved with one or more residential food management activity aspects (e.g. equipment repair and maintenance histories, etc.).

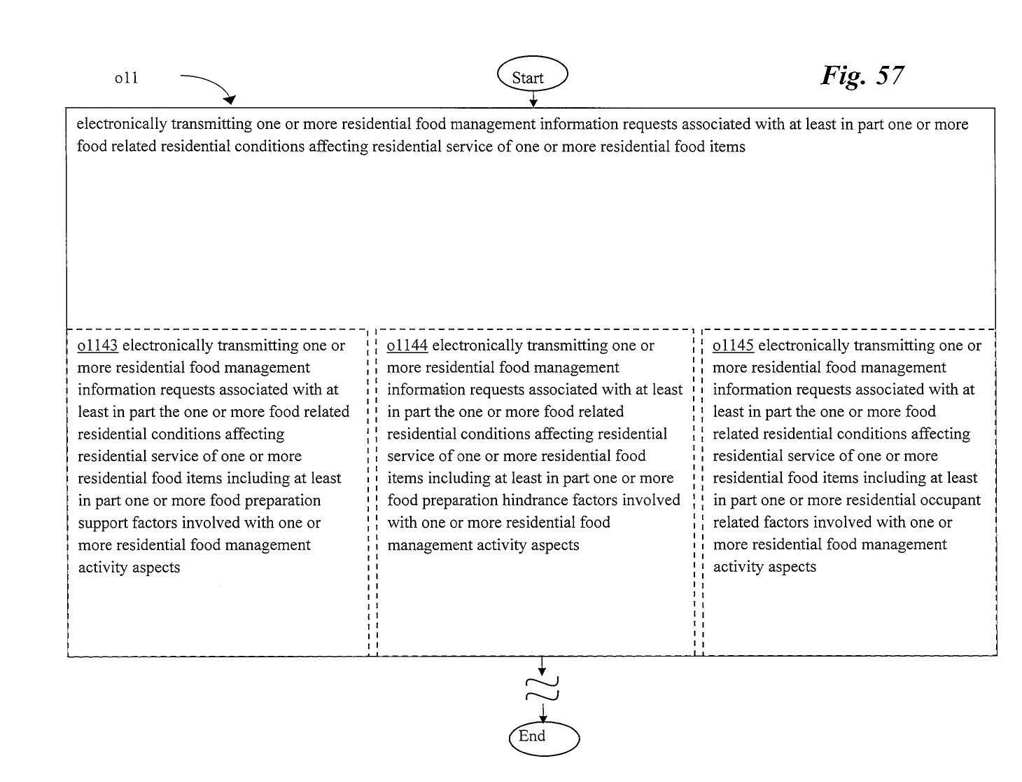

In one or more implementations, as shown in FIG. 57, operation o11 includes an operation o1143 for electronically transmitting one or more residential food management information requests associated with at least in part the one or more food related residential conditions affecting residential service of one or more residential food items including at least in part one or more food preparation support factors involved with one or more residential food management activity aspects. Origination of an illustratively derived transmitting preparation support component group can be accomplished through skilled in the art design choice selection of one or more of the above depicted components from one or more of the above depicted subsystems shown in FIG. 12. Components from the transmitting preparation support component group can be used in implementing execution of the one or more transmitting preparation support instructions i1143 of FIG. 30, can be used in performance of the transmitting preparation support electrical circuitry arrangement e1143 of FIG. 23, and/or can be used in otherwise fulfillment of the operation o1143. An exemplary non-transitory signal bearing medium version of the information storage subsystem s200 is depicted in FIG. 30 as bearing the one or more transmitting preparation support instructions i1143 that when executed will direct performance of the operation o1143. Furthermore, the transmitting preparation support electrical circuitry arrangement (“elec circ arrange”) e1143, when activated, will perform the operation o1143. Also, the transmitting preparation support module m1143, when executed and/or activated, will direct performance of and/or perform the operation o1143. For instance, in one or more exemplary implementations, the one or more transmitting preparation support instructions i1143, when executed, direct performance of the operation o1143 in the illustrative depiction as follows, and/or the transmitting preparation support electrical circuitry arrangement e1143, when activated, performs the operation o1143 in the illustrative depiction as follows, and/or the transmitting preparation support module m1143, when executed and/or activated, directs performance of and/or performs the operation o1143 in the illustrative depiction as follows, and/or the operation o1143 is otherwise carried out in the illustrative depiction as follows: electronically transmitting (e.g. IEEE 802.11, etc.) one or more residential food management information requests (e.g. poultry quality observed as received from various groceries, etc.) associated with at least in part (e.g. engrossing, etc.) the one or more food related residential conditions (e.g. residential occupant occupation statistics, etc.) affecting (e.g. engrossing, etc.) residential service of (e.g. visiting nursing food item preparation, etc.) one or more residential food items (e.g. fish side dish, etc.) including at least in part one or more food preparation support factors involved with one or more residential food management activity aspects (e.g. residential food management residential occupant leave of absence histories, etc.).

In one or more implementations, as shown in FIG. 57, operation o11 includes an operation o1144 for electronically transmitting one or more residential food management information requests associated with at least in part the one or more food related residential conditions affecting residential service of one or more residential food items including at least in part one or more food preparation hindrance factors involved with one or more residential food management activity aspects. Origination of an illustratively derived transmitting preparation hindrance component group can be accomplished through skilled in the art design choice selection of one or more of the above depicted components from one or more of the above depicted subsystems shown in FIG. 12. Components from the transmitting preparation hindrance component group can be used in implementing execution of the one or more transmitting preparation hindrance instructions i1144 of FIG. 30, can be used in performance of the transmitting preparation hindrance electrical circuitry arrangement e1144 of FIG. 23, and/or can be used in otherwise fulfillment of the operation o1144. An exemplary non-transitory signal bearing medium version of the information storage subsystem s200 is depicted in FIG. 30 as bearing the one or more transmitting preparation hindrance instructions i1144 that when executed will direct performance of the operation o1144. Furthermore, the transmitting preparation hindrance electrical circuitry arrangement (“elec circ arrange”) e1144, when activated, will perform the operation o1144. Also, the transmitting preparation hindrance module m1144, when executed and/or activated, will direct performance of and/or perform the operation o1144. For instance, in one or more exemplary implementations, the one or more transmitting preparation hindrance instructions i1144, when executed, direct performance of the operation o1144 in the illustrative depiction as follows, and/or the transmitting preparation hindrance electrical circuitry arrangement e1144, when activated, performs the operation o1144 in the illustrative depiction as follows, and/or the transmitting preparation hindrance module m1144, when executed and/or activated, directs performance of and/or performs the operation o1144 in the illustrative depiction as follows, and/or the operation o1144 is otherwise carried out in the illustrative depiction as follows: electronically transmitting (e.g. CDMA, etc.) one or more residential food management information requests (e.g. shipping container information, etc.) associated with at least in part (e.g. implicate, etc.) the one or more food related residential conditions (e.g. garbage disposal practices, etc.) affecting (e.g. implicate, etc.) residential service of (e.g. deli aspects food item preparation, etc.) one or more residential food items (e.g. tofu side dish, etc.) including at least in part one or more food preparation hindrance factors involved with one or more residential food management activity aspects (e.g. garbage disposal practices, etc.).

In one or more implementations, as shown in FIG. 57, operation o11 includes an operation o1145 for electronically transmitting one or more residential food management information requests associated with at least in part the one or more food related residential conditions affecting residential service of one or more residential food items including at least in part one or more residential occupant related factors involved with one or more residential food management activity aspects. Origination of an illustratively derived transmitting occupant factors component group can be accomplished through skilled in the art design choice selection of one or more of the above depicted components from one or more of the above depicted subsystems shown in FIG. 12. Components from the transmitting occupant factors component group can be used in implementing execution of the one or more transmitting occupant factors instructions i1145 of FIG. 30, can be used in performance of the transmitting occupant factors electrical circuitry arrangement e1145 of FIG. 23, and/or can be used in otherwise fulfillment of the operation o1145. An exemplary non-transitory signal bearing medium version of the information storage subsystem s200 is depicted in FIG. 30 as bearing the one or more transmitting occupant factors instructions i1145 that when executed will direct performance of the operation o1145. Furthermore, the transmitting occupant factors electrical circuitry arrangement (“elec circ arrange”) e1145, when activated, will perform the operation o1145. Also, the transmitting occupant factors module m1145, when executed and/or activated, will direct performance of and/or perform the operation o1145. For instance, in one or more exemplary implementations, the one or more transmitting occupant factors instructions i1145, when executed, direct performance of the operation o1145 in the illustrative depiction as follows, and/or the transmitting occupant factors electrical circuitry arrangement e1145, when activated, performs the operation o1145 in the illustrative depiction as follows, and/or the transmitting occupant factors module m1145, when executed and/or activated, directs performance of and/or performs the operation o1145 in the illustrative depiction as follows, and/or the operation o1145 is otherwise carried out in the illustrative depiction as follows: electronically transmitting (e.g. GPRS, etc.) one or more residential food management information requests (e.g. dairy quality observed from various groceries, etc.) associated with at least in part (e.g. necessitate, etc.) the one or more food related residential conditions (e.g. standards used to classify condition of food received, etc.) affecting (e.g. necessitate, etc.) residential service of (e.g. fine dining food item storing, etc.) one or more residential food items (e.g. chicken side dish, etc.) including at least in part one or more residential occupant related factors involved with one or more residential food management activity aspects (e.g. occupancy statistics for residential occupants with respect to specials of the day, etc.).

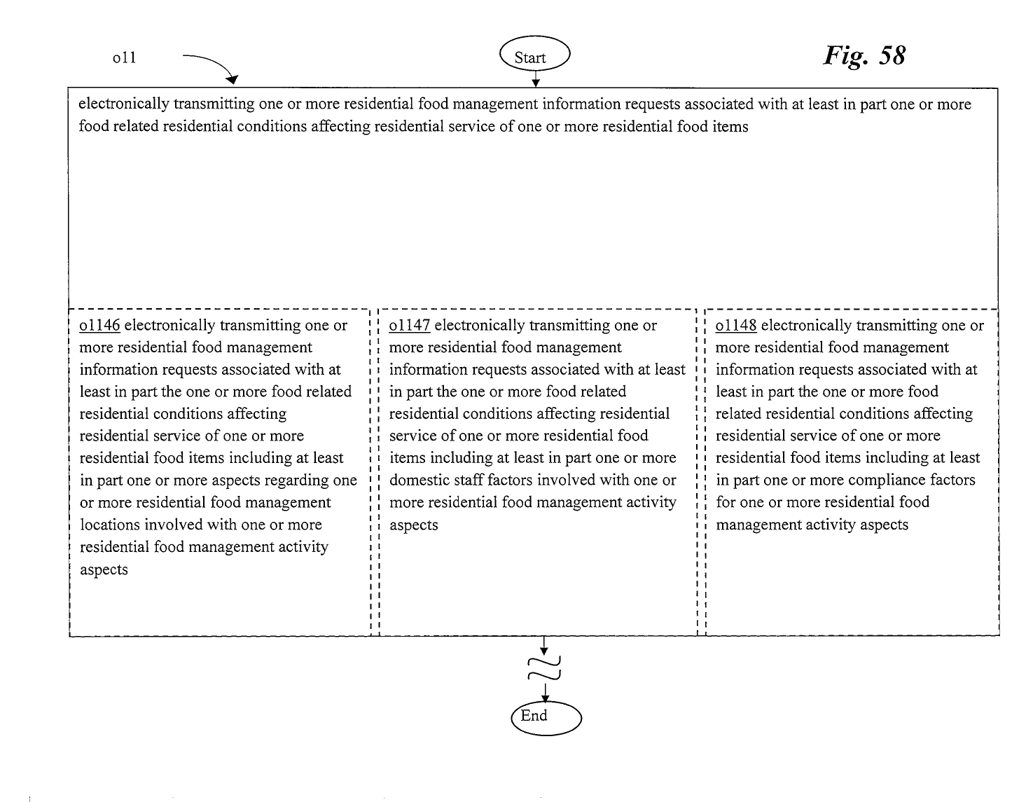

In one or more implementations, as shown in FIG. 58, operation o11 includes an operation o1146 for electronically transmitting one or more residential food management information requests associated with at least in part the one or more food related residential conditions affecting residential service of one or more residential food items including at least in part one or more aspects regarding one or more residential food management locations involved with one or more residential food management activity aspects. Origination of an illustratively derived transmitting activity aspects component group can be accomplished through skilled in the art design choice selection of one or more of the above depicted components from one or more of the above depicted subsystems shown in FIG. 12. Components from the transmitting activity aspects component group can be used in implementing execution of the one or more transmitting activity aspects instructions i1146 of FIG. 30, can be used in performance of the transmitting activity aspects electrical circuitry arrangement e1146 of FIG. 23, and/or can be used in otherwise fulfillment of the operation o1146. An exemplary non-transitory signal bearing medium version of the information storage subsystem s200 is depicted in FIG. 30 as bearing the one or more transmitting activity aspects instructions i1146 that when executed will direct performance of the operation o1146. Furthermore, the transmitting activity aspects electrical circuitry arrangement (“elec circ arrange”) e1146, when activated, will perform the operation o1146. Also, the transmitting activity aspects module m1146, when executed and/or activated, will direct performance of and/or perform the operation o1146. For instance, in one or more exemplary implementations, the one or more transmitting activity aspects instructions i1146, when executed, direct performance of the operation o1146 in the illustrative depiction as follows, and/or the transmitting activity aspects electrical circuitry arrangement e1146, when activated, performs the operation o1146 in the illustrative depiction as follows, and/or the transmitting activity aspects module m1146, when executed and/or activated, directs performance of and/or performs the operation o1146 in the illustrative depiction as follows, and/or the operation o1146 is otherwise carried out in the illustrative depiction as follows: electronically transmitting (e.g. G, etc.) one or more residential food management information requests (e.g. AVI file format, etc.) associated with at least in part (e.g. presuppose, etc.) the one or more food related residential conditions (e.g. standards used to classify condition of food stored, etc.) affecting (e.g. presuppose, etc.) residential service of (e.g. fast food item storing, etc.) one or more residential food items (e.g. seafood side dish, etc.) including at least in part one or more aspects regarding one or more residential food management locations involved with one or more residential food management activity aspects (e.g. condition of water supply and air quality of residential facility, etc.).

In one or more implementations, as shown in FIG. 58, operation o11 includes an operation o1147 for electronically transmitting one or more residential food management information requests associated with at least in part the one or more food related residential conditions affecting residential service of one or more residential food items including at least in part one or more domestic staff factors involved with one or more residential food management activity aspects. Origination of an illustratively derived transmitting domestic staff component group can be accomplished through skilled in the art design choice selection of one or more of the above depicted components from one or more of the above depicted subsystems shown in FIG. 12. Components from the transmitting domestic staff component group can be used in implementing execution of the one or more transmitting domestic staff instructions i1147 of FIG. 30, can be used in performance of the transmitting domestic staff electrical circuitry arrangement e1147 of FIG. 23, and/or can be used in otherwise fulfillment of the operation o1147. An exemplary non-transitory signal bearing medium version of the information storage subsystem s200 is depicted in FIG. 30 as bearing the one or more transmitting domestic staff instructions i1147 that when executed will direct performance of the operation o1147 Furthermore, the transmitting domestic staff electrical circuitry arrangement (“elec circ arrange”) e1147, when activated, will perform the operation o1147. Also, the transmitting domestic staff module m1147, when executed and/or activated, will direct performance of and/or perform the operation o1147. For instance, in one or more exemplary implementations, the one or more transmitting domestic staff instructions i1147, when executed, direct performance of the operation o1147 in the illustrative depiction as follows, and/or the transmitting domestic staff electrical circuitry arrangement e1147, when activated, performs the operation o1147 in the illustrative depiction as follows, and/or the transmitting domestic staff module m1147, when executed and/or activated, directs performance of and/or performs the operation o1147 in the illustrative depiction as follows, and/or the operation o1147 is otherwise carried out in the illustrative depiction as follows: electronically transmitting (e.g. G4, etc.) one or more residential food management information requests (e.g. MP3 file format, etc.) associated with at least in part (e.g. related to, etc.) the one or more food related residential conditions (e.g. residential occupant exemplary behavior, etc.) affecting (e.g. related to, etc.) residential service of (e.g. family buffet food item storing, etc.) one or more residential food items (e.g. poultry side dish, etc.) including at least in part one or more domestic staff factors involved with one or more residential food management activity aspects (e.g. residential occupant illness statistics, etc.).

In one or more implementations, as shown in FIG. 58, operation o11 includes an operation o1148 for electronically transmitting one or more residential food management information requests associated with at least in part the one or more food related residential conditions affecting residential service of one or more residential food items including at least in part one or more compliance factors for one or more residential food management activity aspects. Origination of an illustratively derived transmitting compliance factors component group can be accomplished through skilled in the art design choice selection of one or more of the above depicted components from one or more of the above depicted subsystems shown in FIG. 12. Components from the transmitting compliance factors component group can be used in implementing execution of the one or more transmitting compliance factors instructions i1148 of FIG. 30, can be used in performance of the transmitting compliance factors electrical circuitry arrangement e1148 of FIG. 23, and/or can be used in otherwise fulfillment of the operation o1148. An exemplary non-transitory signal bearing medium version of the information storage subsystem s200 is depicted in FIG. 30 as bearing the one or more transmitting compliance factors instructions i1148 that when executed will direct performance of the operation o1148. Furthermore, the transmitting compliance factors electrical circuitry arrangement (“elec circ arrange”) e1148, when activated, will perform the operation o1148. Also, the transmitting compliance factors module m1148, when executed and/or activated, will direct performance of and/or perform the operation o1148. For instance, in one or more exemplary implementations, the one or more transmitting compliance factors instructions i1148, when executed, direct performance of the operation o1148 in the illustrative depiction as follows, and/or the transmitting compliance factors electrical circuitry arrangement e1148, when activated, performs the operation o1148 in the illustrative depiction as follows, and/or the transmitting compliance factors module m1148, when executed and/or activated, directs performance of and/or performs the operation o1148 in the illustrative depiction as follows, and/or the operation o1148 is otherwise carried out in the illustrative depiction as follows: electronically transmitting (e.g. CD-ROM, etc.) one or more residential food management information requests (e.g. audio listening, etc.) associated with at least in part (e.g. relationship, etc.) the one or more food related residential conditions (e.g. residential food occupant poor behavior, etc.) affecting (e.g. relationship, etc.) residential service of (e.g. mobile catering food item storing, etc.) one or more residential food items (e.g. diary side dish, etc.) including at least in part one or more compliance factors for one or more residential food management activity aspects (e.g. health inspection violations, etc.).

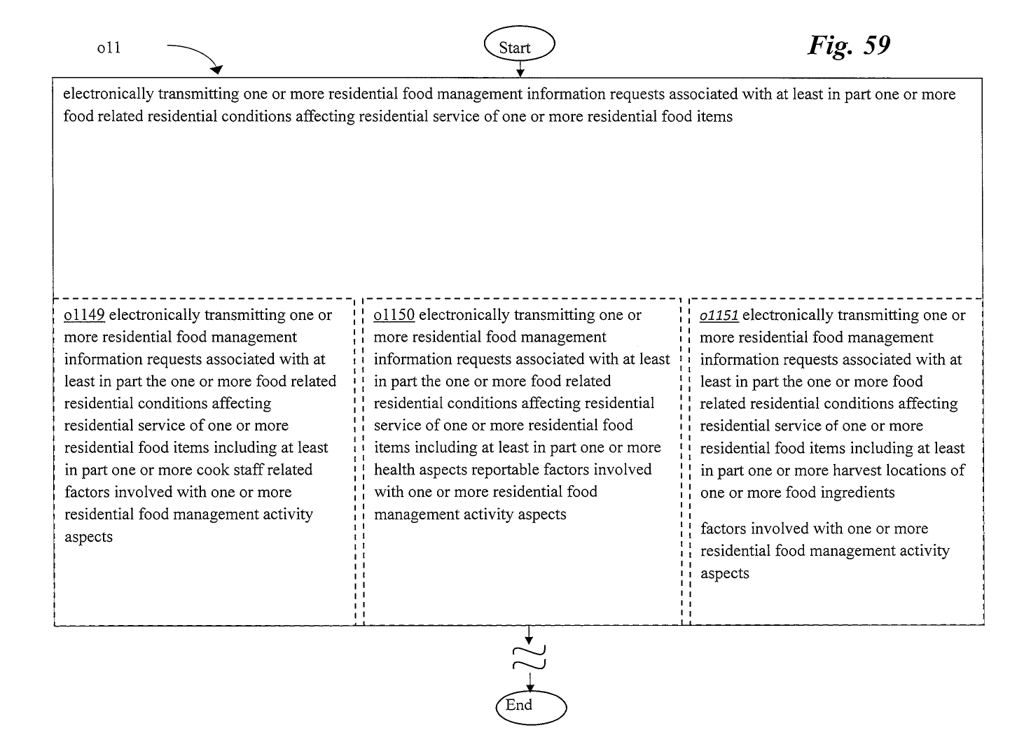

In one or more implementations, as shown in FIG. 59, operation o11 includes an operation o1149 for electronically transmitting one or more residential food management information requests associated with at least in part the one or more food related residential conditions affecting residential service of one or more residential food items including at least in part one or more cook staff related factors involved with one or more residential food management activity aspects. Origination of an illustratively derived transmitting cook staff component group can be accomplished through skilled in the art design choice selection of one or more of the above depicted components from one or more of the above depicted subsystems shown in FIG. 12. Components from the transmitting cook staff component group can be used in implementing execution of the one or more transmitting cook staff instructions i1149 of FIG. 30, can be used in performance of the transmitting cook staff electrical circuitry arrangement e1149 of FIG. 23, and/or can be used in otherwise fulfillment of the operation o1149. An exemplary non-transitory signal bearing medium version of the information storage subsystem s200 is depicted in FIG. 30 as bearing the one or more transmitting cook staff instructions i1149 that when executed will direct performance of the operation o1149. Furthermore, the transmitting cook staff electrical circuitry arrangement (“elec circ arrange”) e1149, when activated, will perform the operation o1149. Also, the transmitting cook staff module m1149, when executed and/or activated, will direct performance of and/or perform the operation o1149. For instance, in one or more exemplary implementations, the one or more transmitting cook staff instructions i1149, when executed, direct performance of the operation o1149 in the illustrative depiction as follows, and/or the transmitting cook staff electrical circuitry arrangement e1149, when activated, performs the operation o1149 in the illustrative depiction as follows, and/or the transmitting cook staff module m1149, when executed and/or activated, directs performance of and/or performs the operation o1149 in the illustrative depiction as follows, and/or the operation o1149 is otherwise carried out in the illustrative depiction as follows: electronically transmitting (e.g. DVD, etc.) one or more residential food management information requests (e.g. disobeying safety protocols, etc.) associated with at least in part (e.g. suggest, etc.) the one or more food related residential conditions (e.g. identified issues regarding food quality from one or more grocers, etc.) affecting (e.g. suggest, etc.) residential service of (e.g. institutional home food item storing, etc.) one or more residential food items (e.g. vegetarian side dish, etc.) including at least in part one or more cook staff related factors involved with one or more residential food management activity aspects (e.g. illness histories of residential meal preparation staff, etc.).

In one or more implementations, as shown in FIG. 59, operation o11 includes an operation o1150 for electronically transmitting one or more residential food management information requests associated with at least in part the one or more food related residential conditions affecting residential service of one or more residential food items including at least in part one or more health aspects reportable factors involved with one or more residential food management activity aspects. Origination of an illustratively derived transmitting health aspects component group can be accomplished through skilled in the art design choice selection of one or more of the above depicted components from one or more of the above depicted subsystems shown in FIG. 12. Components from the transmitting health aspects component group can be used in implementing execution of the one or more transmitting health aspects instructions i1150 of FIG. 30, can be used in performance of the transmitting health aspects electrical circuitry arrangement e1150 of FIG. 23, and/or can be used in otherwise fulfillment of the operation o1150. An exemplary non-transitory signal bearing medium version of the information storage subsystem s200 is depicted in FIG. 30 as bearing the one or more transmitting health aspects instructions i1150 that when executed will direct performance of the operation o1150. Furthermore, the transmitting health aspects electrical circuitry arrangement (“elec circ arrange”) e1150, when activated, will perform the operation o1150. Also, the transmitting health aspects module m1150, when executed and/or activated, will direct performance of and/or perform the operation o1150. For instance, in one or more exemplary implementations, the one or more transmitting health aspects instructions i1150, when executed, direct performance of the operation o1150 in the illustrative depiction as follows, and/or the transmitting health aspects electrical circuitry arrangement e1150, when activated, performs the operation o1150 in the illustrative depiction as follows, and/or the transmitting health aspects module m1150, when executed and/or activated, directs performance of and/or performs the operation o1150 in the illustrative depiction as follows, and/or the operation o1150 is otherwise carried out in the illustrative depiction as follows: electronically transmitting (e.g. hard drive, etc.) one or more residential food management information requests (e.g. residential occupation rates, etc.) associated with at least in part (e.g. tangle, etc.) the one or more food related residential conditions (e.g. identified issues regarding food quality from one or more groceries, etc.) affecting (e.g. tangle, etc.) residential service of (e.g. school lunch food item storing, etc.) one or more residential food items (e.g. salad side dish, etc.) including at least in part one or more health aspects reportable factors involved with one or more residential food management activity aspects (e.g. sanitation procedures mandated by health professionals, etc.).

In one or more implementations, as shown in FIG. 59, operation o11 includes an operation o1151 for electronically transmitting one or more residential food management information requests associated with at least in part the one or more food related residential conditions affecting residential service of one or more residential food items including at least in part one or more harvest locations of one or more food ingredients factors involved with one or more residential food management activity aspects. Origination of an illustratively derived transmitting harvest locations component group can be accomplished through skilled in the art design choice selection of one or more of the above depicted components from one or more of the above depicted subsystems shown in FIG. 12. Components from the transmitting harvest locations component group can be used in implementing execution of the one or more transmitting harvest locations instructions i1151 of FIG. 30, can be used in performance of the transmitting harvest locations electrical circuitry arrangement e1151 of FIG. 23, and/or can be used in otherwise fulfillment of the operation o1151. An exemplary non-transitory signal bearing medium version of the information storage subsystem s200 is depicted in FIG. 30 as bearing the one or more transmitting harvest locations instructions i1151 that when executed will direct performance of the operation o1151. Furthermore, the transmitting harvest locations electrical circuitry arrangement (“elec circ arrange”) e1151, when activated, will perform the operation o1151. Also, the transmitting harvest locations module m1151, when executed and/or activated, will direct performance of and/or perform the operation o1151. For instance, in one or more exemplary implementations, the one or more transmitting harvest locations instructions i1151, when executed, direct performance of the operation o1151 in the illustrative depiction as follows, and/or the transmitting harvest locations electrical circuitry arrangement e1151, when activated, performs the operation o1151 in the illustrative depiction as follows, and/or the transmitting harvest locations module m1151, when executed and/or activated, directs performance of and/or performs the operation o1151 in the illustrative depiction as follows, and/or the operation o1151 is otherwise carried out in the illustrative depiction as follows: electronically transmitting (e.g. wifi, etc.) one or more residential food management information requests (e.g. turnover in machine dispensing if prepared meals, etc.) associated with at least in part (e.g. exclude, etc.) the one or more food related residential conditions (e.g. identified issues regarding one or more residential occupants, etc.) affecting (e.g. exclude, etc.) residential service of (e.g. elderly home food item storing, etc.) one or more residential food items (e.g. grain side dish, etc.) including at least in part one or more harvest locations of one or more food ingredients factors involved with one or more residential food management activity aspects (e.g. country, state and county of origin for apples used in residential dessert meals, etc.).

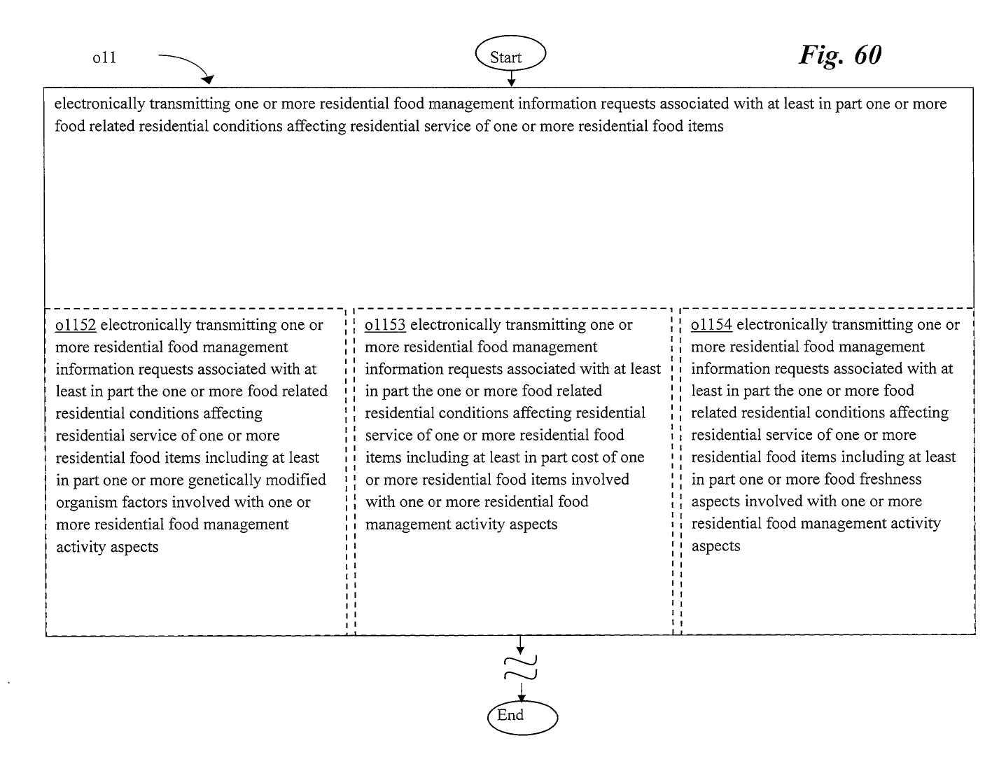

In one or more implementations, as shown in FIG. 60, operation o11 includes an operation o1152 for electronically transmitting one or more residential food management information requests associated with at least in part the one or more food related residential conditions affecting residential service of one or more residential food items including at least in part one or more genetically modified organism factors involved with one or more residential food management activity aspects. Origination of an illustratively derived transmitting genetically modified component group can be accomplished through skilled in the art design choice selection of one or more of the above depicted components from one or more of the above depicted subsystems shown in FIG. 12. Components from the transmitting genetically modified component group can be used in implementing execution of the one or more transmitting genetically modified instructions i1152 of FIG. 30, can be used in performance of the transmitting genetically modified electrical circuitry arrangement e1152 of FIG. 23, and/or can be used in otherwise fulfillment of the operation o1152. An exemplary non-transitory signal bearing medium version of the information storage subsystem s200 is depicted in FIG. 30 as bearing the one or more transmitting genetically modified instructions i1152 that when executed will direct performance of the operation o1152. Furthermore, the transmitting genetically modified electrical circuitry arrangement (“elec circ arrange”) e1152, when activated, will perform the operation o1152. Also, the transmitting genetically modified module m1152, when executed and/or activated, will direct performance of and/or perform the operation o1152. For instance, in one or more exemplary implementations, the one or more transmitting genetically modified instructions i1152, when executed, direct performance of the operation o1152 in the illustrative depiction as follows, and/or the transmitting genetically modified electrical circuitry arrangement e1152, when activated, performs the operation o1152 in the illustrative depiction as follows, and/or the transmitting genetically modified module m1152, when executed and/or activated, directs performance of and/or performs the operation o1152 in the illustrative depiction as follows, and/or the operation o1152 is otherwise carried out in the illustrative depiction as follows: electronically transmitting (e.g. laptop entry, etc.) one or more residential food management information requests (e.g. UV index of current climate, etc.) associated with at least in part (e.g. bound, etc.) the one or more food related residential conditions (e.g. identified issues regarding one or more residential food preparation equipment, etc.) affecting (e.g. bound, etc.) residential service of (e.g. street vendor food item storing, etc.) one or more residential food items (e.g. bean side dish, etc.) including at least in part one or more genetically modified organism factors involved with one or more residential food management activity aspects (e.g. existence of certification on non-GMO produce used in residential salad meals, etc.).

In one or more implementations, as shown in FIG. 60, operation o11 includes an operation o1153 for electronically transmitting one or more residential food management information requests associated with at least in part the one or more food related residential conditions affecting residential service of one or more residential food items including at least in part cost of one or more residential food items involved with one or more residential food management activity aspects. Origination of an illustratively derived transmitting cost of items component group can be accomplished through skilled in the art design choice selection of one or more of the above depicted components from one or more of the above depicted subsystems shown in FIG. 12. Components from the transmitting cost of items component group can be used in implementing execution of the one or more transmitting cost of items instructions i1153 of FIG. 30, can be used in performance of the transmitting cost of items electrical circuitry arrangement e1153 of FIG. 23, and/or can be used in otherwise fulfillment of the operation o1153. An exemplary non-transitory signal bearing medium version of the information storage subsystem s200 is depicted in FIG. 30 as bearing the one or more transmitting cost of items instructions i1153 that when executed will direct performance of the operation o1153. Furthermore, the transmitting cost of items electrical circuitry arrangement (“elec circ arrange”) e1153, when activated, will perform the operation o1153. Also, the transmitting cost of items module m1153, when executed and/or activated, will direct performance of and/or perform the operation o1153. For instance, in one or more exemplary implementations, the one or more transmitting cost of items instructions i1153, when executed, direct performance of the operation o1153 in the illustrative depiction as follows, and/or the transmitting cost of items electrical circuitry arrangement e1153, when activated, performs the operation o1153 in the illustrative depiction as follows, and/or the transmitting cost of items module m1153, when executed and/or activated, directs performance of and/or performs the operation o1153 in the illustrative depiction as follows, and/or the operation o1153 is otherwise carried out in the illustrative depiction as follows: electronically transmitting (e.g. RFID scan, etc.) one or more residential food management information requests (e.g. carbon dioxide levels in facility rooms, etc.) associated with at least in part (e.g. requiring, etc.) the one or more food related residential conditions (e.g. identified issues regarding one or more types of food materials used to prepare one or more food items to be served, etc.) affecting (e.g. requiring, etc.) residential service of (e.g. mobile kitchen food item storing, etc.) one or more residential food items (e.g. cooked side dish, etc.) including at least in part cost of one or more residential food items involved with one or more residential food management activity aspects (e.g. seasonal fluctuations of residential food material item pricing, etc.).

In one or more implementations, as shown in FIG. 60, operation o11 includes an operation o1154 for electronically transmitting one or more residential food management information requests associated with at least in part the one or more food related residential conditions affecting residential service of one or more residential food items including at least in part one or more food freshness aspects involved with one or more residential food management activity aspects. Origination of an illustratively derived transmitting food freshness component group can be accomplished through skilled in the art design choice selection of one or more of the above depicted components from one or more of the above depicted subsystems shown in FIG. 12. Components from the transmitting food freshness component group can be used in implementing execution of the one or more transmitting food freshness instructions i1154 of FIG. 30, can be used in performance of the transmitting food freshness electrical circuitry arrangement e1154 of FIG. 23, and/or can be used in otherwise fulfillment of the operation o1154. An exemplary non-transitory signal bearing medium version of the information storage subsystem s200 is depicted in FIG. 30 as bearing the one or more transmitting food freshness instructions i1154 that when executed will direct performance of the operation o1154. Furthermore, the transmitting food freshness electrical circuitry arrangement (“elec circ arrange”) e1154, when activated, will perform the operation o1154. Also, the transmitting food freshness module m1154, when executed and/or activated, will direct performance of and/or perform the operation o1154. For instance, in one or more exemplary implementations, the one or more transmitting food freshness instructions i1154, when executed, direct performance of the operation o1154 in the illustrative depiction as follows, and/or the transmitting food freshness electrical circuitry arrangement e1154, when activated, performs the operation o1154 in the illustrative depiction as follows, and/or the transmitting food freshness module m1154, when executed and/or activated, directs performance of and/or performs the operation o1154 in the illustrative depiction as follows, and/or the operation o1154 is otherwise carried out in the illustrative depiction as follows: electronically transmitting (e.g. ethernet, etc.) one or more residential food management information requests (e.g. water usage, etc.) associated with at least in part (e.g. enveloped, etc.) the one or more food related residential conditions (e.g. identified issues regarding one or more types of dishes prepared by the residential location, etc.) affecting (e.g. enveloped, etc.) residential service of (e.g. visiting nursing food item storing, etc.) one or more residential food items (e.g. raw side dish, etc.) including at least in part one or more food freshness aspects involved with one or more residential food management activity aspects (e.g. transit time between farm, grocer and residential location, etc.).

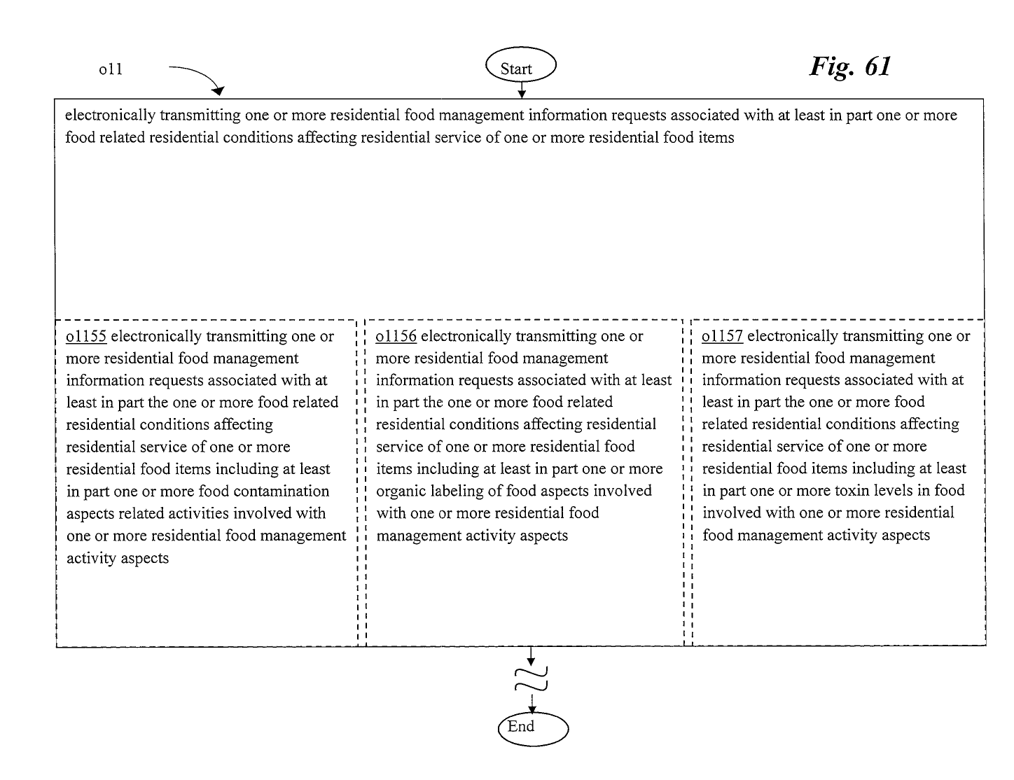

In one or more implementations, as shown in FIG. 61, operation o11 includes an operation o1155 for electronically transmitting one or more residential food management information requests associated with at least in part the one or more food related residential conditions affecting residential service of one or more residential food items including at least in part one or more food contamination aspects related activities involved with one or more residential food management activity aspects. Origination of an illustratively derived transmitting food contamination component group can be accomplished through skilled in the art design choice selection of one or more of the above depicted components from one or more of the above depicted subsystems shown in FIG. 12. Components from the transmitting food contamination component group can be used in implementing execution of the one or more transmitting food contamination instructions i1155 of FIG. 30, can be used in performance of the transmitting food contamination electrical circuitry arrangement e1155 of FIG. 23, and/or can be used in otherwise fulfillment of the operation o1155. An exemplary non-transitory signal bearing medium version of the information storage subsystem s200 is depicted in FIG. 30 as bearing the one or more transmitting food contamination instructions i1155 that when executed will direct performance of the operation o1155. Furthermore, the transmitting food contamination electrical circuitry arrangement (“elec circ arrange”) e1155, when activated, will perform the operation o1155. Also, the transmitting food contamination module m1155, when executed and/or activated, will direct performance of and/or perform the operation o1155. For instance, in one or more exemplary implementations, the one or more transmitting food contamination instructions i1155, when executed, direct performance of the operation o1155 in the illustrative depiction as follows, and/or the transmitting food contamination electrical circuitry arrangement e1155, when activated, performs the operation o1155 in the illustrative depiction as follows, and/or the transmitting food contamination module m1155, when executed and/or activated, directs performance of and/or performs the operation o1155 in the illustrative depiction as follows, and/or the operation o1155 is otherwise carried out in the illustrative depiction as follows: electronically transmitting (e.g. UPC scan, etc.) one or more residential food management information requests (e.g. natural gas usage, etc.) associated with at least in part (e.g. envelope, etc.) the one or more food related residential conditions (e.g. identified issues regarding one or more types of food items served by the residential food location, etc.) affecting (e.g. envelope, etc.) residential service of (e.g. deli aspects food item storing, etc.) one or more residential food items (e.g. buffet side dish, etc.) including at least in part one or more food contamination aspects related activities involved with one or more residential food management activity aspects (e.g. recall notices for ingestible materials used in residential food items, etc.).

In one or more implementations, as shown in FIG. 61, operation o11 includes an operation o1156 for electronically transmitting one or more residential food management information requests associated with at least in part the one or more food related residential conditions affecting residential service of one or more residential food items including at least in part one or more organic labeling of food aspects involved with one or more residential food management activity aspects. Origination of an illustratively derived transmitting organic labeling component group can be accomplished through skilled in the art design choice selection of one or more of the above depicted components from one or more of the above depicted subsystems shown in FIG. 12. Components from the transmitting organic labeling component group can be used in implementing execution of the one or more transmitting organic labeling instructions i1156 of FIG. 30, can be used in performance of the transmitting organic labeling electrical circuitry arrangement e1156 of FIG. 23, and/or can be used in otherwise fulfillment of the operation o1156. An exemplary non-transitory signal bearing medium version of the information storage subsystem s200 is depicted in FIG. 30 as bearing the one or more transmitting organic labeling instructions i1156 that when executed will direct performance of the operation o1156. Furthermore, the transmitting organic labeling electrical circuitry arrangement (“elec circ arrange”) e1156, when activated, will perform the operation o1156. Also, the transmitting organic labeling module m1156, when executed and/or activated, will direct performance of and/or perform the operation o1156. For instance, in one or more exemplary implementations, the one or more transmitting organic labeling instructions i1156, when executed, direct performance of the operation o1156 in the illustrative depiction as follows, and/or the transmitting organic labeling electrical circuitry arrangement e1156, when activated, performs the operation o1156 in the illustrative depiction as follows, and/or the transmitting organic labeling module m1156, when executed and/or activated, directs performance of and/or performs the operation o1156 in the illustrative depiction as follows, and/or the operation o1156 is otherwise carried out in the illustrative depiction as follows: electronically transmitting (e.g. HTML code, etc.) one or more residential food management information requests (e.g. methane gas usage, etc.) associated with at least in part (e.g. associate with, etc.) the one or more food related residential conditions (e.g. identified issues regarding one or more procedures used to prepare one or more food items by the residential food location, etc.) affecting (e.g. associate with, etc.) residential service of (e.g. fine dining food item packaging, etc.) one or more residential food items (e.g. soup side dish, etc.) including at least in part one or more organic labeling of food aspects involved with one or more residential food management activity aspects (e.g. verification of organic labeling of materials used for the residential food items, etc.).

In one or more implementations, as shown in FIG. 61, operation o11 includes an operation o1157 for electronically transmitting one or more residential food management information requests associated with at least in part the one or more food related residential conditions affecting residential service of one or more residential food items including at least in part one or more toxin levels in food involved with one or more residential food management activity aspects. Origination of an illustratively derived transmitting toxin levels component group can be accomplished through skilled in the art design choice selection of one or more of the above depicted components from one or more of the above depicted subsystems shown in FIG. 12. Components from the transmitting toxin levels component group can be used in implementing execution of the one or more transmitting toxin levels instructions i1157 of FIG. 30, can be used in performance of the transmitting toxin levels electrical circuitry arrangement e1157 of FIG. 23, and/or can be used in otherwise fulfillment of the operation o1157. An exemplary non-transitory signal bearing medium version of the information storage subsystem s200 is depicted in FIG. 30 as bearing the one or more transmitting toxin levels instructions i1157 that when executed will direct performance of the operation o1157. Furthermore, the transmitting toxin levels electrical circuitry arrangement (“elec circ arrange”) e1157, when activated, will perform the operation o1157. Also, the transmitting toxin levels module m1157, when executed and/or activated, will direct performance of and/or perform the operation o1157. For instance, in one or more exemplary implementations, the one or more transmitting toxin levels instructions i1157, when executed, direct performance of the operation o1157 in the illustrative depiction as follows, and/or the transmitting toxin levels electrical circuitry arrangement e1157, when activated, performs the operation o1157 in the illustrative depiction as follows, and/or the transmitting toxin levels module m1157, when executed and/or activated, directs performance of and/or performs the operation o1157 in the illustrative depiction as follows, and/or the operation o1157 is otherwise carried out in the illustrative depiction as follows: electronically transmitting (e.g. MMS, etc.) one or more residential food management information requests (e.g. MPEG file format, etc.) associated with at least in part (e.g. embroil, etc.) the one or more food related residential conditions (e.g. age profile of equipment used, etc.) affecting (e.g. embroil, etc.) residential service of (e.g. fast food item packaging, etc.) one or more residential food items (e.g. stew side dish, etc.) including at least in part one or more toxin levels in food involved with one or more residential food management activity aspects (e.g. toxin level histories for produce from various grocers, etc.).

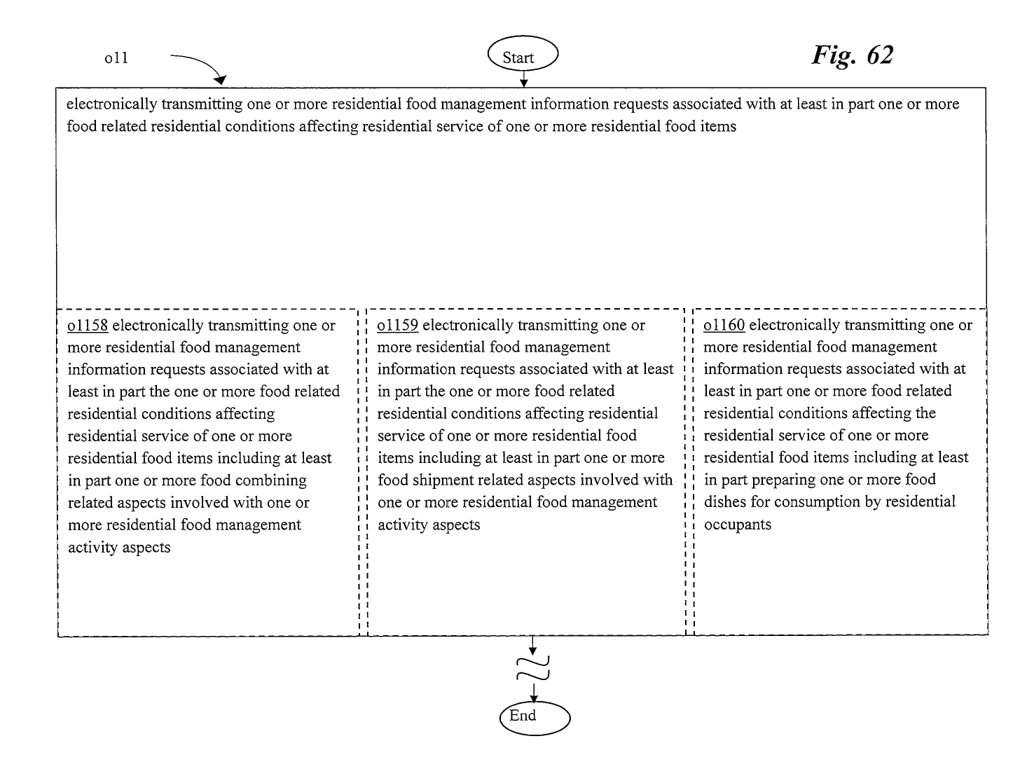

In one or more implementations, as shown in FIG. 62, operation o11 includes an operation o1158 for electronically transmitting one or more residential food management information requests associated with at least in part the one or more food related residential conditions affecting residential service of one or more residential food items including at least in part one or more food combining related aspects involved with one or more residential food management activity aspects. Origination of an illustratively derived transmitting food combining component group can be accomplished through skilled in the art design choice selection of one or more of the above depicted components from one or more of the above depicted subsystems shown in FIG. 12. Components from the transmitting food combining component group can be used in implementing execution of the one or more transmitting food combining instructions i1158 of FIG. 30, can be used in performance of the transmitting food combining electrical circuitry arrangement e1158 of FIG. 23, and/or can be used in otherwise fulfillment of the operation o1158. An exemplary non-transitory signal bearing medium version of the information storage subsystem s200 is depicted in FIG. 30 as bearing the one or more transmitting food combining instructions i1158 that when executed will direct performance of the operation o1158. Furthermore, the transmitting food combining electrical circuitry arrangement (“elec circ arrange”) e1158, when activated, will perform the operation o1158. Also, the transmitting food combining module m1158, when executed and/or activated, will direct performance of and/or perform the operation o1158. For instance, in one or more exemplary implementations, the one or more transmitting food combining instructions i1158, when executed, direct performance of the operation o1158 in the illustrative depiction as follows, and/or the transmitting food combining electrical circuitry arrangement e1158, when activated, performs the operation o1158 in the illustrative depiction as follows, and/or the transmitting food combining module m1158, when executed and/or activated, directs performance of and/or performs the operation o1158 in the illustrative depiction as follows, and/or the operation o1158 is otherwise carried out in the illustrative depiction as follows: electronically transmitting (e.g. 256-bit AES, etc.) one or more residential food management information requests (e.g. WAV file format, etc.) associated with at least in part (e.g. take in, etc.) the one or more food related residential conditions (e.g. lease duration of equipment, etc.) affecting (e.g. take in, etc.) residential service of (e.g. family buffet food item packaging, etc.) one or more residential food items (e.g. hot side dish, etc.) including at least in part one or more food combining related aspects involved with one or more residential food management activity aspects (e.g. instances of fast digesting sugars with slow digesting proteins and fats in various residential food items, etc.).

In one or more implementations, as shown in FIG. 62, operation o11 includes an operation o1159 for electronically transmitting one or more residential food management information requests associated with at least in part the one or more food related residential conditions affecting residential service of one or more residential food items including at least in part one or more food shipment related aspects involved with one or more residential food management activity aspects. Origination of an illustratively derived transmitting food shipment component group can be accomplished through skilled in the art design choice selection of one or more of the above depicted components from one or more of the above depicted subsystems shown in FIG. 12. Components from the transmitting food shipment component group can be used in implementing execution of the one or more transmitting food shipment instructions i1159 of FIG. 30, can be used in performance of the transmitting food shipment electrical circuitry arrangement e1159 of FIG. 23, and/or can be used in otherwise fulfillment of the operation o1159. An exemplary non-transitory signal bearing medium version of the information storage subsystem s200 is depicted in FIG. 30 as bearing the one or more transmitting food shipment instructions i1159 that when executed will direct performance of the operation o1159. Furthermore, the transmitting food shipment electrical circuitry arrangement (“elec circ arrange”) e1159, when activated, will perform the operation o1159. Also, the transmitting food shipment module m1159, when executed and/or activated, will direct performance of and/or perform the operation o1159. For instance, in one or more exemplary implementations, the one or more transmitting food shipment instructions i1159, when executed, direct performance of the operation o1159 in the illustrative depiction as follows, and/or the transmitting food shipment electrical circuitry arrangement e1159, when activated, performs the operation o1159 in the illustrative depiction as follows, and/or the transmitting food shipment module m1159, when executed and/or activated, directs performance of and/or performs the operation o1159 in the illustrative depiction as follows, and/or the operation o1159 is otherwise carried out in the illustrative depiction as follows: electronically transmitting (e.g. compact flash, etc.) one or more residential food management information requests (e.g. visual observation, etc.) associated with at least in part (e.g. comprised of, etc.) the one or more food related residential conditions (e.g. efficiency of equipment used, etc.) affecting (e.g. comprised of, etc.) residential service of (e.g. mobile catering food item packaging, etc.) one or more residential food items (e.g. cold side dish, etc.) including at least in part one or more food shipment related aspects involved with one or more residential food management activity aspects (e.g. temperature profiles of residential meals preparation areas, etc.).

In one or more implementations, as shown in FIG. 62, operation o11 includes an operation o1160 for electronically transmitting one or more residential food management information requests associated with at least in part one or more food related residential conditions affecting the residential service of one or more residential food items including at least in part preparing one or more food dishes for consumption by residential occupants. Origination of an illustratively derived transmitting food dishes component group can be accomplished through skilled in the art design choice selection of one or more of the above depicted components from one or more of the above depicted subsystems shown in FIG. 12. Components from the transmitting food dishes component group can be used in implementing execution of the one or more transmitting food dishes instructions i1160 of FIG. 31, can be used in performance of the transmitting food dishes electrical circuitry arrangement e1160 of FIG. 24, and/or can be used in otherwise fulfillment of the operation o1160. An exemplary non-transitory signal bearing medium version of the information storage subsystem s200 is depicted in FIG. 31 as bearing the one or more transmitting food dishes instructions i1160 that when executed will direct performance of the operation o1160. Furthermore, the transmitting food dishes electrical circuitry arrangement (“elec circ arrange”) e1160, when activated, will perform the operation o1160. Also, the transmitting food dishes module m1160, when executed and/or activated, will direct performance of and/or perform the operation o1160. For instance, in one or more exemplary implementations, the one or more transmitting food dishes instructions i1160, when executed, direct performance of the operation o1160 in the illustrative depiction as follows, and/or the transmitting food dishes electrical circuitry arrangement e1160, when activated, performs the operation o1160 in the illustrative depiction as follows, and/or the transmitting food dishes module m1160, when executed and/or activated, directs performance of and/or performs the operation o1160 in the illustrative depiction as follows, and/or the operation o1160 is otherwise carried out in the illustrative depiction as follows: electronically transmitting (e.g. push-based, etc.) one or more residential food management information requests (e.g. adherence to safety protocols, etc.) associated with at least in part (e.g. comprehend, etc.) one or more food related residential conditions (e.g. location of residential food management facility, etc.) affecting (e.g. comprehend, etc.) the residential service of (e.g. institutional home food item packaging, etc.) one or more residential food items (e.g. weight loss side dish, etc.) including at least in part preparing one or more food dishes for consumption by residential occupants (e.g. residential visual display presentation of Asian food dishes, etc.).

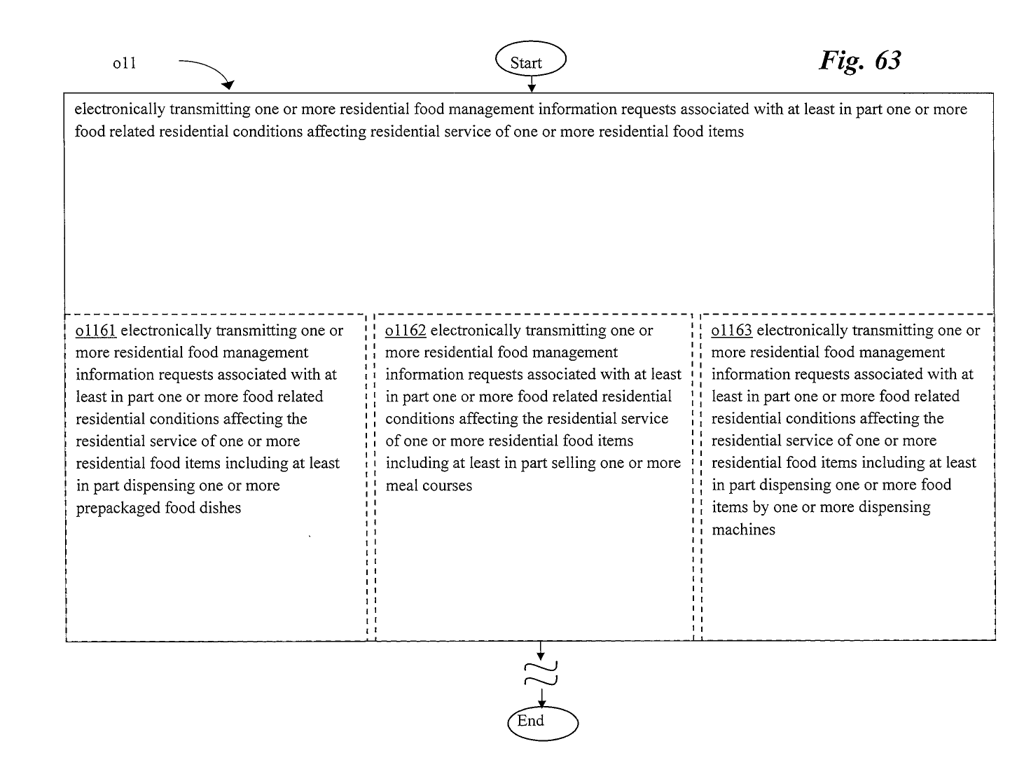

In one or more implementations, as shown in FIG. 63, operation o11 includes an operation o1161 for electronically transmitting one or more residential food management information requests associated with at least in part one or more food related residential conditions affecting the residential service of one or more residential food items including at least in part dispensing one or more prepackaged food dishes. Origination of an illustratively derived transmitting dispensing prepackaged component group can be accomplished through skilled in the art design choice selection of one or more of the above depicted components from one or more of the above depicted subsystems shown in FIG. 12. Components from the transmitting dispensing prepackaged component group can be used in implementing execution of the one or more transmitting dispensing prepackaged instructions i1161 of FIG. 31, can be used in performance of the transmitting dispensing prepackaged electrical circuitry arrangement e1161 of FIG. 24, and/or can be used in otherwise fulfillment of the operation o1161. An exemplary non-transitory signal bearing medium version of the information storage subsystem s200 is depicted in FIG. 31 as bearing the one or more transmitting dispensing prepackaged instructions i1161 that when executed will direct performance of the operation o1161. Furthermore, the transmitting dispensing prepackaged electrical circuitry arrangement (“elec circ arrange”) e1161, when activated, will perform the operation o1161. Also, the transmitting dispensing prepackaged module m1161, when executed and/or activated, will direct performance of and/or perform the operation o1161. For instance, in one or more exemplary implementations, the one or more transmitting dispensing prepackaged instructions i1161, when executed, direct performance of the operation o1161 in the illustrative depiction as follows, and/or the transmitting dispensing prepackaged electrical circuitry arrangement e1161, when activated, performs the operation o1161 in the illustrative depiction as follows, and/or the transmitting dispensing prepackaged module m1161, when executed and/or activated, directs performance of and/or performs the operation o1161 in the illustrative depiction as follows, and/or the operation o1161 is otherwise carried out in the illustrative depiction as follows: electronically transmitting (e.g. SMTP server, etc.) one or more residential food management information requests (e.g. document forgery, etc.) associated with at least in part (e.g. calculate, etc.) one or more food related residential conditions (e.g. type of residential food location, etc.) affecting (e.g. calculate, etc.) the residential service of (e.g. school lunch food item packaging, etc.) one or more residential food items (e.g. sports nutrition side dish, etc.) including at least in part dispensing one or more prepackaged food dishes (e.g. wholesale residential foods items regarding residential food item packaging, etc.).

In one or more implementations, as shown in FIG. 63, operation o11 includes an operation o1162 for electronically transmitting one or more residential food management information requests associated with at least in part one or more food related residential conditions affecting the residential service of one or more residential food items including at least in part selling one or more meal courses. Origination of an illustratively derived transmitting selling courses component group can be accomplished through skilled in the art design choice selection of one or more of the above depicted components from one or more of the above depicted subsystems shown in FIG. 12. Components from the transmitting selling courses component group can be used in implementing execution of the one or more transmitting selling courses instructions i1162 of FIG. 31, can be used in performance of the transmitting selling courses electrical circuitry arrangement e1162 of FIG. 24, and/or can be used in otherwise fulfillment of the operation o1162. An exemplary non-transitory signal bearing medium version of the information storage subsystem s200 is depicted in FIG. 31 as bearing the one or more transmitting selling courses instructions i1162 that when executed will direct performance of the operation o1162. Furthermore, the transmitting selling courses electrical circuitry arrangement (“elec circ arrange”) e1162, when activated, will perform the operation o1162. Also, the transmitting selling courses module m1162, when executed and/or activated, will direct performance of and/or perform the operation o1162. For instance, in one or more exemplary implementations, the one or more transmitting selling courses instructions i1162, when executed, direct performance of the operation o1162 in the illustrative depiction as follows, and/or the transmitting selling courses electrical circuitry arrangement e1162, when activated, performs the operation o1162 in the illustrative depiction as follows, and/or the transmitting selling courses module m1162, when executed and/or activated, directs performance of and/or performs the operation o1162 in the illustrative depiction as follows, and/or the operation o1162 is otherwise carried out in the illustrative depiction as follows: electronically transmitting (e.g. radio wave, etc.) one or more residential food management information requests (e.g. scheduled feedings of residential residences, etc.) associated with at least in part (e.g. affected, etc.) one or more food related residential conditions (e.g. whether residential location is part of a complex, etc.) affecting (e.g. affected, etc.) the residential service of (e.g. elderly home food item packaging, etc.) one or more residential food items (e.g. baked side dish, etc.) including at least in part selling one or more meal courses (e.g. wholesale residential outlet for food items for meals prepared by residential occupants, etc.).

In one or more implementations, as shown in FIG. 63, operation o11 includes an operation o1163 for electronically transmitting one or more residential food management information requests associated with at least in part one or more food related residential conditions affecting the residential service of one or more residential food items including at least in part dispensing one or more food items by one or more dispensing machines. Origination of an illustratively derived transmitting dispensing machines component group can be accomplished through skilled in the art design choice selection of one or more of the above depicted components from one or more of the above depicted subsystems shown in FIG. 12. Components from the transmitting dispensing machines component group can be used in implementing execution of the one or more transmitting dispensing machines instructions i1163 of FIG. 31, can be used in performance of the transmitting dispensing machines electrical circuitry arrangement e1163 of FIG. 24, and/or can be used in otherwise fulfillment of the operation o1163. An exemplary non-transitory signal bearing medium version of the information storage subsystem s200 is depicted in FIG. 31 as bearing the one or more transmitting dispensing machines instructions i1163 that when executed will direct performance of the operation o1163. Furthermore, the transmitting dispensing machines electrical circuitry arrangement (“elec circ arrange”) e1163, when activated, will perform the operation o1163. Also, the transmitting dispensing machines module m1163, when executed and/or activated, will direct performance of and/or perform the operation o1163. For instance, in one or more exemplary implementations, the one or more transmitting dispensing machines instructions i1163, when executed, direct performance of the operation o1163 in the illustrative depiction as follows, and/or the transmitting dispensing machines electrical circuitry arrangement e1163, when activated, performs the operation o1163 in the illustrative depiction as follows, and/or the transmitting dispensing machines module m1163, when executed and/or activated, directs performance of and/or performs the operation o1163 in the illustrative depiction as follows, and/or the operation o1163 is otherwise carried out in the illustrative depiction as follows: electronically transmitting (e.g. infra-red, etc.) one or more residential food management information requests (e.g. storage room temperature. profiles, etc.) associated with at least in part (e.g. affecting, etc.) one or more food related residential conditions (e.g. relative amounts of saturated to unsaturated fat used in preparation of residential food items, etc.) affecting (e.g. affecting, etc.) the residential service of (e.g. street vendor food item packaging, etc.) one or more residential food items (e.g. fried side dish, etc.) including at least in part dispensing one or more food items by one or more dispensing machines (e.g. residential dispensing hot dinners from residential dispensing machine, etc.).

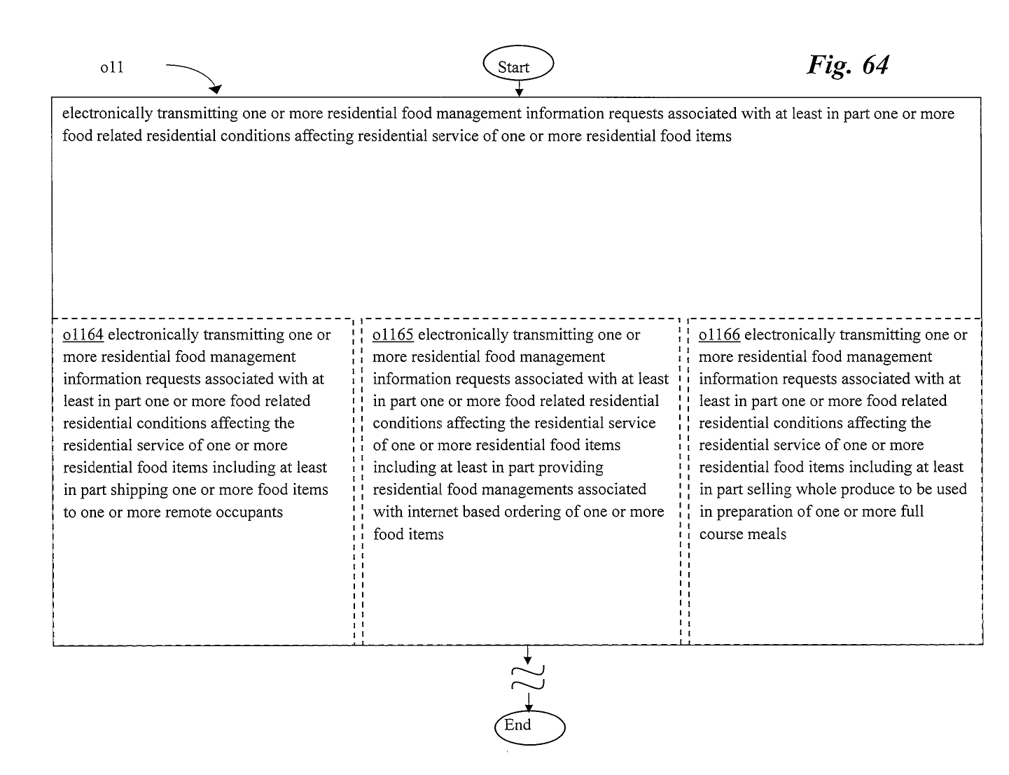

In one or more implementations, as shown in FIG. 64, operation o11 includes an operation o1164 for electronically transmitting one or more residential food management information requests associated with at least in part one or more food related residential conditions affecting the residential service of one or more residential food items including at least in part shipping one or more food items to one or more remote occupants. Origination of an illustratively derived transmitting remote occupants component group can be accomplished through skilled in the art design choice selection of one or more of the above depicted components from one or more of the above depicted subsystems shown in FIG. 12. Components from the transmitting remote occupants component group can be used in implementing execution of the one or more transmitting remote occupants instructions i1164 of FIG. 31, can be used in performance of the transmitting remote occupants electrical circuitry arrangement e1164 of FIG. 24, and/or can be used in otherwise fulfillment of the operation o1164. An exemplary non-transitory signal bearing medium version of the information storage subsystem s200 is depicted in FIG. 31 as bearing the one or more transmitting remote occupants instructions i1164 that when executed will direct performance of the operation o1164. Furthermore, the transmitting remote occupants electrical circuitry arrangement (“elec circ arrange”) e1164, when activated, will perform the operation o1164. Also, the transmitting remote occupants module m1164, when executed and/or activated, will direct performance of and/or perform the operation o1164. For instance, in one or more exemplary implementations, the one or more transmitting remote occupants instructions i1164, when executed, direct performance of the operation o1164 in the illustrative depiction as follows, and/or the transmitting remote occupants electrical circuitry arrangement e1164, when activated, performs the operation o1164 in the illustrative depiction as follows, and/or the transmitting remote occupants module m1164, when executed and/or activated, directs performance of and/or performs the operation o1164 in the illustrative depiction as follows, and/or the operation o1164 is otherwise carried out in the illustrative depiction as follows: electronically transmitting (e.g. bluetooth, etc.) one or more residential food management information requests (e.g. cold storage data for stored food materials, etc.) associated with at least in part (e.g. argue, etc.) one or more food related residential conditions (e.g. labor laws, etc.) affecting (e.g. argue, etc.) the residential service of (e.g. mobile kitchen food item packaging, etc.) one or more residential food items (e.g. grilled side dish, etc.) including at least in part shipping one or more food items to one or more remote occupants (e.g. shipping residential food items through private carrier such as, etc.).

In one or more implementations, as shown in FIG. 64, operation o11 includes an operation o1165 for electronically transmitting one or more residential food management information requests associated with at least in part one or more food related residential conditions affecting the residential service of one or more residential food items including at least in part providing residential food managements associated with internet based ordering of one or more food items. Origination of an illustratively derived transmitting internet ordering component group can be accomplished through skilled in the art design choice selection of one or more of the above depicted components from one or more of the above depicted subsystems shown in FIG. 12. Components from the transmitting internet ordering component group can be used in implementing execution of the one or more transmitting internet ordering instructions i1165 of FIG. 31, can be used in performance of the transmitting internet ordering electrical circuitry arrangement e1165 of FIG. 24, and/or can be used in otherwise fulfillment of the operation o1165. An exemplary non-transitory signal bearing medium version of the information storage subsystem s200 is depicted in FIG. 31 as bearing the one or more transmitting internet ordering instructions i1165 that when executed will direct performance of the operation o1165. Furthermore, the transmitting internet ordering electrical circuitry arrangement (“elec circ arrange”) e1165, when activated, will perform the operation o1165. Also, the transmitting internet ordering module m1165, when executed and/or activated, will direct performance of and/or perform the operation o1165. For instance, in one or more exemplary implementations, the one or more transmitting internet ordering instructions i1165, when executed, direct performance of the operation o1165 in the illustrative depiction as follows, and/or the transmitting internet ordering electrical circuitry arrangement e1165, when activated, performs the operation o1165 in the illustrative depiction as follows, and/or the transmitting internet ordering module m1165, when executed and/or activated, directs performance of and/or performs the operation o1165 in the illustrative depiction as follows, and/or the operation o1165 is otherwise carried out in the illustrative depiction as follows: electronically transmitting (e.g. webpage, etc.) one or more residential food management information requests (e.g. stove maintenance operation, etc.) associated with at least in part (e.g. connected, etc.) one or more food related residential conditions (e.g. safety regulations, etc.) affecting (e.g. connected, etc.) the residential service of (e.g. visiting nursing food item packaging, etc.) one or more residential food items (e.g. steamed side dish, etc.) including at least in part providing residential food managements associated with internet based ordering of one or more food items (e.g. transporting prepared residential food items locally in response to internet ordering, etc.).

In one or more implementations, as shown in FIG. 64, operation o11 includes an operation o1166 for electronically transmitting one or more residential food management information requests associated with at least in part one or more food related residential conditions affecting the residential service of one or more residential food items including at least in part selling whole produce to be used in preparation of one or more full course meals. Origination of an illustratively derived transmitting whole produce component group can be accomplished through skilled in the art design choice selection of one or more of the above depicted components from one or more of the above depicted subsystems shown in FIG. 12. Components from the transmitting whole produce component group can be used in implementing execution of the one or more transmitting whole produce instructions i1166 of FIG. 31, can be used in performance of the transmitting whole produce electrical circuitry arrangement e1166 of FIG. 24, and/or can be used in otherwise fulfillment of the operation o1166. An exemplary non-transitory signal bearing medium version of the information storage subsystem s200 is depicted in FIG. 31 as bearing the one or more transmitting whole produce instructions i1166 that when executed will direct performance of the operation o1166. Furthermore, the transmitting whole produce electrical circuitry arrangement (“elec circ arrange”) e1166, when activated, will perform the operation o1166. Also, the transmitting whole produce module m1166, when executed and/or activated, will direct performance of and/or perform the operation o1166. For instance, in one or more exemplary implementations, the one or more transmitting whole produce instructions i1166, when executed, direct performance of the operation o1166 in the illustrative depiction as follows, and/or the transmitting whole produce electrical circuitry arrangement e1166, when activated, performs the operation o1166 in the illustrative depiction as follows, and/or the transmitting whole produce module m1166, when executed and/or activated, directs performance of and/or performs the operation o1166 in the illustrative depiction as follows, and/or the operation o1166 is otherwise carried out in the illustrative depiction as follows: electronically transmitting (e.g. website, etc.) one or more residential food management information requests (e.g. electricity usage, etc.) associated with at least in part (e.g. commit to, etc.) one or more food related residential conditions (e.g. relative amounts of sugars to slowly digesting starches used in cooking, etc.) affecting (e.g. commit to, etc.) the residential service of (e.g. deli aspects food item packaging, etc.) one or more residential food items (e.g. chilled side dish, etc.) including at least in part selling whole produce to be used in preparation of one or more full course meals (e.g. selling residential food items for preparing appetizers, salads, and Italian main course meals, etc.).

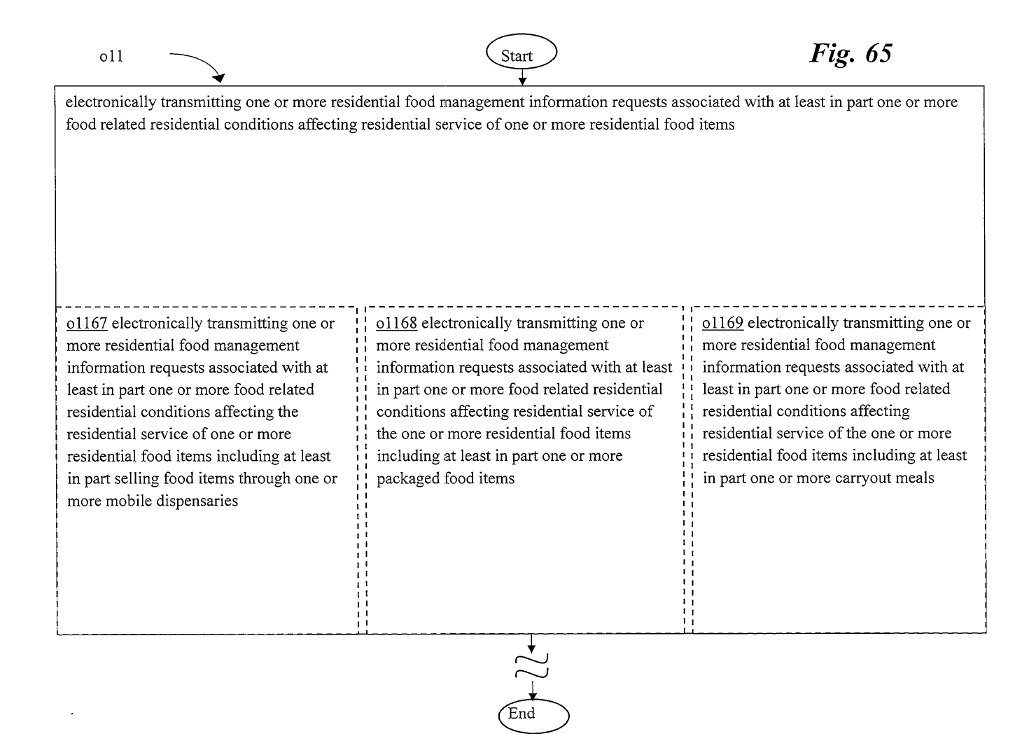

In one or more implementations, as shown in FIG. 65, operation o11 includes an operation o1167 for electronically transmitting one or more residential food management information requests associated with at least in part one or more food related residential conditions affecting the residential service of one or more residential food items including at least in part selling food items through one or more mobile dispensaries. Origination of an illustratively derived transmitting mobile dispensaries component group can be accomplished through skilled in the art design choice selection of one or more of the above depicted components from one or more of the above depicted subsystems shown in FIG. 12. Components from the transmitting mobile dispensaries component group can be used in implementing execution of the one or more transmitting mobile dispensaries instructions i1167 of FIG. 31, can be used in performance of the transmitting mobile dispensaries electrical circuitry arrangement e1167 of FIG. 24, and/or can be used in otherwise fulfillment of the operation o1167. An exemplary non-transitory signal bearing medium version of the information storage subsystem s200 is depicted in FIG. 31 as bearing the one or more transmitting mobile dispensaries instructions i1167 that when executed will direct performance of the operation o1167. Furthermore, the transmitting mobile dispensaries electrical circuitry arrangement (“elec circ arrange”) e1167, when activated, will perform the operation o1167. Also, the transmitting mobile dispensaries module m1167, when executed and/or activated, will direct performance of and/or perform the operation o1167. For instance, in one or more exemplary implementations, the one or more transmitting mobile dispensaries instructions i1167, when executed, direct performance of the operation o1167 in the illustrative depiction as follows, and/or the transmitting mobile dispensaries electrical circuitry arrangement e1167, when activated, performs the operation o1167 in the illustrative depiction as follows, and/or the transmitting mobile dispensaries module m1167, when executed and/or activated, directs performance of and/or performs the operation o1167 in the illustrative depiction as follows, and/or the operation o1167 is otherwise carried out in the illustrative depiction as follows: electronically transmitting (e.g. cellphone entry, etc.) one or more residential food management information requests (e.g. residential occupant water usage, etc.) associated with at least in part (e.g. absorbed by, etc.) one or more food related residential conditions (e.g. relative amounts of denatured to nondenatured protein used in cooking, etc.) affecting (e.g. absorbed by, etc.) the residential service of (e.g. fine dining food item transporting, etc.) one or more residential food items (e.g. microwaved side dish, etc.) including at least in part selling food items through one or more mobile dispensaries (e.g. selling residential food materials to be transported through truck based means to residential facilities, etc.).

In one or more implementations, as shown in FIG. 65, operation o11 includes an operation o1168 for electronically transmitting one or more residential food management information requests associated with at least in part one or more food related residential conditions affecting residential service of the one or more residential food items including at least in part one or more packaged food items. Origination of an illustratively derived transmitting packaged items component group can be accomplished through skilled in the art design choice selection of one or more of the above depicted components from one or more of the above depicted subsystems shown in FIG. 12. Components from the transmitting packaged items component group can be used in implementing execution of the one or more transmitting packaged items instructions i1168 of FIG. 31, can be used in performance of the transmitting packaged items electrical circuitry arrangement e1168 of FIG. 24, and/or can be used in otherwise fulfillment of the operation o1168. An exemplary non-transitory signal bearing medium version of the information storage subsystem s200 is depicted in FIG. 31 as bearing the one or more transmitting packaged items instructions i1168 that when executed will direct performance of the operation o1168. Furthermore, the transmitting packaged items electrical circuitry arrangement (“elec circ arrange”) e1168, when activated, will perform the operation o1168. Also, the transmitting packaged items module m1168, when executed and/or activated, will direct performance of and/or perform the operation o1168. For instance, in one or more exemplary implementations, the one or more transmitting packaged items instructions i1168, when executed, direct performance of the operation o1168 in the illustrative depiction as follows, and/or the transmitting packaged items electrical circuitry arrangement e1168, when activated, performs the operation o1168 in the illustrative depiction as follows, and/or the transmitting packaged items module m1168, when executed and/or activated, directs performance of and/or performs the operation o1168 in the illustrative depiction as follows, and/or the operation o1168 is otherwise carried out in the illustrative depiction as follows: electronically transmitting (e.g. satellite transmission, etc.) one or more residential food management information requests (e.g. distribution of meal costs, etc.) associated with at least in part (e.g. embraced, etc.) one or more food related residential conditions (e.g. relative amounts of animal protein to plant protein used in cooking, etc.) affecting (e.g. embraced, etc.) residential service of (e.g. fast food item transporting, etc.) the one or more residential food items (e.g. convection oven prepared side dish, etc.) including at least in part one or more packaged food items (e.g. fast food hamburger residential meals, etc.).

In one or more implementations, as shown in FIG. 65, operation o11 includes an operation o1169 for electronically transmitting one or more residential food management information requests associated with at least in part one or more food related residential conditions affecting residential service of the one or more residential food items including at least in part one or more carryout meals. Origination of an illustratively derived transmitting carryout meals component group can be accomplished through skilled in the art design choice selection of one or more of the above depicted components from one or more of the above depicted subsystems shown in FIG. 12. Components from the transmitting carryout meals component group can be used in implementing execution of the one or more transmitting carryout meals instructions i1169 of FIG. 31, can be used in performance of the transmitting carryout meals electrical circuitry arrangement e1169 of FIG. 24, and/or can be used in otherwise fulfillment of the operation o1169. An exemplary non-transitory signal bearing medium version of the information storage subsystem s200 is depicted in FIG. 31 as bearing the one or more transmitting carryout meals instructions i1169 that when executed will direct performance of the operation o1169. Furthermore, the transmitting carryout meals electrical circuitry arrangement (“elec circ arrange”) e1169, when activated, will perform the operation o1169. Also, the transmitting carryout meals module m1169, when executed and/or activated, will direct performance of and/or perform the operation o1169. For instance, in one or more exemplary implementations, the one or more transmitting carryout meals instructions i1169, when executed, direct performance of the operation o1169 in the illustrative depiction as follows, and/or the transmitting carryout meals electrical circuitry arrangement e1169, when activated, performs the operation o1169 in the illustrative depiction as follows, and/or the transmitting carryout meals module m1169, when executed and/or activated, directs performance of and/or performs the operation o1169 in the illustrative depiction as follows, and/or the operation o1169 is otherwise carried out in the illustrative depiction as follows: electronically transmitting (e.g. pull-based, etc.) one or more residential food management information requests (e.g. toxin levels in food sources, etc.) associated with at least in part (e.g. contain, etc.) one or more food related residential conditions (e.g. levels of one or more vitamins present in one or more food items prepared by the residential food management, etc.) affecting (e.g. contain, etc.) residential service of (e.g. family buffet food item transporting, etc.) the one or more residential food items (e.g. smoked side dish, etc.) including at least in part one or more carryout meals (e.g. chicken teriyaki dinner residential meals, etc.).

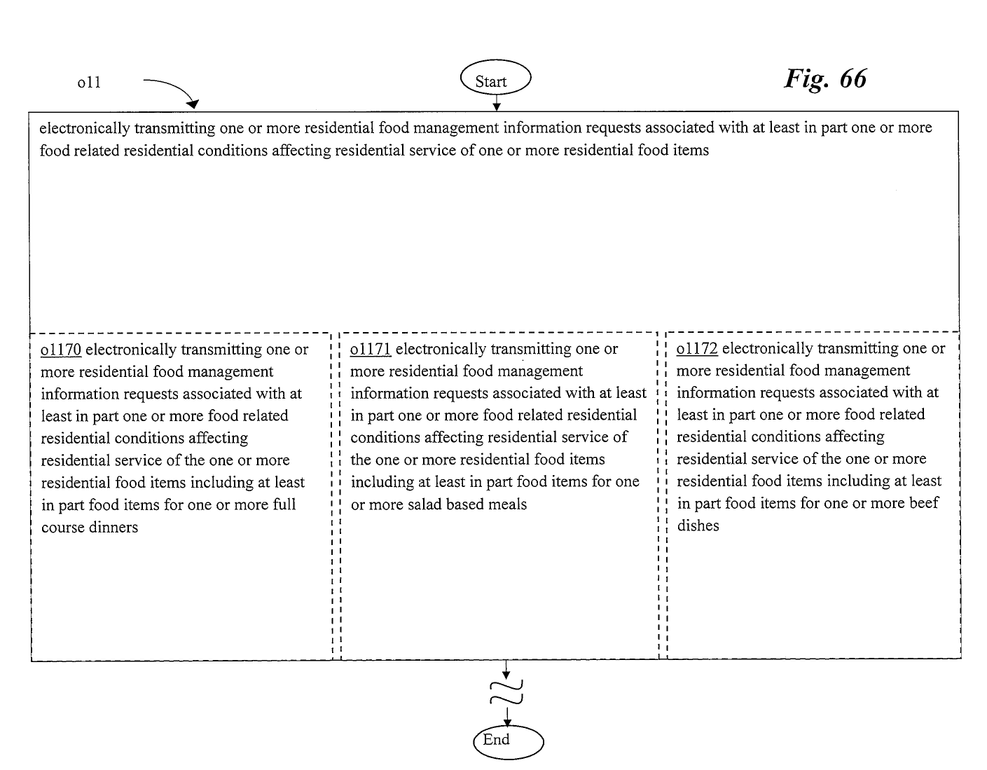

In one or more implementations, as shown in FIG. 66, operation o11 includes an operation o1170 for electronically transmitting one or more residential food management information requests associated with at least in part one or more food related residential conditions affecting residential service of the one or more residential food items including at least in part food items for one or more full course dinners. Origination of an illustratively derived transmitting full course component group can be accomplished through skilled in the art design choice selection of one or more of the above depicted components from one or more of the above depicted subsystems shown in FIG. 12. Components from the transmitting full course component group can be used in implementing execution of the one or more transmitting full course instructions i1170 of FIG. 31, can be used in performance of the transmitting full course electrical circuitry arrangement e1170 of FIG. 24, and/or can be used in otherwise fulfillment of the operation o1170. An exemplary non-transitory signal bearing medium version of the information storage subsystem s200 is depicted in FIG. 31 as bearing the one or more transmitting full course instructions i1170 that when executed will direct performance of the operation o1170. Furthermore, the transmitting full course electrical circuitry arrangement (“elec circ arrange”) e1170, when activated, will perform the operation o1170. Also, the transmitting full course module m1170, when executed and/or activated, will direct performance of and/or perform the operation o1170. For instance, in one or more exemplary implementations, the one or more transmitting full course instructions i1170, when executed, direct performance of the operation o1170 in the illustrative depiction as follows, and/or the transmitting full course electrical circuitry arrangement e1170, when activated, performs the operation o1170 in the illustrative depiction as follows, and/or the transmitting full course module m1170, when executed and/or activated, directs performance of and/or performs the operation o1170 in the illustrative depiction as follows, and/or the operation o1170 is otherwise carried out in the illustrative depiction as follows: electronically transmitting (e.g. POP3 server, etc.) one or more residential food management information requests (e.g. beverage consumption rates, etc.) associated with at least in part (e.g. engage, etc.) one or more food related residential conditions (e.g. levels of one or more minerals present in one or more food items prepared by the residential food management, etc.) affecting (e.g. engage, etc.) residential service of (e.g. mobile catering food item transporting, etc.) the one or more residential food items (e.g. boiled side dish, etc.) including at least in part food items for one or more full course dinners (e.g. steak dinner residential meals, etc.).

In one or more implementations, as shown in FIG. 66, operation o11 includes an operation o1171 for electronically transmitting one or more residential food management information requests associated with at least in part one or more food related residential conditions affecting residential service of the one or more residential food items including at least in part food items for one or more salad based meals. Origination of an illustratively derived transmitting salad based component group can be accomplished through skilled in the art design choice selection of one or more of the above depicted components from one or more of the above depicted subsystems shown in FIG. 12. Components from the transmitting salad based component group can be used in implementing execution of the one or more transmitting salad based instructions i1171 of FIG. 31, can be used in performance of the transmitting salad based electrical circuitry arrangement e1171 of FIG. 24, and/or can be used in otherwise fulfillment of the operation o1171. An exemplary non-transitory signal bearing medium version of the information storage subsystem s200 is depicted in FIG. 31 as bearing the one or more transmitting salad based instructions i1171 that when executed will direct performance of the operation o1171. Furthermore, the transmitting salad based electrical circuitry arrangement (“elec circ arrange”) e1171, when activated, will perform the operation o1171. Also, the transmitting salad based module m1171, when executed and/or activated, will direct performance of and/or perform the operation o1171. For instance, in one or more exemplary implementations, the one or more transmitting salad based instructions i1171, when executed, direct performance of the operation o1171 in the illustrative depiction as follows, and/or the transmitting salad based electrical circuitry arrangement e1171, when activated, performs the operation o1171 in the illustrative depiction as follows, and/or the transmitting salad based module m1171, when executed and/or activated, directs performance of and/or performs the operation o1171 in the illustrative depiction as follows, and/or the operation o1171 is otherwise carried out in the illustrative depiction as follows: electronically transmitting (e.g. hardware based encryption, etc.) one or more residential food management information requests (e.g. labor force scheduling, etc.) associated with at least in part (e.g. engaged by, etc.) one or more food related residential conditions (e.g. level of one or more antioxidants present in one or more food items prepared by the residential food management, etc.) affecting (e.g. engaged by, etc.) residential service of (e.g. institutional home food item transporting, etc.) the one or more residential food items (e.g. sandwich side dish, etc.) including at least in part food items for one or more salad based meals (e.g. residential meals for chef salad, etc.).

In one or more implementations, as shown in FIG. 66, operation o11 includes an operation o1172 for electronically transmitting one or more residential food management information requests associated with at least in part one or more food related residential conditions affecting residential service of the one or more residential food items including at least in part food items for one or more beef dishes. Origination of an illustratively derived transmitting beef dishes component group can be accomplished through skilled in the art design choice selection of one or more of the above depicted components from one or more of the above depicted subsystems shown in FIG. 12. Components from the transmitting beef dishes component group can be used in implementing execution of the one or more transmitting beef dishes instructions i1172 of FIG. 31, can be used in performance of the transmitting beef dishes electrical circuitry arrangement e1172 of FIG. 24, and/or can be used in otherwise fulfillment of the operation o1172. An exemplary non-transitory signal bearing medium version of the information storage subsystem s200 is depicted in FIG. 31 as bearing the one or more transmitting beef dishes instructions i1172 that when executed will direct performance of the operation o1172. Furthermore, the transmitting beef dishes electrical circuitry arrangement (“elec circ arrange”) e1172, when activated, will perform the operation o1172. Also, the transmitting beef dishes module m1172, when executed and/or activated, will direct performance of and/or perform the operation o1172. For instance, in one or more exemplary implementations, the one or more transmitting beef dishes instructions i1172, when executed, direct performance of the operation o1172 in the illustrative depiction as follows, and/or the transmitting beef dishes electrical circuitry arrangement e1172, when activated, performs the operation o1172 in the illustrative depiction as follows, and/or the transmitting beef dishes module m1172, when executed and/or activated, directs performance of and/or performs the operation o1172 in the illustrative depiction as follows, and/or the operation o1172 is otherwise carried out in the illustrative depiction as follows: electronically transmitting (e.g. software based encryption, etc.) one or more residential food management information requests (e.g. future market demands, etc.) associated with at least in part (e.g. incorporate, etc.) one or more food related residential conditions (e.g. characterization of the residential food management in terms of type of residential occupant ethnic demographics, etc.) affecting (e.g. incorporate, etc.) residential service of (e.g. school lunch food item transporting, etc.) the one or more residential food items (e.g. rotisserie side dish, etc.) including at least in part food items for one or more beef dishes (e.g. residential meals for bowl of beef chili, etc.).

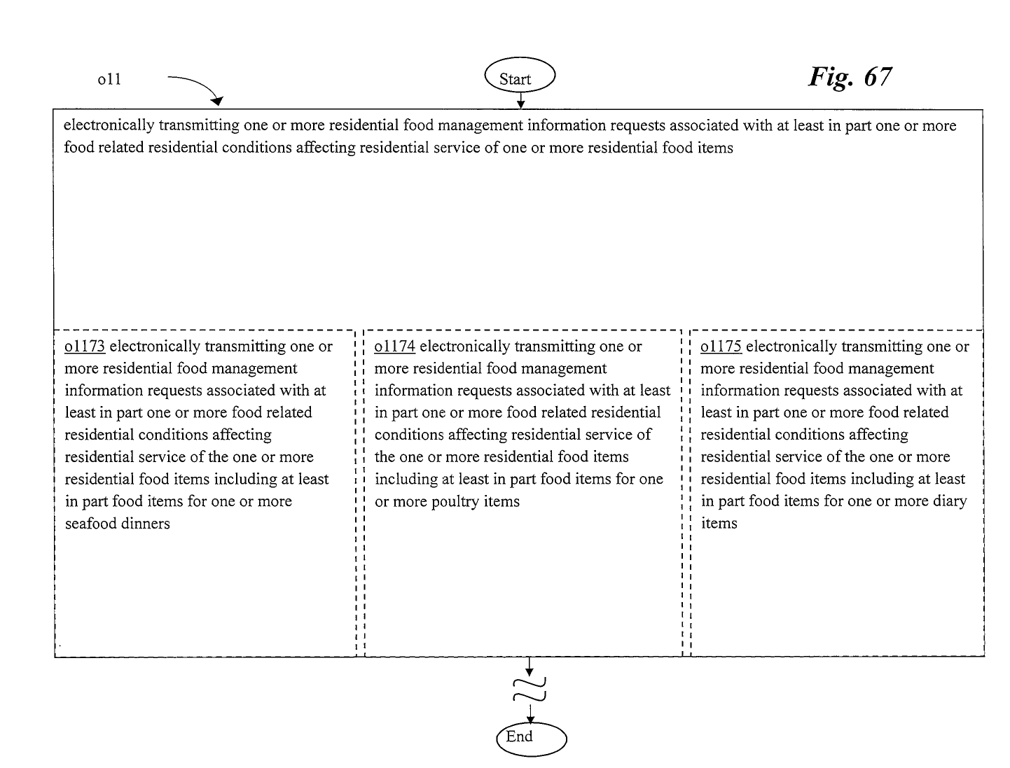

In one or more implementations, as shown in FIG. 67, operation o11 includes an operation o1173 for electronically transmitting one or more residential food management information requests associated with at least in part one or more food related residential conditions affecting residential service of the one or more residential food items including at least in part food items for one or more seafood dinners. Origination of an illustratively derived transmitting seafood component group can be accomplished through skilled in the art design choice selection of one or more of the above depicted components from one or more of the above depicted subsystems shown in FIG. 12. Components from the transmitting seafood component group can be used in implementing execution of the one or more transmitting seafood instructions i1173 of FIG. 31, can be used in performance of the transmitting seafood electrical circuitry arrangement e1173 of FIG. 24, and/or can be used in otherwise fulfillment of the operation o1173. An exemplary non-transitory signal bearing medium version of the information storage subsystem s200 is depicted in FIG. 31 as bearing the one or more transmitting seafood instructions i1173 that when executed will direct performance of the operation o1173. Furthermore, the transmitting seafood electrical circuitry arrangement (“elec circ arrange”) e1173, when activated, will perform the operation o1173. Also, the transmitting seafood module m1173, when executed and/or activated, will direct performance of and/or perform the operation o1173. For instance, in one or more exemplary implementations, the one or more transmitting seafood instructions i1173, when executed, direct performance of the operation o1173 in the illustrative depiction as follows, and/or the transmitting seafood electrical circuitry arrangement e1173, when activated, performs the operation o1173 in the illustrative depiction as follows, and/or the transmitting seafood module m1173, when executed and/or activated, directs performance of and/or performs the operation o1173 in the illustrative depiction as follows, and/or the operation o1173 is otherwise carried out in the illustrative depiction as follows: electronically transmitting (e.g. SD card, etc.) one or more residential food management information requests (e.g. improper data calculation, etc.) associated with at least in part (e.g. engross, etc.) one or more food related residential conditions (e.g. distance between one or more farms and one or more grocers supplying ingestible material to residential location, etc.) affecting (e.g. engross, etc.) residential service of (e.g. elderly home food item transporting, etc.) the one or more residential food items (e.g. braised side dish, etc.) including at least in part food items for one or more seafood dinners (e.g. residential meals for plank roasted salmon, etc.).

In one or more implementations, as shown in FIG. 67, operation o11 includes an operation o1174 for electronically transmitting one or more residential food management information requests associated with at least in part one or more food related residential conditions affecting residential service of the one or more residential food items including at least in part food items for one or more poultry items. Origination of an illustratively derived transmitting poultry items component group can be accomplished through skilled in the art design choice selection of one or more of the above depicted components from one or more of the above depicted subsystems shown in FIG. 12. Components from the transmitting poultry items component group can be used in implementing execution of the one or more transmitting poultry items instructions i1174 of FIG. 31, can be used in performance of the transmitting poultry items electrical circuitry arrangement e1174 of FIG. 24, and/or can be used in otherwise fulfillment of the operation o1174. An exemplary non-transitory signal bearing medium version of the information storage subsystem s200 is depicted in FIG. 31 as bearing the one or more transmitting poultry items instructions i1174 that when executed will direct performance of the operation o1174. Furthermore, the transmitting poultry items electrical circuitry arrangement (“elec circ arrange”) e1174, when activated, will perform the operation o1174. Also, the transmitting poultry items module m1174, when executed and/or activated, will direct performance of and/or perform the operation o1174. For instance, in one or more exemplary implementations, the one or more transmitting poultry items instructions i1174, when executed, direct performance of the operation o1174 in the illustrative depiction as follows, and/or the transmitting poultry items electrical circuitry arrangement e1174, when activated, performs the operation o1174 in the illustrative depiction as follows, and/or the transmitting poultry items module m1174, when executed and/or activated, directs performance of and/or performs the operation o1174 in the illustrative depiction as follows, and/or the operation o1174 is otherwise carried out in the illustrative depiction as follows: electronically transmitting (e.g. SIM card, etc.) one or more residential food management information requests (e.g. rodent infestation of residential location, etc.) associated with at least in part (e.g. implicated, etc.) one or more food related residential conditions (e.g. distance between residential food management and one or more grocers providing ingestible material to residential location, etc.) affecting (e.g. implicated, etc.) residential service of (e.g. street vendor food item transporting, etc.) the one or more residential food items (e.g. sous-vide side dish, etc.) including at least in part food items for one or more poultry items (e.g. residential meals for turkey dinner, etc.).

In one or more implementations, as shown in FIG. 67, operation o11 includes an operation o1175 for electronically transmitting one or more residential food management information requests associated with at least in part one or more food related residential conditions affecting residential service of the one or more residential food items including at least in part food items for one or more diary items. Origination of an illustratively derived transmitting diary items component group can be accomplished through skilled in the art design choice selection of one or more of the above depicted components from one or more of the above depicted subsystems shown in FIG. 12. Components from the transmitting diary items component group can be used in implementing execution of the one or more transmitting diary items instructions i1175 of FIG. 31, can be used in performance of the transmitting diary items electrical circuitry arrangement e1175 of FIG. 24, and/or can be used in otherwise fulfillment of the operation o1175. An exemplary non-transitory signal bearing medium version of the information storage subsystem s200 is depicted in FIG. 31 as bearing the one or more transmitting diary items instructions i1175 that when executed will direct performance of the operation o1175. Furthermore, the transmitting diary items electrical circuitry arrangement (“elec circ arrange”) e1175, when activated, will perform the operation o1175. Also, the transmitting diary items module m1175, when executed and/or activated, will direct performance of and/or perform the operation o1175. For instance, in one or more exemplary implementations, the one or more transmitting diary items instructions i1175, when executed, direct performance of the operation o1175 in the illustrative depiction as follows, and/or the transmitting diary items electrical circuitry arrangement e1175, when activated, performs the operation o1175 in the illustrative depiction as follows, and/or the transmitting diary items module m1175, when executed and/or activated, directs performance of and/or performs the operation o1175 in the illustrative depiction as follows, and/or the operation o1175 is otherwise carried out in the illustrative depiction as follows: electronically transmitting (e.g. email, etc.) one or more residential food management information requests (e.g. sanitizer usage, etc.) associated with at least in part (e.g. necessitate, etc.) one or more food related residential conditions (e.g. one or more activity aspects of residential food management used to reduce costs, etc.) affecting (e.g. necessitate, etc.) residential service of (e.g. mobile kitchen food item transporting, etc.) the one or more residential food items (e.g. blended side dish, etc.) including at least in part food items for one or more diary items (e.g. residential meals for cheese toppings on pizza, etc.).

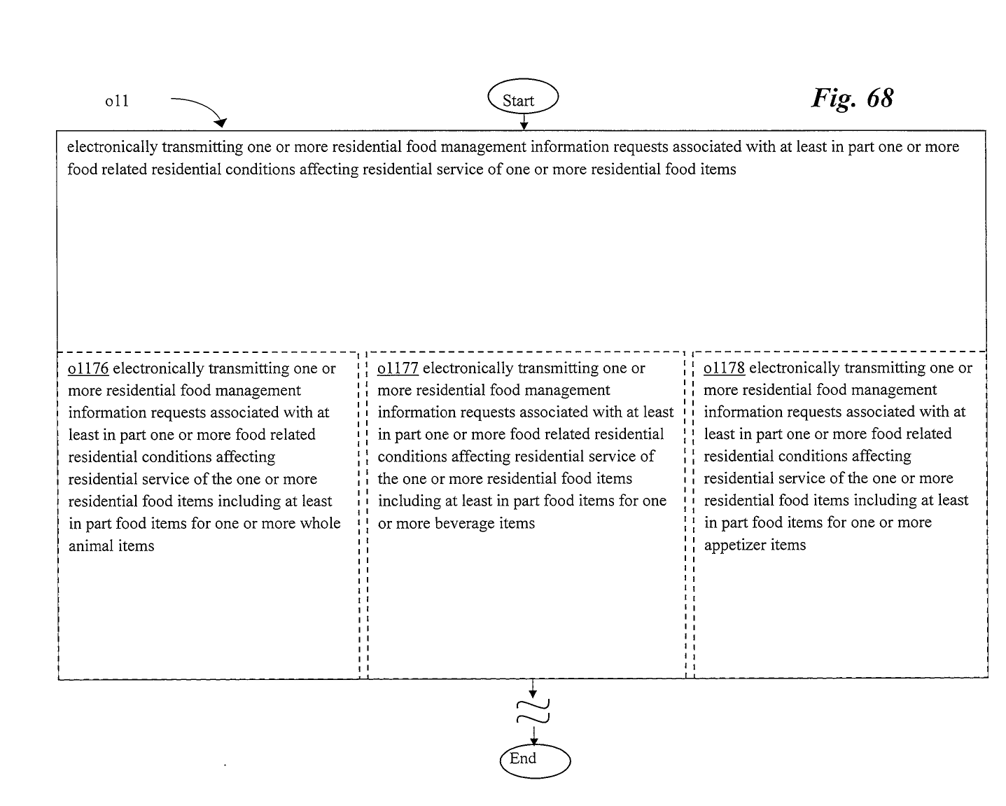

In one or more implementations, as shown in FIG. 68, operation o11 includes an operation o1176 for electronically transmitting one or more residential food management information requests associated with at least in part one or more food related residential conditions affecting residential service of the one or more residential food items including at least in part food items for one or more whole animal items. Origination of an illustratively derived transmitting whole animal component group can be accomplished through skilled in the art design choice selection of one or more of the above depicted components from one or more of the above depicted subsystems shown in FIG. 12. Components from the transmitting whole animal component group can be used in implementing execution of the one or more transmitting whole animal instructions i1176 of FIG. 31, can be used in performance of the transmitting whole animal electrical circuitry arrangement e1176 of FIG. 24, and/or can be used in otherwise fulfillment of the operation o1176. An exemplary non-transitory signal bearing medium version of the information storage subsystem s200 is depicted in FIG. 31 as bearing the one or more transmitting whole animal instructions i1176 that when executed will direct performance of the operation o1176. Furthermore, the transmitting whole animal electrical circuitry arrangement (“elec circ arrange”) e1176, when activated, will perform the operation o1176. Also, the transmitting whole animal module m1176, when executed and/or activated, will direct performance of and/or perform the operation o1176. For instance, in one or more exemplary implementations, the one or more transmitting whole animal instructions i1176, when executed, direct performance of the operation o1176 in the illustrative depiction as follows, and/or the transmitting whole animal electrical circuitry arrangement e1176, when activated, performs the operation o1176 in the illustrative depiction as follows, and/or the transmitting whole animal module m1176, when executed and/or activated, directs performance of and/or performs the operation o1176 in the illustrative depiction as follows, and/or the operation o1176 is otherwise carried out in the illustrative depiction as follows: electronically transmitting (e.g. peer to peer, etc.) one or more residential food management information requests (e.g. distribution of complaints by residential occupants, etc.) associated with at least in part (e.g. presuppose, etc.) one or more food related residential conditions (e.g. one or more activity aspects of residential food management as convenience preparation, etc.) affecting (e.g. presuppose, etc.) residential service of (e.g. visiting nursing food item transporting, etc.) the one or more residential food items (e.g. beverage side dish, etc.) including at least in part food items for one or more whole animal items (e.g. residential meals involving whole milk, etc.).

In one or more implementations, as shown in FIG. 68, operation o11 includes an operation o1177 for electronically transmitting one or more residential food management information requests associated with at least in part one or more food related residential conditions affecting residential service of the one or more residential food items including at least in part food items for one or more beverage items. Origination of an illustratively derived transmitting beverage items component group can be accomplished through skilled in the art design choice selection of one or more of the above depicted components from one or more of the above depicted subsystems shown in FIG. 12. Components from the transmitting beverage items component group can be used in implementing execution of the one or more transmitting beverage items instructions i1177 of FIG. 31, can be used in performance of the transmitting beverage items electrical circuitry arrangement e1177 of FIG. 24, and/or can be used in otherwise fulfillment of the operation o1177. An exemplary non-transitory signal bearing medium version of the information storage subsystem s200 is depicted in FIG. 31 as bearing the one or more transmitting beverage items instructions i1177 that when executed will direct performance of the operation o1177. Furthermore, the transmitting beverage items electrical circuitry arrangement (“elec circ arrange”) e1177, when activated, will perform the operation o1177. Also, the transmitting beverage items module m1177, when executed and/or activated, will direct performance of and/or perform the operation o1177. For instance, in one or more exemplary implementations, the one or more transmitting beverage items instructions i1177, when executed, direct performance of the operation o1177 in the illustrative depiction as follows, and/or the transmitting beverage items electrical circuitry arrangement e1177, when activated, performs the operation o1177 in the illustrative depiction as follows, and/or the transmitting beverage items module m1177, when executed and/or activated, directs performance of and/or performs the operation o1177 in the illustrative depiction as follows, and/or the operation o1177 is otherwise carried out in the illustrative depiction as follows: electronically transmitting (e.g. 10-key, etc.) one or more residential food management information requests (e.g. humidity profiles of low-temperature ovens, etc.) associated with at least in part (e.g. related to, etc.) one or more food related residential conditions (e.g. one or more activity aspects of residential food management as a domestic residential location, etc.) affecting (e.g. related to, etc.) residential service of (e.g. deli aspects food item transporting, etc.) the one or more residential food items (e.g. protein dominant side dish, etc.) including at least in part food items for one or more beverage items (e.g. residential meals involving sports drink, etc.).

In one or more implementations, as shown in FIG. 68, operation o11 includes an operation o1178 for electronically transmitting one or more residential food management information requests associated with at least in part one or more food related residential conditions affecting residential service of the one or more residential food items including at least in part food items for one or more appetizer items. Origination of an illustratively derived transmitting appetizer items component group can be accomplished through skilled in the art design choice selection of one or more of the above depicted components from one or more of the above depicted subsystems shown in FIG. 12. Components from the transmitting appetizer items component group can be used in implementing execution of the one or more transmitting appetizer items instructions i1178 of FIG. 31, can be used in performance of the transmitting appetizer items electrical circuitry arrangement e1178 of FIG. 24, and/or can be used in otherwise fulfillment of the operation o1178. An exemplary non-transitory signal bearing medium version of the information storage subsystem s200 is depicted in FIG. 31 as bearing the one or more transmitting appetizer items instructions i1178 that when executed will direct performance of the operation o1178. Furthermore, the transmitting appetizer items electrical circuitry arrangement (“elec circ arrange”) e1178, when activated, will perform the operation o1178. Also, the transmitting appetizer items module m1178, when executed and/or activated, will direct performance of and/or perform the operation o1178. For instance, in one or more exemplary implementations, the one or more transmitting appetizer items instructions i1178, when executed, direct performance of the operation o1178 in the illustrative depiction as follows, and/or the transmitting appetizer items electrical circuitry arrangement e1178, when activated, performs the operation o1178 in the illustrative depiction as follows, and/or the transmitting appetizer items module m1178, when executed and/or activated, directs performance of and/or performs the operation o1178 in the illustrative depiction as follows, and/or the operation o1178 is otherwise carried out in the illustrative depiction as follows: electronically transmitting (e.g. USB port, etc.) one or more residential food management information requests (e.g. profile of oxygen levels in storage areas, etc.) associated with at least in part (e.g. relationship, etc.) one or more food related residential conditions (e.g. one or more activity aspects of residential food management as an upscale residential location, etc.) affecting (e.g. relationship, etc.) residential service of (e.g. fine dining food item planning, etc.) the one or more residential food items (e.g. carbohydrate dominant side dish, etc.) including at least in part food items for one or more appetizer items (e.g. residential meals involving vegetables and dip, etc.).

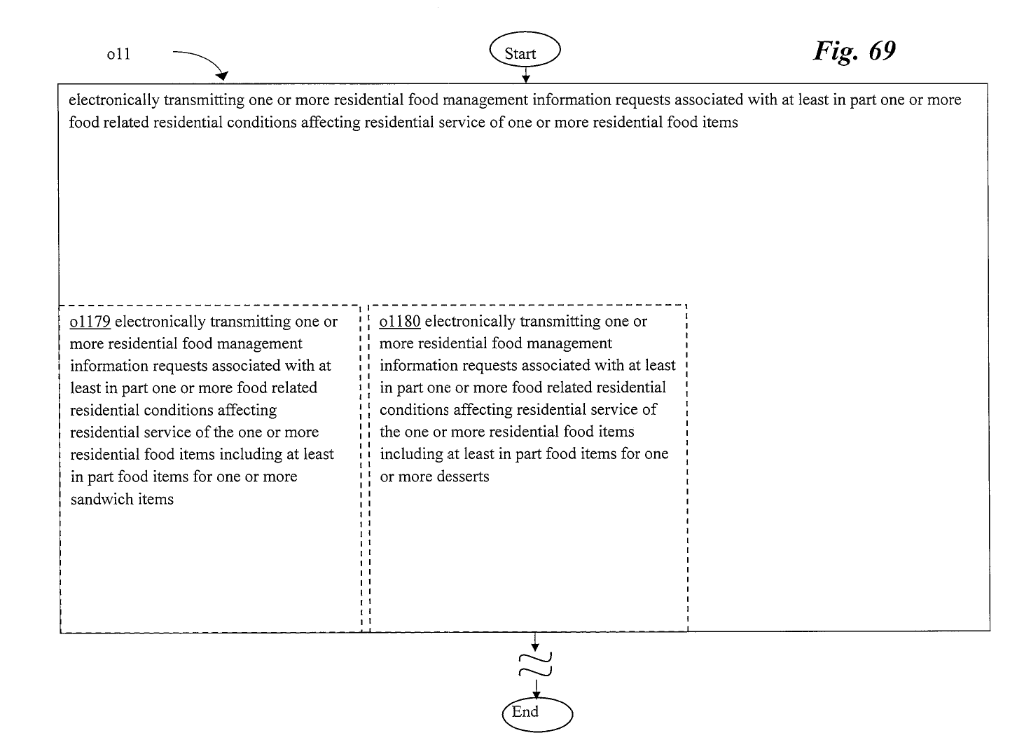

In one or more implementations, as shown in FIG. 69, operation o11 includes an operation o1179 for electronically transmitting one or more residential food management information requests associated with at least in part one or more food related residential conditions affecting residential service of the one or more residential food items including at least in part food items for one or more sandwich items. Origination of an illustratively derived transmitting component group can be accomplished through skilled in the art design choice selection of one or more of the above depicted components from one or more of the above depicted subsystems shown in FIG. 12. Components from the transmitting component group can be used in implementing execution of the one or more transmitting instructions i1179 of FIG. 31, can be used in performance of the transmitting electrical circuitry arrangement e1179 of FIG. 24, and/or can be used in otherwise fulfillment of the operation o1179. An exemplary non-transitory signal bearing medium version of the information storage subsystem s200 is depicted in FIG. 31 as bearing the one or more transmitting instructions i1179 that when executed will direct performance of the operation o1179. Furthermore, the transmitting electrical circuitry arrangement (“elec circ arrange”) e1179, when activated, will perform the operation o1179. Also, the transmitting module m1179, when executed and/or activated, will direct performance of and/or perform the operation o1179. For instance, in one or more exemplary implementations, the one or more transmitting instructions i1179, when executed, direct performance of the operation o1179 in the illustrative depiction as follows, and/or the transmitting electrical circuitry arrangement e1179, when activated, performs the operation o1179 in the illustrative depiction as follows, and/or the transmitting module m1179, when executed and/or activated, directs performance of and/or performs the operation o1179 in the illustrative depiction as follows, and/or the operation o1179 is otherwise carried out in the illustrative depiction as follows: electronically transmitting (e.g. FTP, etc.) one or more residential food management information requests (e.g. profile of carbon dioxide levels in dining areas, etc.) associated with at least in part (e.g. suggest, etc.) one or more food related residential conditions (e.g. one or more activity aspects of residential food management as a mobile based residential location, etc.) affecting (e.g. suggest, etc.) residential service of (e.g. fast food item planning, etc.) the one or more residential food items (e.g. fat dominant side dish, etc.) including at least in part food items for one or more sandwich items (e.g. residential meals involving subway sandwich, etc.).

In one or more implementations, as shown in FIG. 69, operation o11 includes an operation o1180 for electronically transmitting one or more residential food management information requests associated with at least in part one or more food related residential conditions affecting residential service of the one or more residential food items including at least in part food items for one or more desserts. Origination of an illustratively derived transmitting desserts component group can be accomplished through skilled in the art design choice selection of one or more of the above depicted components from one or more of the above depicted subsystems shown in FIG. 12. Components from the transmitting desserts component group can be used in implementing execution of the one or more transmitting desserts instructions i1180 of FIG. 32, can be used in performance of the transmitting desserts electrical circuitry arrangement e1180 of FIG. 25, and/or can be used in otherwise fulfillment of the operation o1180. An exemplary non-transitory signal bearing medium version of the information storage subsystem s200 is depicted in FIG. 32 as bearing the one or more transmitting desserts instructions i1180 that when executed will direct performance of the operation o1180. Furthermore, the transmitting desserts electrical circuitry arrangement (“elec circ arrange”) e1180, when activated, will perform the operation o1180. Also, the transmitting desserts module m1180, when executed and/or activated, will direct performance of and/or perform the operation o1180. For instance, in one or more exemplary implementations, the one or more transmitting desserts instructions i1180, when executed, direct performance of the operation o1180 in the illustrative depiction as follows, and/or the transmitting desserts electrical circuitry arrangement e1180, when activated, performs the operation o1180 in the illustrative depiction as follows, and/or the transmitting desserts module m1180, when executed and/or activated, directs performance of and/or performs the operation o1180 in the illustrative depiction as follows, and/or the operation o1180 is otherwise carried out in the illustrative depiction as follows: electronically transmitting (e.g. HTTP, etc.) one or more residential food management information requests (e.g. residential occupant loyalty profiles, etc.) associated with at least in part (e.g. entangle, etc.) one or more food related residential conditions (e.g. one or more activity aspects of residential food management as an internet based residential location, etc.) affecting (e.g. entangle, etc.) residential service of (e.g. family buffet food item planning, etc.) the one or more residential food items (e.g. pasta side dish, etc.) including at least in part food items for one or more desserts (e.g. residential meals involving pasta side dish, etc.).

As shown in FIG. 42, the operational flow o10 proceeds to operation o12 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items. An exemplary version of a non-transitory signal bearing medium of information storage subsystem s200 is depicted as bearing one or more electronically receiving instructions i12 that when executed will direct performance of the operation o12. In an implementation, the one or more electronically receiving instructions i12 when executed direct electronically receiving, subsequent to said electronically transmitting, (e.g. FRS, GMRS, IEEE 802.11, etc.) at least a portion of residential food management response information (e.g. cleaning protocols implemented, humidity of storage units, oxygen sensor of preparation equipment, etc.) associated with at least in part (e.g. associated, affected, affecting, etc.) one or more food related residential conditions (e.g. cost of extra equipment use, equipment maintenance schedule, tool requirements for repair of residential food management equipment, etc.) affecting (e.g. associated, affected, affecting, etc.) residential service of (e.g. elderly home food item distribution, school lunch food item distribution, institutional home food item distribution, etc.) one or more residential food items, (e.g. weight loss side dish, cold side dish, hot side dish, etc.) said residential food management response information including description logged (e.g. document discriminator, hologram, color code, etc.) as being accessible through (e.g. through electromagnetic reception, through search terms, through storage retrieval, etc.) one or more physical accessories (e.g. high frequency RFID, UHF emitter, ISM band emitter, etc.) and including description of said one or more physical accessories (e.g. via server information, via index information, via body information, etc.) as being at least temporarily (e.g. time since introduction of oxygen absorber, shipping time on truck from distribution center to residential location, portion of shipping time returning from grocery, etc.) near to (e.g. adhered to container, tied to material, stapled to container, etc.) one or more food items (e.g. filleted salmon, carrot, wheat, etc.). Furthermore, the electronically receiving electrical circuitry arrangement e12 when activated will perform the operation o12. Also, the electronically receiving module m12, when executed and/or activated, will direct performance of and/or perform the operation o12. In an implementation, the electronically receiving electrical circuitry arrangement e12, when activated performs the operation o12 in the illustrative depiction as follows, and/or the electronically receiving module m12, when executed and/or activated, directs performance of and/or performs electronically receiving, subsequent to said electronically transmitting, (e.g. FRS, GMRS, IEEE 802.11, etc.) at least a portion of residential food management response information (e.g. cleaning protocols implemented, humidity of storage units, oxygen sensor of preparation equipment, etc.) associated with at least in part (e.g. associated, affected, affecting, etc.) one or more food related residential conditions (e.g. cost of extra equipment use, equipment maintenance schedule, tool requirements for repair of residential food management equipment, etc.) affecting (e.g. associated, affected, affecting, etc.) residential service of (e.g. elderly home food item distribution, school lunch food item distribution, institutional home food item distribution, etc.) one or more residential food items, (e.g. weight loss side dish, cold side dish, hot side dish, etc.) said residential food management response information including description logged (e.g. document discriminator, hologram, color code, etc.) as being accessible through (e.g. through electromagnetic reception, through search terms, through storage retrieval, etc.) one or more physical accessories (e.g. high frequency RFID, UHF emitter, ISM band emitter, etc.) and including description of said one or more physical accessories (e.g. via server information, via index information, via body information, etc.) as being at least temporarily (e.g. time since introduction of oxygen absorber, shipping time on truck from distribution center to residential location, portion of shipping time returning from grocery, etc.) near to (e.g. adhered to container, tied to material, stapled to container, etc.) one or more food items (e.g. filleted salmon, carrot, wheat, etc.). In an implementation, the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items is carried out by electronically receiving, subsequent to said electronically transmitting, (e.g. FRS, GMRS, IEEE 802.11, etc.) at least a portion of residential food management response information (e.g. cleaning protocols implemented, humidity of storage units, oxygen sensor of preparation equipment, etc.) associated with at least in part (e.g. associated, affected, affecting, etc.) one or more food related residential conditions (e.g. cost of extra equipment use, equipment maintenance schedule, tool requirements for repair of residential food management equipment, etc.) affecting (e.g. associated, affected, affecting, etc.) residential service of (e.g. elderly home food item distribution, school lunch food item distribution, institutional home food item distribution, etc.) one or more residential food items, (e.g. weight loss side dish, cold side dish, hot side dish, etc.) said residential food management response information including description logged (e.g. document discriminator, hologram, color code, etc.) as being accessible through (e.g. through electromagnetic reception, through search terms, through storage retrieval, etc.) one or more physical accessories (e.g. high frequency RFID, UHF emitter, ISM band emitter, etc.) and including description of said one or more physical accessories (e.g. via server information, via index information, via body information, etc.) as being at least temporarily (e.g. time since introduction of oxygen absorber, shipping time on truck from distribution center to residential location, portion of shipping time returning from grocery, etc.) near to (e.g. adhered to container, tied to material, stapled to container, etc.) one or more food items (e.g. filleted salmon, carrot, wheat, etc.).

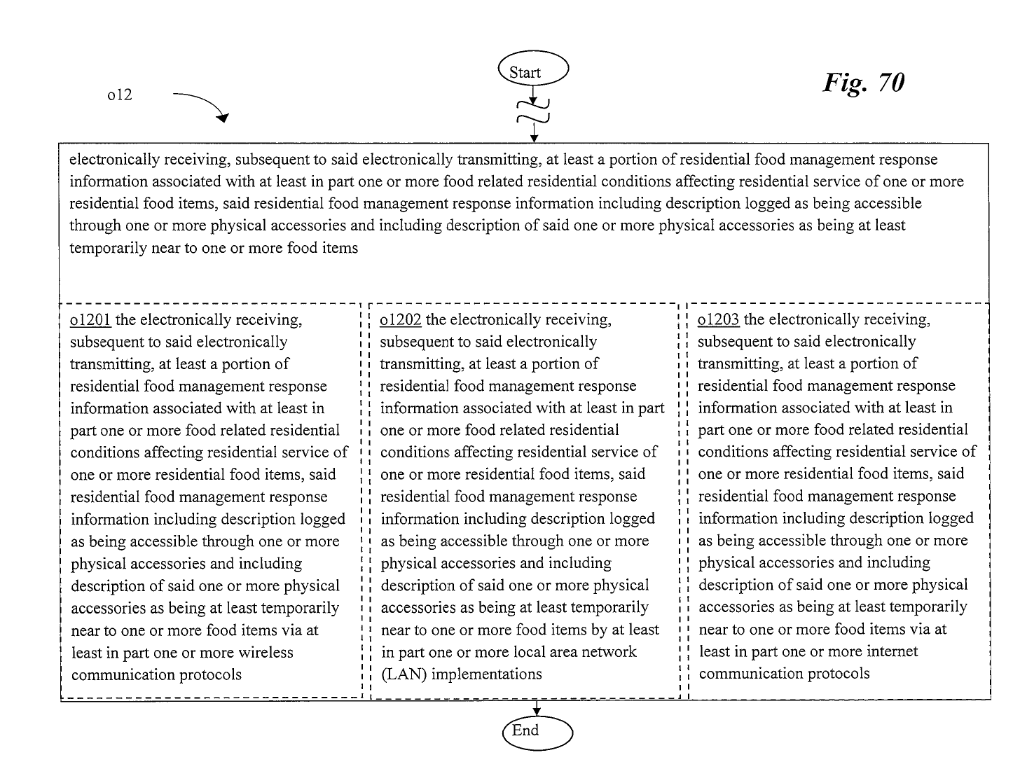

In one or more implementations, as shown in FIG. 70, operation o12 includes an operation o1201 for the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items via at least in part one or more wireless communication protocols. Origination of an illustratively derived receiving wireless protocols component group can be accomplished through skilled in the art design choice selection of one or more of the above depicted components from one or more of the above depicted subsystems shown in FIG. 12. Components from the receiving wireless protocols component group can be used in implementing execution of the one or more receiving wireless protocols instructions i1201 of FIG. 33, can be used in performance of the receiving wireless protocols electrical circuitry arrangement e1201 of FIG. 26, and/or can be used in otherwise fulfillment of the operation o1201. An exemplary non-transitory signal bearing medium version of the information storage subsystem s200 is depicted in FIG. 33 as bearing the one or more receiving wireless protocols instructions i1201 that when executed will direct performance of the operation o1201. Furthermore, the receiving wireless protocols electrical circuitry arrangement (“elec circ arrange”) e1201, when activated, will perform the operation o1201. Also, the receiving wireless protocols module m1201, when executed and/or activated, will direct performance of and/or perform the operation o1201. For instance, in one or more exemplary implementations, the one or more receiving wireless protocols instructions i1201, when executed, direct performance of the operation o1201 in the illustrative depiction as follows, and/or the receiving wireless protocols electrical circuitry arrangement e1201, when activated, performs the operation o1201 in the illustrative depiction as follows, and/or the receiving wireless protocols module m1201, when executed and/or activated, directs performance of and/or performs the operation o1201 in the illustrative depiction as follows, and/or the operation o1201 is otherwise carried out in the illustrative depiction as follows: the electronically receiving, subsequent to said electronically transmitting, (e.g. FRS, etc.) at least a portion of residential food management response information (e.g. cleaning protocols implemented, etc.) associated with at least in part (e.g. associated, etc.) one or more food related residential conditions (e.g. cost of extra equipment use, etc.) affecting (e.g. associated, etc.) residential service of (e.g. elderly home food item distribution, etc.) one or more residential food items, (e.g. weight loss side dish, etc.) said residential food management response information including description logged (e.g. document discriminator, etc.) as being accessible through (e.g. through electromagnetic reception, etc.) one or more physical accessories (e.g. high frequency RFID, etc.) and including description of said one or more physical accessories (e.g. via server information, etc.) as being at least temporarily (e.g. time since introduction of oxygen absorber, etc.) near to (e.g. adhered to container, etc.) one or more food items (e.g. filleted salmon, etc.) via at least in part one or more wireless communication protocols (e.g. through wifi, cellular, g4, etc.).

In one or more implementations, as shown in FIG. 70, operation o12 includes an operation o1202 for the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items by at least in part one or more local area network (LAN) implementations. Origination of an illustratively derived receiving LAN component group can be accomplished through skilled in the art design choice selection of one or more of the above depicted components from one or more of the above depicted subsystems shown in FIG. 12. Components from the receiving LAN component group can be used in implementing execution of the one or more receiving LAN instructions i1202 of FIG. 33, can be used in performance of the receiving LAN electrical circuitry arrangement e1202 of FIG. 26, and/or can be used in otherwise fulfillment of the operation o1202. An exemplary non-transitory signal bearing medium version of the information storage subsystem s200 is depicted in FIG. 33 as bearing the one or more receiving LAN instructions i1202 that when executed will direct performance of the operation o1202. Furthermore, the receiving LAN electrical circuitry arrangement (“elec circ arrange”) e1202, when activated, will perform the operation o1202. Also, the receiving LAN module m1202, when executed and/or activated, will direct performance of and/or perform the operation o1202. For instance, in one or more exemplary implementations, the one or more receiving LAN instructions i1202, when executed, direct performance of the operation o1202 in the illustrative depiction as follows, and/or the receiving LAN electrical circuitry arrangement e1202, when activated, performs the operation o1202 in the illustrative depiction as follows, and/or the receiving LAN module m1202, when executed and/or activated, directs performance of and/or performs the operation o1202 in the illustrative depiction as follows, and/or the operation o1202 is otherwise carried out in the illustrative depiction as follows: the electronically receiving, subsequent to said electronically transmitting, (e.g. GMRS, etc.) at least a portion of residential food management response information (e.g. humidity of storage units, etc.) associated with at least in part (e.g. affected, etc.) one or more food related residential conditions (e.g. equipment maintenance schedule, etc.) affecting (e.g. affected, etc.) residential service of (e.g. school lunch food item distribution, etc.) one or more residential food items, (e.g. cold side dish, etc.) said residential food management response information including description logged (e.g. hologram, etc.) as being accessible through (e.g. through search terms, etc.) one or more physical accessories (e.g. UHF emitter, etc.) and including description of said one or more physical accessories (e.g. via index information, etc.) as being at least temporarily (e.g. shipping time on truck from distribution center to residential location, etc.) near to (e.g. tied to material, etc.) one or more food items (e.g. carrot, etc.) by at least in part one or more local area network (LAN) implementations (e.g. ethernet, etc.).

In one or more implementations, as shown in FIG. 70, operation o12 includes an operation o1203 for the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items via at least in part one or more internet communication protocols. Origination of an illustratively derived receiving internet protocols component group can be accomplished through skilled in the art design choice selection of one or more of the above depicted components from one or more of the above depicted subsystems shown in FIG. 12. Components from the receiving internet protocols component group can be used in implementing execution of the one or more receiving internet protocols instructions i1203 of FIG. 33, can be used in performance of the receiving internet protocols electrical circuitry arrangement e1203 of FIG. 26, and/or can be used in otherwise fulfillment of the operation o1203. An exemplary non-transitory signal bearing medium version of the information storage subsystem s200 is depicted in FIG. 33 as bearing the one or more receiving internet protocols instructions i1203 that when executed will direct performance of the operation o1203. Furthermore, the receiving internet protocols electrical circuitry arrangement (“elec circ arrange”) e1203, when activated, will perform the operation o1203. Also, the receiving internet protocols module m1203, when executed and/or activated, will direct performance of and/or perform the operation o1203. For instance, in one or more exemplary implementations, the one or more receiving internet protocols instructions i1203, when executed, direct performance of the operation o1203 in the illustrative depiction as follows, and/or the receiving internet protocols electrical circuitry arrangement e1203, when activated, performs the operation o1203 in the illustrative depiction as follows, and/or the receiving internet protocols module m1203, when executed and/or activated, directs performance of and/or performs the operation o1203 in the illustrative depiction as follows, and/or the operation o1203 is otherwise carried out in the illustrative depiction as follows: the electronically receiving, subsequent to said electronically transmitting, (e.g. IEEE 802.11, etc.) at least a portion of residential food management response information (e.g. oxygen sensor of preparation equipment, etc.) associated with at least in part (e.g. affecting, etc.) one or more food related residential conditions (e.g. tool requirements for repair of residential food management equipment, etc.) affecting (e.g. affecting, etc.) residential service of (e.g. institutional home food item distribution, etc.) one or more residential food items, (e.g. hot side dish, etc.) said residential food management response information including description logged (e.g. color code, etc.) as being accessible through (e.g. through storage retrieval, etc.) one or more physical accessories (e.g. ISM band emitter, etc.) and including description of said one or more physical accessories (e.g. via body information, etc.) as being at least temporarily (e.g. portion of shipping time returning from grocery, etc.) near to (e.g. stapled to container, etc.) one or more food items (e.g. wheat, etc.) via at least in part one or more internet communication protocols (e.g. tcp/ip, etc.).

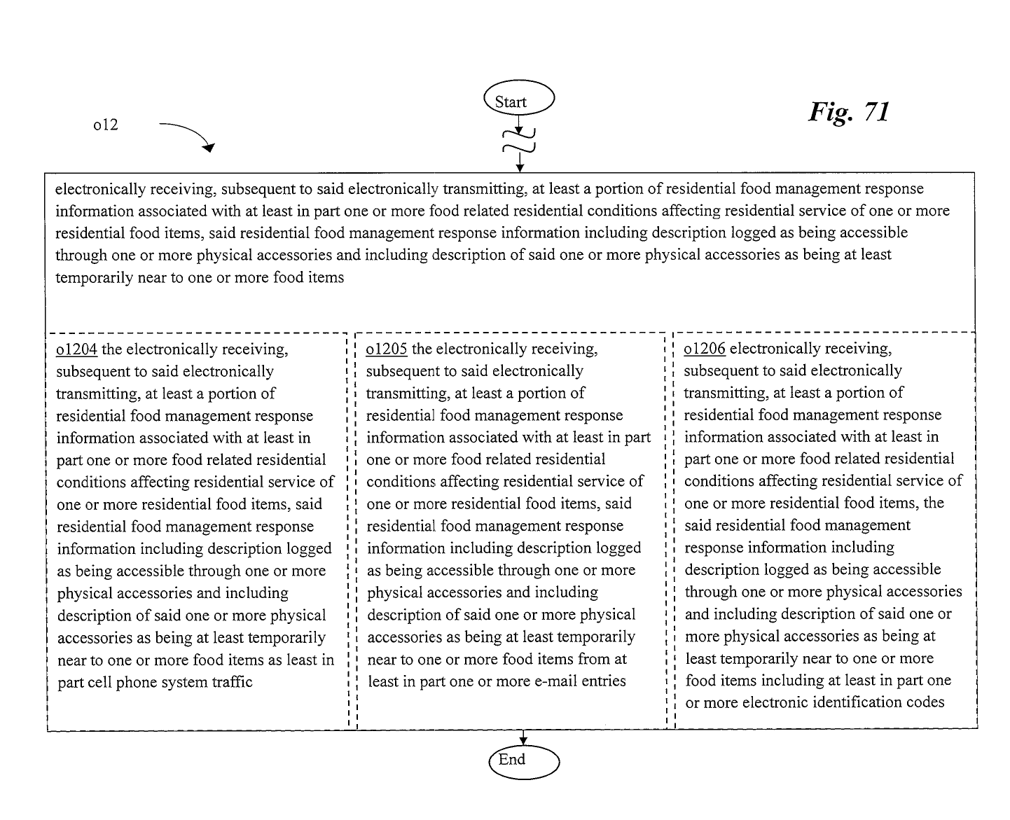

In one or more implementations, as shown in FIG. 71, operation o12 includes an operation o1204 for the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items as least in part cell phone system traffic. Origination of an illustratively derived receiving cell phone component group can be accomplished through skilled in the art design choice selection of one or more of the above depicted components from one or more of the above depicted subsystems shown in FIG. 12. Components from the receiving cell phone component group can be used in implementing execution of the one or more receiving cell phone instructions i1204 of FIG. 33, can be used in performance of the receiving cell phone electrical circuitry arrangement e1204 of FIG. 26, and/or can be used in otherwise fulfillment of the operation o1204. An exemplary non-transitory signal bearing medium version of the information storage subsystem s200 is depicted in FIG. 33 as bearing the one or more receiving cell phone instructions i1204 that when executed will direct performance of the operation o1204. Furthermore, the receiving cell phone electrical circuitry arrangement (“elec circ arrange”) e1204, when activated, will perform the operation o1204. Also, the receiving cell phone module m1204, when executed and/or activated, will direct performance of and/or perform the operation o1204. For instance, in one or more exemplary implementations, the one or more receiving cell phone instructions i1204, when executed, direct performance of the operation o1204 in the illustrative depiction as follows, and/or the receiving cell phone electrical circuitry arrangement e1204, when activated, performs the operation o1204 in the illustrative depiction as follows, and/or the receiving cell phone module m1204, when executed and/or activated, directs performance of and/or performs the operation o1204 in the illustrative depiction as follows, and/or the operation o1204 is otherwise carried out in the illustrative depiction as follows: the electronically receiving, subsequent to said electronically transmitting, (e.g. CDMA, etc.) at least a portion of residential food management response information (e.g. bacteria count in produce, etc.) associated with at least in part (e.g. argue, etc.) one or more food related residential conditions (e.g. local regulations, etc.) affecting (e.g. argue, etc.) residential service of (e.g. mobile catering food item distribution, etc.) one or more residential food items, (e.g. stew side dish, etc.) said residential food management response information including description logged (e.g. visual pattern, etc.) as being accessible through (e.g. through barcode scanning, etc.) one or more physical accessories (e.g. microwave emitter, etc.) and including description of said one or more physical accessories (e.g. via food composition database, etc.) as being at least temporarily (e.g. time spent on conveyor belt, etc.) near to (e.g. laser etched onto container, etc.) one or more food items (e.g. ground chicken, etc.) as least in part cell phone system traffic (e.g. textual traffic, etc.).

In one or more implementations, as shown in FIG. 71, operation o12 includes an operation o1205 for the electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily near to one or more food items from at least in part one or more e-mail entries. Origination of an illustratively derived receiving e-mail entries component group can be accomplished through skilled in the art design choice selection of one or more of the above depicted components from one or more of the above depicted subsystems shown in FIG. 12. Components from the receiving e-mail entries component group can be used in implementing execution of the one or more receiving e-mail entries instructions i1205 of FIG. 33, can be used in performance of the receiving e-mail entries electrical circuitry arrangement e1205 of FIG. 26, and/or can be used in otherwise fulfillment of the operation o1205. An exemplary non-transitory signal bearing medium version of the information storage subsystem s200 is depicted in FIG. 33 as bearing the one or more receiving e-mail entries instructions i1205 that when executed will direct performance of the operation o1205. Furthermore, the receiving e-mail entries electrical circuitry arrangement (“elec circ arrange”) e1205, when activated, will perform the operation o1205. Also, the receiving e-mail entries module m1205, when executed and/or activated, will direct performance of and/or perform the operation o1205. For instance, in one or more exemplary implementations, the one or more receiving e-mail entries instructions i1205, when executed, direct performance of the operation o1205 in the illustrative depiction as follows, and/or the receiving e-mail entries electrical circuitry arrangement e1205, when activated, performs the operation o1205 in the illustrative depiction as follows, and/or the receiving e-mail entries module m1205, when executed and/or activated, directs performance of and/or performs the operation o1205 in the illustrative depiction as follows, and/or the operation o1205 is otherwise carried out in the illustrative depiction as follows: the electronically receiving, subsequent to said electronically transmitting, (e.g. GPRS, etc.) at least a portion of residential food management response information (e.g. bacteria count on surfaces, etc.) associated with at least in part (e.g. connected, etc.) one or more food related residential conditions (e.g. type of cuisine served by the residential location, etc.) affecting (e.g. connected, etc.) residential service of (e.g. family buffet food item distribution, etc.) one or more residential food items, (e.g. soup side dish, etc.) said residential food management response information including description logged (e.g. Morse code, etc.) as being accessible through (e.g. through radiation detection, etc.) one or more physical accessories (e.g. laser ranging tracker, etc.) and including description of said one or more physical accessories (e.g. via DVD-ROM storage, etc.) as being at least temporarily (e.g. portion of time since sealed in carton, etc.) near to (e.g. subdermally injected into material, etc.) one or more food items (e.g. parsnip, etc.) from at least in part one or more e-mail entries (e.g. push e-mail traffic, etc.).

In one or more implementations, as shown in FIG. 71, operation o12 includes an operation o1206 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronic identification codes. Origination of an illustratively derived receiving electronic identification component group can be accomplished through skilled in the art design choice selection of one or more of the above depicted components from one or more of the above depicted subsystems shown in FIG. 12. Components from the receiving electronic identification component group can be used in implementing execution of the one or more receiving electronic identification instructions i1206 of FIG. 33, can be used in performance of the receiving electronic identification electrical circuitry arrangement e1206 of FIG. 26, and/or can be used in otherwise fulfillment of the operation o1206. An exemplary non-transitory signal bearing medium version of the information storage subsystem s200 is depicted in FIG. 33 as bearing the one or more receiving electronic identification instructions i1206 that when executed will direct performance of the operation o1206. Furthermore, the receiving electronic identification electrical circuitry arrangement (“elec circ arrange”) e1206, when activated, will perform the operation o1206. Also, the receiving electronic identification module m1206, when executed and/or activated, will direct performance of and/or perform the operation o1206. For instance, in one or more exemplary implementations, the one or more receiving electronic identification instructions i1206, when executed, direct performance of the operation o1206 in the illustrative depiction as follows, and/or the receiving electronic identification electrical circuitry arrangement e1206, when activated, performs the operation o1206 in the illustrative depiction as follows, and/or the receiving electronic identification module m1206, when executed and/or activated, directs performance of and/or performs the operation o1206 in the illustrative depiction as follows, and/or the operation o1206 is otherwise carried out in the illustrative depiction as follows: electronically receiving, subsequent to said electronically transmitting, (e.g. G3, etc.) at least a portion of residential food management response information (e.g. equipment maintenance, etc.) associated with at least in part (e.g. commit to, etc.) one or more food related residential conditions (e.g. demographics of the residential location, etc.) affecting (e.g. commit to, etc.) residential service of (e.g. fast food item distribution, etc.) one or more residential food items, (e.g. buffet side dish, etc.) the said residential food management response information including description logged (e.g. tertiary code, etc.) as being accessible through (e.g. through isotope identification, etc.) one or more physical accessories (e.g. ultrasonic emitter, etc.) and including description of said one or more physical accessories (e.g. via relational database, etc.) as being at least temporarily (e.g. portion of time spent packaged with similar material, etc.) near to (e.g. adhered to material, etc.) one or more food items (e.g. sheep cheese, etc.) including at least in part one or more electronic identification codes (e.g. HTML code, etc.).

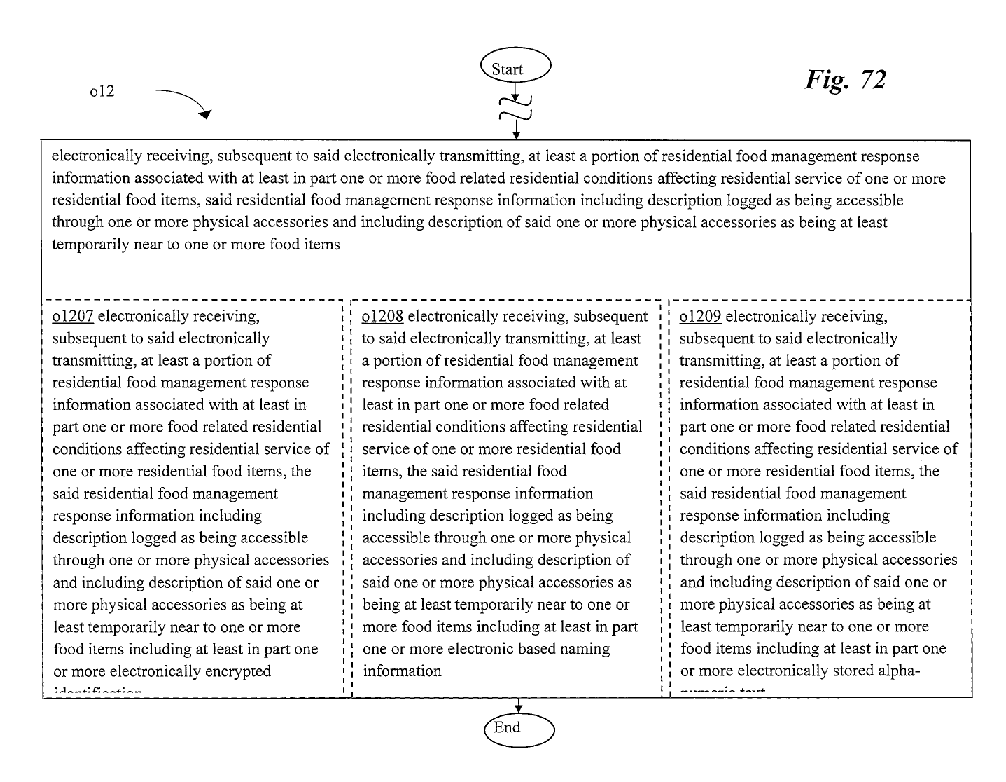

In one or more implementations, as shown in FIG. 72, operation o12 includes an operation o1207 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronically encrypted identification. Origination of an illustratively derived receiving encrypted identification component group can be accomplished through skilled in the art design choice selection of one or more of the above depicted components from one or more of the above depicted subsystems shown in FIG. 12. Components from the receiving encrypted identification component group can be used in implementing execution of the one or more receiving encrypted identification instructions i1207 of FIG. 33, can be used in performance of the receiving encrypted identification electrical circuitry arrangement e1207 of FIG. 26, and/or can be used in otherwise fulfillment of the operation o1207. An exemplary non-transitory signal bearing medium version of the information storage subsystem s200 is depicted in FIG. 33 as bearing the one or more receiving encrypted identification instructions i1207 that when executed will direct performance of the operation o1207. Furthermore, the receiving encrypted identification electrical circuitry arrangement (“elec circ arrange”) e1207, when activated, will perform the operation o1207. Also, the receiving encrypted identification module m1207, when executed and/or activated, will direct performance of and/or perform the operation o1207. For instance, in one or more exemplary implementations, the one or more receiving encrypted identification instructions i1207, when executed, direct performance of the operation o1207 in the illustrative depiction as follows, and/or the receiving encrypted identification electrical circuitry arrangement e1207, when activated, performs the operation o1207 in the illustrative depiction as follows, and/or the receiving encrypted identification module m1207, when executed and/or activated, directs performance of and/or performs the operation o1207 in the illustrative depiction as follows, and/or the operation o1207 is otherwise carried out in the illustrative depiction as follows: electronically receiving, subsequent to said electronically transmitting, (e.g. G4, etc.) at least a portion of residential food management response information (e.g. nitrogen gas levels of storage units, etc.) associated with at least in part (e.g. absorbed by, etc.) one or more food related residential conditions (e.g. age of equipment used in the residential location, etc.) affecting (e.g. absorbed by, etc.) residential service of (e.g. fine dining food item distribution, etc.) one or more residential food items, (e.g. raw side dish, etc.) the said residential food management response information including description logged (e.g. model number, etc.) as being accessible through (e.g. through beacon signal reception, etc.) one or more physical accessories (e.g. gyroscope, etc.) and including description of said one or more physical accessories (e.g. via database management layer, etc.) as being at least temporarily (e.g. portion of time spent on shipping vessel, etc.) near to (e.g. ink stamped directly onto material, etc.) one or more food items (e.g. via food composition database, etc.) including at least in part one or more electronically encrypted identification (e.g. through 256 bit encryption, etc.).

In one or more implementations, as shown in FIG. 72, operation o12 includes an operation o1208 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronic based naming information. Origination of an illustratively derived receiving electronic naming component group can be accomplished through skilled in the art design choice selection of one or more of the above depicted components from one or more of the above depicted subsystems shown in FIG. 12. Components from the receiving electronic naming component group can be used in implementing execution of the one or more receiving electronic naming instructions i1208 of FIG. 33, can be used in performance of the receiving electronic naming electrical circuitry arrangement e1208 of FIG. 26, and/or can be used in otherwise fulfillment of the operation o1208. An exemplary non-transitory signal bearing medium version of the information storage subsystem s200 is depicted in FIG. 33 as bearing the one or more receiving electronic naming instructions i1208 that when executed will direct performance of the operation o1208. Furthermore, the receiving electronic naming electrical circuitry arrangement (“elec circ arrange”) e1208, when activated, will perform the operation o1208. Also, the receiving electronic naming module m1208, when executed and/or activated, will direct performance of and/or perform the operation o1208. For instance, in one or more exemplary implementations, the one or more receiving electronic naming instructions i1208, when executed, direct performance of the operation o1208 in the illustrative depiction as follows, and/or the receiving electronic naming electrical circuitry arrangement e1208, when activated, performs the operation o1208 in the illustrative depiction as follows, and/or the receiving electronic naming module m1208, when executed and/or activated, directs performance of and/or performs the operation o1208 in the illustrative depiction as follows, and/or the operation o1208 is otherwise carried out in the illustrative depiction as follows: electronically receiving, subsequent to said electronically transmitting, (e.g. CD-ROM, etc.) at least a portion of residential food management response information (e.g. amount of waste to disposed of, etc.) associated with at least in part (e.g. embraced by, etc.) one or more food related residential conditions (e.g. distribution of various type of foods served, etc.) affecting (e.g. embraced by, etc.) residential service of (e.g. deli aspects food item use, etc.) one or more residential food items, (e.g. cooked side dish, etc.) the said residential food management response information including description logged (e.g. phonetic alphabet, etc.) as being accessible through (e.g. through image scanning, etc.) one or more physical accessories (e.g. inertial sensor, etc.) and including description of said one or more physical accessories (e.g. via footer information, etc.) as being at least temporarily (e.g. time spent in cold storage, etc.) near to (e.g. placed inside material, etc.) one or more food items (e.g. bison meat, etc.) including at least in part one or more electronic based naming information (e.g. through hierarchical nomenclature, etc.).

In one or more implementations, as shown in FIG. 72, operation o12 includes an operation o1209 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronically stored alpha-numeric text. Origination of an illustratively derived receiving alpha-numeric component group can be accomplished through skilled in the art design choice selection of one or more of the above depicted components from one or more of the above depicted subsystems shown in FIG. 12. Components from the receiving alpha-numeric component group can be used in implementing execution of the one or more receiving alpha-numeric instructions i1209 of FIG. 33, can be used in performance of the receiving alpha-numeric electrical circuitry arrangement e1209 of FIG. 26, and/or can be used in otherwise fulfillment of the operation o1209. An exemplary non-transitory signal bearing medium version of the information storage subsystem s200 is depicted in FIG. 33 as bearing the one or more receiving alpha-numeric instructions i1209 that when executed will direct performance of the operation o1209. Furthermore, the receiving alpha-numeric electrical circuitry arrangement (“elec circ arrange”) e1209, when activated, will perform the operation o1209. Also, the receiving alpha-numeric module m1209, when executed and/or activated, will direct performance of and/or perform the operation o1209. For instance, in one or more exemplary implementations, the one or more receiving alpha-numeric instructions i1209, when executed, direct performance of the operation o1209 in the illustrative depiction as follows, and/or the receiving alpha-numeric electrical circuitry arrangement e1209, when activated, performs the operation o1209 in the illustrative depiction as follows, and/or the receiving alpha-numeric module m1209, when executed and/or activated, directs performance of and/or performs the operation o1209 in the illustrative depiction as follows, and/or the operation o1209 is otherwise carried out in the illustrative depiction as follows: electronically receiving, subsequent to said electronically transmitting, (e.g. DVD, etc.) at least a portion of residential food management response information (e.g. carrier information for food shipments, etc.) associated with at least in part (e.g. containing, etc.) one or more food related residential conditions (e.g. labor laws, etc.) affecting (e.g. containing, etc.) residential service of (e.g. visiting nursing food item use, etc.) one or more residential food items, (e.g. bean side dish, etc.) the said residential food management response information including description logged (e.g. Arabic alphabet, etc.) as being accessible through (e.g. through audio reception, etc.) one or more physical accessories (e.g. accelerometer, etc.) and including description of said one or more physical accessories (e.g. via header information, etc.) as being at least temporarily (e.g. portion of time spent on shipping vessel, etc.) near to (e.g. placed inside container, etc.) one or more food items (e.g. chicken feet, etc.) including at least in part one or more electronically stored alpha-numeric text (e.g. via textual descriptors, etc.).

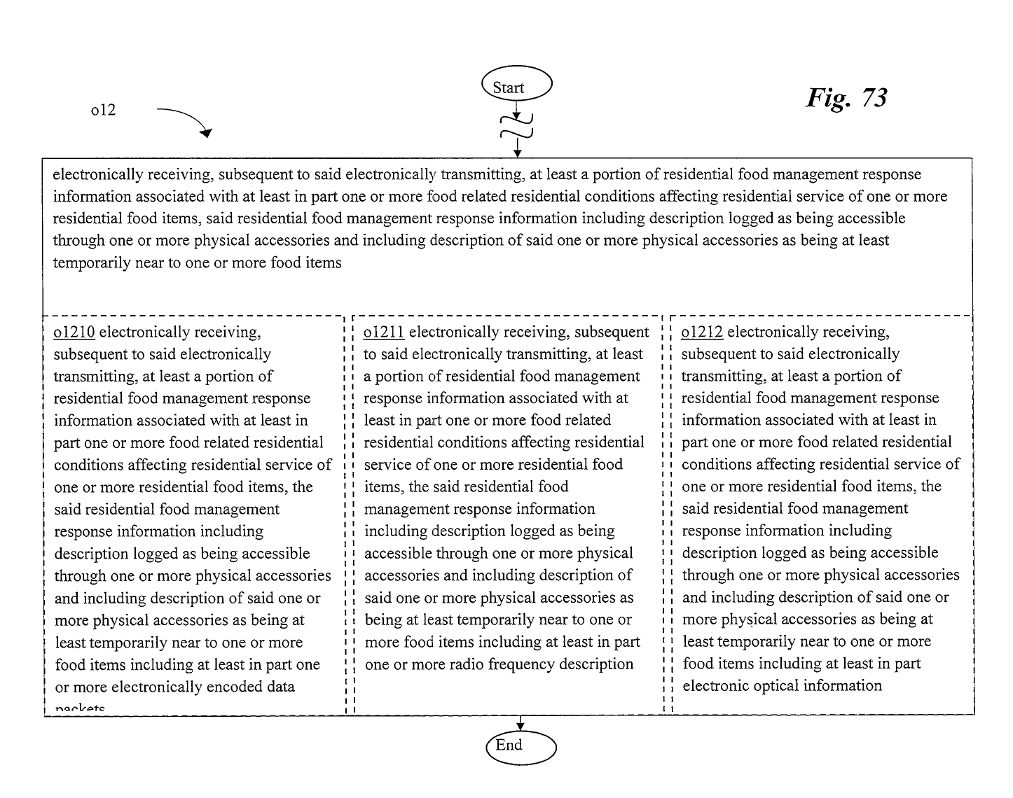

In one or more implementations, as shown in FIG. 73, operation o12 includes an operation o1210 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronically encoded data packets. Origination of an illustratively derived receiving encoded data component group can be accomplished through skilled in the art design choice selection of one or more of the above depicted components from one or more of the above depicted subsystems shown in FIG. 12. Components from the receiving encoded data component group can be used in implementing execution of the one or more receiving encoded data instructions i1210 of FIG. 33, can be used in performance of the receiving encoded data electrical circuitry arrangement e1210 of FIG. 26, and/or can be used in otherwise fulfillment of the operation o1210. An exemplary non-transitory signal bearing medium version of the information storage subsystem s200 is depicted in FIG. 33 as bearing the one or more receiving encoded data instructions i1210 that when executed will direct performance of the operation o1210. Furthermore, the receiving encoded data electrical circuitry arrangement (“elec circ arrange”) e1210, when activated, will perform the operation o1210. Also, the receiving encoded data module m1210, when executed and/or activated, will direct performance of and/or perform the operation o1210. For instance, in one or more exemplary implementations, the one or more receiving encoded data instructions i1210, when executed, direct performance of the operation o1210 in the illustrative depiction as follows, and/or the receiving encoded data electrical circuitry arrangement e1210, when activated, performs the operation o1210 in the illustrative depiction as follows, and/or the receiving encoded data module m1210, when executed and/or activated, directs performance of and/or performs the operation o1210 in the illustrative depiction as follows, and/or the operation o1210 is otherwise carried out in the illustrative depiction as follows: electronically receiving, subsequent to said electronically transmitting, (e.g. hard drive, etc.) at least a portion of residential food management response information (e.g. water usage, etc.) associated with at least in part (e.g. engaging, etc.) one or more food related residential conditions (e.g. safety regulations, etc.) affecting (e.g. engaging, etc.) residential service of (e.g. mobile kitchen food item use, etc.) one or more residential food items, (e.g. grain side dish, etc.) the said residential food management response information including description logged (e.g. security data, etc.) as being accessible through (e.g. through visual identification, etc.) one or more physical accessories (e.g. phase difference sensor, etc.) and including description of said one or more physical accessories (e.g. via portion of packet information, etc.) as being at least temporarily (e.g. time spent exposed to air before packaging, etc.) near to (e.g. riveted to container, etc.) one or more food items (e.g. ground beef, etc.) including at least in part one or more electronically encoded data packets (e.g. tcp-ip packet, etc.).

In one or more implementations, as shown in FIG. 73, operation o12 includes an operation o1211 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more radio frequency description. Origination of an illustratively derived receiving radio frequency component group can be accomplished through skilled in the art design choice selection of one or more of the above depicted components from one or more of the above depicted subsystems shown in FIG. 12. Components from the receiving radio frequency component group can be used in implementing execution of the one or more receiving radio frequency instructions i1211 of FIG. 33, can be used in performance of the receiving radio frequency electrical circuitry arrangement e1211 of FIG. 26, and/or can be used in otherwise fulfillment of the operation o1211. An exemplary non-transitory signal bearing medium version of the information storage subsystem s200 is depicted in FIG. 33 as bearing the one or more receiving radio frequency instructions i1211 that when executed will direct performance of the operation o1211. Furthermore, the receiving radio frequency electrical circuitry arrangement (“elec circ arrange”) e1211, when activated, will perform the operation o1211. Also, the receiving radio frequency module m1211, when executed and/or activated, will direct performance of and/or perform the operation o1211. For instance, in one or more exemplary implementations, the one or more receiving radio frequency instructions i1211, when executed, direct performance of the operation o1211 in the illustrative depiction as follows, and/or the receiving radio frequency electrical circuitry arrangement e1211, when activated, performs the operation o1211 in the illustrative depiction as follows, and/or the receiving radio frequency module m1211, when executed and/or activated, directs performance of and/or performs the operation o1211 in the illustrative depiction as follows, and/or the operation o1211 is otherwise carried out in the illustrative depiction as follows: electronically receiving, subsequent to said electronically transmitting, (e.g. wifi, etc.) at least a portion of residential food management response information (e.g. produce quality observed as received from various groceries, etc.) associated with at least in part (e.g. engaged by, etc.) one or more food related residential conditions (e.g. neighboring residential location, etc.) affecting (e.g. engaged by, etc.) residential service of (e.g. street vendor sourced food item use, etc.) one or more residential food items, (e.g. salad side dish, etc.) the said residential food management response information including description logged (e.g. binary sequence, etc.) as being accessible through (e.g. through light reception, etc.) one or more physical accessories (e.g. magnetic field sensor, etc.) and including description of said one or more physical accessories (e.g. via solid state memory, etc.) as being at least temporarily (e.g. portion of time spent in ice bath, etc.) near to (e.g. enveloping container, etc.) one or more food items (e.g. cod fish, etc.) including at least in part one or more radio frequency description (e.g. RFID physical accessory, etc.).

In one or more implementations, as shown in FIG. 73, operation o12 includes an operation o1212 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part electronic optical information. Origination of an illustratively derived receiving electronic optical component group can be accomplished through skilled in the art design choice selection of one or more of the above depicted components from one or more of the above depicted subsystems shown in FIG. 12. Components from the receiving electronic optical component group can be used in implementing execution of the one or more receiving electronic optical instructions i1212 of FIG. 33, can be used in performance of the receiving electronic optical electrical circuitry arrangement e1212 of FIG. 26, and/or can be used in otherwise fulfillment of the operation o1212. An exemplary non-transitory signal bearing medium version of the information storage subsystem s200 is depicted in FIG. 33 as bearing the one or more receiving electronic optical instructions i1212 that when executed will direct performance of the operation o1212. Furthermore, the receiving electronic optical electrical circuitry arrangement (“elec circ arrange”) e1212, when activated, will perform the operation o1212. Also, the receiving electronic optical module m1212, when executed and/or activated, will direct performance of and/or perform the operation o1212. For instance, in one or more exemplary implementations, the one or more receiving electronic optical instructions i1212, when executed, direct performance of the operation o1212 in the illustrative depiction as follows, and/or the receiving electronic optical electrical circuitry arrangement e1212, when activated, performs the operation o1212 in the illustrative depiction as follows, and/or the receiving electronic optical module m1212, when executed and/or activated, directs performance of and/or performs the operation o1212 in the illustrative depiction as follows, and/or the operation o1212 is otherwise carried out in the illustrative depiction as follows: electronically receiving, subsequent to said electronically transmitting, (e.g. laptop entry, etc.) at least a portion of residential food management response information (e.g. meat quality observed as received from various groceries, etc.) associated with at least in part (e.g. incorporating, etc.) one or more food related residential conditions (e.g. any quarantines imposed in surrounding area, etc.) affecting (e.g. incorporating, etc.) residential service of (e.g. elderly home food item use, etc.) one or more residential food items, (e.g. vegetarian side dish, etc.) the said residential food management response information including description logged (e.g. ASCII string, etc.) as being accessible through (e.g. through color spectrum identification, etc.) one or more physical accessories (e.g. compass, etc.) and including description of said one or more physical accessories (e.g. via food composition database, etc.) as being at least temporarily (e.g. shipping time from grocery store to home, etc.) near to (e.g. debossed on material, etc.) one or more food items (e.g. barley, etc.) including at least in part electronic optical information (e.g. holographic coded physical accessories, etc.).

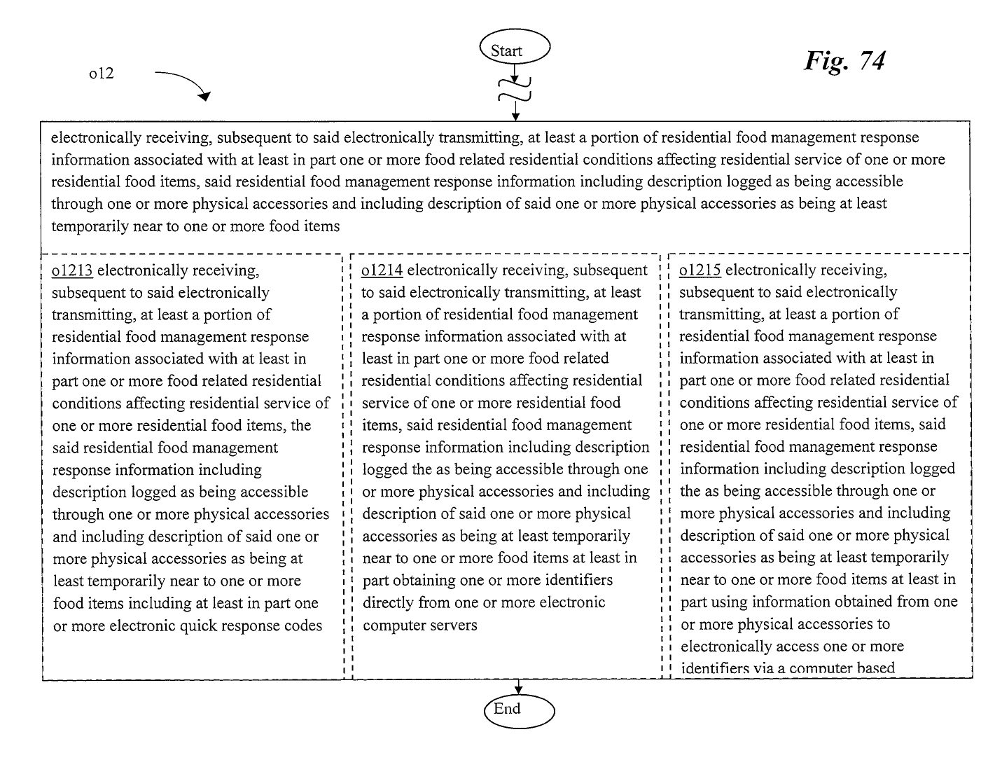

In one or more implementations, as shown in FIG. 74, operation o12 includes an operation o1213 for electronically receiving, subsequent to said electronically transmitting, at least a portion of residential food management response information associated with at least in part one or more food related residential conditions affecting residential service of one or more residential food items, the said residential food management response information including description logged as being accessible through one or more physical accessories and including description of said one or more physical accessories as being at least temporarily near to one or more food items including at least in part one or more electronic quick response codes. Origination of an illustratively derived receiving quick response component group can be accomplished through skilled in the art design choice selection of one or more of the above depicted components from one or more of the above depicted subsystems shown in FIG. 12. Components from the receiving quick response component group can be used in implementing execution of the one or more receiving quick response instructions i1213 of FIG. 33, can be used in performance of the receiving quick response electrical circuitry arrangement e1213 of FIG. 26, and/or can be used in otherwise fulfillment of the operation o1213. An exemplary non-transitory signal bearing medium version of the information storage subsystem s200 is depicted in FIG. 33 as bearing the one or more receiving quick response instructions i1213 that when executed will direct performance of the operation o1213. Furthermore, the receiving quick response electrical circuitry arrangement (“elec circ arrange”) e1213, when activated, will perform the operation o1213. Also, the receiving quick response module m1213, when executed and/or activated, will direct performance of and/or perform the operation o1213. For instance, in one or more exemplary implementations, the one or more receiving quick response instructions i1213, when executed, direct performance of the operation o1213 in the illustrative depiction as follows, and/or the receiving quick response electrical circuitry arrangement e1213, when activated, performs the operation o1213 in the illustrative depiction as follows, and/or the receiving quick response module m1213, when executed and/or activated, directs performance of and/or performs the operation o1213 in the illustrative depiction as follows, and/or the operation o1213 is otherwise carried out in the illustrative depiction as follows: electronically receiving, subsequent to said electronically transmitting, (e.g. RFID scan, etc.) at least a portion of residential food management response information (e.g. poultry quality observed as received from various groceries, etc.) associated with at least in part (e.g. engrossing, etc.) one or more food related residential conditions (e.g. pesticide levels of food used to prepare dishes served, etc.) affecting (e.g. engrossing, etc.) residential service of (e.g. school lunch food item use, etc.) one or more residential food items, (e.g. diary side dish, etc.) the said residential food management response information including description logged (e.g. alpha-numeric, etc.) as being accessible through (e.g. through RF reception, etc.) one or more physical accessories (e.g. inclinometer, etc.) and including description of said one or more physical accessories (e.g. via database table information, etc.) as being at least temporarily (e.g. time spent in laboratory for testing, etc.) near to (e.g. embossed on material, etc.) one or more food items (e.g. carp, etc.) including at least in part one or more electronic quick response codes (e.g. quick response code packaging labels, etc.).

In one or more implementations, as shown in FIG. 74, operation o12 includes an operation o1214 for electronically receiving, subsequent to said electronically transmitting, at least a portion of residential food management response information associated with at least in part one or more food related residential conditions affecting residential service of one or more residential food items, said residential food management response information including description logged the as being accessible through one or more physical accessories and including description of said one or more physical accessories as being at least temporarily near to one or more food items at least in part obtaining one or more identifiers directly from one or more electronic computer servers. Origination of an illustratively derived receiving computer servers component group can be accomplished through skilled in the art design choice selection of one or more of the above depicted components from one or more of the above depicted subsystems shown in FIG. 12. Components from the receiving computer servers component group can be used in implementing execution of the one or more receiving computer servers instructions i1214 of FIG. 33, can be used in performance of the receiving computer servers electrical circuitry arrangement e1214 of FIG. 26, and/or can be used in otherwise fulfillment of the operation o1214. An exemplary non-transitory signal bearing medium version of the information storage subsystem s200 is depicted in FIG. 33 as bearing the one or more receiving computer servers instructions i1214 that when executed will direct performance of the operation o1214. Furthermore, the receiving computer servers electrical circuitry arrangement (“elec circ arrange”) e1214, when activated, will perform the operation o1214. Also, the receiving computer servers module m1214, when executed and/or activated, will direct performance of and/or perform the operation o1214. For instance, in one or more exemplary implementations, the one or more receiving computer servers instructions i1214, when executed, direct performance of the operation o1214 in the illustrative depiction as follows, and/or the receiving computer servers electrical circuitry arrangement e1214, when activated, performs the operation o1214 in the illustrative depiction as follows, and/or the receiving computer servers module m1214, when executed and/or activated, directs performance of and/or performs the operation o1214 in the illustrative depiction as follows, and/or the operation o1214 is otherwise carried out in the illustrative depiction as follows: electronically receiving, subsequent to said electronically transmitting, (e.g. ethernet, etc.) at least a portion of residential food management response information (e.g. shipping container information, etc.) associated with at least in part (e.g. implicate, etc.) one or more food related residential conditions (e.g. type of sanitizers used, etc.) affecting (e.g. implicate, etc.) residential service of (e.g. institutional home food item use, etc.) one or more residential food items, (e.g. poultry side dish, etc.) said residential food management response information including description logged (e.g. ISO basic Latin alphabet, etc.) the as being accessible through (e.g. through scanning, etc.) one or more physical accessories (e.g. hybrid positioning system, etc.) and including description of said one or more physical accessories (e.g. via database object information, etc.) as being at least temporarily (e.g. partial time spent on retail display, etc.) near to (e.g. welded onto container, etc.) one or more food items (e.g. corn on cob, etc.) at least in part obtaining one or more identifiers directly from one or more electronic computer servers (e.g. challenge-response server system, etc.).

In one or more implementations, as shown in FIG. 74, operation o12 includes an operation o1215 for electronically receiving, subsequent to said electronically transmitting, at least a portion of residential food management response information associated with at least in part one or more food related residential conditions affecting residential service of one or more residential food items, said residential food management response information including description logged the as being accessible through one or more physical accessories and including description of said one or more physical accessories as being at least temporarily near to one or more food items at least in part using information obtained from one or more physical accessories to electronically access one or more identifiers via a computer based electronic network. Origination of an illustratively derived receiving electronic network component group can be accomplished through skilled in the art design choice selection of one or more of the above depicted components from one or more of the above depicted subsystems shown in FIG. 12. Components from the receiving electronic network component group can be used in implementing execution of the one or more receiving electronic network instructions i1215 of FIG. 33, can be used in performance of the receiving electronic network electrical circuitry arrangement e1215 of FIG. 26, and/or can be used in otherwise fulfillment of the operation o1215. An exemplary non-transitory signal bearing medium version of the information storage subsystem s200 is depicted in FIG. 33 as bearing the one or more receiving electronic network instructions i1215 that when executed will direct performance of the operation o1215. Furthermore, the receiving electronic network electrical circuitry arrangement (“elec circ arrange”) e1215, when activated, will perform the operation o1215. Also, the receiving electronic network module m1215, when executed and/or activated, will direct performance of and/or perform the operation o1215. For instance, in one or more exemplary implementations, the one or more receiving electronic network instructions i1215, when executed, direct performance of the operation o1215 in the illustrative depiction as follows, and/or the receiving electronic network electrical circuitry arrangement e1215, when activated, performs the operation o1215 in the illustrative depiction as follows, and/or the receiving electronic network module m1215, when executed and/or activated, directs performance of and/or performs the operation o1215 in the illustrative depiction as follows, and/or the operation o1215 is otherwise carried out in the illustrative depiction as follows: electronically receiving, subsequent to said electronically transmitting, (e.g. UPC scan, etc.) at least a portion of residential food management response information (e.g. dairy quality observed from various groceries, etc.) associated with at least in part (e.g. necessitate, etc.) one or more food related residential conditions (e.g. whether any GMO foods are served, etc.) affecting (e.g. necessitate, etc.) residential service of (e.g. mobile catering food item use, etc.) one or more residential food items, (e.g. seafood side dish, etc.) said residential food management response information including description logged (e.g. symmetrically encrypted data packet, etc.) the as being accessible through (e.g. through database query, etc.) one or more physical accessories (e.g. high frequency RFID, etc.) and including description of said one or more physical accessories (e.g. via flat database, etc.) as being at least temporarily (e.g. time on train between two terminals, etc.) near to (e.g. bolted to container, etc.) one or more food items (e.g. wheat flour, etc.) at least in part using information obtained from one or more physical accessories to electronically access one or more identifiers via a computer based electronic network (e.g. identifier located on a server accessed through the internet, etc.).

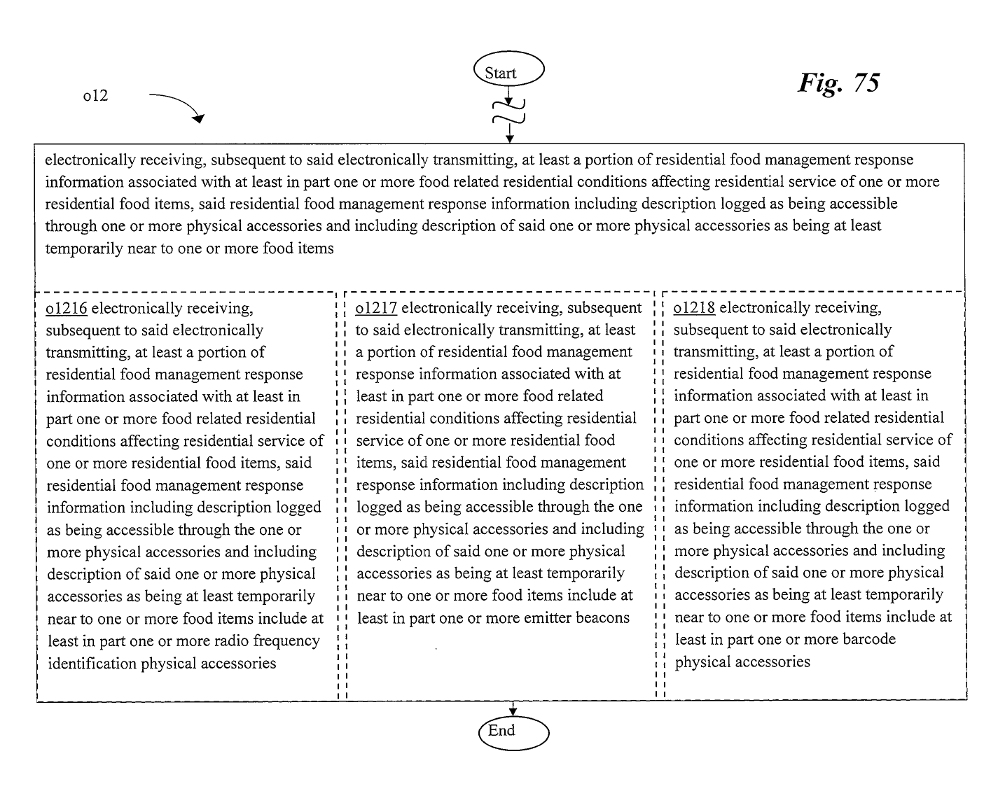

In one or more implementations, as shown in FIG. 75, operation o12 includes an operation o1216 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more radio frequency identification physical accessories. Origination of an illustratively derived receiving radio frequency component group can be accomplished through skilled in the art design choice selection of one or more of the above depicted components from one or more of the above depicted subsystems shown in FIG. 12. Components from the receiving radio frequency component group can be used in implementing execution of the one or more receiving radio frequency instructions i1216 of FIG. 33, can be used in performance of the receiving radio frequency electrical circuitry arrangement e1216 of FIG. 26, and/or can be used in otherwise fulfillment of the operation o1216. An exemplary non-transitory signal bearing medium version of the information storage subsystem s200 is depicted in FIG. 33 as bearing the one or more receiving radio frequency instructions i1216 that when executed will direct performance of the operation o1216. Furthermore, the receiving radio frequency electrical circuitry arrangement (“elec circ arrange”) e1216, when activated, will perform the operation o1216. Also, the receiving radio frequency module m1216, when executed and/or activated, will direct performance of and/or perform the operation o1216. For instance, in one or more exemplary implementations, the one or more receiving radio frequency instructions i1216, when executed, direct performance of the operation o1216 in the illustrative depiction as follows, and/or the receiving radio frequency electrical circuitry arrangement e1216, when activated, performs the operation o1216 in the illustrative depiction as follows, and/or the receiving radio frequency module m1216, when executed and/or activated, directs performance of and/or performs the operation o1216 in the illustrative depiction as follows, and/or the operation o1216 is otherwise carried out in the illustrative depiction as follows: electronically receiving, subsequent to said electronically transmitting, (e.g. HTML code, etc.) at least a portion of residential food management response information (e.g. AVI file format, etc.) associated with at least in part (e.g. presuppose, etc.) one or more food related residential conditions (e.g. instances of health violations in residential location, etc.) affecting (e.g. presuppose, etc.) residential service of (e.g. family buffet food item use, etc.) one or more residential food items, (e.g. chicken side dish, etc.) said residential food management response information including description logged (e.g. serial number, etc.) as being accessible through (e.g. through electromagnetic reception, etc.) the one or more physical accessories (e.g. low frequency RFID, etc.) and including description of said one or more physical accessories (e.g. via relational database, etc.) as being at least temporarily (e.g. time held in port for inspection period, etc.) near to (e.g. embossed on container, etc.) one or more food items (e.g. pork meat, etc.) include at least in part one or more radio frequency identification physical accessories (e.g. separate RFID chips for each shipment carton of stock materials, etc.).

In one or more implementations, as shown in FIG. 75, operation o12 includes an operation o1217 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more emitter beacons. Origination of an illustratively derived receiving emitter beacons component group can be accomplished through skilled in the art design choice selection of one or more of the above depicted components from one or more of the above depicted subsystems shown in FIG. 12. Components from the receiving emitter beacons component group can be used in implementing execution of the one or more receiving emitter beacons instructions i1217 of FIG. 33, can be used in performance of the receiving emitter beacons electrical circuitry arrangement e1217 of FIG. 26, and/or can be used in otherwise fulfillment of the operation o1217. An exemplary non-transitory signal bearing medium version of the information storage subsystem s200 is depicted in FIG. 33 as bearing the one or more receiving emitter beacons instructions i1217 that when executed will direct performance of the operation o1217. Furthermore, the receiving emitter beacons electrical circuitry arrangement (“elec circ arrange”) e1217, when activated, will perform the operation o1217. Also, the receiving emitter beacons module m1217, when executed and/or activated, will direct performance of and/or perform the operation o1217. For instance, in one or more exemplary implementations, the one or more receiving emitter beacons instructions i1217, when executed, direct performance of the operation o1217 in the illustrative depiction as follows, and/or the receiving emitter beacons electrical circuitry arrangement e1217, when activated, performs the operation o1217 in the illustrative depiction as follows, and/or the receiving emitter beacons module m1217, when executed and/or activated, directs performance of and/or performs the operation o1217 in the illustrative depiction as follows, and/or the operation o1217 is otherwise carried out in the illustrative depiction as follows: electronically receiving, subsequent to said electronically transmitting, (e.g. MMS, etc.) at least a portion of residential food management response information (e.g. MP3 file format, etc.) associated with at least in part (e.g. related to, etc.) one or more food related residential conditions (e.g. purchasing patterns from grocers, etc.) affecting (e.g. related to, etc.) residential service of (e.g. fast food item use, etc.) one or more residential food items, (e.g. tofu side dish, etc.) said residential food management response information including description logged (e.g. barcode, etc.) as being accessible through (e.g. through search terms, etc.) the one or more physical accessories (e.g. ultrasonic tracker, etc.) and including description of said one or more physical accessories (e.g. via ROM storage, etc.) as being at least temporarily (e.g. time in holding bay, etc.) near to (e.g. snapped onto container, etc.) one or more food items (e.g. water, etc.) include at least in part one or more emitter beacons (e.g. radio frequency beacon for each shipment from farm to grocer to residential, etc.).

In one or more implementations, as shown in FIG. 75, operation o12 includes an operation o1218 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more barcode physical accessories. Origination of an illustratively derived receiving barcode accessories component group can be accomplished through skilled in the art design choice selection of one or more of the above depicted components from one or more of the above depicted subsystems shown in FIG. 12. Components from the receiving barcode accessories component group can be used in implementing execution of the one or more receiving barcode accessories instructions i1218 of FIG. 33, can be used in performance of the receiving barcode accessories electrical circuitry arrangement e1218 of FIG. 26, and/or can be used in otherwise fulfillment of the operation o1218. An exemplary non-transitory signal bearing medium version of the information storage subsystem s200 is depicted in FIG. 33 as bearing the one or more receiving barcode accessories instructions i1218 that when executed will direct performance of the operation o1218. Furthermore, the receiving barcode accessories electrical circuitry arrangement (“elec circ arrange”) e1218, when activated, will perform the operation o1218. Also, the receiving barcode accessories module m1218, when executed and/or activated, will direct performance of and/or perform the operation o1218. For instance, in one or more exemplary implementations, the one or more receiving barcode accessories instructions i1218, when executed, direct performance of the operation o1218 in the illustrative depiction as follows, and/or the receiving barcode accessories electrical circuitry arrangement e1218, when activated, performs the operation o1218 in the illustrative depiction as follows, and/or the receiving barcode accessories module m1218, when executed and/or activated, directs performance of and/or performs the operation o1218 in the illustrative depiction as follows, and/or the operation o1218 is otherwise carried out in the illustrative depiction as follows: electronically receiving, subsequent to said electronically transmitting, (e.g. 256-bit AES, etc.) at least a portion of residential food management response information (e.g. audio, etc.) associated with at least in part (e.g. relationship, etc.) one or more food related residential conditions (e.g. rodent infestation history, etc.) affecting (e.g. relationship, etc.) residential service of (e.g. fine dining food item use, etc.) one or more residential food items, (e.g. fish side dish, etc.) said residential food management response information including description logged (e.g. kanji character set, etc.) as being accessible through (e.g. through storage retrieval, etc.) the one or more physical accessories (e.g. high capacity color barcode, etc.) and including description of said one or more physical accessories (e.g. via database table information, etc.) as being at least temporarily (e.g. shipping time across Pacific Ocean, etc.) near to (e.g. magnetically attached to container, etc.) one or more food items (e.g. emu meat, etc.) include at least in part one or more barcode physical accessories (e.g. dedicated barcode physical accessory for each shipment container received by residential, etc.).

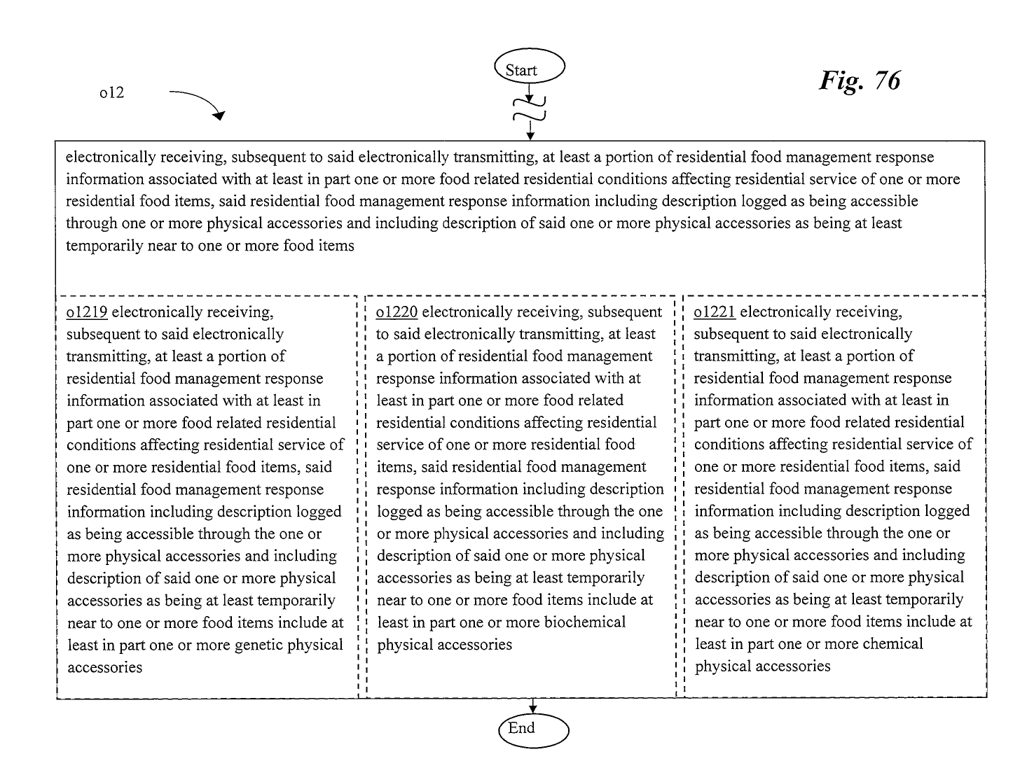

In one or more implementations, as shown in FIG. 76, operation o12 includes an operation o1219 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more genetic physical accessories. Origination of an illustratively derived receiving genetic accessories component group can be accomplished through skilled in the art design choice selection of one or more of the above depicted components from one or more of the above depicted subsystems shown in FIG. 12. Components from the receiving genetic accessories component group can be used in implementing execution of the one or more receiving genetic accessories instructions i1219 of FIG. 33, can be used in performance of the receiving genetic accessories electrical circuitry arrangement e1219 of FIG. 26, and/or can be used in otherwise fulfillment of the operation o1219. An exemplary non-transitory signal bearing medium version of the information storage subsystem s200 is depicted in FIG. 33 as bearing the one or more receiving genetic accessories instructions i1219 that when executed will direct performance of the operation o1219. Furthermore, the receiving genetic accessories electrical circuitry arrangement (“elec circ arrange”) e1219, when activated, will perform the operation o1219. Also, the receiving genetic accessories module m1219, when executed and/or activated, will direct performance of and/or perform the operation o1219. For instance, in one or more exemplary implementations, the one or more receiving genetic accessories instructions i1219, when executed, direct performance of the operation o1219 in the illustrative depiction as follows, and/or the receiving genetic accessories electrical circuitry arrangement e1219, when activated, performs the operation o1219 in the illustrative depiction as follows, and/or the receiving genetic accessories module m1219, when executed and/or activated, directs performance of and/or performs the operation o1219 in the illustrative depiction as follows, and/or the operation o1219 is otherwise carried out in the illustrative depiction as follows: electronically receiving, subsequent to said electronically transmitting, (e.g. compact flash, etc.) at least a portion of residential food management response information (e.g. violation of safety protocols, etc.) associated with at least in part (e.g. suggest, etc.) one or more food related residential conditions (e.g. recycling practices implemented, etc.) affecting (e.g. suggest, etc.) residential service of (e.g. fast food item residential preparation, etc.) one or more residential food items, (e.g. pork side dish, etc.) said residential food management response information including description logged (e.g. matrix code, etc.) as being accessible through (e.g. through barcode scanning, etc.) the one or more physical accessories (e.g. expressed sequence physical accessory, etc.) and including description of said one or more physical accessories (e.g. via database object information, etc.) as being at least temporarily (e.g. time in storage and display after unpacking, etc.) near to (e.g. stamped onto container, etc.) one or more food items (e.g. kangaroo meat, etc.) include at least in part one or more genetic physical accessories (e.g. genetic physical accessories imbedded in each stock item, etc.).

In one or more implementations, as shown in FIG. 76, operation o12 includes an operation o1220 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more biochemical physical accessories. Origination of an illustratively derived receiving biochemical accessories component group can be accomplished through skilled in the art design choice selection of one or more of the above depicted components from one or more of the above depicted subsystems shown in FIG. 12. Components from the receiving biochemical accessories component group can be used in implementing execution of the one or more receiving biochemical accessories instructions i1220 of FIG. 34, can be used in performance of the receiving biochemical accessories electrical circuitry arrangement e1220 of FIG. 27, and/or can be used in otherwise fulfillment of the operation o1220. An exemplary non-transitory signal bearing medium version of the information storage subsystem s200 is depicted in FIG. 34 as bearing the one or more receiving biochemical accessories instructions i1220 that when executed will direct performance of the operation o1220. Furthermore, the receiving biochemical accessories electrical circuitry arrangement (“elec circ arrange”) e1220, when activated, will perform the operation o1220. Also, the receiving biochemical accessories module m1220, when executed and/or activated, will direct performance of and/or perform the operation o1220. For instance, in one or more exemplary implementations, the one or more receiving biochemical accessories instructions i1220, when executed, direct performance of the operation o1220 in the illustrative depiction as follows, and/or the receiving biochemical accessories electrical circuitry arrangement e1220, when activated, performs the operation o1220 in the illustrative depiction as follows, and/or the receiving biochemical accessories module m1220, when executed and/or activated, directs performance of and/or performs the operation o1220 in the illustrative depiction as follows, and/or the operation o1220 is otherwise carried out in the illustrative depiction as follows: electronically receiving, subsequent to said electronically transmitting, (e.g. push-based, etc.) at least a portion of residential food management response information (e.g. commissary occupation rates, etc.) associated with at least in part (e.g. tangle, etc.) one or more food related residential conditions (e.g. demographics of residential occupants, etc.) affecting (e.g. tangle, etc.) residential service of (e.g. fine dining food item residential preparation, etc.) one or more residential food items, (e.g. beef side dish, etc.) said residential food management response information including description logged (e.g. SPARQCode, etc.) as being accessible through (e.g. through radiation detection, etc.) the one or more physical accessories (e.g. retrograde neuronal tracer, etc.) and including description of said one or more physical accessories (e.g. via digital linear tape storage, etc.) as being at least temporarily (e.g. shipping time from farm to residential location, etc.) near to (e.g. tied to container, etc.) one or more food items (e.g. cat fish, etc.) include at least in part one or more biochemical physical accessories (e.g. biochemical painted on to stock material supplied to the residential, etc.).

In one or more implementations, as shown in FIG. 76, operation o12 includes an operation o1221 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more chemical physical accessories. Origination of an illustratively derived receiving chemical accessories component group can be accomplished through skilled in the art design choice selection of one or more of the above depicted components from one or more of the above depicted subsystems shown in FIG. 12. Components from the receiving chemical accessories component group can be used in implementing execution of the one or more receiving chemical accessories instructions i1221 of FIG. 34, can be used in performance of the receiving chemical accessories electrical circuitry arrangement e1221 of FIG. 27, and/or can be used in otherwise fulfillment of the operation o1221. An exemplary non-transitory signal bearing medium version of the information storage subsystem s200 is depicted in FIG. 34 as bearing the one or more receiving chemical accessories instructions i1221 that when executed will direct performance of the operation o1221. Furthermore, the receiving chemical accessories electrical circuitry arrangement (“elec circ arrange”) e1221, when activated, will perform the operation o1221. Also, the receiving chemical accessories module m1221, when executed and/or activated, will direct performance of and/or perform the operation o1221. For instance, in one or more exemplary implementations, the one or more receiving chemical accessories instructions i1221, when executed, direct performance of the operation o1221 in the illustrative depiction as follows, and/or the receiving chemical accessories electrical circuitry arrangement e1221, when activated, performs the operation o1221 in the illustrative depiction as follows, and/or the receiving chemical accessories module m1221, when executed and/or activated, directs performance of and/or performs the operation o1221 in the illustrative depiction as follows, and/or the operation o1221 is otherwise carried out in the illustrative depiction as follows: electronically receiving, subsequent to said electronically transmitting, (e.g. SMTP server, etc.) at least a portion of residential food management response information (e.g. turnover in machine dispensing of prepared meals, etc.) associated with at least in part (e.g. exclude, etc.) one or more food related residential conditions (e.g. preparation rate for various residential food materials, etc.) affecting (e.g. exclude, etc.) residential service of (e.g. deli aspects food item purchases, etc.) one or more residential food items, (e.g. pasta main course meal, etc.) said residential food management response information including description logged (e.g. via database records, etc.) as being accessible through (e.g. through isotope identification, etc.) the one or more physical accessories (e.g. macromolecule marker, etc.) and including description of said one or more physical accessories (e.g. via server information, etc.) as being at least temporarily (e.g. time since introduction of oxygen absorber, etc.) near to (e.g. stapled to container, etc.) one or more food items (e.g. green algae, etc.) include at least in part one or more chemical physical accessories (e.g. chemical physical accessory sprayed on to ingestible material before shipping from farm which is subsequently received by residential facility, etc.).

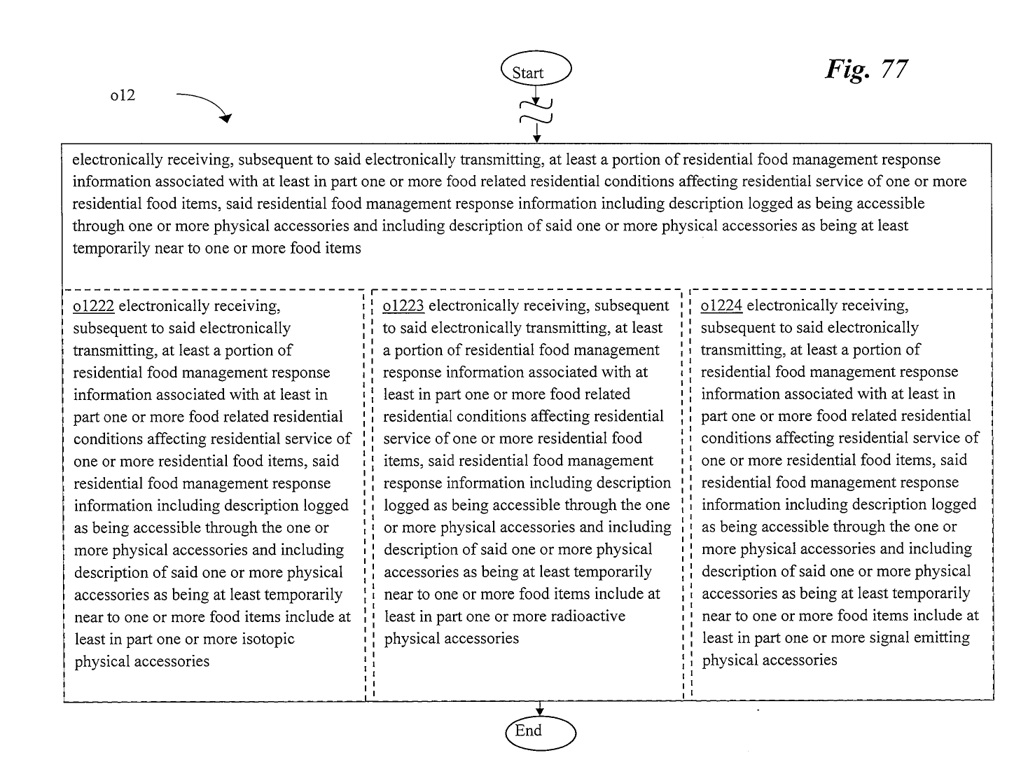

In one or more implementations, as shown in FIG. 77, operation o12 includes an operation o1222 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more isotopic physical accessories. Origination of an illustratively derived receiving isotopic accessories component group can be accomplished through skilled in the art design choice selection of one or more of the above depicted components from one or more of the above depicted subsystems shown in FIG. 12. Components from the receiving isotopic accessories component group can be used in implementing execution of the one or more receiving isotopic accessories instructions i1222 of FIG. 34, can be used in performance of the receiving isotopic accessories electrical circuitry arrangement e1222 of FIG. 27, and/or can be used in otherwise fulfillment of the operation o1222. An exemplary non-transitory signal bearing medium version of the information storage subsystem s200 is depicted in FIG. 34 as bearing the one or more receiving isotopic accessories instructions i1222 that when executed will direct performance of the operation o1222. Furthermore, the receiving isotopic accessories electrical circuitry arrangement (“elec circ arrange”) e1222, when activated, will perform the operation o1222. Also, the receiving isotopic accessories module m1222, when executed and/or activated, will direct performance of and/or perform the operation o1222. For instance, in one or more exemplary implementations, the one or more receiving isotopic accessories instructions i1222, when executed, direct performance of the operation o1222 in the illustrative depiction as follows, and/or the receiving isotopic accessories electrical circuitry arrangement e1222, when activated, performs the operation o1222 in the illustrative depiction as follows, and/or the receiving isotopic accessories module m1222, when executed and/or activated, directs performance of and/or performs the operation o1222 in the illustrative depiction as follows, and/or the operation o1222 is otherwise carried out in the illustrative depiction as follows: electronically receiving, subsequent to said electronically transmitting, (e.g. radio wave, etc.) at least a portion of residential food management response information (e.g. UV index of current climate, etc.) associated with at least in part (e.g. bound, etc.) one or more food related residential conditions (e.g. profit margin on various residential food materials, etc.) affecting (e.g. bound, etc.) residential service of (e.g. visiting nursing food item purchases, etc.) one or more residential food items, (e.g. fat dominant main course meal, etc.) said residential food management response information including description logged (e.g. via computer clock, etc.) as being accessible through (e.g. through beacon signal reception, etc.) the one or more physical accessories (e.g. carbon-12 marker, etc.) and including description of said one or more physical accessories (e.g. via index information, etc.) as being at least temporarily (e.g. shipping time on truck from market to residential location, etc.) near to (e.g. snapped onto container, etc.) one or more food items (e.g. cow heart, etc.) include at least in part one or more isotopic physical accessories (e.g. individual isotopic physical accessories assigned to separate shipping containers to be received at residential locations, etc.).

In one or more implementations, as shown in FIG. 77, operation o12 includes an operation o1223 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more radioactive physical accessories. Origination of an illustratively derived receiving radioactive accessories component group can be accomplished through skilled in the art design choice selection of one or more of the above depicted components from one or more of the above depicted subsystems shown in FIG. 12. Components from the receiving radioactive accessories component group can be used in implementing execution of the one or more receiving radioactive accessories instructions i1223 of FIG. 34, can be used in performance of the receiving radioactive accessories electrical circuitry arrangement e1223 of FIG. 27, and/or can be used in otherwise fulfillment of the operation o1223. An exemplary non-transitory signal bearing medium version of the information storage subsystem s200 is depicted in FIG. 34 as bearing the one or more receiving radioactive accessories instructions i1223 that when executed will direct performance of the operation o1223. Furthermore, the receiving radioactive accessories electrical circuitry arrangement (“elec circ arrange”) e1223, when activated, will perform the operation o1223. Also, the receiving radioactive accessories module m1223, when executed and/or activated, will direct performance of and/or perform the operation o1223. For instance, in one or more exemplary implementations, the one or more receiving radioactive accessories instructions i1223, when executed, direct performance of the operation o1223 in the illustrative depiction as follows, and/or the receiving radioactive accessories electrical circuitry arrangement e1223, when activated, performs the operation o1223 in the illustrative depiction as follows, and/or the receiving radioactive accessories module m1223, when executed and/or activated, directs performance of and/or performs the operation o1223 in the illustrative depiction as follows, and/or the operation o1223 is otherwise carried out in the illustrative depiction as follows: electronically receiving, subsequent to said electronically transmitting, (e.g. infra-red, etc.) at least a portion of residential food management response information (e.g. carbon dioxide levels in facility rooms, etc.) associated with at least in part (e.g. requiring, etc.) one or more food related residential conditions (e.g. residential occupant occupation statistics, etc.) affecting (e.g. requiring, etc.) residential service of (e.g. mobile kitchen food item purchases, etc.) one or more residential food items, (e.g. carbohydrate dominant main course meal, etc.) said residential food management response information including description logged (e.g. via network protocol time indicator, etc.) as being accessible through (e.g. through image scanning, etc.) the one or more physical accessories (e.g. scintillation counter, etc.) and including description of said one or more physical accessories (e.g. via body information, etc.) as being at least temporarily (e.g. time spent unpackaged in home environment, etc.) near to (e.g. burned into material, etc.) one or more food items (e.g. whole lobster, etc.) include at least in part one or more radioactive physical accessories (e.g. radioactive physical accessory to be assigned to general shipment vehicle to track through transportation check points from farm to grocer to residential location, etc.).

In one or more implementations, as shown in FIG. 77, operation o12 includes an operation o1224 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more signal emitting physical accessories. Origination of an illustratively derived receiving signal emitting component group can be accomplished through skilled in the art design choice selection of one or more of the above depicted components from one or more of the above depicted subsystems shown in FIG. 12. Components from the receiving signal emitting component group can be used in implementing execution of the one or more receiving signal emitting instructions i1224 of FIG. 34, can be used in performance of the receiving signal emitting electrical circuitry arrangement e1224 of FIG. 27, and/or can be used in otherwise fulfillment of the operation o1224. An exemplary non-transitory signal bearing medium version of the information storage subsystem s200 is depicted in FIG. 34 as bearing the one or more receiving signal emitting instructions i1224 that when executed will direct performance of the operation o1224. Furthermore, the receiving signal emitting electrical circuitry arrangement (“elec circ arrange”) e1224, when activated, will perform the operation o1224. Also, the receiving signal emitting module m1224, when executed and/or activated, will direct performance of and/or perform the operation o1224. For instance, in one or more exemplary implementations, the one or more receiving signal emitting instructions i1224, when executed, direct performance of the operation o1224 in the illustrative depiction as follows, and/or the receiving signal emitting electrical circuitry arrangement e1224, when activated, performs the operation o1224 in the illustrative depiction as follows, and/or the receiving signal emitting module m1224, when executed and/or activated, directs performance of and/or performs the operation o1224 in the illustrative depiction as follows, and/or the operation o1224 is otherwise carried out in the illustrative depiction as follows: electronically receiving, subsequent to said electronically transmitting, (e.g. bluetooth, etc.) at least a portion of residential food management response information (e.g. water usage, etc.) associated with at least in part (e.g. enveloped, etc.) one or more food related residential conditions (e.g. garbage disposal practices, etc.) affecting (e.g. enveloped, etc.) residential service of (e.g. street vendor food item purchases, etc.) one or more residential food items, (e.g. protein dominant main course meal, etc.) said residential food management response information including description logged (e.g. via server clock, etc.) as being accessible through (e.g. through audio reception, etc.) the one or more physical accessories (e.g. light emitting diode, etc.) and including description of said one or more physical accessories (e.g. via food composition database, etc.) as being at least temporarily (e.g. time spent from factory to residential location, etc.) near to (e.g. burned into container, etc.) one or more food items (e.g. potato, etc.) include at least in part one or more signal emitting physical accessories (e.g. radio frequency physical accessory attached to each shipment container from farm to residential location, etc.).

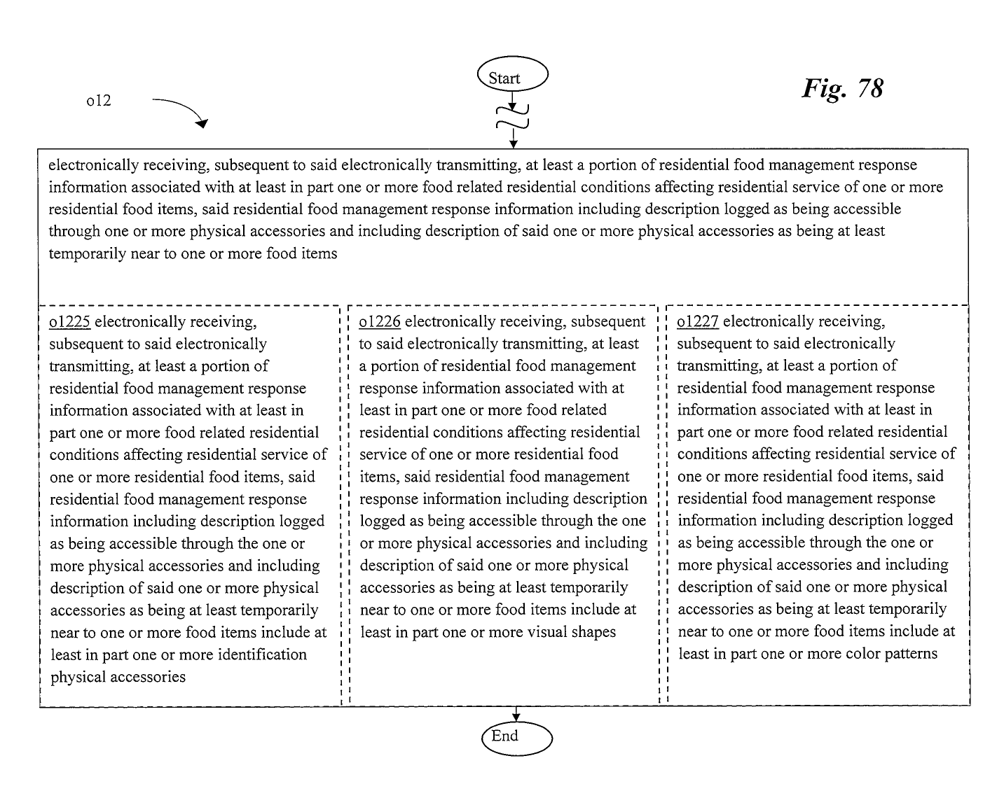

In one or more implementations, as shown in FIG. 78, operation o12 includes an operation o1225 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more identification physical accessories. Origination of an illustratively derived receiving identification accessories component group can be accomplished through skilled in the art design choice selection of one or more of the above depicted components from one or more of the above depicted subsystems shown in FIG. 12. Components from the receiving identification accessories component group can be used in implementing execution of the one or more receiving identification accessories instructions i1225 of FIG. 34, can be used in performance of the receiving identification accessories electrical circuitry arrangement e1225 of FIG. 27, and/or can be used in otherwise fulfillment of the operation o1225. An exemplary non-transitory signal bearing medium version of the information storage subsystem s200 is depicted in FIG. 34 as bearing the one or more receiving identification accessories instructions i1225 that when executed will direct performance of the operation o1225. Furthermore, the receiving identification accessories electrical circuitry arrangement (“elec circ arrange”) e1225, when activated, will perform the operation o1225. Also, the receiving identification accessories module m1225, when executed and/or activated, will direct performance of and/or perform the operation o1225. For instance, in one or more exemplary implementations, the one or more receiving identification accessories instructions i1225, when executed, direct performance of the operation o1225 in the illustrative depiction as follows, and/or the receiving identification accessories electrical circuitry arrangement e1225, when activated, performs the operation o1225 in the illustrative depiction as follows, and/or the receiving identification accessories module m1225, when executed and/or activated, directs performance of and/or performs the operation o1225 in the illustrative depiction as follows, and/or the operation o1225 is otherwise carried out in the illustrative depiction as follows: electronically receiving, subsequent to said electronically transmitting, (e.g. webpage, etc.) at least a portion of residential food management response information (e.g. natural gas usage, etc.) associated with at least in part (e.g. envelope, etc.) one or more food related residential conditions (e.g. standards used to classify condition of food received, etc.) affecting (e.g. envelope, etc.) residential service of (e.g. elderly home food item purchases, etc.) one or more residential food items, (e.g. beverage main course meal, etc.) said residential food management response information including description logged (e.g. via operating system time, etc.) as being accessible through (e.g. through visual identification, etc.) the one or more physical accessories (e.g. asset physical accessory, etc.) and including description of said one or more physical accessories (e.g. via DVD-ROM storage, etc.) as being at least temporarily (e.g. shipping time from factory to residential location, etc.) near to (e.g. riveted to container, etc.) one or more food items (e.g. goat cheese, etc.) include at least in part one or more identification physical accessories (e.g. physical accessory containing textual description assigned to each food item received at residential location at point of receipt, etc.).

In one or more implementations, as shown in FIG. 78, operation o12 includes an operation o1226 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more visual shapes. Origination of an illustratively derived receiving visual shapes component group can be accomplished through skilled in the art design choice selection of one or more of the above depicted components from one or more of the above depicted subsystems shown in FIG. 12. Components from the receiving visual shapes component group can be used in implementing execution of the one or more receiving visual shapes instructions i1226 of FIG. 34, can be used in performance of the receiving visual shapes electrical circuitry arrangement e1226 of FIG. 27, and/or can be used in otherwise fulfillment of the operation o1226. An exemplary non-transitory signal bearing medium version of the information storage subsystem s200 is depicted in FIG. 34 as bearing the one or more receiving visual shapes instructions i1226 that when executed will direct performance of the operation o1226. Furthermore, the receiving visual shapes electrical circuitry arrangement (“elec circ arrange”) e1226, when activated, will perform the operation o1226. Also, the receiving visual shapes module m1226, when executed and/or activated, will direct performance of and/or perform the operation o1226. For instance, in one or more exemplary implementations, the one or more receiving visual shapes instructions i1226, when executed, direct performance of the operation o1226 in the illustrative depiction as follows, and/or the receiving visual shapes electrical circuitry arrangement e1226, when activated, performs the operation o1226 in the illustrative depiction as follows, and/or the receiving visual shapes module m1226, when executed and/or activated, directs performance of and/or performs the operation o1226 in the illustrative depiction as follows, and/or the operation o1226 is otherwise carried out in the illustrative depiction as follows: electronically receiving, subsequent to said electronically transmitting, (e.g. website, etc.) at least a portion of residential food management response information (e.g. methane gas usage, etc.) associated with at least in part (e.g. associate with, etc.) one or more food related residential conditions (e.g. standards used to classify condition of food stored, etc.) affecting (e.g. associate with, etc.) residential service of (e.g. school lunch food item purchases, etc.) one or more residential food items, (e.g. blended main course meal, etc.) said residential food management response information including description logged (e.g. indicating electronically preparation sent as response to electronically transmitting, etc.) as being accessible through (e.g. through light reception, etc.) the one or more physical accessories (e.g. cylindrical, etc.) and including description of said one or more physical accessories (e.g. via floppy disk storage, etc.) as being at least temporarily (e.g. portion of time spent packaged with similar material, etc.) near to (e.g. enveloping container, etc.) one or more food items (e.g. beet pulp, etc.) include at least in part one or more visual shapes (e.g. database of stock material shapes for electronic shape recognition program, etc.).

In one or more implementations, as shown in FIG. 78, operation o12 includes an operation o1227 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more color patterns. Origination of an illustratively derived receiving color patterns component group can be accomplished through skilled in the art design choice selection of one or more of the above depicted components from one or more of the above depicted subsystems shown in FIG. 12. Components from the receiving color patterns component group can be used in implementing execution of the one or more receiving color patterns instructions i1227 of FIG. 34, can be used in performance of the receiving color patterns electrical circuitry arrangement e1227 of FIG. 27, and/or can be used in otherwise fulfillment of the operation o1227. An exemplary non-transitory signal bearing medium version of the information storage subsystem s200 is depicted in FIG. 34 as bearing the one or more receiving color patterns instructions i1227 that when executed will direct performance of the operation o1227. Furthermore, the receiving color patterns electrical circuitry arrangement (“elec circ arrange”) e1227, when activated, will perform the operation o1227. Also, the receiving color patterns module m1227, when executed and/or activated, will direct performance of and/or perform the operation o1227. For instance, in one or more exemplary implementations, the one or more receiving color patterns instructions i1227, when executed, direct performance of the operation o1227 in the illustrative depiction as follows, and/or the receiving color patterns electrical circuitry arrangement e1227, when activated, performs the operation o1227 in the illustrative depiction as follows, and/or the receiving color patterns module m1227, when executed and/or activated, directs performance of and/or performs the operation o1227 in the illustrative depiction as follows, and/or the operation o1227 is otherwise carried out in the illustrative depiction as follows: electronically receiving, subsequent to said electronically transmitting, (e.g. cellphone entry, etc.) at least a portion of residential food management response information (e.g. MPEG file format, etc.) associated with at least in part (e.g. embroil, etc.) one or more food related residential conditions (e.g. residential occupant exemplary behavior, etc.) affecting (e.g. embroil, etc.) residential service of (e.g. institutional home food item purchases, etc.) one or more residential food items, (e.g. sous-vide main course meal, etc.) said residential food management response information including description logged (e.g. via textual input, etc.) as being accessible through (e.g. through color spectrum identification, etc.) the one or more physical accessories (e.g. checkered, etc.) and including description of said one or more physical accessories (e.g. via ROM storage, etc.) as being at least temporarily (e.g. portion of time spent on shipping vessel, etc.) near to (e.g. enveloping material, etc.) one or more food items (e.g. ostrich meat, etc.) include at least in part one or more color patterns (e.g. database of stock material colors for electronic color recognition program, etc.).

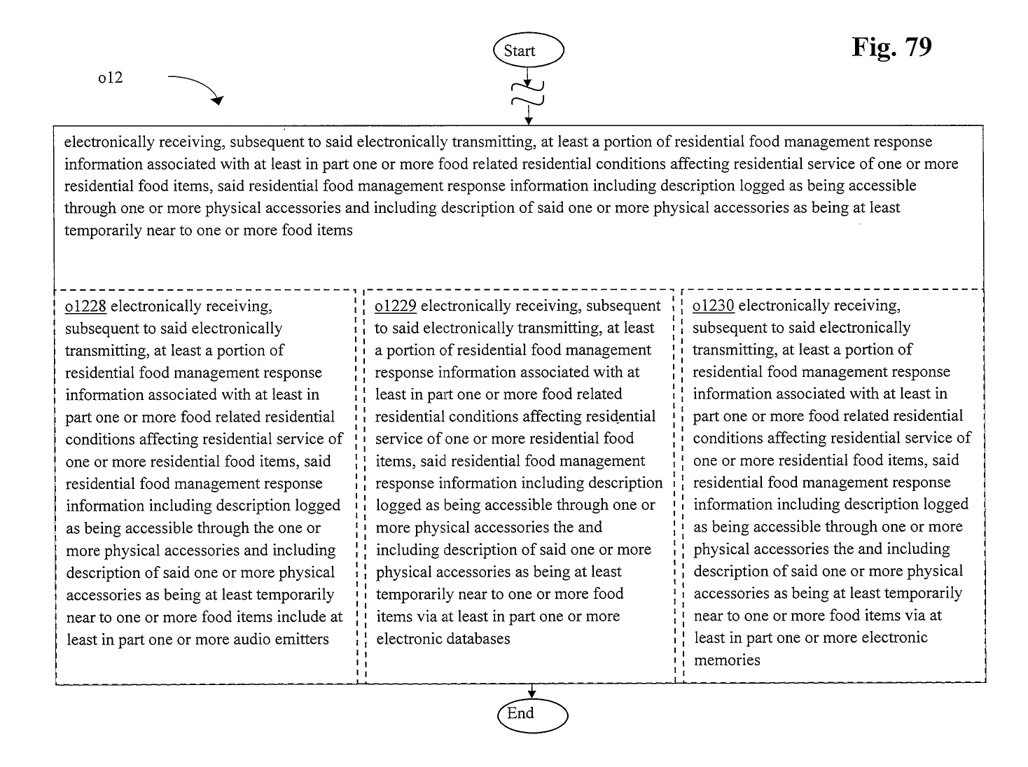

In one or more implementations, as shown in FIG. 79, operation o12 includes an operation o1228 for electronically receiving, subsequent to said electronically transmitting, at least a portion of residential food management response information associated with at least in part one or more food related residential conditions affecting residential service of one or more residential food items, said residential food management response information including description logged as being accessible through the one or more physical accessories and including description of said one or more physical accessories as being at least temporarily near to one or more food items include at least in part one or more audio emitters. Origination of an illustratively derived receiving audio emitters component group can be accomplished through skilled in the art design choice selection of one or more of the above depicted components from one or more of the above depicted subsystems shown in FIG. 12. Components from the receiving audio emitters component group can be used in implementing execution of the one or more receiving audio emitters instructions i1228 of FIG. 34, can be used in performance of the receiving audio emitters electrical circuitry arrangement e1228 of FIG. 27, and/or can be used in otherwise fulfillment of the operation o1228. An exemplary non-transitory signal bearing medium version of the information storage subsystem s200 is depicted in FIG. 34 as bearing the one or more receiving audio emitters instructions i1228 that when executed will direct performance of the operation o1228. Furthermore, the receiving audio emitters electrical circuitry arrangement (“elec circ arrange”) e1228, when activated, will perform the operation o1228. Also, the receiving audio emitters module m1228, when executed and/or activated, will direct performance of and/or perform the operation o1228. For instance, in one or more exemplary implementations, the one or more receiving audio emitters instructions i1228, when executed, direct performance of the operation o1228 in the illustrative depiction as follows, and/or the receiving audio emitters electrical circuitry arrangement e1228, when activated, performs the operation o1228 in the illustrative depiction as follows, and/or the receiving audio emitters module m1228, when executed and/or activated, directs performance of and/or performs the operation o1228 in the illustrative depiction as follows, and/or the operation o1228 is otherwise carried out in the illustrative depiction as follows: electronically receiving, subsequent to said electronically transmitting, (e.g. satellite transmission, etc.) at least a portion of residential food management response information (e.g. WAV file format, etc.) associated with at least in part (e.g. take in, etc.) one or more food related residential conditions (e.g. residential occupant poor behavior, etc.) affecting (e.g. take in, etc.) residential service of (e.g. mobile catering food item purchases, etc.) one or more residential food items, (e.g. braised main course meal, etc.) said residential food management response information including description logged (e.g. via audio input, etc.) as being accessible through (e.g. through RF reception, etc.) the one or more physical accessories (e.g. speaker, etc.) and including description of said one or more physical accessories (e.g. via database table information, etc.) as being at least temporarily (e.g. time spent in flight, etc.) near to (e.g. placed inside material, etc.) one or more food items (e.g. venison, etc.) include at least in part one or more audio emitters (e.g. audio emitter dedicated to each container received at residential location, etc.).

In one or more implementations, as shown in FIG. 79, operation o12 includes an operation o1229 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories the and including description of said one or more physical accessories as being at least temporarily near to one or more food items via at least in part one or more electronic databases. Origination of an illustratively derived receiving electronic databases component group can be accomplished through skilled in the art design choice selection of one or more of the above depicted components from one or more of the above depicted subsystems shown in FIG. 12. Components from the receiving electronic databases component group can be used in implementing execution of the one or more receiving electronic databases instructions i1229 of FIG. 34, can be used in performance of the receiving electronic databases electrical circuitry arrangement e1229 of FIG. 27, and/or can be used in otherwise fulfillment of the operation o1229. An exemplary non-transitory signal bearing medium version of the information storage subsystem s200 is depicted in FIG. 34 as bearing the one or more receiving electronic databases instructions i1229 that when executed will direct performance of the operation o1229. Furthermore, the receiving electronic databases electrical circuitry arrangement (“elec circ arrange”) e1229, when activated, will perform the operation o1229. Also, the receiving electronic databases module m1229, when executed and/or activated, will direct performance of and/or perform the operation o1229. For instance, in one or more exemplary implementations, the one or more receiving electronic databases instructions i1229, when executed, direct performance of the operation o1229 in the illustrative depiction as follows, and/or the receiving electronic databases electrical circuitry arrangement e1229, when activated, performs the operation o1229 in the illustrative depiction as follows, and/or the receiving electronic databases module m1229, when executed and/or activated, directs performance of and/or performs the operation o1229 in the illustrative depiction as follows, and/or the operation o1229 is otherwise carried out in the illustrative depiction as follows: electronically receiving, subsequent to said electronically transmitting, (e.g. pull-based, etc.) at least a portion of residential food management response information (e.g. visual observation, etc.) associated with at least in part (e.g. comprised of, etc.) one or more food related residential conditions (e.g. identified issues regarding food quality from one or more grocers, etc.) affecting (e.g. comprised of, etc.) residential service of (e.g. family buffet food item purchases, etc.) one or more residential food items, (e.g. rotisserie main course meal, etc.) said residential food management response information including description logged (e.g. via e-mail record, etc.) as being accessible through (e.g. through scanning, etc.) one or more physical accessories (e.g. UHF emitter, etc.) the and including description of said one or more physical accessories (e.g. via database object information, etc.) as being at least temporarily (e.g. time spent in cold storage, etc.) near to (e.g. placed inside container, etc.) one or more food items (e.g. edible frog, etc.) via at least in part one or more electronic databases (e.g. electronic database at residential food location to report details regarding shipments received, etc.).

In one or more implementations, as shown in FIG. 79, operation o12 includes an operation o1234 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily the near to one or more food items including at least in part affixed to one or more food items. Origination of an illustratively derived receiving affixed to items component group can be accomplished through skilled in the art design choice selection of one or more of the above depicted components from one or more of the above depicted subsystems shown in FIG. 12. Components from the receiving affixed to items component group can be used in implementing execution of the one or more receiving affixed to items instructions i1234 of FIG. 34, can be used in performance of the receiving affixed to items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more receiving affixed to items instructions i1234 that when executed will direct performance of the operation o1234. Furthermore, the receiving affixed to items electrical circuitry arrangement (“elec circ arrange”) e1234, when activated, will perform the operation o1234. Also, the receiving affixed to items module m1234, when executed and/or activated, will direct performance of and/or perform the operation o1234. For instance, in one or more exemplary implementations, the one or more receiving affixed to items instructions i1234, when executed, direct performance of the operation o1234 in the illustrative depiction as follows, and/or the receiving affixed to items electrical circuitry arrangement e1234, when activated, performs the operation o1234 in the illustrative depiction as follows, and/or the receiving affixed to items module m1234, when executed and/or activated, directs performance of and/or performs the operation o1234 in the illustrative depiction as follows, and/or the operation o1234 is otherwise carried out in the illustrative depiction as follows: electronically receiving, subsequent to said electronically transmitting, (e.g. SIM card, etc.) at least a portion of residential food management response information (e.g. cold storage data for stored food materials, etc.) associated with at least in part (e.g. argue, etc.) one or more food related residential conditions (e.g. identified issues regarding one or more types of dishes prepared at the residential location, etc.) affecting (e.g. argue, etc.) residential service of (e.g. mobile kitchen food item residential preparation, etc.) one or more residential food items, (e.g. microwaved main course meal, etc.) said residential food management response information including description logged (e.g. due in part to application response delay, etc.) as being accessible through (e.g. through barcode scanning, etc.) one or more physical accessories (e.g. gyroscope, etc.) and including description of said one or more physical accessories (e.g. via CD-ROM storage, etc.) as being at least temporarily (e.g. partial time spent on retail display, etc.) the near to (e.g. welded onto container, etc.) one or more food items (e.g. feed grain, etc.) including at least in part affixed to one or more food items (e.g. label adhesively attached to whole fruit, etc.).

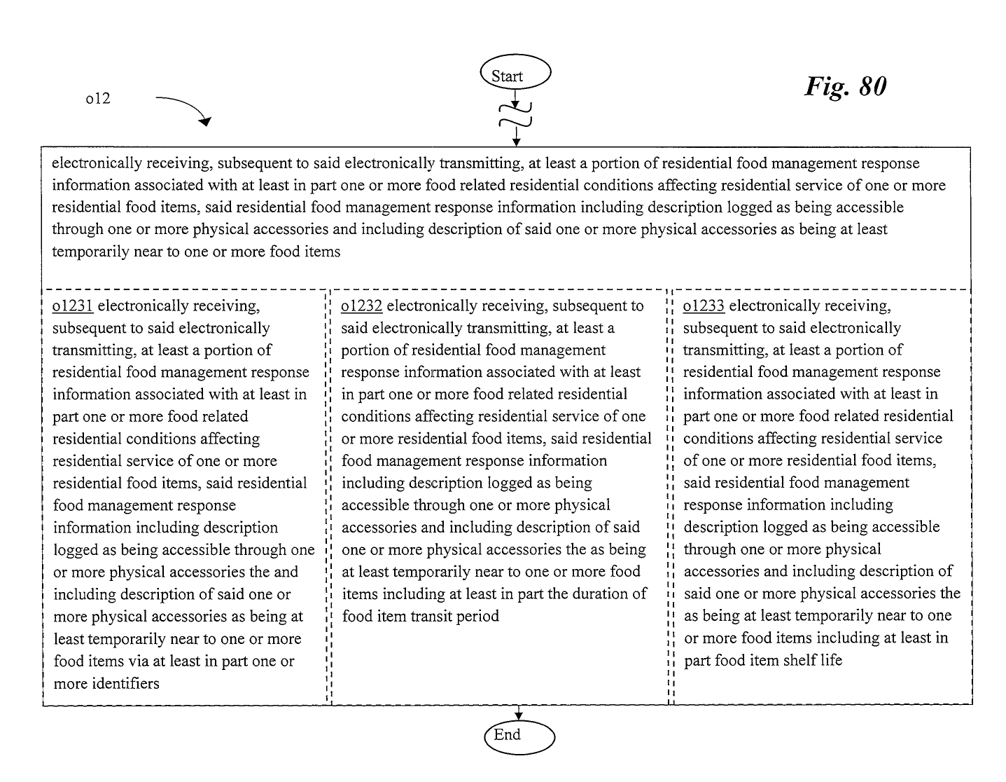

In one or more implementations, as shown in FIG. 80, operation o12 includes an operation o1231 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories the and including description of said one or more physical accessories as being at least temporarily near to one or more food items via at least in part one or more identifiers. Origination of an illustratively derived receiving identifiers component group can be accomplished through skilled in the art design choice selection of one or more of the above depicted components from one or more of the above depicted subsystems shown in FIG. 12. Components from the receiving identifiers component group can be used in implementing execution of the one or more receiving identifiers instructions i1231 of FIG. 34, can be used in performance of the receiving identifiers electrical circuitry arrangement e1231 of FIG. 27, and/or can be used in otherwise fulfillment of the operation o1231. An exemplary non-transitory signal bearing medium version of the information storage subsystem s200 is depicted in FIG. 34 as bearing the one or more receiving identifiers instructions i1231 that when executed will direct performance of the operation o1231. Furthermore, the receiving identifiers electrical circuitry arrangement (“elec circ arrange”) e1231, when activated, will perform the operation o1231. Also, the receiving identifiers module m1231, when executed and/or activated, will direct performance of and/or perform the operation o1231. For instance, in one or more exemplary implementations, the one or more receiving identifiers instructions i1231, when executed, direct performance of the operation o1231 in the illustrative depiction as follows, and/or the receiving identifiers electrical circuitry arrangement e1231, when activated, performs the operation o1231 in the illustrative depiction as follows, and/or the receiving identifiers module m1231, when executed and/or activated, directs performance of and/or performs the operation o1231 in the illustrative depiction as follows, and/or the operation o1231 is otherwise carried out in the illustrative depiction as follows: electronically receiving, subsequent to said electronically transmitting, (e.g. hardware based encryption, etc.) at least a portion of residential food management response information (e.g. document forgery, etc.) associated with at least in part (e.g. associated, etc.) one or more food related residential conditions (e.g. identified issues regarding one or more residential occupants, etc.) affecting (e.g. associated, etc.) residential service of (e.g. fine dining food item purchases, etc.) one or more residential food items, (e.g. boiled main course meal, etc.) said residential food management response information including description logged (e.g. as being immediately thereafter, etc.) as being accessible through (e.g. through electromagnetic reception, etc.) one or more physical accessories (e.g. microwave emitter, etc.) the and including description of said one or more physical accessories (e.g. via relational database, etc.) as being at least temporarily (e.g. portion of time spent in ice bath, etc.) near to (e.g. embossed on container, etc.) one or more food items (e.g. cow liver, etc.) via at least in part one or more identifiers (e.g. one or more identifiers containing textual descriptions of stock material contained therein, etc.).

In one or more implementations, as shown in FIG. 80, operation o12 includes an operation o1232 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories the as being at least temporarily near to one or more food items including at least in part the duration of food item transit period. Origination of an illustratively derived receiving transit period component group can be accomplished through skilled in the art design choice selection of one or more of the above depicted components from one or more of the above depicted subsystems shown in FIG. 12. Components from the receiving transit period component group can be used in implementing execution of the one or more receiving transit period instructions i1232 of FIG. 34, can be used in performance of the receiving transit period electrical circuitry arrangement e1232 of FIG. 27, and/or can be used in otherwise fulfillment of the operation o1232. An exemplary non-transitory signal bearing medium version of the information storage subsystem s200 is depicted in FIG. 34 as bearing the one or more receiving transit period instructions i1232 that when executed will direct performance of the operation o1232. Furthermore, the receiving transit period electrical circuitry arrangement (“elec circ arrange”) e1232, when activated, will perform the operation o1232. Also, the receiving transit period module m1232, when executed and/or activated, will direct performance of and/or perform the operation o1232. For instance, in one or more exemplary implementations, the one or more receiving transit period instructions i1232, when executed, direct performance of the operation o1232 in the illustrative depiction as follows, and/or the receiving transit period electrical circuitry arrangement e1232, when activated, performs the operation o1232 in the illustrative depiction as follows, and/or the receiving transit period module m1232, when executed and/or activated, directs performance of and/or performs the operation o1232 in the illustrative depiction as follows, and/or the operation o1232 is otherwise carried out in the illustrative depiction as follows: electronically receiving, subsequent to said electronically transmitting, (e.g. software based encryption, etc.) at least a portion of residential food management response information (e.g. poorly scheduled feedings in home residences, etc.) associated with at least in part (e.g. affected, etc.) one or more food related residential conditions (e.g. identified issues regarding one or more residential food equipment, etc.) affecting (e.g. affected, etc.) residential service of (e.g. deli aspects food item residential preparation, etc.) one or more residential food items, (e.g. smoked main course meal, etc.) said residential food management response information including description logged (e.g. as being thereafter due to server delay, etc.) as being accessible through (e.g. through search terms, etc.) one or more physical accessories (e.g. laser ranging tracker, etc.) and including description of said one or more physical accessories (e.g. via database management layer, etc.) the as being at least temporarily (e.g. shipping time from grocery store to home, etc.) near to (e.g. debossed on material, etc.) one or more food items (e.g. goat milk, etc.) including at least in part the duration of food item transit period (e.g. transit period between farm and grocer and residential food location, etc.).

In one or more implementations, as shown in FIG. 80, operation o12 includes an operation o1233 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories the as being at least temporarily near to one or more food items including at least in part food item shelf life. Origination of an illustratively derived receiving shelf life component group can be accomplished through skilled in the art design choice selection of one or more of the above depicted components from one or more of the above depicted subsystems shown in FIG. 12. Components from the receiving shelf life component group can be used in implementing execution of the one or more receiving shelf life instructions i1233 of FIG. 34, can be used in performance of the receiving shelf life electrical circuitry arrangement e1233 of FIG. 27, and/or can be used in otherwise fulfillment of the operation o1233. An exemplary non-transitory signal bearing medium version of the information storage subsystem s200 is depicted in FIG. 34 as bearing the one or more receiving shelf life instructions i1233 that when executed will direct performance of the operation o1233. Furthermore, the receiving shelf life electrical circuitry arrangement (“elec circ arrange”) e1233, when activated, will perform the operation o1233. Also, the receiving shelf life module m1233, when executed and/or activated, will direct performance of and/or perform the operation o1233. For instance, in one or more exemplary implementations, the one or more receiving shelf life instructions i1233, when executed, direct performance of the operation o1233 in the illustrative depiction as follows, and/or the receiving shelf life electrical circuitry arrangement e1233, when activated, performs the operation o1233 in the illustrative depiction as follows, and/or the receiving shelf life module m1233, when executed and/or activated, directs performance of and/or performs the operation o1233 in the illustrative depiction as follows, and/or the operation o1233 is otherwise carried out in the illustrative depiction as follows: electronically receiving, subsequent to said electronically transmitting, (e.g. SD card, etc.) at least a portion of residential food management response information (e.g. storage room temperature. profiles, etc.) associated with at least in part (e.g. affecting, etc.) one or more food related residential conditions (e.g. identified issues regarding one or more types of food materials used to prepare one or more food items to be served, etc.) affecting (e.g. affecting, etc.) residential service of (e.g. visiting nursing food item residential preparation, etc.) one or more residential food items, (e.g. convection oven prepared main course meal, etc.) said residential food management response information including description logged (e.g. as being thereafter due in part to database retrieval times, etc.) as being accessible through (e.g. through storage retrieval, etc.) one or more physical accessories (e.g. ultrasonic emitter, etc.) and including description of said one or more physical accessories (e.g. via flat database, etc.) the as being at least temporarily (e.g. time spent in laboratory for testing, etc.) near to (e.g. embossed on material, etc.) one or more food items (e.g. whole king crab, etc.) including at least in part food item shelf life (e.g. including shelf life of broccoli packed under nitrogen gas, etc.).

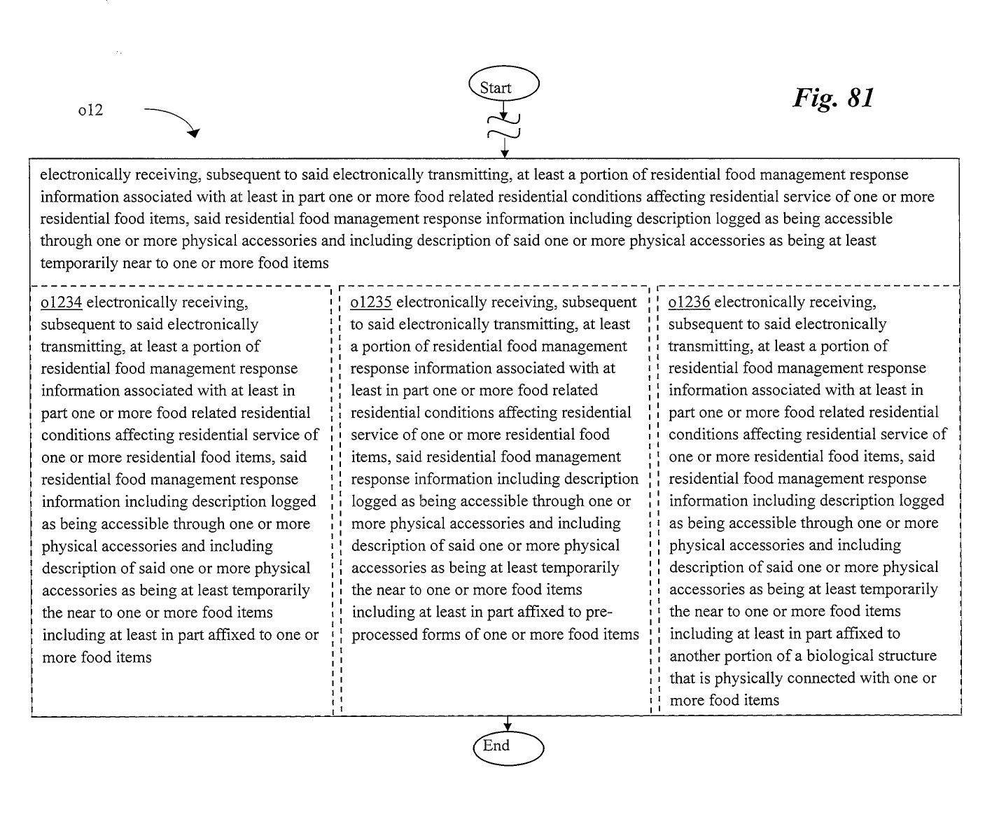

In one or more implementations, as shown in FIG. 81, operation o12 includes an operation o1234 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily the near to one or more food items including at least in part affixed to one or more food items. Origination of an illustratively derived receiving affixed to items component group can be accomplished through skilled in the art design choice selection of one or more of the above depicted components from one or more of the above depicted subsystems shown in FIG. 12. Components from the receiving affixed to items component group can be used in implementing execution of the one or more receiving affixed to items instructions i1234 of FIG. 34, can be used in performance of the receiving affixed to items electrical circuitry arrangement e1234 of FIG. 27, and/or can be used in otherwise fulfillment of the operation o1234. An exemplary non-transitory signal bearing medium version of the information storage subsystem s200 is depicted in FIG. 34 as bearing the one or more receiving affixed to items instructions i1234 that when executed will direct performance of the operation o1234. Furthermore, the receiving affixed to items electrical circuitry arrangement (“elec circ arrange”) e1234, when activated, will perform the operation o1234. Also, the receiving affixed to items module m1234, when executed and/or activated, will direct performance of and/or perform the operation o1234. For instance, in one or more exemplary implementations, the one or more receiving affixed to items instructions i1234, when executed, direct performance of the operation o1234 in the illustrative depiction as follows, and/or the receiving affixed to items electrical circuitry arrangement e1234, when activated, performs the operation o1234 in the illustrative depiction as follows, and/or the receiving affixed to items module m1234, when executed and/or activated, directs performance of and/or performs the operation o1234 in the illustrative depiction as follows, and/or the operation o1234 is otherwise carried out in the illustrative depiction as follows: electronically receiving, subsequent to said electronically transmitting, (e.g. SIM card, etc.) at least a portion of residential food management response information (e.g. cold storage data for stored food materials, etc.) associated with at least in part (e.g. argue, etc.) one or more food related residential conditions (e.g. identified issues regarding one or more types of dishes prepared at the residential location, etc.) affecting (e.g. argue, etc.) residential service of (e.g. mobile kitchen food item residential preparation, etc.) one or more residential food items, (e.g. microwaved main course meal, etc.) said residential food management response information including description logged (e.g. due in part to application response delay, etc.) as being accessible through (e.g. through barcode scanning, etc.) one or more physical accessories (e.g. gyroscope, etc.) and including description of said one or more physical accessories (e.g. via CD-ROM storage, etc.) as being at least temporarily (e.g. partial time spent on retail display, etc.) the near to (e.g. welded onto container, etc.) one or more food items (e.g. feed grain, etc.) including at least in part affixed to one or more food items (e.g. label adhesively attached to whole fruit, etc.).

In one or more implementations, as shown in FIG. 81, operation o12 includes an operation o1235 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily the near to one or more food items including at least in part affixed to pre-processed forms of one or more food items. Origination of an illustratively derived receiving affixed to pre-processed component group can be accomplished through skilled in the art design choice selection of one or more of the above depicted components from one or more of the above depicted subsystems shown in FIG. 12. Components from the receiving affixed to pre-processed component group can be used in implementing execution of the one or more receiving affixed to pre-processed instructions i1235 of FIG. 34, can be used in performance of the receiving affixed to pre-processed electrical circuitry arrangement e1235 of FIG. 27, and/or can be used in otherwise fulfillment of the operation o1235. An exemplary non-transitory signal bearing medium version of the information storage subsystem s200 is depicted in FIG. 34 as bearing the one or more receiving affixed to pre-processed instructions i1235 that when executed will direct performance of the operation o1235. Furthermore, the receiving affixed to pre-processed electrical circuitry arrangement (“elec circ arrange”) e1235, when activated, will perform the operation o1235. Also, the receiving affixed to pre-processed module m1235, when executed and/or activated, will direct performance of and/or perform the operation o1235. For instance, in one or more exemplary implementations, the one or more receiving affixed to pre-processed instructions i1235, when executed, direct performance of the operation o1235 in the illustrative depiction as follows, and/or the receiving affixed to pre-processed electrical circuitry arrangement e1235, when activated, performs the operation o1235 in the illustrative depiction as follows, and/or the receiving affixed to pre-processed module m1235, when executed and/or activated, directs performance of and/or performs the operation o1235 in the illustrative depiction as follows, and/or the operation o1235 is otherwise carried out in the illustrative depiction as follows: electronically receiving, subsequent to said electronically transmitting, (e.g. email, etc.) at least a portion of residential food management response information (e.g. stove maintenance operation, etc.) associated with at least in part (e.g. connected, etc.) one or more food related residential conditions (e.g. identified issues regarding one or more types of food items served at the residential location, etc.) affecting (e.g. connected, etc.) residential service of (e.g. street vendor food item residential preparation, etc.) one or more residential food items, (e.g. chilled main course meal, etc.) said residential food management response information including description logged (e.g. due in part to network transmission delays, etc.) as being accessible through (e.g. through radiation detection, etc.) one or more physical accessories (e.g. inertial sensor, etc.) and including description of said one or more physical accessories (e.g. via digital linear tape storage, etc.) as being at least temporarily (e.g. time on train between two terminals, etc.) the near to (e.g. bolted to container, etc.) one or more food items (e.g. sturgeon eggs, etc.) including at least in part affixed to pre-processed forms of one or more food items (e.g. RFID physical accessory clipped to raw meat, etc.).

In one or more implementations, as shown in FIG. 81, operation o12 includes an operation o1236 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily the near to one or more food items including at least in part affixed to another portion of a biological structure that is physically connected with one or more food items. Origination of an illustratively derived receiving affixed to biological component group can be accomplished through skilled in the art design choice selection of one or more of the above depicted components from one or more of the above depicted subsystems shown in FIG. 12. Components from the receiving affixed to biological component group can be used in implementing execution of the one or more receiving affixed to biological instructions i1236 of FIG. 34, can be used in performance of the receiving affixed to biological electrical circuitry arrangement e1236 of FIG. 27, and/or can be used in otherwise fulfillment of the operation o1236. An exemplary non-transitory signal bearing medium version of the information storage subsystem s200 is depicted in FIG. 34 as bearing the one or more receiving affixed to biological instructions i1236 that when executed will direct performance of the operation o1236. Furthermore, the receiving affixed to biological electrical circuitry arrangement (“elec circ arrange”) e1236, when activated, will perform the operation o1236. Also, the receiving affixed to biological module m1236, when executed and/or activated, will direct performance of and/or perform the operation o1236. For instance, in one or more exemplary implementations, the one or more receiving affixed to biological instructions i1236, when executed, direct performance of the operation o1236 in the illustrative depiction as follows, and/or the receiving affixed to biological electrical circuitry arrangement e1236, when activated, performs the operation o1236 in the illustrative depiction as follows, and/or the receiving affixed to biological module m1236, when executed and/or activated, directs performance of and/or performs the operation o1236 in the illustrative depiction as follows, and/or the operation o1236 is otherwise carried out in the illustrative depiction as follows: electronically receiving, subsequent to said electronically transmitting, (e.g. peer to peer, etc.) at least a portion of residential food management response information (e.g. electricity usage, etc.) associated with at least in part (e.g. commit to, etc.) one or more food related residential conditions (e.g. identified issues regarding one or more procedures used to prepare one or more food items at the residential location, etc.) affecting (e.g. commit to, etc.) residential service of (e.g. elderly home food item residential preparation, etc.) one or more residential food items, (e.g. steamed main course meal, etc.) said residential food management response information including description logged (e.g. via application records, etc.) as being accessible through (e.g. through genetic testing, etc.) one or more physical accessories (e.g. accelerometer, etc.) and including description of said one or more physical accessories (e.g. via hard disk drive storage, etc.) as being at least temporarily (e.g. time held in port for inspection period, etc.) the near to (e.g. stapled to container, etc.) one or more food items (e.g. shrimp, etc.) including at least in part affixed to another portion of a biological structure that is physically connected with one or more food items (e.g. physical accessory attached to grape stem, etc.).

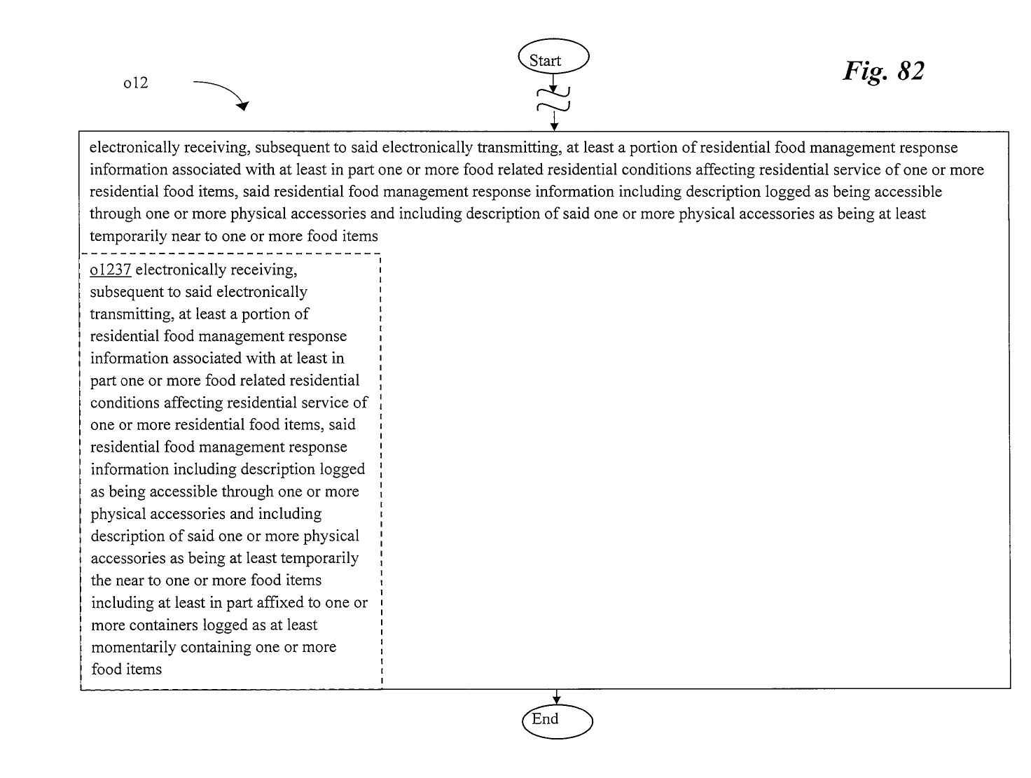

In one or more implementations, as shown in FIG. 82, operation o12 includes an operation o1237 for electronically receiving, subsequent to said electronically transmitting, at least a portion of residential food management response information associated with at least in part one or more food related residential conditions affecting residential service of one or more residential food items, said residential food management response information including description logged as being accessible through one or more physical accessories and including description of said one or more physical accessories as being at least temporarily the near to one or more food items including at least in part affixed to one or more containers logged as at least momentarily containing one or more food items. Origination of an illustratively derived receiving affixed to containers component group can be accomplished through skilled in the art design choice selection of one or more of the above depicted components from one or more of the above depicted subsystems shown in FIG. 12. Components from the receiving affixed to containers component group can be used in implementing execution of the one or more receiving affixed to containers instructions i1237 of FIG. 34, can be used in performance of the receiving affixed to containers electrical circuitry arrangement e1237 of FIG. 27, and/or can be used in otherwise fulfillment of the operation o1237. An exemplary non-transitory signal bearing medium version of the information storage subsystem s200 is depicted in FIG. 34 as bearing the one or more receiving affixed to containers instructions i1237 that when executed will direct performance of the operation o1237. Furthermore, the receiving affixed to containers electrical circuitry arrangement (“elec circ arrange”) e1237, when activated, will perform the operation o1237. Also, the receiving affixed to containers module m1237, when executed and/or activated, will direct performance of and/or perform the operation o1237. For instance, in one or more exemplary implementations, the one or more receiving affixed to containers instructions i1237, when executed, direct performance of the operation o1237 in the illustrative depiction as follows, and/or the receiving affixed to containers electrical circuitry arrangement e1237, when activated, performs the operation o1237 in the illustrative depiction as follows, and/or the receiving affixed to containers module m1237, when executed and/or activated, directs performance of and/or performs the operation o1237 in the illustrative depiction as follows, and/or the operation o1237 is otherwise carried out in the illustrative depiction as follows: electronically receiving, subsequent to said electronically transmitting, (e.g. 10-key, etc.) at least a portion of residential food management response information (e.g. residential occupant water usage, etc.) associated with at least in part (e.g. absorbed by, etc.) one or more food related residential conditions (e.g. age profile of equipment used, etc.) affecting (e.g. absorbed by, etc.) residential service of (e.g. school lunch food item residential preparation, etc.) one or more residential food items, (e.g. grilled main course meal, etc.) said residential food management response information including description logged (e.g. via operating system records, etc.) as being accessible through (e.g. through beacon signal reception, etc.) one or more physical accessories (e.g. compass, etc.) and including description of said one or more physical accessories (e.g. via index information, etc.) as being at least temporarily (e.g. time in holding bay, etc.) the near to (e.g. snapped onto container, etc.) one or more food items (e.g. domestic goose, etc.) including at least in part affixed to one or more containers logged as at least momentarily containing one or more food items (e.g. physical accessory embedded into shipping container, etc.).

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The one or more instructions discussed herein may be, for example, computer executable and/or logic-implemented instructions. In some implementations, signal-bearing medium as articles of manufacture may store the one or more instructions. In some implementations, the signal bearing medium may include a computer-readable medium. In some implementations, the signal-bearing medium may include a recordable medium. In some implementations, the signal-bearing medium may include a communication medium.

Those having skill in the art will recognize that the state of the art has progressed to the point where there is little distinction left between hardware and software implementations of aspects of systems; the use of hardware or software is generally (but not always, in that in certain contexts the choice between hardware an d software can become significant) a design choice representing cost vs. efficiency tradeoffs. Those having skill in the art will appreciate that there are various vehicles by which processes and/or systems and/or other technologies described herein can be effected (e.g., hardware, software, and/or firmware in one or more machines or articles of manufacture), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation that is implemented in one or more machines or articles of manufacture; or, yet again alternatively, the implementer may opt for some combination of hardware, software, and/or firmware in one or more machines or articles of manufacture (limited to patentable subject matter under 35 USC 101). Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware in one or more machines or articles of manufacture.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof (limited to patentable subject matter under 35 U.S.C. 101). In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure (limited to patentable subject matter under 35 USC 101). In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, (e.g., transmitter, receiver, transmission logic, reception logic, etc.), etc.).

### Electro-Mechanical System Support

In a general sense, those skilled in the art will recognize that the various embodiments described herein can be implemented, individually and/or collectively, by various types of electro-mechanical systems having a wide range of electrical components such as hardware, software, firmware, and/or virtually any combination thereof; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

### Electrical Circuitry Support

In a general sense, those skilled in the art will recognize that the various aspects described herein which can be implemented, individually and/or collectively, by a wide range of hardware, software, firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

### Image Processing System Support

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

### Data Processing System Support

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

### Software as Patentable Subject Matter Support

The claims, description, and drawings of this application may describe one or more of the instant technologies in operational/functional language, for example as a set of operations to be performed by a computer. Such operational/functional description in most instances would be understood by one skilled the art as specifically-configured hardware (e.g., because a general purpose computer in effect becomes a special purpose computer once it is programmed to perform particular functions pursuant to instructions from program software).

Importantly, although the operational/functional descriptions described herein are understandable by the human mind, they are not abstract ideas of the operations/functions divorced from computational implementation of those operations/functions. Rather, the operations/functions represent a specification for the massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to the human mind. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail in the following paragraphs, these logical operations/functions are not representations of abstract ideas, but rather representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. See, e.g., Wikipedia, High-level programming language, http://en.wikipedia.org/wiki/High-level_programming_language (as of Jun. 5, 2012, 21:00 GMT). In order to facilitate human comprehension, in many instances, high-level programming languages resemble or even share symbols with natural languages. See, e.g., Wikipedia, Natural language, http://en.wikipedia.org/wiki/Natural_language (as of Jun. 5, 2012, 21:00 GMT).

It has been argued that because high-level programming languages use strong abstraction (e.g., that they may resemble or share symbols with natural languages), they are therefore a “purely mental construct.” (e.g., that “software”—a computer program or computer programming—is somehow an ineffable mental construct, because at a high level of abstraction, it can be conceived and understood in the human mind). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors). See, e.g., Wikipedia, Logic gates, http://en.wikipedia.org/wiki/Logic_gates (as of Jun. 5, 2012, 21:03 GMT).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output. See, e.g., Wikipedia, Computer architecture, http://en.wikipedia.org/wiki/Computer_architecture (as of Jun. 5, 2012, 21:03 GMT).

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configuration, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). See, e.g., Wikipedia, Instructions per second, http://en.wikipedia.org/wiki/Instructions_per_second (as of Jun. 5, 2012, 21:04 GMT). Thus, programs written in machine language—which may be tens of millions of machine language instructions long—are incomprehensible. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that humanly useful, tangible, and concrete work is done. For example, as indicated above, such machine language—the compiled version of the higher-level language—functions as a technical specification which selects out hardware logic gates, specifies voltage levels, voltage transition timings, etc., such that the humanly useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality representative of logic(s), or (d) virtually any combination of the foregoing. Indeed, any physical object which has a stable, measurable, and changeable state may be used to construct a machine based on the above technical description. Charles Babbage, for example, constructed the first computer out of wood and powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language simply cannot be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

### Mote System Support

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software, and/or firmware.

### Licensing System Support Language

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

### Extraterritorial Use Language

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

### Residual Incorporation Language

All of the above U.S. patents, U.S. patent application publications, U.S. patent applications, foreign patents, foreign patent applications and non-patent publications referred to in this specification and/or listed in any Application Data Sheet, are incorporated herein by reference, to the extent not inconsistent herewith.

### Not Limited to Implementations Described Language

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

### Not Limited to Human User Language

Although user XXX is shown/described herein as a single illustrated figure, those skilled in the art will appreciate that user XXX may be representative of a human user, a robotic user (e.g., computational entity), and/or substantially any combination thereof (e.g., a user may be assisted by one or more robotic agents) unless context dictates otherwise. Those skilled in the art will appreciate that, in general, the same may be said of “sender” and/or other entity-oriented terms as such terms are used herein unless context dictates otherwise.

### Plural Terms Language

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

### Operably-Coupled Language

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

### Active/Inactive Component Language

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

### Cloud Computing Standard Language

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software components that deliver or assist in the delivery of computational and/or storage capacity, including, but not limited to, one or more of a client, an application, a platform, an infrastructure, and/or a server The cloud may refer to any of the hardware and/or software associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, a software back-end, and/or a software application. A cloud may refer to a private cloud, a public cloud, a hybrid cloud, and/or a community cloud. A cloud may be a shared pool of configurable computing resources, which may be public, private, semi-private, distributable, scalable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more software and/or development tools hosted on an infrastructure (e.g., a computing platform and/or a solution stack from which the client can create software interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

### Use of Trademarks in Specification Language

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

### Caselaw-Driven Clarification Language

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

1.-122. (canceled)

123. A system comprising:
an electronically interrogating module configured to operate in accordance with electronically interrogating regarding domestic ingestible material preparation information including at least in part one or more domestic ingestible material preparation aspects involved with domestic preparation of one or more domestic ingestible material selections; and
an electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections.

124.-125. (canceled)

126. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating RFID module configured to operate in accordance with the electronically interrogating regarding domestic ingestible material preparation information including at least in part one or more domestic ingestible material preparation aspects involved with domestic preparation of one or more domestic ingestible material selections through at least in part radio frequency identification (RFID).

127.-128. (canceled)

129. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating internet module configured to operate in accordance with the electronically interrogating regarding domestic ingestible material preparation information including at least in part one or more domestic ingestible material preparation aspects involved with domestic preparation of one or more domestic ingestible material selections via at least in part internet communication.

130.-131. (canceled)

132. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating memory cards module configured to operate in accordance with the electronically interrogating regarding domestic ingestible material preparation information including at least in part one or more domestic ingestible material preparation aspects involved with domestic preparation of one or more domestic ingestible material selections via at least in part access to one or more memory cards.

133.-134. (canceled)

135. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating video content module configured to operate in accordance with electronically interrogating the regarding domestic ingestible material preparation information including at least in part one or more domestic ingestible material preparation aspects involved with domestic preparation of one or more domestic ingestible material selections at least in part regarding video content information.

136.-137. (canceled)

138. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating human behavior module configured to operate in accordance with electronically interrogating the regarding domestic ingestible material preparation information including at least in part one or more domestic ingestible material preparation aspects involved with domestic preparation of one or more domestic ingestible material selections at least in part regarding human behavior.

139.-140. (canceled)

141. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating sources used module configured to operate in accordance with electronically interrogating the regarding domestic ingestible material preparation information including at least in part one or more domestic ingestible material preparation aspects involved with domestic preparation of one or more domestic ingestible material selections including at least in part regarding one or more sources of one or more ingestible materials used to prepare one or more domestic ingestible material selections.

142.-143. (canceled)

144. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating aspect handling module configured to operate in accordance with electronically interrogating the regarding domestic ingestible material preparation information including at least in part one or more domestic ingestible material preparation aspects involved with domestic preparation of one or more domestic ingestible material selections at least in part including regarding one or more domestic ingestible material preparation aspect handling of one or more domestic ingestible material aspects.

145.-146. (canceled)

147. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating test handling module configured to operate in accordance with electronically interrogating the regarding domestic ingestible material preparation information including at least in part one or more domestic ingestible material preparation aspects involved with domestic preparation of one or more domestic ingestible material selections at least in part including regarding test information regarding handling of domestic ingestible material preparation related items.

148.-149. (canceled)

150. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating health status module configured to operate in accordance with electronically interrogating the regarding domestic ingestible material preparation information including at least in part one or more domestic ingestible material preparation aspects involved with domestic preparation of one or more domestic ingestible material selections at least in part including regarding test information regarding health status of one or more humans involved with one or more domestic ingestible material preparation activities.

151.-152. (canceled)

153. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating human behavior module configured to operate in accordance with electronically interrogating the regarding domestic ingestible material preparation information including at least in part one or more domestic ingestible material preparation aspects involved with domestic preparation of one or more domestic ingestible material selections at least in part including regarding human behavior.

154.-155. (canceled)

156. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating staff ordering module configured to operate in accordance with electronically interrogating the regarding domestic ingestible material preparation information including at least in part one or more domestic ingestible material preparation aspects involved with domestic preparation of one or more domestic ingestible material selections at least in part as domestic ingestible material preparation staff ordering information of one or more ingredients for one or more domestic ingestible material selections.

157.-158. (canceled)

159. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating fat factors module configured to operate in accordance with electronically interrogating regarding domestic ingestible material preparation information including at least in part the one or more domestic ingestible material preparation aspects involved with domestic preparation of one or more domestic ingestible material selections including at least in part one or more fat factors involved with one or more domestic ingestible material preparation activity aspects.

160.-161. (canceled)

162. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating refrigeration factors module configured to operate in accordance with electronically interrogating regarding domestic ingestible material preparation information including at least in part the one or more domestic ingestible material preparation aspects involved with domestic preparation of one or more domestic ingestible material selections including at least in part one or more refrigeration factors involved with one or more domestic ingestible material preparation activity aspects.

163.-164. (canceled)

165. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating equipment use module configured to operate in accordance with electronically interrogating regarding domestic ingestible material preparation information including at least in part the one or more domestic ingestible material preparation aspects involved with domestic preparation of one or more domestic ingestible material selections including at least in part one or more equipment use factors involved with one or more domestic ingestible material preparation activity aspects.

166.-167. (canceled)

168. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating domestic occupant module configured to operate in accordance with electronically interrogating regarding domestic ingestible material preparation information including at least in part the one or more domestic ingestible material preparation aspects involved with domestic preparation of one or more domestic ingestible material selections including at least in part one or more domestic occupant related factors involved with one or more domestic ingestible material preparation activity aspects.

169.-170. (canceled)

171. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating compliance factors module configured to operate in accordance with electronically interrogating regarding domestic ingestible material preparation information including at least in part the one or more domestic ingestible material preparation aspects involved with domestic preparation of one or more domestic ingestible material selections including at least in part one or more compliance factors for one or more domestic ingestible material preparation activity aspects.

172.-173. (canceled)

174. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating module configured to operate in accordance with electronically interrogating regarding domestic ingestible material preparation information including at least in part the one or more domestic ingestible material preparation aspects involved with domestic preparation of one or more domestic ingestible material selections including at least in part one or more harvest locations of one or more food ingredients factors involved with one or more domestic ingestible material preparation activity aspects.

175.-176. (canceled)

177. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating food freshness module configured to operate in accordance with electronically interrogating regarding domestic ingestible material preparation information including at least in part the one or more domestic ingestible material preparation aspects involved with domestic preparation of one or more domestic ingestible material selections including at least in part one or more food freshness aspects involved with one or more domestic ingestible material preparation activity aspects.

178.-179. (canceled)

180. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating toxin levels module configured to operate in accordance with electronically interrogating regarding domestic ingestible material preparation information including at least in part the one or more domestic ingestible material preparation aspects involved with domestic preparation of one or more domestic ingestible material selections including at least in part one or more toxin levels in food involved with one or more domestic ingestible material preparation activity aspects.

181.-182. (canceled)

183. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating food dishes module configured to operate in accordance with electronically interrogating regarding domestic ingestible material preparation information including at least in part one or more domestic ingestible material preparation aspects involved with the domestic preparation of one or more domestic ingestible material selections including at least in part preparing one or more food dishes for consumption by domestic occupants.

184.-185. (canceled)

186. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating dispensing machines module configured to operate in accordance with electronically interrogating regarding domestic ingestible material preparation information including at least in part one or more domestic ingestible material preparation aspects involved with the domestic preparation of one or more domestic ingestible material selections including at least in part dispensing one or more domestic ingestible material selections by one or more dispensing machines.

187.-188. (canceled)

189. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating full course module configured to operate in accordance with electronically interrogating regarding domestic ingestible material preparation information including at least in part one or more domestic ingestible material preparation aspects involved with the domestic preparation of one or more domestic ingestible material selections including at least in part purchasing whole produce to be used in preparation of one or more full course meals.

190.-191. (canceled)

192. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating carryout meals module configured to operate in accordance with electronically interrogating regarding domestic ingestible material preparation information including at least in part one or more domestic ingestible material preparation aspects involved with domestic preparation of the one or more domestic ingestible material selections including at least in part one or more carryout meals.

193.-194. (canceled)

195. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating beef dishes module configured to operate in accordance with electronically interrogating regarding domestic ingestible material preparation information including at least in part one or more domestic ingestible material preparation aspects involved with domestic preparation of the one or more domestic ingestible material selections including at least in part domestic ingestible material selections for one or more beef dishes.

196.-197. (canceled)

198. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating diary items module configured to operate in accordance with electronically interrogating regarding domestic ingestible material preparation information including at least in part one or more domestic ingestible material preparation aspects involved with domestic preparation of the one or more domestic ingestible material selections including at least in part domestic ingestible material selections for one or more diary items.

199.-200. (canceled)

201. The system of claim 123, wherein the electronically interrogating module configured to operate in accordance with electronically interrogating regarding domestic ingestible material preparation information including at least in part one or more domestic ingestible material preparation aspects involved with domestic preparation of one or more domestic ingestible material selections comprises:
an interrogating appetizer items module configured to operate in accordance with electronically interrogating regarding domestic ingestible material preparation information including at least in part one or more domestic ingestible material preparation aspects involved with domestic preparation of the one or more domestic ingestible material selections including at least in part domestic ingestible material selections for one or more appetizer items.

202.-203. (canceled)

204. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying wireless protocols module configured to operate in accordance with the electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections via at least in part one or more wireless communication protocols.

205.-206. (canceled)

207. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying cell phone module configured to operate in accordance with the electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections as least in part cell phone system traffic.

208.-209. (canceled)

210. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying encrypted identification module configured to operate in accordance with electronically conveying, subsequent to said electronically interrogating, domestic ingestible material preparation information including at least in part one or more domestic ingestible material preparation aspects involved with domestic preparation of one or more domestic ingestible material selections the said domestic ingestible material preparation information including identification information recorded as being retained in one or more information retainers and identifying said one or more information retainers as being at least momentarily in proximity to one or more substances related to said domestic preparation of one or more domestic ingestible material selections including at least in part one or more electronically encrypted identification.

211.-212. (canceled)

213. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying encoded data module configured to operate in accordance with electronically conveying, subsequent to said electronically interrogating, domestic ingestible material preparation information including at least in part one or more domestic ingestible material preparation aspects involved with domestic preparation of one or more domestic ingestible material selections the said domestic ingestible material preparation information including identification information recorded as being retained in one or more information retainers and identifying said one or more information retainers as being at least momentarily in proximity to one or more substances related to said domestic preparation of one or more domestic ingestible material selections including at least in part one or more electronically encoded data packets.

214.-215. (canceled)

216. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying quick response module configured to operate in accordance with electronically conveying, subsequent to said electronically interrogating, domestic ingestible material preparation information including at least in part one or more domestic ingestible material preparation aspects involved with domestic preparation of one or more domestic ingestible material selections the said domestic ingestible material preparation information including identification information recorded as being retained in one or more information retainers and identifying said one or more information retainers as being at least momentarily in proximity to one or more substances related to said domestic preparation of one or more domestic ingestible material selections including at least in part one or more electronic quick response codes.

217.-218. (canceled)

219. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying radio frequency module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in the one or more information retainers and identifying said one or more information retainers as being at least momentarily in proximity to one or more substances related to said domestic preparation of one or more domestic ingestible material selections include at least in part one or more radio frequency identification information retainers.

220.-221. (canceled)

222. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying genetic retainers module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in the one or more information retainers and identifying said one or more information retainers as being at least momentarily in proximity to one or more substances related to said domestic preparation of one or more domestic ingestible material selections include at least in part one or more genetic information retainers.

223.-224. (canceled)

225. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying isotopic retainers module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in the one or more information retainers and identifying said one or more information retainers as being at least momentarily in proximity to one or more substances related to said domestic preparation of one or more domestic ingestible material selections include at least in part one or more isotopic information retainers.

226.-227. (canceled)

228. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying identification retainers module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in the one or more information retainers and identifying said one or more information retainers as being at least momentarily in proximity to one or more substances related to said domestic preparation of one or more domestic ingestible material selections include at least in part one or more identification information retainers.

229.-230. (canceled)

231. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying audio emitters module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in the one or more information retainers and identifying said one or more information retainers as being at least momentarily in proximity to one or more substances related to said domestic preparation of one or more domestic ingestible material selections include at least in part one or more audio emitters.

232.-233. (canceled)

234. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying identifiers module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers the and identifying said one or more information retainers as being at least momentarily in proximity to one or more substances related to said domestic preparation of one or more domestic ingestible material selections via at least in part one or more identifiers.

235.-236. (canceled)

237. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying affixed to selections module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily the in proximity to one or more substances related to said domestic preparation of one or more domestic ingestible material selections including at least in part affixed to one or more domestic ingestible material selections.

238.-239. (canceled)

240. The system of claim 123, wherein the electronically conveying module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections comprises:
a conveying containing selections module configured to operate in accordance with electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily the in proximity to one or more substances related to said domestic preparation of one or more domestic ingestible material selections including at least in part affixed to one or more containers logged as at least momentarily containing one or more domestic ingestible material selections.

241. An article of manufacture comprising:
one or more non-transitory signal bearing storage medium bearing:
one or more electronically interrogating instructions for electronically interrogating regarding domestic ingestible material preparation information including at least in part one or more domestic ingestible material preparation aspects involved with domestic preparation of one or more domestic ingestible material selections; and
one or more electronically conveying instructions for electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections.

242.-245. (canceled)

246. A system comprising:
one or more computing devices; and
one or more instructions when executed on the one or more computing devices cause the one or more computing devices to perform
electronically interrogating regarding domestic ingestible material preparation information including at least in part one or more domestic ingestible material preparation aspects involved with domestic preparation of one or more domestic ingestible material selections; and
electronically conveying, subsequent to said electronically interrogating, domestic ingestible material preparation information including at least in part one or more domestic ingestible material preparation aspects involved with domestic preparation of one or more domestic ingestible material selections said domestic ingestible material preparation information including identification information recorded as being retained in one or more information retainers and identifying said one or more information retainers as being at least momentarily in proximity to one or more substances related to said domestic preparation of one or more domestic ingestible material selections.

247. (canceled)
